(19) United States
(12) Patent Application Publication
(10) Pub. No.: US 2014/0310746 A1
(43) Pub. Date: Oct. 16, 2014

(54) DIGITAL ASSET MANAGEMENT, AUTHORING, AND PRESENTATION TECHNIQUES

(71) Applicants: Jeffrey Ward Larsen, Boulder, CO (US); Andrew Smith, Boulder, CO (US); Gavin Maurer, Aurora, CO (US); Kevin Johnson, Nederland, CO (US); Damon Amiotes, Superior, CO (US); Dean E. Wolf, Boulder, CO (US)

(72) Inventors: Jeffrey Ward Larsen, Boulder, CO (US); Andrew Smith, Boulder, CO (US); Gavin Maurer, Aurora, CO (US); Kevin Johnson, Nederland, CO (US); Damon Amiotes, Superior, CO (US); Dean E. Wolf, Boulder, CO (US)

(73) Assignee: INTHETELLING.COM, INC., Boulder, CO (US)

(21) Appl. No.: 14/316,765

(22) Filed: Jun. 26, 2014

Related U.S. Application Data
(63) Continuation of application No. 13/358,493, filed on Jan. 25, 2012.
(60) Provisional application No. 61/436,998, filed on Jan. 27, 2011.

(51) Int. Cl. H04N 21/43; H04N 21/81; H04N 21/2343; H04N 21/431; H04N 21/242; H04N 21/439; H04N 21/233; H04N 21/235; H04N 21/2368; H04N 21/8547; H04N 21/435

(52) U.S. Cl. CPC H04N 21/4302; H04N 21/8547; H04N 21/8106; H04N 21/8133; H04N 21/234336; H04N 21/4316; H04N 21/435; H04N 21/439; H04N 21/233; H04N 21/235; H04N 21/2368; H04N 21/242
USPC 725/37

(57) ABSTRACT

Various techniques are disclosed for authoring and/or presenting packages of multimedia content. In at least one embodiment, the digital multimedia package may include video content, audio content, and text transcription content representing a transcription of the audio content. The video content, audio content, and text transcription content are each maintained in continuous synchronization with each other during video playback, and also as a user selectively navigates to different scenes of the video content. The text transcription content is presented via an interactive Resources Display GUI. Interacting with the Resources Display GUI, a user may cause the displayed text to dynamically scroll to a different portion of the text transcription corresponding to a different scene of the video. In response, the concurrent presentation of video content may automatically and dynamically change to display video content corresponding to the scene associated with the text transcription currently displayed in the Resources Display GUI.

### RELATED APPLICATION DATA

This application is a continuation application, pursuant to the provisions of 35 U.S.C. §120, of prior U.S. patent application Ser. No. 13/358,493 (Attorney Docket No. TELLP001C1) titled “DIGITAL ASSET MANAGEMENT, AUTHORING, AND PRESENTATION TECHNIQUES” by LARSEN et al., filed on 25 Jan. 2012, the entirety of which is incorporated herein by reference for all purposes.

U.S. patent application Ser. No. 13/358,493 claims benefit, pursuant to the provisions of 35 U.S.C. §119, of U.S. Provisional Application Ser. No. 61/436,998 (Attorney Docket No. TELLP001P), titled “DIGITAL ASSET MANAGEMENT, AUTHORING, AND PRESENTATION TECHNIQUES”, naming Larsen et al. as inventors, and filed 27 Jan. 2011, the entirety of which is incorporated herein by reference for all purposes.

### BACKGROUND

The present disclosure relates to gaming machines such as slot machines and video poker machines. More particularly, the present disclosure describes various techniques relating to digital asset management, authoring, and presentation.

### BRIEF DESCRIPTION OF THE DRAWINGS

FIG. 1 illustrates a simplified block diagram of a specific example embodiment of a Digital Asset Management, Authoring, and Presentation (DAMAP) System 100.

FIG. 2 illustrates a simplified block diagram of a specific example embodiment of a DAMAP Server System 200.

FIG. 3 shows a flow diagram of a Digital Asset Management, Authoring, and Presentation (DAMAP) Procedure in accordance with a specific embodiment.

FIG. 4 shows a simplified block diagram illustrating a specific example embodiment of a portion of Transmedia Narrative package 400.

FIG. 5 is a simplified block diagram of an exemplary client system 500 in accordance with a specific embodiment.

FIG. 6 shows a specific example embodiment of a portion of a DAMAP System, illustrating various types of information flows and communications.

FIG. 7 shows a flow diagram of a DAMAP Client Application Procedure in accordance with a specific embodiment.

FIG. 8 shows an example embodiment of different types of informational flows and business applications which may be enabled, utilized, and/or leveraged using the various functionalities and features of the different DAMAP System techniques described herein.

FIGS. 9-12 show different example embodiments of DAMAP Client Application GUIs (e.g., screenshots) illustrating various aspects/features of the social commentary and/or crowd sourcing functionality of the DAMAP system.

FIGS. 13-16, 17A, 17B, 17C, 18-20, 21A, 21B, 22A, 22B, 23-36, 37A, 37B, 38-42, 43A, 43B, 44-50 show various example embodiments of Transmedia Navigator application GUIs which may be implemented at one or more client system(s).

FIGS. 51-58, 59A, 59B, 60A, 60B, 61-62, 63A, 63B, 64A, 64B, 65-77, 78A, 78B, 79-85 show various example embodiments of Transmedia Narrative Authoring data flows, architectures, hierarchies, GUIs and/or other operations which may be involved in creating, authoring, storing, compiling, producing, editing, bundling, distributing, and/or disseminating Transmedia Narrative packages.

### DETAILED DESCRIPTION OF EXAMPLE EMBODIMENTS

### Overview

Various aspects described or referenced herein are directed to different methods, systems, and computer program products for authoring and/or presenting multimedia content comprising: identifying a digital multimedia package, wherein the digital multimedia package includes: video content, audio content, and text transcription content representing a transcription of the audio content; causing synchronous presentation of the video content, audio content, and text transcription content; wherein the synchronous presentation of the video content, audio content, and text transcription content are each maintained in continuous synchronization with each other during playback of the video content; wherein the synchronous presentation of the video content, audio content, and text transcription content are each maintained in continuous synchronization with each other as a user selectively navigates to different scenes of the video content. In at least one embodiment, the video content is presented via an interactive Video Player graphical user interface (GUI) at a display of the client system, and the text transcription content is presented via a an interactive Resources Display GUI at the display of the client system.

In some embodiments, the authoring and/or presentation of the multimedia content may include: causing a first portion of video content corresponding to a first scene to be displayed in the Video Player GUI; causing a first portion of text transcription content corresponding to the first scene to be displayed in the Resources Display GUI; wherein the display of the first portion of video content in the Video Player GUI is concurrent with the display of the first portion of text transcription content in the Resources Display GUI; receiving user input via the Resources Display GUI; causing, in response to the received user input, the presentation of text displayed in the Resources Display GUI to dynamically scroll to a second portion of the text transcription content corresponding to a second scene; and causing, in response to the received user input, the presentation of video content displayed in the Video Player GUI to dynamically display a second portion of video content corresponding to the second scene.

In some embodiments, the first portion of the video content is mapped to a first timecode value set, the first portion of the text transcription content is mapped to the first timecode value set, and the display of the first portion of video content in the Video Player GUI is concurrent with the display of the first portion of text transcription content in the Resources Display GUI. In some embodiments, the authoring and/or presentation of the multimedia content may include: receiving user input via the Resources Display GUI; causing, in response to the received user input, the presentation of text displayed in the Resources Display GUI to dynamically scroll to a second portion of the text transcription content corresponding to a second scene, wherein the second portion of the text transcription content is mapped to a second timecode value set; causing, in response to the received user input, the presentation of video content displayed in the Video Player GUI to dynamically display a second portion of video content corresponding to the second scene, wherein the second portion of video content is mapped to the second timecode value set; and wherein the display of the second portion of video content in the Video Player GUI is concurrent with the display of the second portion of text transcription content in the Resources Display GUI.

In some embodiments, the digital multimedia package further includes timecode synchronization information and additional resources such as, for example, one or more of the following (or combinations thereof): metadata, notes, games, drawings, images, diagrams, photos, assessments, documents, slides, documents, photos, games, communication threads, events, URLs, and spreadsheets. In at least one embodiment, distinct segments of the video, audio, and text content may each be mapped to a respective timecode of the timecode synchronization information. Similarly, each of the additional resources associated with the digital multimedia package may be mapped to a respective timecode of the timecode synchronization information. In some embodiments, the authoring and/or presentation of the multimedia content may include maintaining, using at least a portion of the mapped timecode information, presentation synchronization among different portions of content being concurrently displayed (e.g., at a client system display).

Other aspects described or referenced herein are directed to different methods, systems, and computer program products for automated conversion of a source video into a digital multimedia package. In at least one embodiment, the automated conversion and/or digital multimedia package authoring techniques may include: analyzing the source video for identifying specific properties and characteristics; automatically generating a text transcription of the source video's audio content using speech processing analysis; automatically generating synchronization data for use in synchronizing distinct chunks of the text transcription with respective distinct chunks of the video content; and automatically generating the digital multimedia package, wherein the digital multimedia package includes: a video content derived from the source video, an audio content derived from the source video, and a text transcription content representing a transcription of the audio content.

In at least one embodiment, the automated conversion and/or digital multimedia package authoring techniques may further include: analyzing the source video in order to automatically identify one or more different segments of the source video which match specific characteristics such as, for example, one or more of the following (or combinations thereof): voice characteristics relating to voices of different persons speaking in the audio portion of the source video; image characteristics relating to facial recognition features, color features, object recognition, and/or scene transitions; audio characteristics relating to sounds matching a particular frequency, pitch, duration, and/or pattern; etc.

In some embodiments, the automated conversion and/or digital multimedia package authoring techniques may include: analyzing the audio portion of the source video to automatically identify different vocal characteristics relating to voices of one or more different persons speaking in the audio portion of the source video; and identifying and associate selected portions of the text transcription with a particular voice identified in the audio portion of the source video.

In some embodiments, the automated conversion and/or digital multimedia package authoring techniques may include one or more of the following (or combinations thereof): identifying one or more scenes in the digital multimedia package where a selected person's face has been identified in the video content of the digital multimedia package; identifying one or more scenes in the digital multimedia package where a selected person's voice has been identified in the audio content of the digital multimedia package; identifying one or more scenes in the digital multimedia package where audio characteristics matching a specific pattern or criteria have been identified in the audio content of the digital multimedia package; identifying one or more scenes in the digital multimedia package which have been identified as being filmed at a specified geographic location; identifying one or more scenes in the digital multimedia package where image characteristics matching a specific pattern or criteria have been identified in the video content of the digital multimedia package, etc.

Various objects, features and advantages of the various aspects described or referenced herein will become apparent from the following descriptions of its example embodiments, which descriptions should be taken in conjunction with the accompanying drawings.

### SPECIFIC EXAMPLE EMBODIMENTS

Various techniques may now be described in detail with reference to a few example embodiments thereof as illustrated in the accompanying drawings. In the following description, numerous specific details are set forth in order to provide a thorough understanding of one or more aspects and/or features described or reference herein. It may be apparent, however, to one skilled in the art, that one or more aspects and/or features described or reference herein may be practiced without some or one or more of these specific details. In other instances, well known process steps and/or structures have not been described in detail in order to not obscure some of the aspects and/or features described or reference herein.

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art may recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It may be understood, however, that such features are not limited to usage in the one or more particular embodiments or figures with reference to which they are described. The present disclosure is neither a literal description of one or more embodiments of one or more of the invention(s) nor a listing of features of one or more of the invention(s) that may be present in one or more embodiments.

Headings of sections provided in this patent application and the title of this patent application are for convenience only, and are not to be taken as limiting the disclosure in any way.

Devices that are in communication with at least one other need not be in continuous communication with at least one other, unless expressly specified otherwise. In addition, devices that are in communication with at least one other may communicate directly or indirectly through one or more intermediaries.

A description of an embodiment with several components in communication with at least one other does not imply that one or more such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it may be readily apparent that more than one device/article (whether or not they cooperate) may be used in place of a single device/article. Similarly, where more than one device or article is described (whether or not they cooperate), it may be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

Techniques and mechanisms described or reference herein may sometimes be described in singular form for clarity. However, it may be noted that particular embodiments include multiple iterations of a technique or multiple instantiations of a mechanism unless noted otherwise.

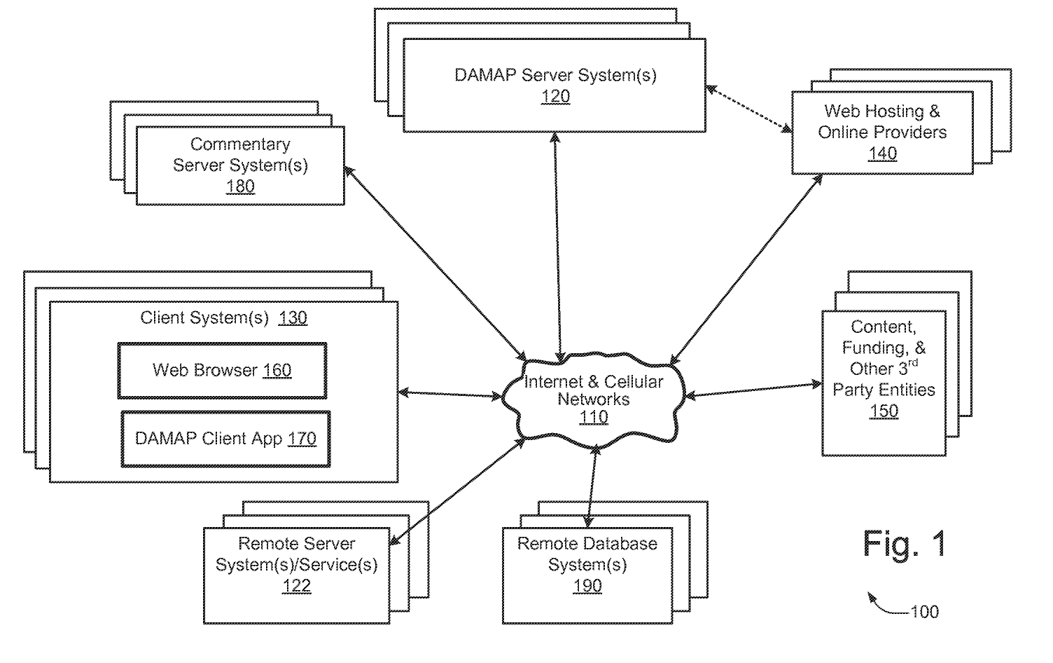

FIG. 1 illustrates a simplified block diagram of a specific example embodiment of a Digital Asset Management, Authoring, and Presentation System 100 that may be implemented in network portion 100. As described in greater detail herein, different embodiments of Digital Asset Management, Authoring, and Presentation Systems may be configured, designed, and/or operable to provide various different types of operations, functionalities, and/or features generally relating to Digital Asset Management, Authoring, and Presentation System (herein “DAMAP System”) technology. Further, as described in greater detail herein, many of the various operations, functionalities, and/or features of the DAMAP System(s) disclosed herein may provide may enable or provide different types of advantages and/or benefits to different entities interacting with the DAMAP System(s).

For example, according to different embodiments, at least some DAMAP System(s) may be configured, designed, and/or operable to provide a number of different advantages and/or benefits and/or may be operable to initiate, and/or enable various different types of operations, functionalities, and/or features, such as, for example, one or more of the following (or combinations thereof):
Automatically add digital camera feeds, voice recognition, voice transcriptions, time stamping, thumbnail images, dynamic external data, and other forms of metadata to audio/video files and streams ingested into, edited, and displayed through the DAMAP Systems.
Automatically generate indexes to synchronize ingested, edited, and displayed audio/video files and streams with other text, graphic, web-based, and programmatic files and features that comprise the DAMAP Systems.
Automatically export open HTML5 and proprietary run-time files and routines that maintain synchronized relationships between audio/video files and streams and other text, graphic, web-based, and programmatic files and features that comprise the DAMAP Systems.
Blending voice, music, text, graphics, audio, video, interactive features, web resources, and various forms of metadata into searchable multimedia narratives that provide a greater variety of multi-sensory learning opportunities than do existing DAMAP System technologies.
Addressing the special needs of people with learning challenges including Attention Deficit Disorder, blindness, deafness, dyslexia, etc.
Delivering a more video-centric alternative to the market for e-readers by creating media products that transcribe one or more narrative video/audio elements into text files that are synchronized and displayed alongside their companion video/audio files and streams.
Overcoming the search capabilities of present “closed caption” video-based systems by making one or more media content searchable based on keywords, descriptions, and other metadata include literal transcriptions of the spoken word.
Allowing users to annotate video/audio streams and files with built-in text entry, camera and microphone recording capabilities of their multimedia device, and through social media and crowd sourcing sites, thereby expanding the content stored, metadata-tagged, indexed, and available to the DAMAP System(s).
Improving the integration of multimedia files, streams, and features by linking them through time-based indexes rather than page-based, folder-based, or other “static” integration methods.
Significantly reducing the time to develop synchronized, multimedia narratives by automating and linking processes that are presently accomplished manually
In at least one embodiment, the DAMAP System's architecture may combine (e.g., on the same platform), video, transcribed scrolling text that is time-synced to the video, URLs that may be synced to the video, SoundSync verbal narrative synced to the video, user profile, user calendar, course schedules, ability to chat with group members, assessments, slides, photos, games, spreadsheets, and a notes function.
The DAMAP System may also include other visual features such as games, drawings, diagrams, photos, assessments, slides, documents, photos, games, spreadsheets, and 3D renderings. Terms, phrases, and visual metatags enable a smart search that encompasses text and video elements. The video, text, and notes functions may be combined on one screen, and at least one may also be shown separately on the screen.
In at least one embodiment, the video, text, notes, games, drawings, diagrams, photos, assessments, slides, documents, photos, games, spreadsheets, and 3D renderings functions may be linked by time. As the video plays, the text scrolls with the video. If the user scrolls forward or backward in the text file, the video may move to the point in the production that matches that point in the text. The user may also move the video forward or backward in time, and the text may automatically scroll to that point in the production that matches the same point in the video.
In at least one embodiment, the video, text, and notes functions may be linked by time. As the video plays, the text scrolls with the video. If the user scrolls forward or backward in the text file, the video may move to the point in the production that matches that point in the text. The user may also move the video forward or backward in time, and the text may automatically scroll to that point in the production that matches the same point in the video.
In at least one embodiment, the notes function enables the user to take notes via the keypad, and also to copy notes from the text and paste them into the notepad. This copy/paste into notes also creates a time-stamp and bookmark so that the user may go to any note via the bookmark, touch the bookmark, and the video and text go immediately to that moment in the video/text that corresponds with the original note.
URL's: As the video is playing, corresponding URLs may be displayed
In at least one embodiment, the video screen may be maximized to encompass the entire screen by placing fingers on the video screen and spreading them. The video screen may be brought back to its original size by placing fingers on the screen and pinching them.
The DAMAP technology application(s) work may be configured or designed to operate on iPad, iPhone, iPod, Mac products, Windows 7 products, and/or on other tablet platforms such as Android, etc.
In at least one embodiment, portions of the DAMAP technology functionality could also be available as a Java app on web sites. For example, in one embodiment, a DAMAP technology application may be configured or designed to combine video, time-synced text (SoundSync), and possibly a notes function as in the DAMAP technology tablet app. Terms, phrases, and visual metatags also enable a smart search that encompasses text and video elements.
Steps in the process may include creating and shooting a video, creating a set of metatags that match the video and text, creating a text file of the video (this may also be automated), time-stamping and time-coding the text to match the video, syncing the video and text files, formatting the text and video for display.
As the automation process is incorporated, text files may be dragged and dropped into the video to facilitate efficient processing.
Cascading style sheets that may be automatically associated with text, graphic, game, and video files and streams.
In at least one embodiment, the DAMAP System may be operable to blend voice, music, text, graphics, audio, video, interactive features, web resources, and various forms of metadata into searchable multimedia narratives that provide a greater variety of multi-sensory learning opportunities than do existing multimedia technologies.
In at least one embodiment, the DAMAP System may be utilized to provide users with a more engaging, story-based learning experience. For example, by synchronizing original documentary narratives with transcripts and written analyses, multimedia case studies may be produced which provide users with the flexibility to access content in multiple ways, depending on their learning needs. Users may also be provided with interactive exhibits and data, allowing them to manipulate information to more fully pursue their ideas. By merging text, audio, video, note taking, crowd-sourcing, and web-based interactivity, the DAMAP Client Application makes searching and referencing of content significantly easier. Case study content is easily updated through connections to the company's server-based ReelContent Library.
In at least one embodiment, the DAMAP System may combine video, transcribed text that is time-synced to the video, URLs that are synced to the video, and notes on the same platform. Terms, phrases, and visual metadata tags enable a smart search that encompasses text and video elements. The video, text, and notes functions may be combined on one screen, and at least one may also be shown separately on the screen.
In at least one embodiment, the video, text, and notes functions are linked by time. As the video plays, the text scrolls with the video. If the user scrolls forward or backward in the text file, the video may move to the point in the production that matches that point in the text. The user may also move the video forward or backward in time, and the text may automatically scroll to that point in the production that matches the same point in the video.
In at least one embodiment, the notes function enables the user to take notes via the keypad, and also to copy notes from the text and paste them into the notepad. This copy/paste into notes also creates a time-stamp and bookmark so that the user may go to any note via the bookmark, touch the bookmark, and the video and text go immediately to that moment in the video/text that corresponds with the original note.
In at least one embodiment, the video screen may be maximized to encompass the entire screen by placing fingers on the video screen and spreading them. The video screen may be brought back to its original size by placing fingers on the screen and pinching them.
In at least one embodiment, the DAMAP System may be configured or designed to facilitate crowd-sourcing operations. For example, crowd-sourcing enables users and instructors to engage in ongoing dialogue and discussions about the cases.
According to different embodiments, the DAMAP client application may be configured or designed to work on iPads, iPhones, iPods, tablets, and/or other computing devices such as, for example Android tablets and Windows 7 devices, Apple computing devices, PC computing devices, the Internet, etc. The DAMAP System may also be implemented or configured as a Java app on web sites.
Addresses the special needs of people with learning challenges including Attention Deficit Disorder, blindness, deafness, dyslexia, etc.
Takes a video-centric approach for creating more immersive, engaging learning experiences.
Overcomes the search capabilities of present “closed caption” video-based systems by making one or more media content searchable based on keywords, descriptions, and other metadata, including literal transcriptions of the spoken word.
Improves the integration of multimedia files, streams, and features by linking them through time-based indexes rather than page-based, folder-based, or other “static” integration methods.
Significantly reduces the time to develop synchronized, multimedia narratives by automating and linking processes that are presently accomplished manually.
Enables crowd-sourcing commentary within the context of a presentation or video so users may maintain an ongoing dialogue about the case studies.
Creates a new video-centric, multi-sensory communication model: The Transmedia Narrative
Transforms read-only text into read/watch/listen/photo/interact “Transmedia Narratives”
Blends one or more forms of digital media along the timeline of a Transmedia Narrative
Addresses a wide variety of learning styles
Offers multi-language translation support
Replaces typical e-book readers and video player apps with an integrated content solution
Lowers product development costs by authoring within a digital asset management system
Synchronizes video with one or more of the following (or combinations thereof): video transcripts; survey questions or test assessments; Web pages; interactive games; crowd-sourced commentary; e-commerce sales opportunities; interactive spreadsheets; photos; documents; games; advertisements, etc.
Enables one or more of the following (or combinations thereof): video display and navigation; video searches; video bookmarks; video commentary in cloud-computing database; video transcript copy/paste; video transcript note-taking; users to perform reading (book mode); users to perform listening (audio book mode); users to perform watching (video mode); users to perform surfing (Web mode); users to perform interacting (game mode); users to perform commenting (chat mode); users to perform testing (assessment mode); users to interact with one or more modes simultaneously (e.g., multi-screen viewing mode); use of content relevant hyperlinks, editable spreadsheets, linked note-taking, content linked bookmarking, etc.; users to engage in social networking interactions (e.g., time code synchronized messaging, etc.); etc.
Provides and facilitates Video Narrative production services, creative services, and integration tools including, for example, one or more of the following (or combinations thereof):
   Production Services
   One or more phases of film and media production
   Editing, transcription, audio, voice-over
   Transcoding of digital video assets to one or more formats
   Create new assets (Simulations, animations, quizzes, etc)
   Integration of legacy content
   Video Narrative Authoring
   Rapid App authoring from digital asset management systems
   Creation of media layers for Video Narrative Apps
   API's to enable quick file transfer with a user's existing digital asset management system
   Transmedia Navigator Application Processing
   Turnkey App processing, from authoring to launch
   Liaison with App stores to ensure App approval and support
Etc.

According to different embodiments, at least a portion of the various types of functions, operations, actions, and/or other features provided by the DAMAP System may be implemented at one or more client systems(s), at one or more server systems (s), and/or combinations thereof.

According to different embodiments, the DAMAP System 100 may include a plurality of different types of components, devices, modules, processes, systems, etc., which, for example, may be implemented and/or instantiated via the use of hardware and/or combinations of hardware and software. For example, as illustrated in the example embodiment of FIG. 1, the DAMAP System may include one or more of the following types of systems, components, devices, processes, etc. (or combinations thereof):
DAMAP Server System component(s) 120
Web Hosting & Online Provider System component(s) 140
Client System component(s) 160
Content, Funding, and 3^{rd} Party Entity System component(s) 150
WAN component(s) 110
Crowd Sourcing Server System(s) 180

For purposes of illustration, at least a portion of the different types of components of a specific example embodiment of a DAMAP System may now be described in greater detail with reference to the example DAMAP System embodiment of FIG. 1.
DAMAP Server System component(s) (e.g., 120)—In at least one embodiment, the DAMAP Server System component(s) may be operable to perform and/or implement various types of functions, operations, actions, and/or other features such as, for example, one or more of the following (or combinations thereof):
   The DAMAP Server System functions include digital asset management and authoring content for presentation.
   The digital asset management component facilitates assignment of metadata to an unlimited set of media files, media streams, hyperlinks, widgets, and other digital resources with database storage on physical or virtual hard drives
   Automated and semi-automated processes for the assignment of metadata to the contents of this digital asset management component include the conversion of speech captured as audio or video files and streams into text, as well as text into speech, and the association of that text and speech with the time-code and time-base information linked to video/audio files and streams
   Various thin-client and web-based services are derived from the metadata and content stored in the digital asset management component, including advanced search, retrieval, upload, and input functions for just-in-time content editing, assembly, delivery, and storage
   Among the just-in-time functions and operations of the digital asset management component is the ability to manage the authoring new content for storage and presentation with text-editing, format conversion, time-stamping, hyper-linking,
   Authoring new content for storage or presentation involves thin client and web-based interfaces featuring input fields, drop zones, text entry, graphic creation, media enhancement, linking tools, and export features that trigger actions and associations between content elements in the digital asset management component, Internet and Intranet resources, as well as facilitating the creation of new content altogether
   Together, the digital asset management component and the authoring component manage and facilitate the dynamic assembly of content for delivery to the presentation component in the form of media files and indexes, as well as encapsulated run-time files and HTML5 content bundles
   The presentation component permits customizable thin client and web-based interfaces for viewing media files and indexes, as well as encapsulated run-time files and HTML5 content bundles generated and managed by the digital asset management and authoring environments
   What distinguishes the DAMAP Server System from other combination DAMAP systems is the tight integration of time-code and time-based audio/video files and streams with media files, media streams, hyperlinks, widgets, and other digital resources that are managed and linked to by the DAMAP Server System. In some embodiments, this tight integration of media based on time-based information is known as SoundSync™ Technology.

According to specific embodiments, multiple instances or threads of the DAMAP Server System component(s) may be concurrently implemented and/or initiated via the use of one or more processors and/or other combinations of hardware and/or hardware and software. For example, in at least some embodiments, various aspects, features, and/or functionalities of the DAMAP Server System component(s) may be performed, implemented and/or initiated by one or more of the following types of systems, components, systems, devices, procedures, processes, etc. (or combinations thereof):
The DAMAP Server System Legacy Content Conversion Component(s) 202a perform the function of disaggregating and deconstructing existing media files in order to store their constituent media elements in the digital asset management system and assign metadata to these components
Content conversion in the DAMAP System also provides for automated or semi-automated speech to text and text to speech conversion, metadata tagging, time-stamping, and file format conversion
The DAMAP Production Component(s) 202b provide for similar services as Legacy Content Conversion but also include the generation of new content or the enhancement of existing content through the management of user-based or automated inputs for text, graphics, and media enhancements via the other components of the DAMAP Server System
The Batch Processing Component(s) 204 integrate with the Legacy Content Conversion Components and DAMAP Production Components and automate or semi-automate the association of meta-data with media content stored in the Digital Asset Management component. In some embodiments, these Batch Processing Components resemble spreadsheets where meta-data is entered automatically or semi-automatically as well as programmatic scripts and routines that merge metadata with indexes associated with media content Stored in the Digital Asset Management System
The Media Content Library 206, also known in some embodiments as the ReelContent Library™, functions as a digital asset management system as well as a dynamic media server, to manage the database operations, storage, and delivery of one or more media files, media streams, hyperlinks, widgets, and other digital resources included in and associated with The Media Content Library.
The Transcription Processing Component(s) 208a automates or semi-automates the conversion of speech to text and text to speech and associates that text and speech with the appropriate metadata fields in the Media Content Library.
The Time Code And Time Sync Processing Component(s) 208b automate or semi-automate the association of time code and time stamping information with one or more media files, media streams, hyperlinks, widgets, and other digital resources included in and associated with The Media Content Library
The DAMAP Authoring Wizards 210, known in some embodiments as the iTell Authoring Environment™, features thin client and web-based Graphical User Interfaces for assembling and processing media files, media streams, hyperlinks, widgets, and other digital resources included in and associated with The Media Content Library
The DAMAP Authoring Component(s) 212, known in some embodiments as the iTell Authoring Environment™, features thin client and web-based Graphical User Interfaces for creating new and original media files, media streams, hyperlinks, widgets, and other digital resources included in and associated with The Media Content Library
The Asset File Processing Component(s) 214 automate or semi-automate the qualitative and quantitative transformation, format conversion, metadata tagging, time-stamping, transcription, and exporting of media files, media streams, hyperlinks, widgets, and other digital resources included in and associated with The Media Content Library
The Platform Conversion Component(s) 216a automate or semi-automate qualitative and quantitative transformation, format conversion, metadata tagging, time-stamping, transcription, and exporting of media files, media streams, hyperlinks, widgets, and other digital resources included in and associated with and associated with The Media Content Library for device-specific operating systems such as the iPad, iPod, iPhone, Macintosh, Windows 7, Androids, smart phones, tablet devices, and other and other operating systems and computer platforms.
The Application Delivery Component(s) 216b, referred to in at least one embodiment as the DAMAP System Player™, Blends voice, music, text, graphics, audio, video, interactive features, web resources, and various forms of metadata into searchable multimedia narratives that provide a greater variety of multi-sensory learning opportunities
Other Digital Asset Management, Authoring, System Component(s) 218 include, in at least one embodiment, integration features with Learning Management Systems, Social Media Sites, and other network-based resources

According to different embodiments, one or more different threads or instances of the DAMAP Server System component(s) may be initiated in response to detection of one or more conditions or events satisfying one or more different types of minimum threshold criteria for triggering initiation of at least one instance of the DAMAP Server System component(s). Various examples of conditions or events which may trigger initiation and/or implementation of one or more different threads or instances of the DAMAP Server System component(s) may include, but are not limited to, one or more of the following (or combinations thereof):
drag and drop media file onto a target area
text entry
change in status of web resource
user input
automatic and/or dynamic detection of one or more event(s)/condition(s)
etc.

In at least one embodiment, a given instance of the DAMAP Server System component(s) may access and/or utilize information from one or more associated databases. In at least one embodiment, at least a portion of the database information may be accessed via communication with one or more local and/or remote memory devices. Examples of different types of data which may be accessed by the DAMAP Server System component(s) may include, but are not limited to, one or more of the following (or combinations thereof):
Input data/files such as, for example, one or more of the following (or combinations thereof): video files/content, image files/content, text files/content, audio files/content, metadata, URLs, etc.
Output data/files such as, for example, one or more of the following (or combinations thereof): URL Index files; Table of Contents (TOC) files; Transcription files; Time code synchronization files; Text files; HTML files; etc.
etc.
Web Hosting & Online Provider System component(s) 140—In at least one embodiment, this may include various types of online systems and/or providers such as, for example: web hosting server systems, online content providers/publishers (such as, for example, youtube.com, Netflix.com, cnn.com, pbs.org, hbr.org, etc.), online advertisers, online merchants (e.g., Amazon.com, Apple.com, store.apple.com, etc.), online education websites, etc.
Client System component(s) 160 which, for example, may include one or more end user computing systems (e.g., iPads, notebook computers, tablets, net books, desktop computing systems, smart phones, PDAs, etc.). According to various embodiments, one or more Client Systems may include a variety of components, modules and/or systems for providing various types of functionality. For example, in at least one embodiment, at least some Client Systems may include a web browser application which is operable to process, execute, and/or support the use of scripts (e.g., JavaScript, AJAX, etc.), Plug-ins, executable code, virtual machines, HTML5, vector-based web animation (e.g., Adobe Flash), etc. In at least one embodiment, the web browser application may be configured or designed to instantiate components and/or objects at the Client Computer System in response to processing scripts, instructions, and/or other information received from a remote server such as a web server. Examples of such components and/or objects may include, but are not limited to, one or more of the following (or combinations thereof):
   UI Components such as those illustrated, described, and/or referenced herein.
   Database Components such as those illustrated, described, and/or referenced herein.
   Processing Components such as those illustrated, described, and/or referenced herein.
   Other Components which, for example, may include components for facilitating and/or enabling the Client Computer System to perform and/or initiate various types of operations, activities, functions such as those described herein.
Content, Funding, and 3^{rd} Party Entity System component(s) 150 which, for example, may include 3^{rd} party content providers, advertisers, publishers, investors, service providers, etc.
WAN component(s) 110 which, for example, may represent local and/or wide area networks such as the Internet.
Commentary Server System(s) 180 which, for example, may be configured or designed to enable, manage and/or facilitate the exchange of user commentaries and/or other types of content/communications (e.g., crowd sourcing communications/content, social networking communications/content, etc.).
Remote Database and Storage System(s) 190.
Remote Server System(s)/Service(s) 122, which, for example, may include, but are not limited to, one or more of the following (or combinations thereof):
   Content provider servers/services
   Media Streaming servers/services
   Database storage/access/query servers/services
   Financial transaction servers/services
   Payment gateway servers/services
   Electronic commerce servers/services
   Event management/scheduling servers/services
   Etc.

### Example Features, Benefits, Advantages, Applications:

Transmedia Narratives

In at least one embodiment, a Transmedia Narrative is a story told primarily through video, displayed on a digital device like an iPad or laptop computer. However, visual media alone doesn't allow users to search for keywords, create bookmarks and highlights, or use the traditional reference features inherent with books. Transmedia Narratives therefore include words presented using scrolling text as well as voice-over audio that is synchronized to the visual media. Bonus material, exhibits, games, interactive games, assessments, Web pages, discussion threads, advertisements, and other digital resources are also synchronized with the time-base of a video or presentation.

The DAMAP Client Application

The DAMAP Client Application replaces typical e-book readers, video players, and presentation displays with an integrated content solution. The DAMAP Client Application is the first Transmedia Narrative app that synchronizes video, audio, and text with other digital media. Scroll the video and text scrolls along with it; scroll the text and the video stays in synch. Let the video or audio play and the synchronized text scrolls along with the words being said, just like closed captioning. The difference is, you may search this text, copy it to a user's Notepad, email it, bookmark the scene, and reach a deeper understanding of the Transmedia Narrative through a user's eyes, ears, and fingers.

The DAMAP Client Application creates a new video-centric, multi-sensory communication model that transforms read-only text into read/watch/listen/photo/interact Transmedia Narratives. This breakthrough technology synchronizes one or more forms of digital media, not just text and video.

The DAMAP Client Application enables users to choose from any combination of reading, listening, or watching Transmedia Narratives. The app addresses a wide variety of learning styles and individual needs including dyslexia, attention deficit disorder, and language barriers. Users may select voice-over audio in their native tongue while reading the written transcript in a second language or vice versa.

The DAMAP Transmedia Narratives are collections of videos and presentations with synchronized text and other digital resources. A video may be a short documentary film, while a presentation may be a slide show with voice over narration. In both cases, the words that you hear on the sound track are synchronized with the text transcriptions from the sound track. Whether the story began as a screen play, an interview, a speech, a book, or an essay, the DAMAP Client Application synchronizes the spoken word with the written word along a timeline.

In addition to scrolling text, the DAMAP Client Application also synchronizes other media along the timelines of videos and presentations. When a moment in the story relates contextually to a website, then that website becomes available to view. If the story calls for an interactive game to help explain a concept in depth, then that game becomes available to interact with. The same is true for test questions, graphic illustrations, online discussions, or any other digital media relevant to that part of the story—with the DAMAP Client Application, everything is in sync. Stop the video and explore the website, take the test, or interact with the game. When you're ready to continue, hit play and one or more the media in the Transmedia Narrative stays in sync.

One or more this media synchronization may be a nightmare to program by hand. The DAMAP Client Application Technologies™ has automated this process by storing one or more media assets and their associated metadata in a ReelContent Library™. That server-based architecture communicates directly with a DAMAP Authoring environment and SoundSync™ tools. Assembling Transmedia Narratives is easy in the DAMAP Authoring environment, and files export to the DAMAP Client Application in seconds.

The following examples of applicability and illustrative embodiments is intended to help illustrate some of the various types of functions, operations, actions, and/or other features which may be enabled and/or provided by the DAMAP System technology:
Education/Case studies:
   In at least one embodiment, case studies may focus on selected companies, and may be designed to be used as educational tools. At least one case is developed using the DAMAP System's video/filmmaking studios, in collaboration with experts in the field and educational experts such as professors, lecturers, users, and administrators.
   Cases may be conceptualized with the company and writers. At least one company study yields cases across a variety of disciplines, resulting in five to ten cases per company. For instance, a Transmedia Narrative case study for a solar company may include specific modules on management, marketing, entrepreneurship, organization, real estate, etc. This enables users to attain a deep understanding of the company from a number of perspectives.
   Video may be combined with SoundSync text and audio and presented to users via the DAMAP Client Application. In addition, cases may be also developed to be compatible as PDF's with video components. The student may gain access to the PDF version of the case, and while reading, may also refer to deeper information via video links to selected video portions of the case.
   The DAMAP System also provides a unique user interface enabling the user to view thumbnails of chapters and portions of chapters, then to click on that thumbnail to go to the place in the video/text that corresponds to the chapter heading.
Education/Law cases and training
   Cases may be based on specific topics, such as constitutional law, civil law, business law, criminal law, real estate law, international law, etc. Cases may be conceptualized working with experts and educators.
   Cases may be used for training (lawyers, paralegals, administrators, etc), for education (law schools, business schools, paralegal, criminal justice, etc), for continuing education for persons in the legal field, and in the court room as an adjunct to court reporting.
Education/Teachers' authoring tool
   Lectures, class notes, and other in-class presentation materials may be compiled by teachers and quickly disseminated to users to augment the class learning experience and environment. Video may be taken of the class lecture, processed, then transcribed using automatic transcription and SoundSync services. The output may be an electronic file that users may access and view or download to their computers or mobile learning devices.
Publishing
   Publishers may be looking for innovative ways to create new markets for their new works, and for their vast back catalogs. The DAMAP System works with publishers to combine their current or back catalog publications, and creates a new version of the work or portions of the work for DAMAP technology applications.
   Digital publications encompassing whole works may be created, combining video, SoundSync text, notes, and URLs to create a full learning/reading experience.
   Digital publications may be created to support specific or modularized publications. For instance, an author wishing to create a series on “best practices” may create a chapter-by-chapter, or concept-by-concept approach that uses DAMAP technology as the medium for distribution.
   Training There may be numerous ways in which DAMAP technology may be combined with publishers' works to create training publications. Publishers of technical works may use the combined video, SoundSync text, URL, notes to facilitate deeper learning along with mobile learning capabilities. Examples:
      Medical, in which DAMAP technology may be used to show video of procedures, combined with SoundSync text, diagrams, games, URLs, and notes.
      IT, in which complicated process may be described via DAMAP System's video, SoundSync text, diagrams, games, URLs, and notes.
      Criminal Justice, in which officers may be trained to respond to specific events or circumstances using DAMAP technology's video, SoundSync text, diagrams, games, URLs, and notes.
      Sales, in which sales people may be trained across a wide spectrum of topics, including prospecting, interviewing, presentations, reporting, etc, using DAMAP System's video, SoundSync text, diagrams, games, URLs, and notes.
      At least one of the training topics above may be applied to publishers' works, expanding their ability to create deeper training across digital platforms using DAMAP technology.
Entertainment/Film
   DAMAP technology may be used to enrich the film viewing experience. The film may be combined with the script, notes, text, and URLs about the actors, writers, directors, producers, filming methods, back stories, etc.
Entertainment/Television and Media
   DAMAP technology may be used to create an “out of show” experience for viewers. For example, a reality show may want to engage viewers more deeply by offering additional video, along with scripts, story lines, notes, photos, in-depth information about the settings, etc.
Entertainment/Media
   DAMAP technology may be used to repurpose content from National Geographic or Discovery—large media companies who have vast video repositories. DAMAP technology may be used to put a new face on this existing content, along with transcribed, time-synced, and SoundSynced text, as well as notes, URLs, photos, etc.
   DAMAP technology may be used by National Geographic to create a Mobile National Geographic Magazine. As the magazine was being compiled for publication, assets such as articles, photos, video, narratives, and behind-the-story glimpses may be published as an application for tablets or the web. Subscribers could receive this as an added value to their existing subscription, or the application may be sold as a separate subscription.
Entertainment/Screenwriting
   DAMAP technology may be used to enhance the screen writer's ability to combine visual elements and notes
Entertainment/dramatic direction and performances
   DAMAP technology may be used to create a holistic dramatic learning experience. For instance, for Shakespeare's “A Midsummer Night's Dream,” DAMAP technology could combine a video of the performance with the SoundSynced script, directors notes, actors' notes, and URLs to learn more about the play, the setting, the history. For at least one actor's role, DAMAP technology may be used to display only those portions of the video in which that actor plays. For directors, DAMAP technology may be used as a Director's Script, including notes from other directors, various stages of the play, notes and visuals of costumes and sets, etc.
Twideo, a new way to communicate short video messages. In at least one embodiment, the DAMAP System may be configured or designed to include Twideo functionality in which a short video message that enables users to send and receive brief video messages. Twideo content may be uploaded by the user to the DAMAP System's servers, then distributed to a chosen distribution list. Users may also go to the ReelContent Library for to select specific content using keyword/keyphrases. They may then use the DAMAP System's editing tools and wizard to create their Twideo for distribution. Twideo may also be an excellent tool for businesses wishing to send brief videos to mailing lists and contacts.

It may be appreciated that the DAMAP System of FIG. 1 is but one example from a wide range of DAMAP System embodiments which may be implemented. Other embodiments of the DAMAP System (not shown) may include additional, fewer and/or different components/features that those illustrated in the example DAMAP System embodiment of FIG. 1.

### Specific Example Embodiment(s) of Transmedia Navigators and Transmedia Narratives

The following description relates to specific example embodiments of DAMAP Client Applications implemented on various client systems. In one embodiment, the client system is assumed to be an iPad. As described herein, the term “DAMAP Client Application” may also be referred to herein by its trade name(s) Transmedia Navigator and/or Tell It App.

Transmedia Narratives

A Transmedia Narrative is a story told primarily through video, displayed on a digital device like an iPad or laptop computer. However, visual media alone doesn't allow users to search for keywords, create bookmarks and highlights, or use the traditional reference features inherent with books. Transmedia Narratives therefore include words presented using scrolling text as well as voice-over audio that is synchronized to the visual media. Bonus material, exhibits, animations, interactive simulations, assessments, Web pages, discussion threads, advertisements, and other digital resources are also synchronized with the time-base of a video or presentation.

Transmedia Narratives are collections of videos and presentations with synchronized text and other digital resources. A video may be a short documentary film, while a presentation may be a slide show with voice over narration. In both cases, the words that a user hear on the sound track are synchronized with the text transcriptions from the sound track. Whether the story began as a screen play, an interview, a speech, a book, or an essay, the Transmedia Navigator application synchronizes the spoken word with the written word along a timeline.

In addition to scrolling text, Transmedia Navigator also synchronizes other media along the timelines of videos and presentations. When a moment in the story relates contextually to a website, then that website becomes available to view. If the story calls for an interactive simulation to help explain a concept in depth, then that simulation becomes available to interact with. The same is true for test questions, graphic illustrations, online discussions, or any other digital media relevant to that part of the story—with Transmedia Navigator, everything is in sync. Stop the video and explore the website, take the test, or interact with the simulation. When you're ready to continue, hit play and one or more the media in the Visual Narrative stays in sync.

One or more this media synchronization may be a nightmare to program by hand. In at least one embodiment, the DAMAP System has automated this process by storing one or more media assets and their associated metadata in a ReelContent Library™ database. That server-based architecture may communicate directly with Transmedia Narrative authoring components and tools. Using these and other features and technology of DAMAP System, Transmedia Narratives may be easily, automatically and/or dynamically produced. Moreover, in at least one embodiment, the DAMAP System may be configured or designed to automatically and dynamically analyze, process and convert existing video files into one or more customized Transmedia Narratives.

Transmedia Navigator replaces typical e-book readers, video players, and presentation displays with an integrated content solution. Transmedia Navigator is the first Transmedia Narrative app that synchronizes video, audio, and text with other digital media. Scroll the video and text scrolls along with it; scroll the text and the video stays in synch. Let the video or audio play and the synchronized text scrolls along with the words being said. A user may search this text, copy it to the user's Notepad, email it, bookmark the scene, and reach a deeper understanding of the Transmedia Narrative through the user's eyes, ears, and fingers.

Transmedia Navigator creates a new video-centric, multi-sensory communication model that transforms read-only text into read/watch/listen/comment/interact Transmedia Narratives. This breakthrough technology synchronizes one or more forms of digital media, not just text and video. Transmedia Navigator enables users to choose from any combination of reading, listening, or watching Transmedia Narratives. The app addresses a wide variety of learning styles and individual needs including dyslexia, attention deficit disorder, and language barriers. Users may select voice-over audio in their native tongue while reading the written transcript in a second language or vice versa.

From the beginning, we learned about the world through stories. Over time, the tools for storytelling evolved and combined to involve one or more of the users' senses. Reading, listening, watching, even interacting with the users' stories. Transmedia Navigator is the world's first storytelling iPad App that synchronizes movies, scripts, presentations, text, websites, animations, simulations, and a universe of other digital media. Whether the purpose of a user's Video Narrative is educational, or marketing, or entertainment—Transmedia Navigator enriches stories with meaning and impact.
Find Video Narratives here in the Library.
Return by tapping on the Library icon.
Video Narratives begin at the beginning, or pick up where you left off.
Find a user's way around a Video Narrative through the Table of Contents. Episodes appear on the left. Chapters and other synchronized media appear on the right.
Manage which episodes are stored on a user's iPad by downloading or deleting them. A user may always download an episode again later.
Begin watching a chapter by selecting it from the Table of Contents.
Transmedia Navigator synchronizes video with text and other media. With Transmedia Navigator, a user may read while he/she watches and/or listens. Scroll the video and the transcript stays in sync; or a user's may swipe the transcript text and move the video.
Video, Text, and Notes may one or more be displayed full screen by tapping on these icons.
Tap this icon to copy text to a user's Notepad. Expand the Notepad full screen, then tap anywhere to bring up the keyboard
Tap on the Tools Icon to email a user's Notepad, or change fonts.
To add bookmarks in an episode, just tap on a block of text. Tap on the bookmarks icon and navigate back to that part of the story.
To search, place a user's cursor in the search field. Type in a word and locate the exact moment in the story where that term occurs.
By swiping right with a user's finger, discover other things related to that part of the story, like websites, quiz questions, PDF files, and more.

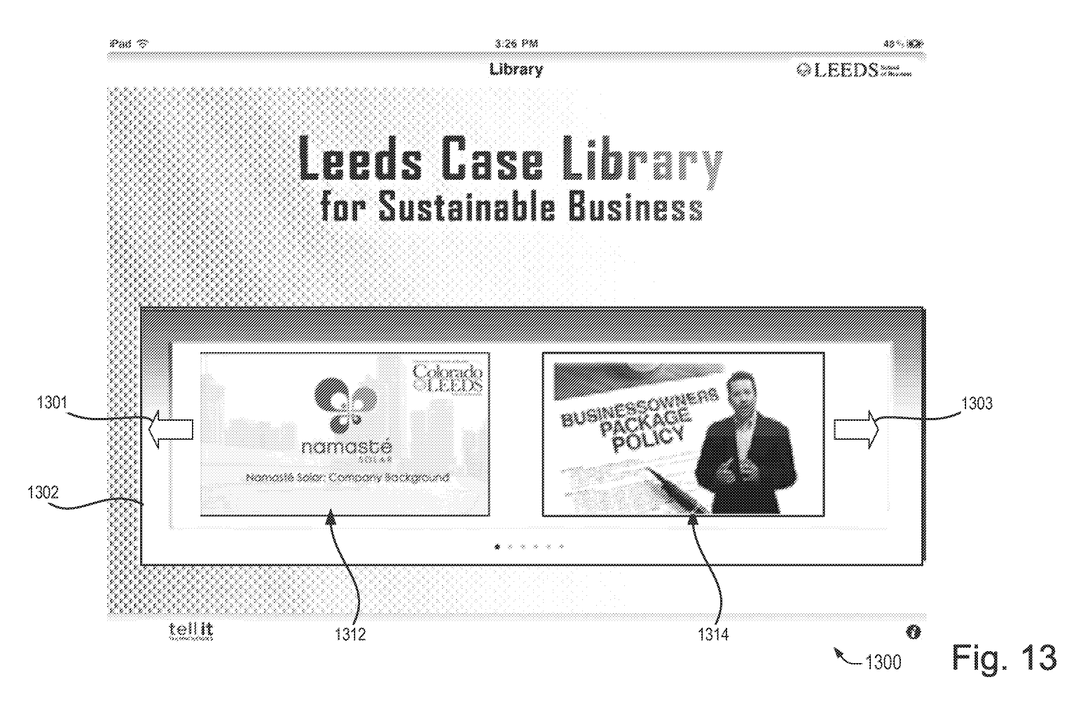

In at least one embodiment, Transmedia Navigator opens to a Library page, an example embodiment of which is shown in FIG. 13. As illustrated in the example embodiment of FIG. 13, a plurality of different 1302, 1304, etc.) may be represented, identified and/or selected by the user. To access a desired Transmedia Narrative, tap on a Transmedia Narrative which may then cause to be displayed the Multi-View format of the selected Transmedia Narrative. If a user has not already accessed this Transmedia Narrative, it may cue up to the beginning. If a user had already accessed this Transmedia Narrative™, tapping on the Transmedia Narrative™ may cue up to where a user left off. Tapping the Information Icon on the Library displays an Information Display including instructions for using the Transmedia Navigator app.

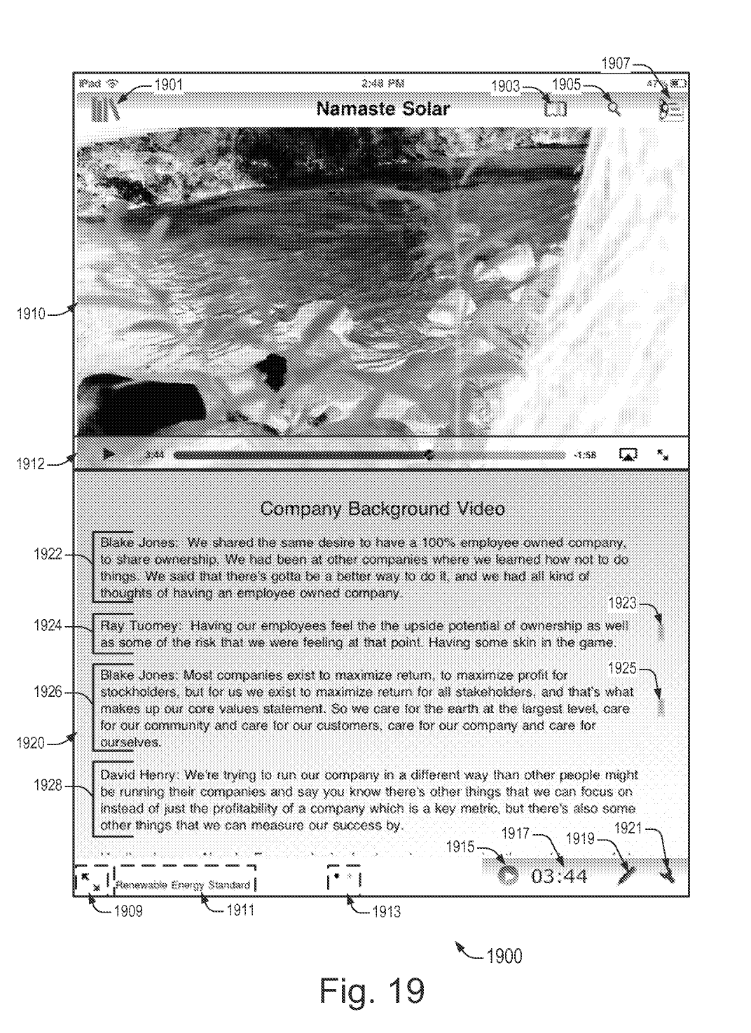

Multi-Display View—Portrait Mode (e.g., FIG. 19)

In this view, user's may access the Library Icon 1901, Bookmarks Icon 1903, Search Icon 1905, and Table of Contents Icon 1907 along the top navigation row. Below that is the Video Player GUI 1910. Under that is the Resources Display GUI 1920. Below the Resources Display GUI is the bottom navigation row. This includes the Resource Display Resize Icon 1909, the Resource Indicator 1911, the Resource Display Toggle Icon 1913, the Play/Pause Button 1915, the Time Code Indicator 1917, the Notepad Icon 1919, and the Tools Icon 1921.

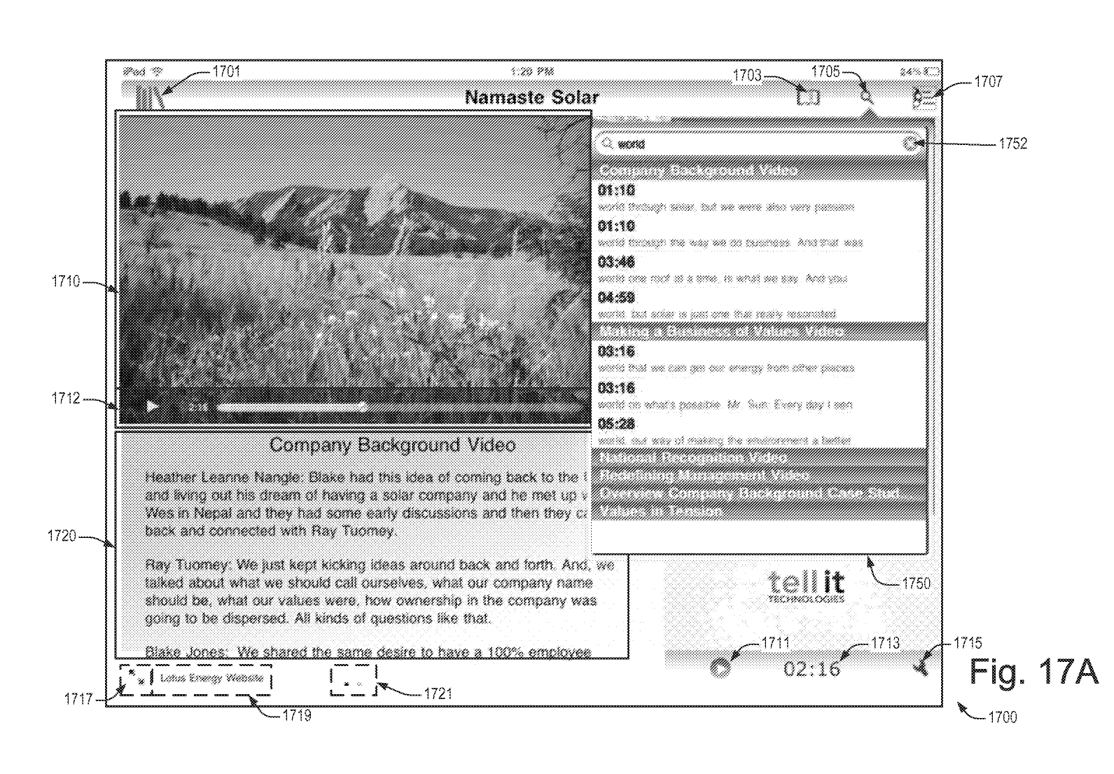

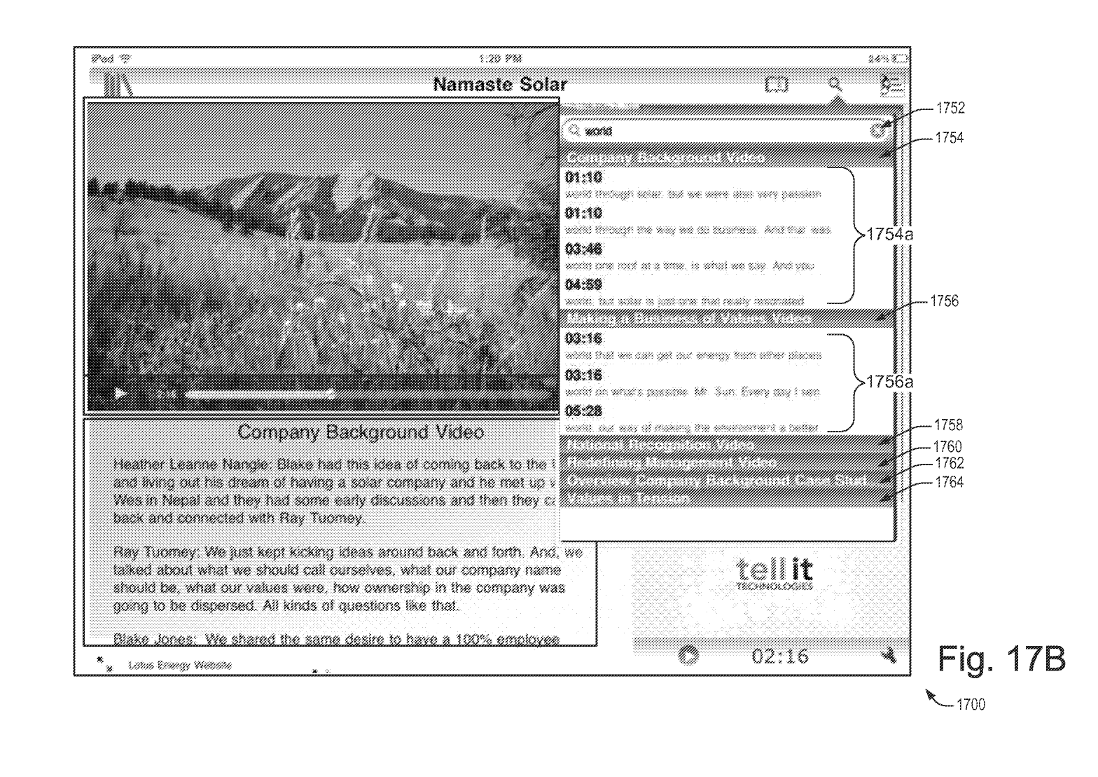

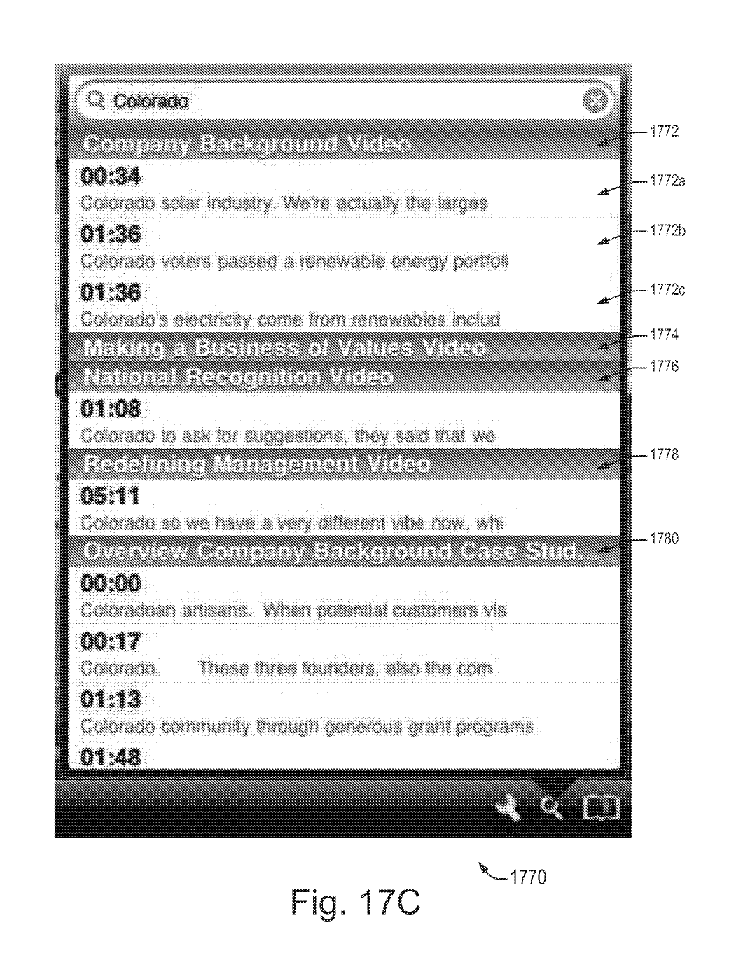

Multi-Display View—Landscape Mode (e.g., FIG. 17A)

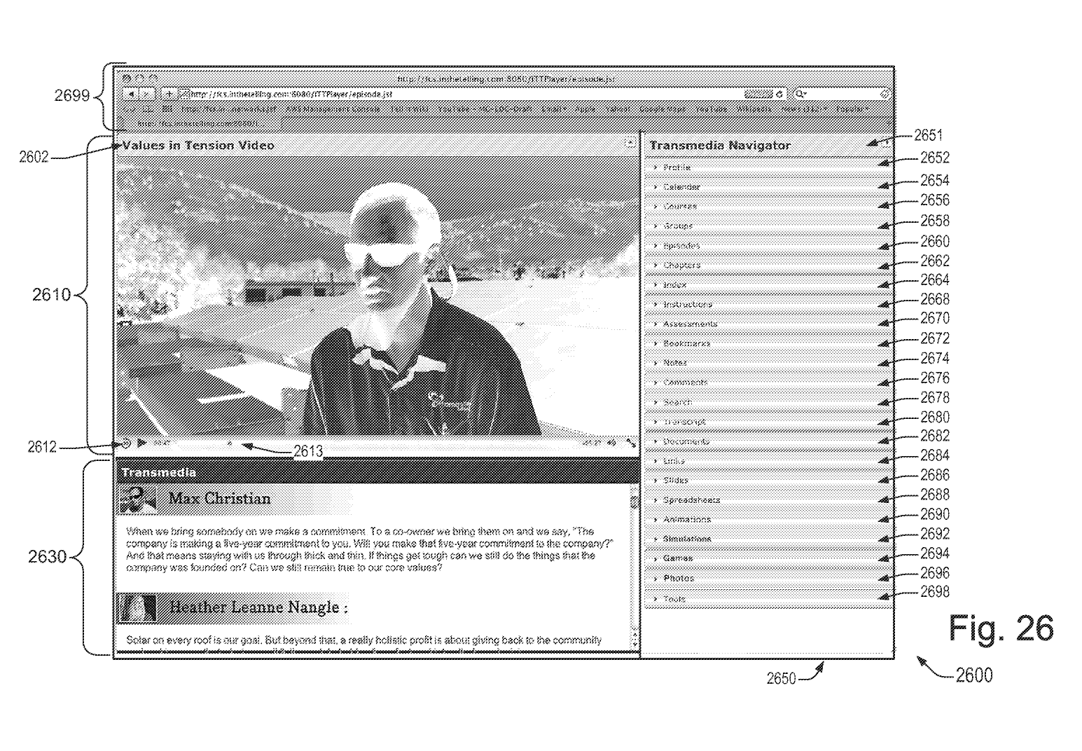

In this view, users may access the Library Icon, Bookmarks Icon 1703, Search Icon 1705, and Table of Contents Icon 1707 along the top navigation row. Below that in the upper left is the Video Player GUI 1710. Under that is the Resources Display GUI 1720. Adjacent to that (e.g., to the right) a Transmedia Navigator GUI (see, e.g., 2651, FIG. 26), which, for example, may be configured or designed to facilitate user access to a variety of different types of information, functions, and/or features such as, for example, one or more of the following (or combinations thereof):

| | |
|---|---|
| Profile Information/Features Access | Assessments Information/ |
| Calendar Information/Features Access | Features Access |
| Courses Information/Features Access | Bookmarks Information/ |
| Groups and Social Networking | Features Access |
| Information/Features Access | Notes Information/Features |
| Episodes Information/Features Access | Access |
| Chapters Information/Features Access | Comments Information/ |
| Index Information/Features Access | Features Access |
| Instructions Information/Features Access | Search Information/Features |
| Spreadsheets Information/Features Access | Access |
| Animations Information/Features Access | Transcript Information/ |
| Simulations Information/Features Access | Features Access |
| | Documents Information/ |
| | Features Access |
| | Links Information/Features |
| | Access |
| | Slides Information/Features |
| | Access |
| | Games Information/Features |
| | Access |
| | Comments Information/ |
| | Features Access |
| | Tools Information/Features |
| | Access |

Below the Resources Display GUI is the bottom navigation row. This includes the Resource Display Resize Icon 1717, the Resource Indicator 1719, the Resource Display Toggle Icon 1721, the Play/Pause Button 1711, Time Indicator 1713, and Tools Icon 1715.

Bookmarks GUI

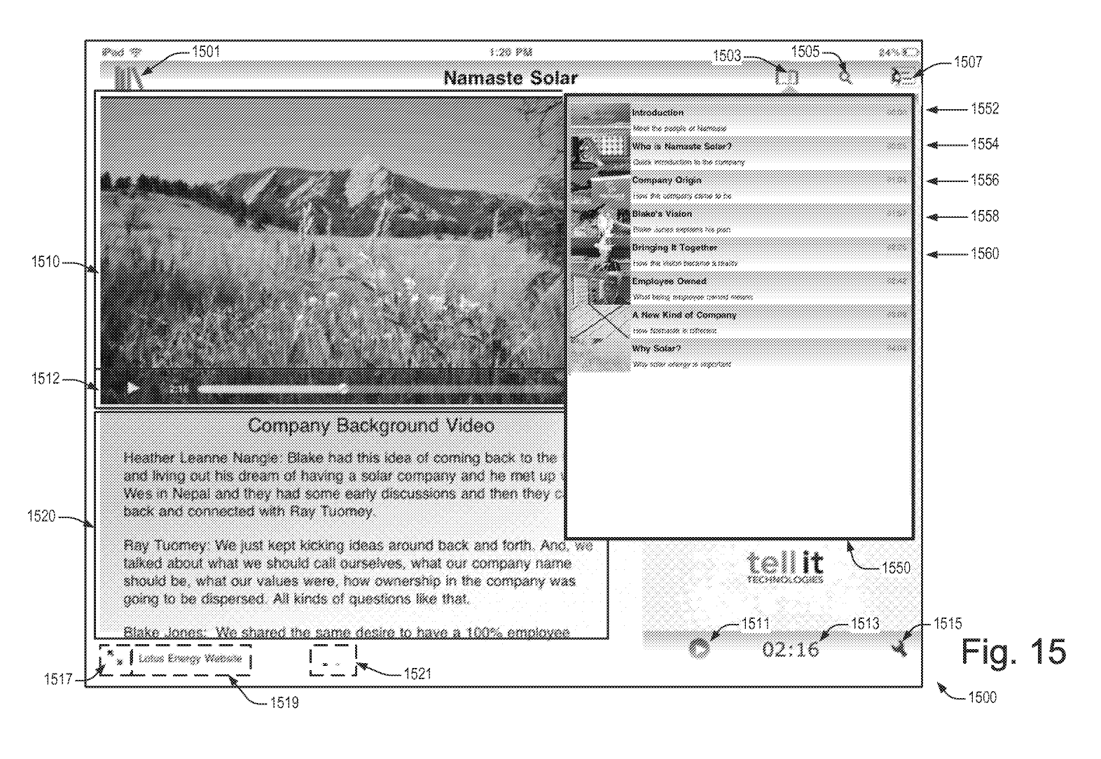

In at least one embodiment, tapping on any block of text in the Resources Display GUI (e.g., 1920) places a red Bookmark icon (e.g., 1923, 1925, FIG. 19) adjacent to the text indicating that a new Bookmark has been created. As illustrated in the example embodiment of FIG. 15, tapping on the Bookmarks Icon 1503 opens a Bookmarks Display GUI 1550. In at least one embodiment, a user may tap on any one of the display bookmark entries (e.g., 1552, 1554, 1556, etc.) to directly access Transmedia Narrative content (e.g., video, audio, text, etc.) corresponding to the selected bookmark.

In at least one embodiment, the Bookmarks Display 1550 includes the Chapter Headings for the selected Transmedia Narrative. If the user has created any Bookmarks, they may be displayed with a thumbnail, timestamp, and descriptive text underneath the Chapter Heading. Tapping on a Bookmark Thumbnail may take the user to that location in the Transmedia Narrative. To close the Bookmarks Display without navigating to another location, tap anywhere outside the Bookmarks Display. Tapping on the Clear Button allows a user to delete bookmarks for the current narrative or one or more narratives in the product.

Search Display GUI

As illustrated in the example embodiment of FIGS. 17A-17C, tapping on the Search Icon 1705 brings up the Search Display GUI 1750. As illustrated in the example embodiment of FIG. 17B, the Search Display GUI includes a search field input box 1752. Type any word or phrase a user want to find in any video or presentation in the Transmedia Narrative and then hit Enter or tap the Search button. The Search Display GUI may display one or more instances in one or more video or presentation where the input search word or search phrase occurs in the Transmedia Narrative. This may include, for example, instances which occur in the audio, text transcript, links, related references/documents, etc. The time-stamp for where that word or phrase occurs, the word or phrase itself, and/or other type of data described and/or referenced herein may be displayed as part of the search results. In at least one embodiment, a user may tap on any one of the search result entries (e.g., 1772a, 1772b, etc., FIG. 17C) to directly access Transmedia Narrative content (e.g., video, audio, text, etc.) corresponding to the selected search result entry.

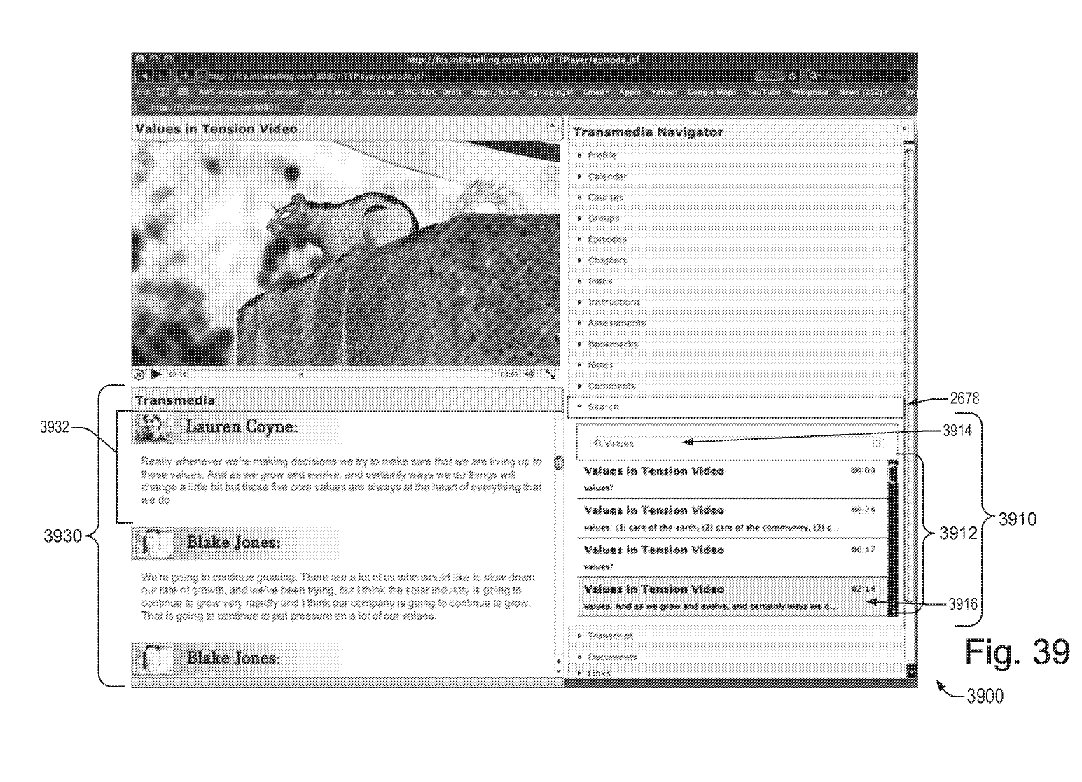

According to various embodiments, the DAMAP System may be configured or designed to automatically and/or dynamically analyze and index (e.g., for subsequent searchability) different types of characteristics, criteria, properties, etc. that relate to (or are associated with) a given Transmedia Narrative (and it's respective video, audio, and textual components) in order to facilitate searchability of the Transmedia Narrative using one or more of those characteristics, criteria, properties, etc. For example, according to different embodiments, the DAMAP System automatically and/or dynamically analyze a given Transmedia Narrative, and identify and index one or more of the following characteristics, criteria, properties, etc. (or combinations thereof) that relate to (or are associated with) the Transmedia Narrative, or that relate to a section, chapter, scene, or other portion of the Transmedia Narrative:
Text-related content (e.g., words, phrases, characters, numbers, etc.). For example, words and phrases of the transcribed text relating to the audio content of the Transmedia Narrative may be analyzed and indexed by the DAMAP system to facilitate subsequent user searchability for portions of Transmedia Narrative content matching specific words and/or phrases. In at least one embodiment, the indexed words/phrases may at least one be mapped to a particular sentence, paragraph, chunk and/or block of text identified in the Transmedia Narrative transcription. Additionally, at least one identified paragraph, chunk and/or block of text of the Transmedia Narrative transcription may be mapped to a respective section, chapter, scene, timecode or other portion of the Transmedia Narrative video/audio. As a result, in at least one embodiment, when a user initiates a search for desired word or phrase in the Transmedia Narrative, and selects a particular entry from the search results in which an occurrence of the search term has been identified in a particular block or scene of the Transmedia Narrative, the user may then be directed to the beginning of the identified block/scene of the Transmedia Narrative (e.g., as opposed to the user being directed to the exact moment of the Transmedia Narrative where the use of the search term occurred), thereby providing the user with improved contextual search and playback capabilities. For example, as illustrated in the example embodiment of FIG. 39, it is assumed that the user initiates a search for the occurrences of the term “values” (3914) in the Transmedia Narrative, and that the search results include entry 3916, which identifies the occurrence of the term “values” in a portion of the Transmedia Narrative transcription corresponding to 3932. In at least one embodiment, when the user selects entry 3916 from the search results, the Transmedia Navigator App may respond by automatically jumping to a location in the Transmedia Narrative (e.g., for playback) corresponding to the start or beginning of portion 3932 of the Transmedia Narrative transcription.
Image-related content such as, for example, images (and/or portions thereof), colors, pixel grouping characteristics, etc. For example, in at least one embodiment, images of selected frames of a video file may be analyzed by the DAMAP system for identifiable characteristics such as, for example: facial recognition, color matching, location/background setting recognition, object recognition, scene transitions, etc. For example, in at least one embodiment, a user may initiate a search for one or more scenes in the Transmedia Narrative where a particular person's face has been identified in the video portion(s) of the Transmedia Narrative.
Speaker-related criteria such as, for example, voice characteristics of different persons speaking on the Transmedia Narrative audio track; identity of different persons speaking on the Transmedia Narrative audio track, etc. For example, in at least one embodiment, a user may initiate a search for one or more scenes in the Transmedia Narrative where a particular person's voice occurred in the corresponding audio portion of the Transmedia Narrative.
Audio-related criteria such as, for example, silence gaps, sounds (in the Transmedia Narrative audio track) matching a particular frequency, pitch, duration, and/or pattern (e.g., a car horn, a jet airplane engine, a train whistle, the ocean, a barking dog, a telephone ringing, a song or portion thereof, etc.). For example, in at least one embodiment, a user may initiate a search for one or more scenes in the Transmedia Narrative where a telephone may be heard ringing in the audio portion of the Transmedia Narrative.
Scene-related criteria such as, for example, set location characteristics relating to different scenes in the Transmedia Narrative; geolocation data relating to different scenes in the Transmedia Narrative; environmental characteristics relating to different scenes in the Transmedia Narrative (e.g., indoor scene, outdoor scene, beach scene, underwater scene, airplane scene, etc.). For example, in at least one embodiment, a user may initiate a search for one or more scenes in the Transmedia Narrative which were filmed at Venice Beach, Calif.
Branding-related criteria such as, for example, occurrences of textual, audio, and/or visual content relating to one or more types of brands and/or products. For example, in at least one embodiment, a user may initiate a search for one or more scenes in the Transmedia Narrative where the display of an Apple Logo occurs.
Social network-related criteria such as, for example, various users' posts/comments (e.g., at various scenes in the Transmedia Narrative), users' votes (e.g., thumbs up/down); identities of users who have viewed, posted, commented, or otherwise interacted with the Transmedia Narrative; relationship characteristics between users who have viewed, posted, commented, or otherwise interacted with the Transmedia Narrative; demographic information relating to users who have viewed, posted, commented, or otherwise interacted with the Transmedia Narrative, etc. For example, in at least one embodiment, a user may initiate a search for one or more scenes in the Transmedia Narrative which have been positively commented on by other women users over the age of 40.
Metadata-related criteria such as, for example, metadata (e.g., which may be associated with different sections, chapters, scenes, or other portions of a Transmedia Narrative) relating to one or more of the following (or combinations thereof): source files which were used to generate the Transmedia Narrative; identity of persons or characters observable in different scenes of the Transmedia Narrative; identity and/or other information about users who worked on the Transmedia Narrative; tag information; clip or playlist names; duration; timecode; quality of video content; quality of audio content; rating(s); description(s); topic(s), classification(s), and/or subject matter(s) of selected scenes; (for example, during a sport event, keywords like goal, red card may be associated to some clips), etc. For example, in at least one embodiment, a user may initiate a search for one or more scenes in the Transmedia Narrative which may be identified (e.g., via metadata) as originating from a specific source file.

According to different embodiments, the various types of Transmedia Narrative characteristics, criteria, properties which are analyzed, identified, and indexed (e.g., by the DAMAP System) may be automatically and/or dynamically mapped to a respective section, chapter, scene, timecode or other portion of the Transmedia Narrative video/audio.

Table of Contents GUI

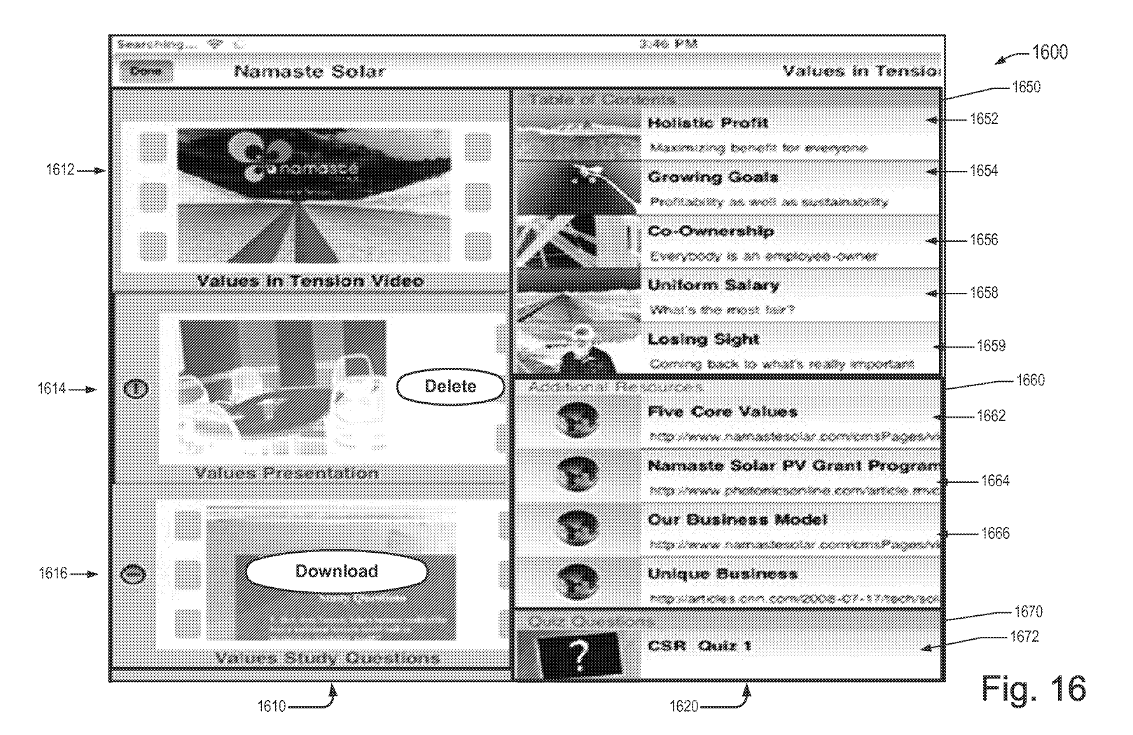

In at least one embodiment, tapping on the Table of Contents Icon (e.g., 1707, FIG. 17A) causes a Table of Contents GUI (e.g., 1600, FIG. 16) to be displayed. In at least one embodiment, the Table of Contents functions as a user's portal to one or more of the Episodes and Resources within the Transmedia Narrative. In one embodiment, an Episode may be defined as a video, presentation, or set of study questions. Start from the beginning of the selected Episode by tapping on the first thumbnail at the top of the list, or start from any Chapter below that and Transmedia Navigator may open the Multi-Display View with one or more the media in sync at that point in the story. The left section (1610) of the Table of Contents displays one or more the available Episodes. Tapping on any Episode brings up a display on the right section of one or more the resources for that Episode. Note that above the right-hand display, the name of that Episode is shown. The right section (1620) displays a plurality of Transmedia Narrative resources such as, for example, one or more of the following (or combinations thereof): Episode Chapters (1650), Additional Resources (1660), Quiz Questions (1670), etc. As illustrated in the example embodiment of FIG. 16, Episode Resources may be categorized and/or sorted by type. The Table of Contents category lists the Chapters within that Episode. At least one Chapter bar shows the name of the Chapter, the subheading for the Chapter, and the time code for the beginning of that Chapter within the Episode. Tap on any portion of the Chapter bar to go to that moment in the Chapter and Episode. The Additional Resources category lists the additional resources within at least one Episode. Tap on any portion of the Additional Resources bar to go to that moment in the Chapter and Episode. The Quiz Questions category includes Episode quizzes. Tap on any portion of the Quiz Questions bar to go to the quiz for that Episode.

The Table of Contents is a navigation device and powerful media management tool that enables a user to navigate to any episode, any chapter within an episode, and to additional resources such as quizzes Available Episodes within the Transmedia Narrative appear in the left section of the Media Manager display. Scroll up or down on the film strip to see one or more the Episodes included in the Transmedia Narrative. Note, some Episodes show a “download” icon in the center of the filmstrip screen. This indicates that the Episode is not yet loaded into a user's Transmedia Narrative, but is available for download. To download a desired Episode, tap the “Download” icon in that Episode. A progress bar indicates the status of the download, and may disappear when the download is complete. In one embodiment, a user may remove episodes from a user's Transmedia Narrative any time by tapping the Episode Delete icon, causing a “Delete” button to appear. To remove that episode from a user's iPad's hard drive, tap “Delete,” and that episode may be removed. Even if a user has removed the Episode, a user may download it again by using the Media Manager and going through the download process again.

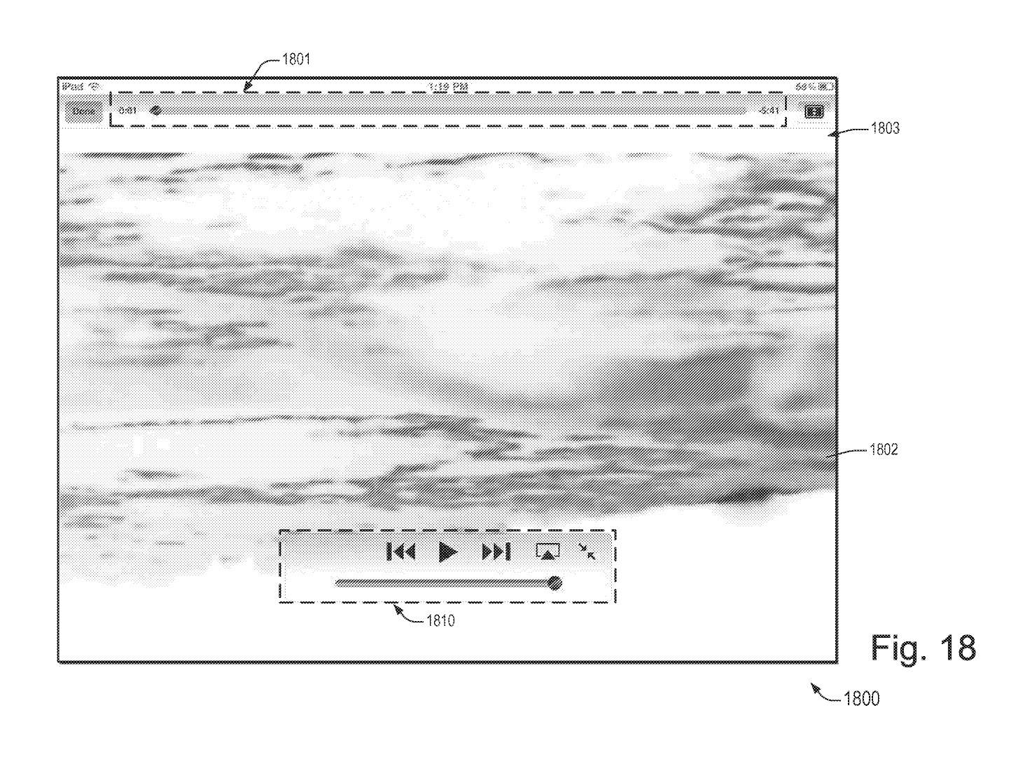

Video Player GUI may be operated within one or more of the Multi-Display View mode(s) (e.g., FIG. 17A, FIG. 19), or it may be enlarged full screen (as shown, e.g., in FIG. 18). In at least one embodiment, to display a video or presentation full screen, use two fingers to expand the picture by flicking them away from at least one other. To shrink a video or presentation from full screen back down the Multi-Display View, pinch the user's fingers together on the iPad surface. The built-in play/pause button starts and stops the video presentation. There is also a Play/Pause Button in the bottom control bar of the Transmedia Navigator App. In at least one embodiment, in Multi-Display View, when a user moves the video slider bar (e.g., 2613, FIG. 26), the automated scrolling of the text displayed in the Resources Display GUI (e.g., 2630) stays in sync with the video (& audio) content displayed in the Video Player GUI (2610). In at least one embodiment, to the right of the video slider is an Apple TV display icon that lets a user project the video or presentation on an Apple TV device. In the bottom right corner of the Video Player GUI is the Resource Display Resize icon that expands or contracts the size of the video. As illustrated in the example embodiment of FIG. 18, when the Video Player GUI is maximized in either of the Multi-Display mode formats, a Video Player GUI Functions Bar (1810) appears.

Resources Display GUI

According to different embodiments, the Resources Display GUI (e.g., 1920, FIG. 19) displays digital content that is synchronized with the video or presentation in the Video Player GUI. Swiping the Resources Display GUI left or right reveals whatever other digital resources are available at that particular moment, chapter, section, or scene in the Transmedia Narrative. In some embodiments, the Resource Indicator (1911) and Resource Display Toggle Icon (1913) also change in sync with the Transmedia Narrative as new resource(s) are accessed and displayed in the Resources Display GUI. In at least one embodiment, by default, the Resources Display GUI may display a synchronized text transcription of the audio portion of a video or presentation being presented in the Video Player GUI. In Multi-View Display mode, this text may be scrolled up or down by the user such as, for example, by swiping or flicking on the touchscreen display surface corresponding to the Resources Display GUI. For example, when a user flicks (e.g., up or down), a portion of the touchscreen displaying the text of the Resources Display GUI, the displayed text may scroll up/down (as appropriate). Substantially synchronized with the scrolling of this text, the associated video (or presentation) displayed in the Video Player GUI (and corresponding audio) may maintain substantial synchronization with the scrolling of the text in the Resources Display GUI. In one embodiment, playing the video or presentation in the Video Player GUI causes the corresponding text in the Resources Display GUI to automatically scroll in a substantially synchronized manner.

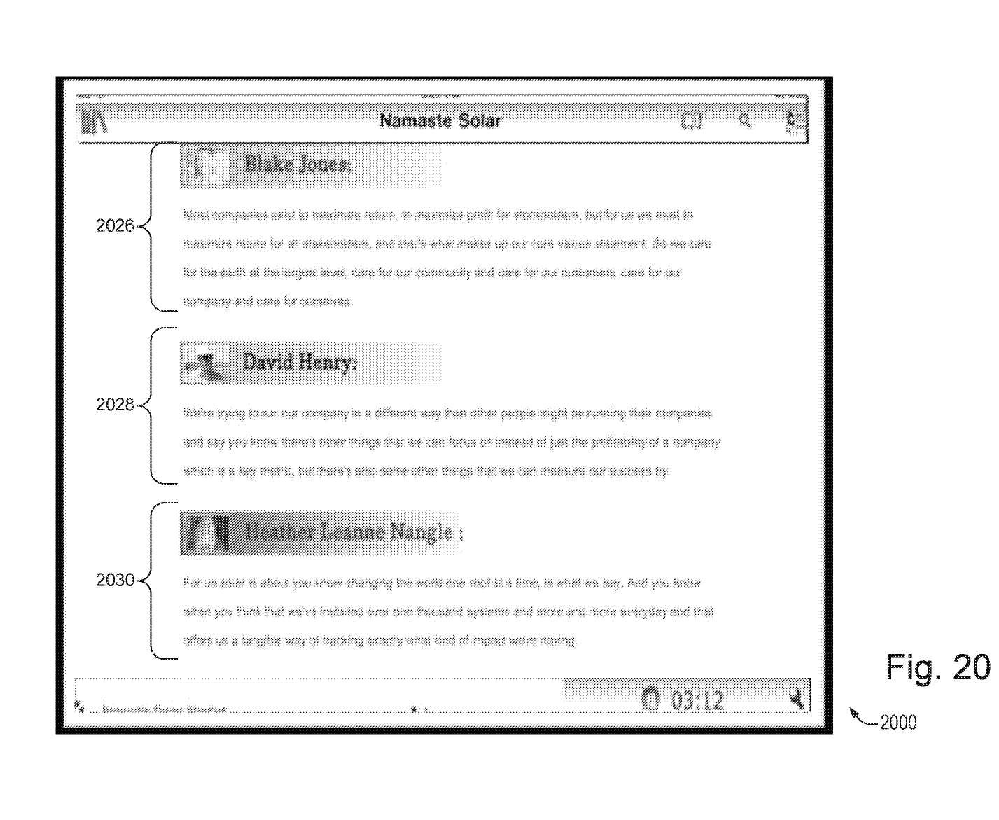

In at least one embodiment, the Resources Display GUI includes a Resource Display Resize Icon that may be used to expand the text to full screen (e.g., FIG. 20) or shrink it back into the Multi-View Display. In at least one embodiment, a user may tap (or otherwise select) a Copy to Notepad Icon to copy the block of text nearest to the icon to the Transmedia Narrative's Notepad GUI. In Multi-Display View mode, tapping on any block of text in the Resources Display may create a Bookmark for bookmarking the identified location in the Transmedia Narrative. Tapping on the Copy to Notepad Icon copies a desired block of text (e.g., displayed in the Resources Display GUI) to the user's Notepad.

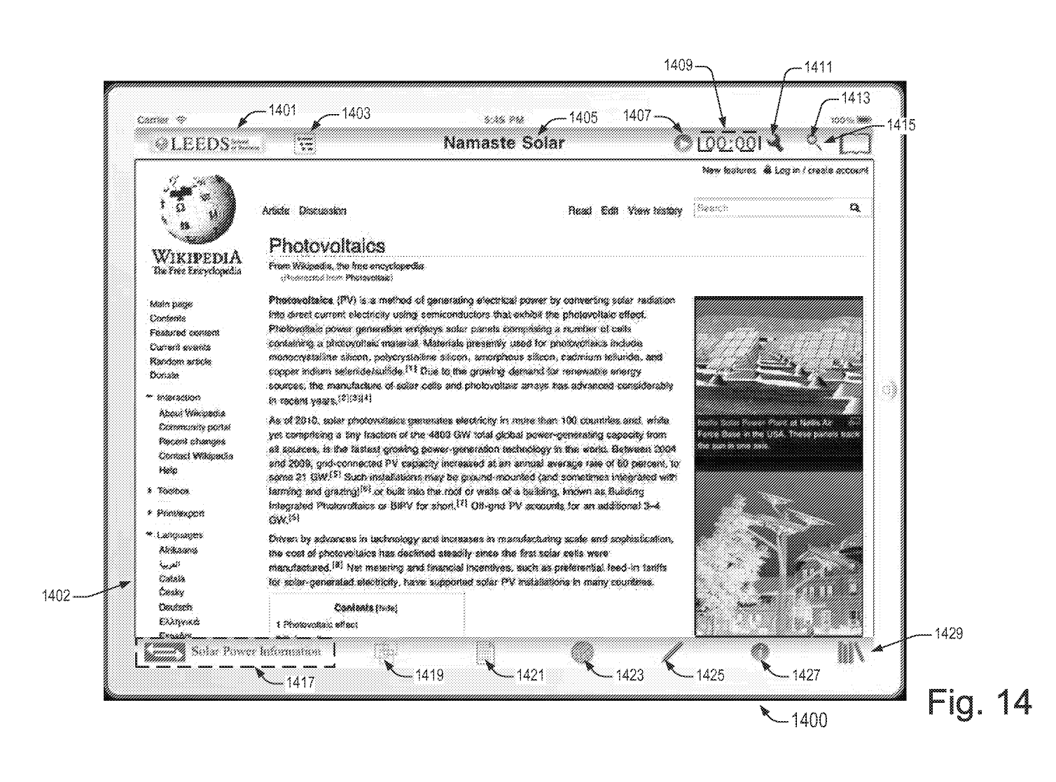

When text is enlarged full-screen in the Resources Display GUI, additional graphics and functionality may become available, depending on the Transmedia Narrative and/or other types of criteria described and/or referenced herein. For example, if a user displays a website full-screen in the Resources Display GUI (e.g., FIG. 14), some of the other features of a regular web browser may be available to the user as well, such as, for example, one or more of the following (or combinations thereof): forward and backward, copy the URL to Notepad, Email the URL, Publish URL, Google search, etc.

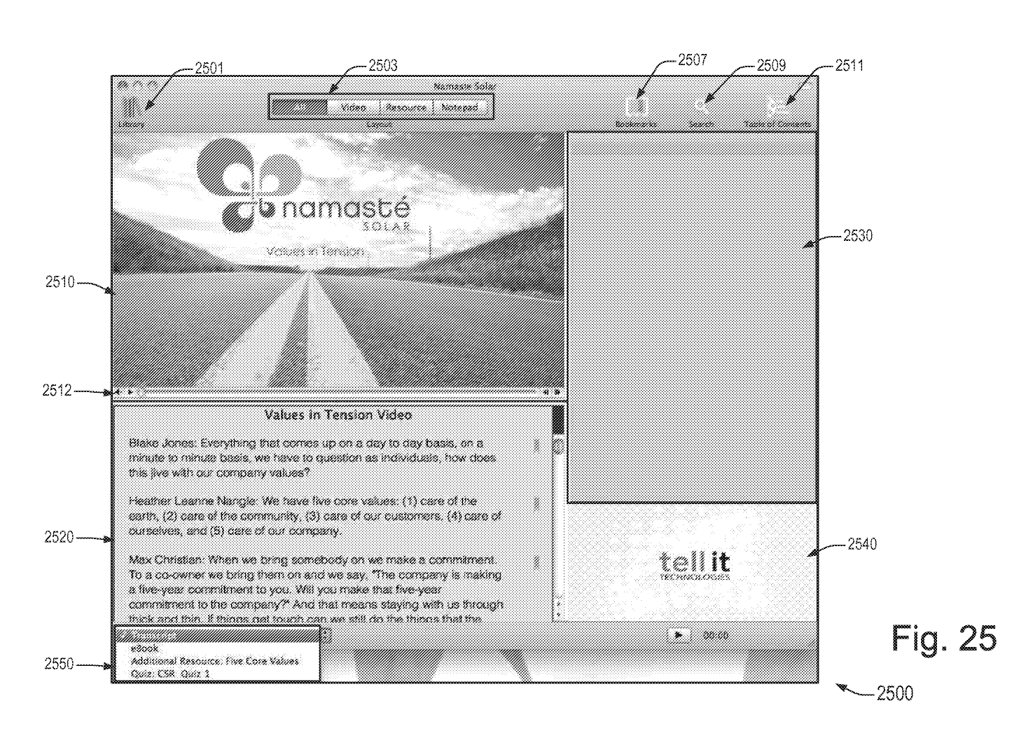

In at least one embodiment, below the Resources Display in the Toolbar is the Resources Indicator. In at least one embodiment, the Resource Indicator may be configured or designed as a GUI (e.g., 2550, FIG. 25) which may display information relating to the resource(s) currently being displayed in the Resources Display GUI, and which may also display information relating to other types of resources which are currently available to be displayed in the Resources Display GUI. The Resource Indicator may also show a brief description of Web sites that are contextually linked to the subject being presented at that point in the Episode. According to different embodiments, there are several methods to access the Web site associated with the subject. For example, a user may access any of the Additional Resources in the Table of Contents. A user may also tap appropriate button(s) on the Resource Display Toggle Icon, or a user may swipe a user's finger left to move the appropriate Web site into view in the Resource Window Display.

In some embodiments, quizzes may be added and displayed in a third Resource Window. According to different embodiments, are several ways to access the Quizzes. For example, a user may access Quizzes from the Table of Contents. A user may also tap the right button on the Resource Display Toggle Icon, or a user may swipe a user's finger left to move Quiz into the Resource Window Display.

Notepad GUI

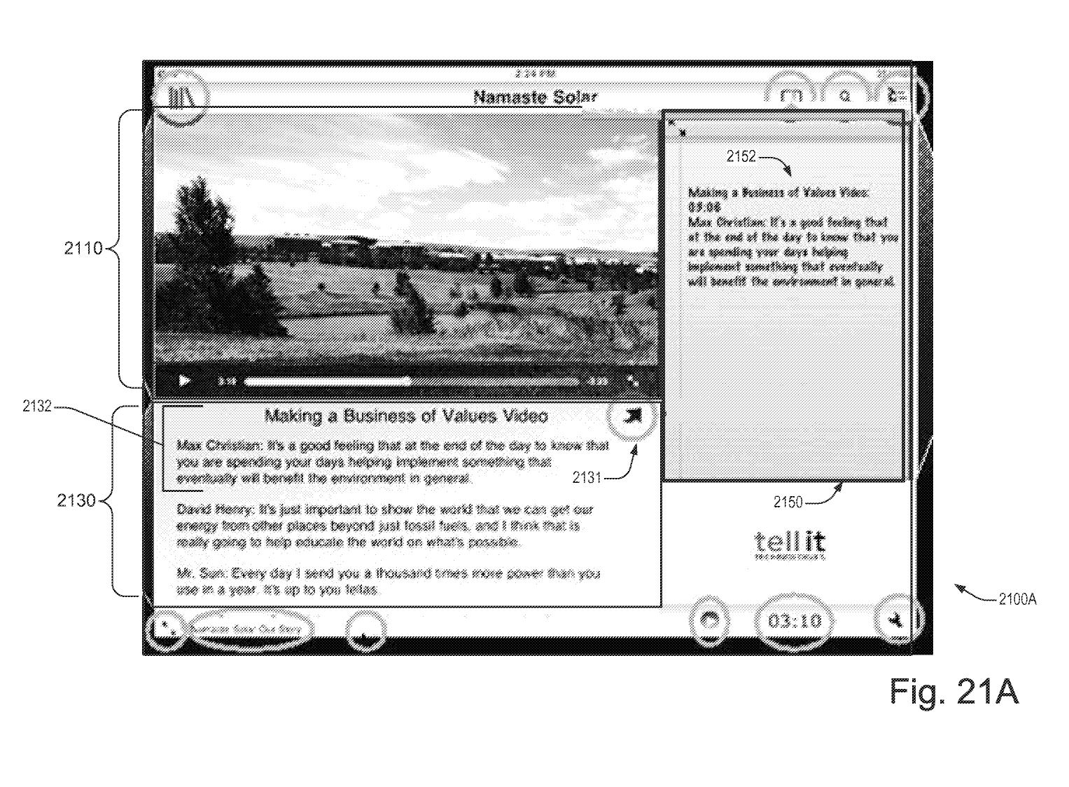

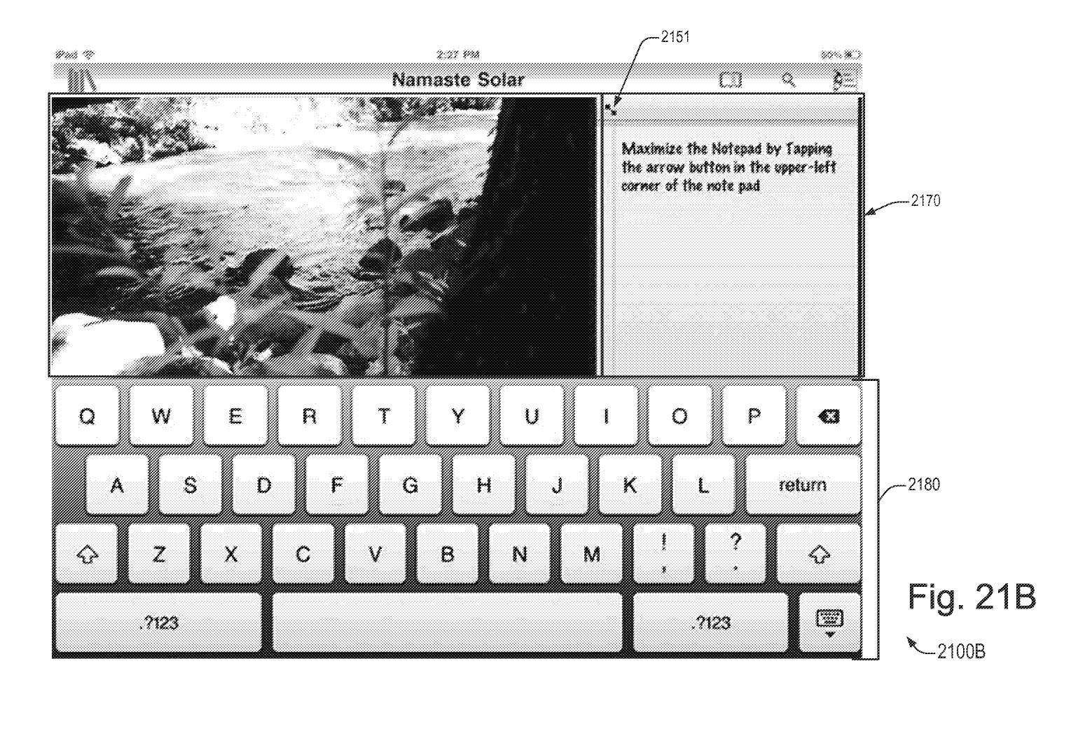

As illustrated in the example embodiment of FIG. 21A, in Multi-Display View (Landscape) mode, the Notepad GUI (herein “Notepad” 2150) is displayed on the right half of the screen. Tapping on the Copy to Notepad Icon (2131) copies the associated block of text (2132) to the user's Notepad (as shown at 2152) where a user may edit the text, or write notes, by tapping anywhere on the Notepad and bringing up the Keyboard GUI (2180, FIG. 21B). To expand or shrink the size of the Notepad, tap on the Notepad Resize Icon (2151). In one embodiment, from the Tools menu, a user may select Email Notepad to email the entire contents of the user's Notepad to selected recipients.

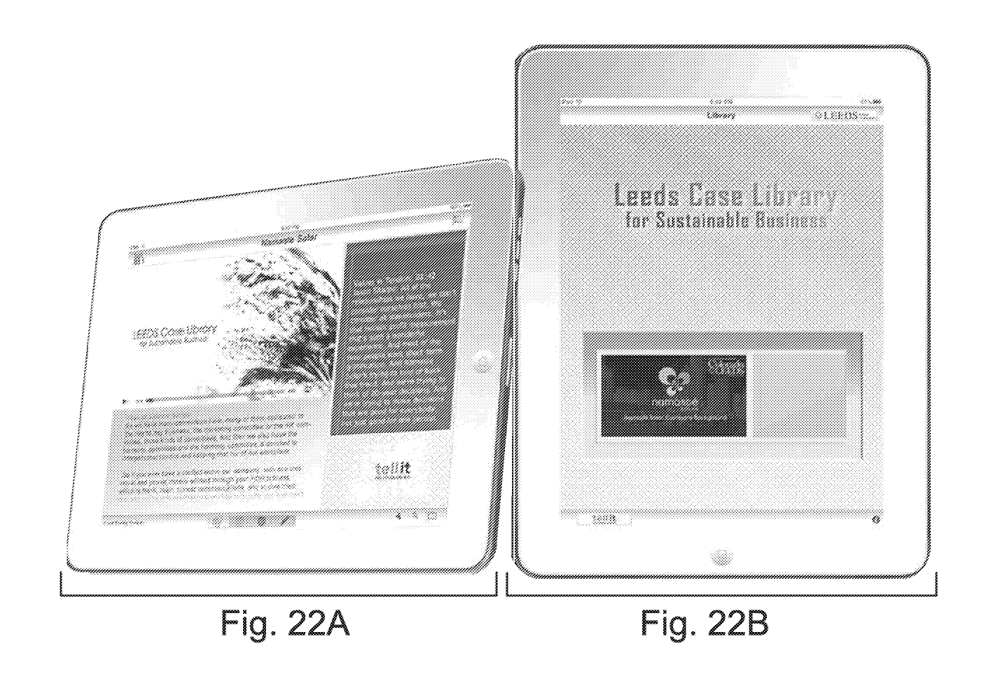

FIGS. 22A-B illustrate example images of a DAMAP Client Application playing a Transmedia Narrative on a client system (iPad) in both landscape mode (FIG. 22A) and portrait mode (FIG. 22B).

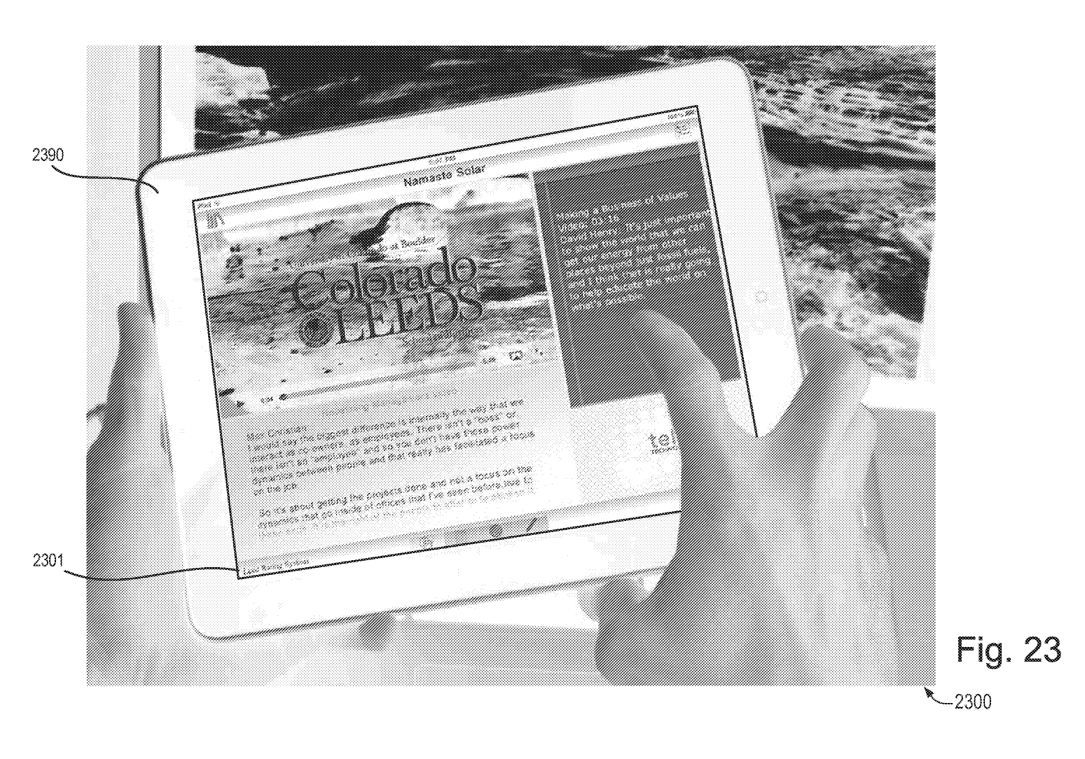

FIG. 23 shows an example image of a user interacting with a DAMAP Client Application playing a Transmedia Narrative on a client system (iPad) 2390.

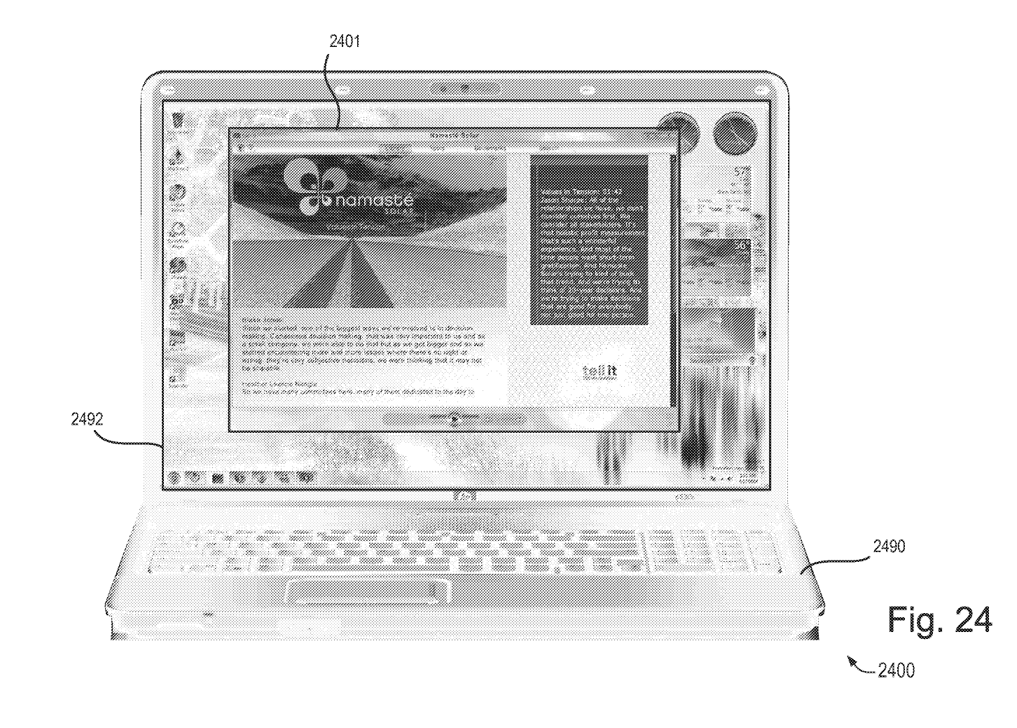

FIG. 24-25 show examples of a DAMAP Client Application embodiment implemented on a notebook computer (e.g., Mac, PC, or other computing device).

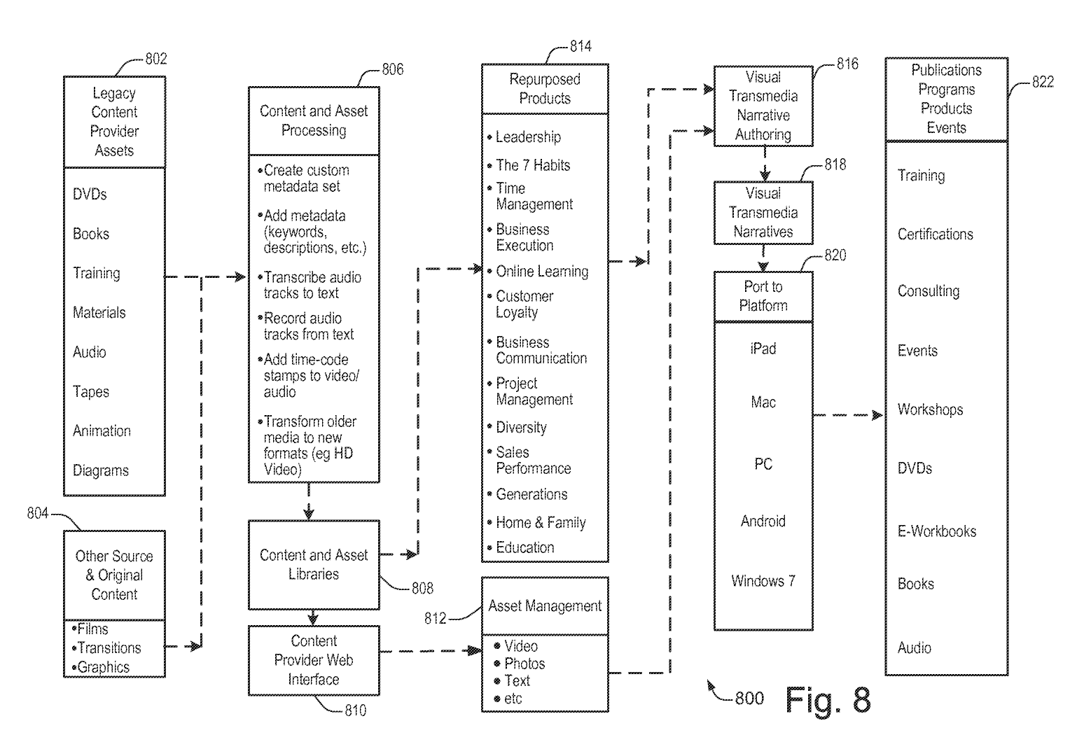

FIG. 8 shows an example embodiment of different types of informational flows and business applications which may be enabled, utilized, and/or leveraged using the various functionalities and features of the different DAMAP System techniques described herein. For example, as illustrated in the example embodiment of FIG. 8, new content and/or existing legacy content may be processed and repackaged (e.g., according to the various DAMAP System techniques described herein) into different types of Transmedia Narratives which may be configured or designed to be presented (e.g., via DAMAP Client Applications) on different types of platforms and/or client systems (e.g., 820). For example, in at least one embodiment, new content and/or existing legacy content may be accessed or acquired from one or more of the following (or combinations thereof): Legacy Content Provider Assets 802, Other Source & Original Content 804, RealContent Asset Library Processing 806, Content and Asset Libraries 808, Repurposed Products 814, etc. In at least one embodiment, at least a portion of the processing, authoring, production, and packaging of Transmedia Narratives may be performed by Asset Management System(s) 812, Transmedia Narrative Authoring (iTell Authoring) System(s) 816, etc. In at least one embodiment, presentation of one or more Transmedia Narratives may be used for a variety of purposes including, for example, one or more of the following (or combinations thereof): Training, Certifications, Consulting, Education, Events, Workshops, DVDs, E-Workbooks, Books, Audio, etc.

### Threaded Conversation, CrowdSourcing and Social Networking Functionality

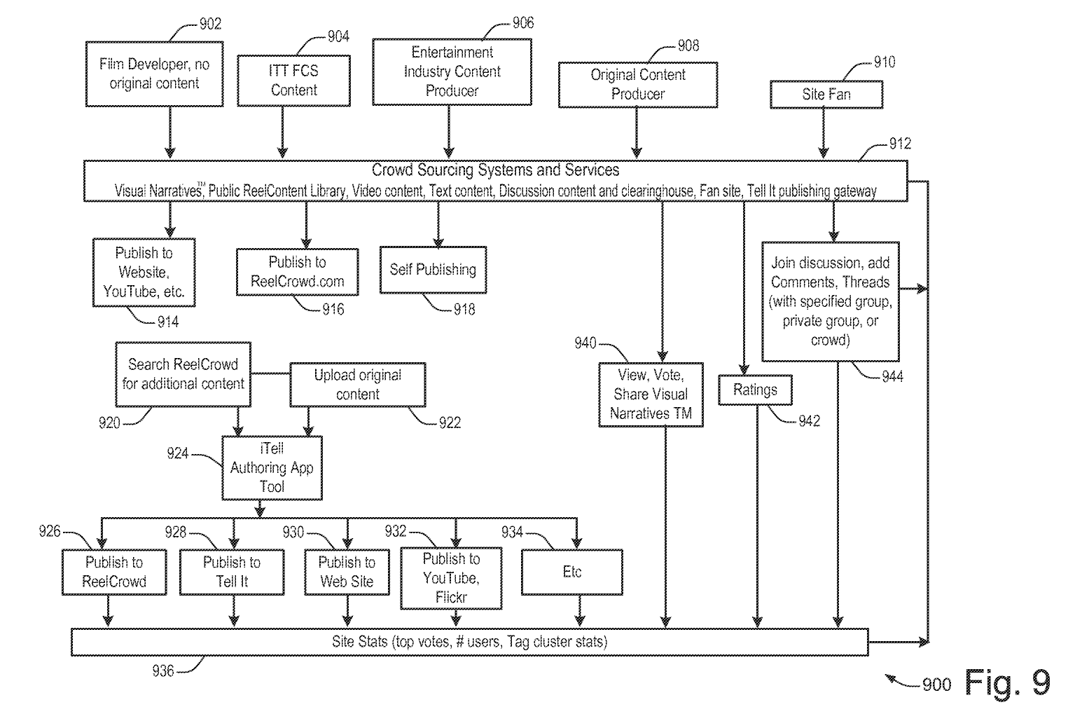

According to different embodiments, the DAMAP system may be configured or designed to include functionality for enabling and/or facilitating threaded conversations (e.g., timecode based threaded conversations between multiple users), crowd sourcing and/or other social networking related functionality. Example embodiments of different communication flows which may be enabled by the DAMAP system threaded discussion functionality are illustrated in FIGS. 9-12.

For example, in at least one embodiment, various aspects of the DAMAP system may be configured or designed to include functionality for allowing users to insert threaded discussions into the timeline of a Transmedia Narrative episode. Example screenshots showing various aspects/features of the DAMAP system threaded discussion functionality are illustrated in FIGS. 9-12. In at least one embodiment portions of the DAMAP system threaded discussion functionality may be implemented and/or managed by the commentary Server System(s) (FIG. 1, 180). Further, in at least one embodiment, the DAMAP Client Application may be configured or designed to exchange threaded discussion messages (and related information) with the commentary Server System(s), and to properly display time-based threaded conversation messages (e.g., from other users) at the appropriate time during the presentation of a Transmedia Narrative at the client system.

FIG. 9 shows a specific example embodiment of a DAMAP-compatible commentary Website architecture which may be configured or designed to interface with components of the DAMAP system in order to enable and/or facilitate the use of threaded conversations, crowd sourcing and/or other social networking communications between different entities of the DAMAP system (and/or other networks/systems). In at least one embodiment, the commentary Website of FIG. 9 may be configured or designed to function as a centralized place for adding, sharing, creating, and discussing video-based content and Transmedia Narratives.

Input to the Commentary Website may come from diverse sources such as DAMAP users, DAMAP databases (e.g., via the ReelContent Library, such as content designated for public consumption/access); entertainment industry content producers; original content producers; corporations; online sources (e.g., vimeo.com, youtube.com, etc.), etc.

In at least one embodiment, the Commentary Website may provide its users and/or visitor with access to various types of Commentary-related features such as, for example, one or more of the following (or combinations thereof):
Enabling a user to create one or more Transmedia Narratives
Enabling a user to identify and select content to be included in a user customized Transmedia Narrative
Enabling a user to identify and select content to be included in a user customized Transmedia Narrative Mashup
Providing the ability for the user to manage or control public and/or private access to the user's Transmedia Narratives
Enabling a user to embed threaded commentaries and/or threaded discussions into one or more Transmedia Narratives. In at least one embodiment, at least a portion of the embedded threaded commentaries and/or threaded discussions may be tied or linked to specific timecodes of a Transmedia Narrative to thereby enable the threaded commentaries/discussions to be automatically displayed (e.g., by the DAMAP Client Application) when the playback of the Transmedia Narrative reaches that specific timecode.
Transmedia Narratives). In at least one embodiment, users may be provided with the ability to select and control the granularity of a Transmedia Narrative's™ privacy settings, and to select, control, and moderate the threaded discussions and membership of the discussion group. For example, in one embodiment, users may access the Commentary Website to view Transmedia Narratives and content, to rate content, to vote on content, to join content contests, etc (e.g., with selected private groups, larger crowd groups within ReelCrowd, or the full ReelCrowd population).
Enable a user to access and utilize Transmedia Narrative authoring templates to create a Transmedia Narrative profile for that user, which, for example, may be used for conveying the user's public profile, for self-promotion, for advertising the user's talents and/or services, etc.
Provide the user with access to professional Transmedia Narrative production services.
Enable the user to access and form personal, business, and/or strategic partnerships/alliances with 3^{rd} party entities such as, for example, professional producers, editors, and marketing people. In this way, users may be provided with the ability to create and publish high quality, highly marketable Transmedia Narratives for worldwide distribution.
Enable content publishers to access and search the Commentary Website databases, aggregate content, upload their own content for private or public use/access, provide tags for the content, publish Transmedia Narratives, etc.
Enable content providers to define and/or provide their own social tagging taxonomy, which, in at least one embodiment, may be defined as the process by which many users add metadata in the form of keywords to shared content.
In addition to functioning as a clearinghouse for content and discussions, the Commentary Website may also be configured or designed to gather and aggregate tags, compile and report on votes, contests, number of users, tag statistics, and/or other site information that may be desired or considered to be valuable to visitors.
According to different embodiments, the social commentary functionality of the DAMAP system provides opportunities to content owners/publishers (e.g., such as those illustrated in FIG. 21) opportunities to rekindle public interest and exposure to their content. For example, in one embodiment, the social commentary functionality of the DAMAP system provides users with tools for:
Mining 3^{rd} party content (e.g., movies, films, videos, TV shows, sporting events, etc.) for desired scenes/clips
Tagging scenes, events, locations, persons appearing in a video, etc.
Embedding threaded timecode based comments
Share selected scenes/clips with others
Create a “social buzz” around selected scenes/clips which the user has shared or promoted
Making content (movies, TV shows, scenes, clips, etc.) more publically accessible, thereby providing valuable marketing and distribution opportunities.
Surfacing selected portions of content (e.g., embedded in films, movies, videos) into the social networking streams, thereby giving people the power to quickly locate and access their favorite lines/scenes, be able to post those lines/scenes, and bring TV and movie content back to the forefront of people's awareness. Driving that awareness may result in these films being rented and bought more just because their back on the minds of people.
Creating campaigns to surface this content back into the stream of awareness and commerce
Leveraging movie and TV content for use in the online dating world. For example, in one embodiment, the social commentary functionality of the DAMAP system may be configured or designed to provide tools for enabling for users to create “Movie Montages” for themselves (and/or others) which, for example, may be comprised of multiple different movie scenes/clips that are assembled together to thereby create a movie montage which may be use to express or convey a statement/sentiment about that user (e.g., movie montage of a user's favorite movie clips/scenes may be used to convey aspects about the user's profile, tastes, preferences, etc.). Example scenario: 30 something women looking for the right guy. Watches his Movie Montage Profile, sees that half of the scenes and lines he loves most are the same favorites she has, clips for Officer and a Gentlemen, Pretty Woman, and Cinema Paradiso. Woman decides to take action based on these similarities. “Let's go on a date, let's go see a movie, let's go to the user's place a rent these movies.”
Creating Social Network games (e.g., for Facebook and/or other social networks) such as a Movie Trivia Game, or a Screen Writer Role play game. The game(s) may be linked to a creative new TV series, something like Lost where a user run contests for writing the next serial scenes, the winner's scripts get to drive further episodes. New scenes may be socially rated by one or more the players, the studio could create several alternate editions of the next episode catering to the most popularly rated versions. As may be readily appreciated, the marketing and promotional potential of a social networked game that is configured or designed to surface or re-surface movie/television content (e.g., from older inventory) may be of great value to movie and television studios.

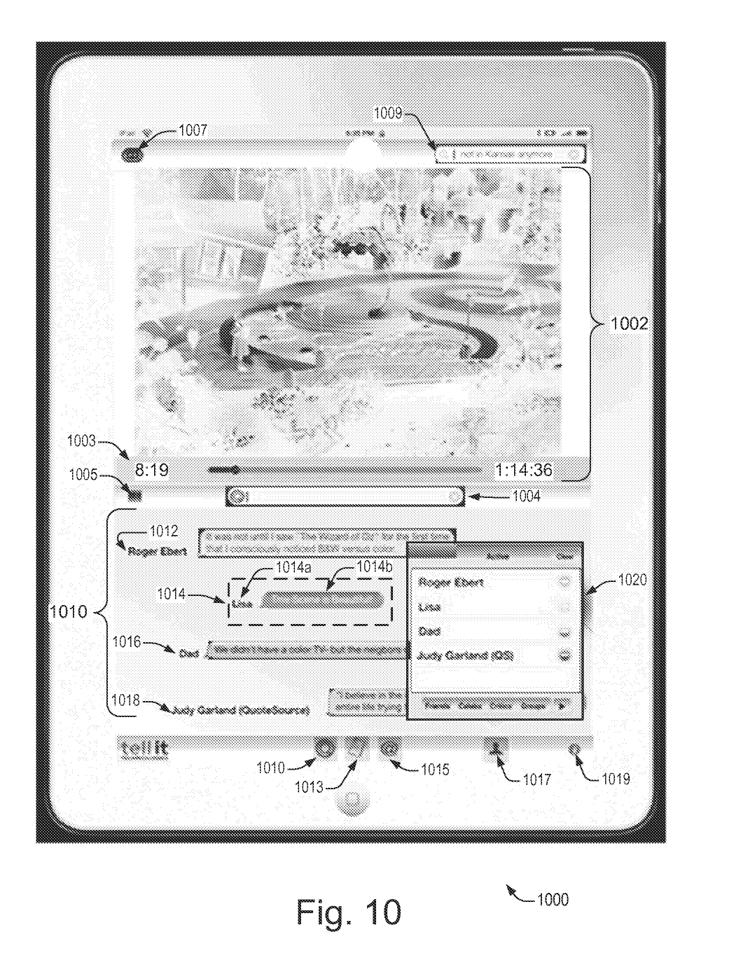

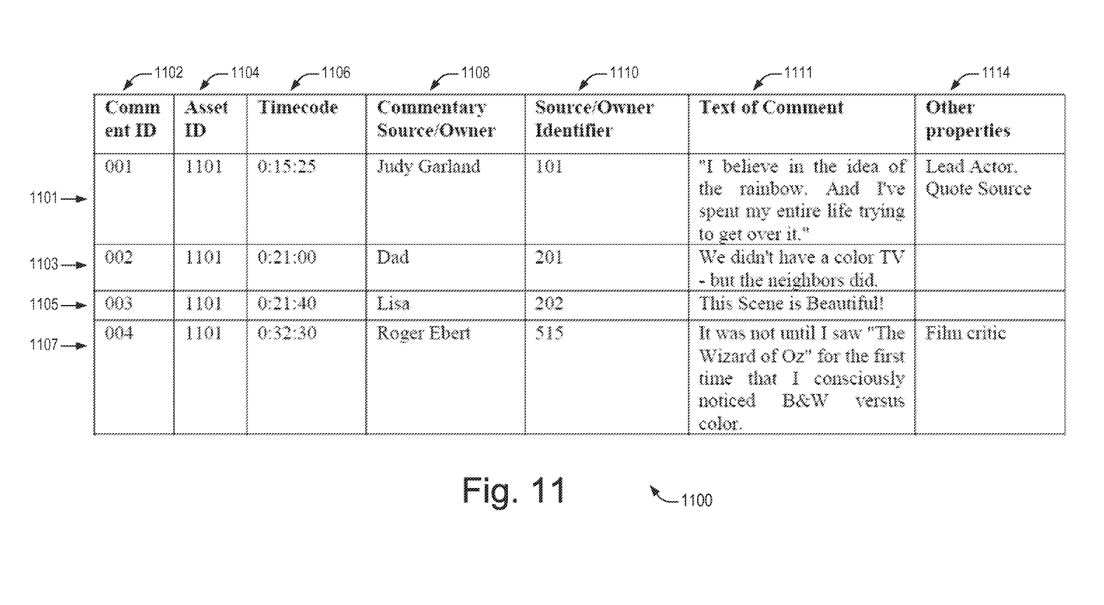

In the example screenshots of FIGS. 10-11, it is assumed that a user is viewing a movie (e.g., The Wizard of Oz) via the DAMAP Client Application (e.g., running on a client system). In this particular example, the display screen is shown divided into two main portions: the Video Player GUI (1002), and social commentary GUI (1010). It is further assumed in this example that several time-based comments from other users/3^{rd} parties have been associated and/or linked with specific timecodes of the movie currently being presented. When the movie is played at the client system, the movie timeline and associated timecode advances. The DAMAP Client Application continuously or periodically monitors the current status of the movie timeline and associated timecode.

In this particular example, for purposes of illustration, it is assumed that the DAMAP Client Application is also aware of several threaded commentaries which have been associated and/or linked with specific timecodes of the movie currently being played. For example, in at least one embodiment, when a user of the client system selects a movie or Transmedia Narrative to be played, the DAMAP Client Application may automatically and/or dynamically initiate one or more queries at the Commentary Server System (e.g., 180) to access or retrieve any threaded commentaries which may be associated with or linked to the movie identifier corresponding to movie or multimedia narrative which is currently being played at the client system. In at least one embodiment, the query may also include filter criteria which, for example, may be used to dynamically adjust the scope of the search to be performed and/or to dynamically broaden/narrow the set of search results.

In at least one embodiment, while the movie is being played at the client system, the DAMAP Client Application may be configured or designed to periodically initiate additional queries at the Commentary Server System (e.g., 180, FIG. 1) to access or retrieve any new or recent threaded commentaries which were not identified in any previous search results. Additionally, in at least one embodiment, the primary user is provided with the ability to selectively choose and filter the threaded discussions/comments (e.g., from other users/3^{rd} parties) which are allowed to be displayed on the primary user's Social Commentary GUI.

For purposes of illustration, it is assumed, in this particular example, that the DAMAP Client Application has identified 4 different time-based comments which are associated with the movie currently being presented at the client system, namely the following (also illustrated in FIG. 11):

| | | | Comment | Source/ | | |
|---|---|---|---|---|---|---|
| Comment | Asset | | Source/ | Owner | | Other |
| ID | ID | Timecode | Owner | Identifier | Text of Comment | properties |
| 1 | 1101 | 0:15:25 | Judy | 101 | “I believe in the idea of the | Lead Actor, |
| | | | Garland | | rainbow. And I've spent my | Quote Source |
| | | | | | entire life trying to get over it.” | |
| 2 | 1101 | 0:21:00 | Dad | 201 | We didn't have a color TV - but | |
| | | | | | the neighbors did. | |
| 3 | 1101 | 0:21:40 | Lisa | 202 | This Scene is Beautiful! | |
| 4 | 1101 | 0:32:30 | Roger Ebert | 515 | It was not until I saw “The | Film critic |
| | | | | | Wizard of Oz” for the first time | |
| | | | | | that I consciously noticed | |
| | | | | | B&W versus color. | |

In at least one embodiment, at least one commentary item (or record) may include various types of information, properties, and/or other criteria such as, for example, one or more of the following (or combinations thereof):
CommentID—this field may include an identifier which may be used to reference and identify at least one of the different commentary items.
Asset ID—this field may include an identifier which may be used to uniquely identify a particular movie, Transmedia Narrative, movie playlist (e.g., defining a collection of movies), and/or other types of media assets/content.
Timecode—this field may include one or more specific timecode(s) (e.g., to be associated with the Asset ID) at which the commentary text is to be visually displayed at the client system.
Comment Source/Owner—this field may include a name or nickname of the person/entity responsible for creating or originating the comment associated with that commentary item.
Owner/Source Identifier—this field may include an identifier which may be used to uniquely identify the person/entity responsible for creating or originating the comment associated with that commentary item.
Text of Comment—this field may include text (and/or other content) of the comment to be displayed at the client system.
Other properties—this may represent one or more additional fields which may be used for specifying other types of characteristics, properties and/or other details relating to the commentary item and/or its owner/originator.

Returning to the present example, as the movie is played at the client system, the DAMAP Client Application may continuously or periodically monitor the current status of the movie timeline and associated timecode. In at least one embodiment, when the DAMAP Client Application detects that the timecode value of the movie timeline matches a timecode value associated with an identified commentary item, the DAMAP Client Application may respond by displaying (e.g., in the Commentary GUI) the commentary text (and related information such as the originator's name) associated with the identified commentary item. In this way, the commentary information is displayed at substantially the same time that the movie timeline reaches the specified timecode value.

Thus, for example, as illustrated in the specific example screenshots of FIG. 10:
when the DAMAP Client Application detects that the current timecode status of the movie timeline matches a timecode value 0:15:25, it may display (or cause to be displayed) the comment (and corresponding originator info) associated with Comment ID 001;
when the DAMAP Client Application detects that the current timecode status of the movie timeline matches a timecode value 0:21:00, it may display (or cause to be displayed) the comment (and corresponding originator info) associated with Comment ID 002;
when the DAMAP Client Application detects that the current timecode status of the movie timeline matches a timecode value 0:21:40, it may display (or cause to be displayed) the comment (and corresponding originator info) associated with Comment ID 003;
when the DAMAP Client Application detects that the current timecode status of the movie timeline matches a timecode value 0:32:30, it may display (or cause to be displayed) the comment (and corresponding originator info) associated with Comment ID 004.

In at least some embodiments, the social commentary functionality of the DAMAP system may also be configured or designed to allow users to transmit and display threaded commentaries as they are in real-time (or substantially real-time). Thus, for example, two different users who are synchronously watching the same video/Transmedia Narrative on their respective client systems may benefit from being able to engage in a threaded discussion with at least one other in real-time.

In the specific example screenshots of FIG. 10, it is assumed that the user desires to join in on the threaded discussion by composing and sending out his own commentary. Accordingly, as shown in the example screenshot of FIG. 10, the user may be provided with a Contact GUI (1020) which enables the user to identify and select specific recipients (and/or groups of recipients) that may receive and view the user's comment(s) at their respective client systems. In at least one embodiment, an interface is provided for allowing the user to compose and post his commentary. In at least one embodiment, the DAMAP Client Application may be configured or designed to transmit the user's comments (and related commentary information such as, for example, Asset ID corresponding to the movie being played at the client system, timecode data representing the point in the movie timeline when the user composed the comment, comment text, Owner/Source Identifier information, recipient information, etc.) to the Commentary Server System. In at least one embodiment, the Commentary Server System may process and store the user's commentary information in a social commentary database and/or other database. The Commentary Server may also be operable to distribute or disseminate the user's comment(s) to other client systems for viewing by other users. The user's commentary may then be posted to the threaded discussion and displayed at the client systems of the intended recipients.

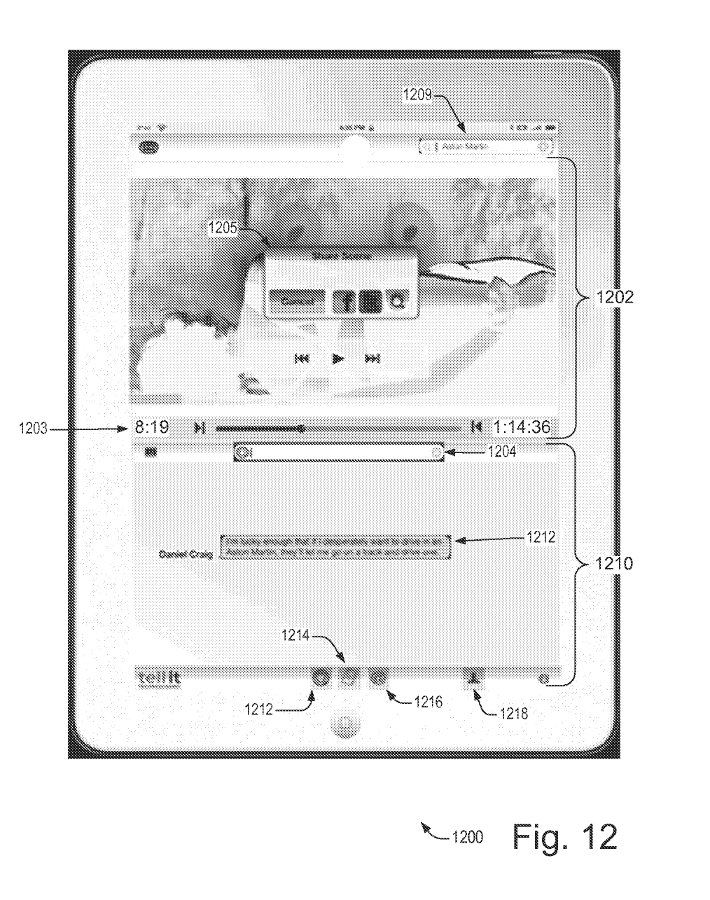

According to different embodiments, the DAMAP System may be operable to include other social commentary and social sharing features and functionalities which, for example, may enable a user perform one or more of the following activities (or combinations thereof):
Navigate or browse through a movie or multimedia narrative in order to identify and/or locate specific scenes/clips to be uploaded to one or more social networking sites and/or to be shared with selected recipients.
Specify the user's desired beginning and ending points of the video clip to be posted/shared.
Browse and select one or more social networking sites where the user's video clip is to be posted. (e.g., FIG. 12)
Browse and select one or more intended recipients for receiving notification of the user's posted video clip.
Tag, annotate, and/or provide comments to be associated with the user's posted video clip(s).

FIGS. 26-50 show various example embodiments of Transmedia Navigator application GUIs implemented on one or more client system(s). In some embodiments, the Transmedia Navigator application may be installed and deployed locally at one or more client systems (e.g., iPhones, iPads, personal computers, notebooks, tablets, electronic readers, etc.). In other embodiments, the Transmedia Navigator application may be instantiated at a remote server system (such as, for example, the DAMAP Server System) and deployed and/or implemented at one or more client systems via a web browser application (e.g., Microsoft Explorer, Mozilla Firefox, Google Chrome, Apple Safari, etc.) which is operable to process, execute, and/or support the use of scripts (e.g., JavaScript, AJAX, etc.), Plug-ins, executable code, virtual machines, HTML5, vector-based web animation (e.g., Adobe Flash), etc. In at least one embodiment, the web browser application may be configured or designed to instantiate components and/or objects at the Client Computer System in response to processing scripts, instructions, and/or other information received from a remote server such as a web server, DAMAP Server(s), and/or other servers described and/or referenced herein. In at least one embodiment, at least a portion of the Transmedia Navigator operations described herein may be initiated or performed at the DAMAP Server System. Examples of such components and/or objects may include, but are not limited to, one or more of the following (or combinations thereof):
UI Components such as those illustrated, described, and/or referenced herein.
Database Components such as those illustrated, described, and/or referenced herein.
Processing Components such as those illustrated, described, and/or referenced herein.
Other Components which, for example, may include components for facilitating and/or enabling the Client Computer System to perform and/or initiate various types of operations, activities, functions such as those described herein.

For example, as shown in the example screenshot embodiments illustrated in FIGS. 26-50, an HTML5-based version of the Transmedia Navigator may served from a remote server (e.g., DAMAP Server) and implemented at a client system (such as, for example, a PC-based or MAC-based computer) via a local Web browser application which supports HTML5.

FIG. 26 shows an example embodiment of a Transmedia Navigator GUI 2600. As illustrated in the example embodiment of FIG. 26, the Transmedia Navigator GUI may include one or more of the following (or combinations thereof): Video Player GUI 2610, Resources Display GUI 2630, Transmedia Navigator Menu GUI 2650, etc. The Resources Display GUI is operable to display a synchronized scrolling transcript of the audio portion of the video which is playing in the Video Player GUI. At least one of these GUIs may be maximized to full screen, or minimized.

As illustrated in the example embodiment of FIG. 26, the Transmedia Navigator Menu GUI may be operable to provide and/or facilitate access to a variety of features, functions and GUIs provided by the Transmedia Navigator application such as, for example, one or more of the following (or combinations thereof):

| | |
|---|---|
| Profile-related GUIs and features | Assessments-related GUIs and |
| Calendar-related GUIs and features | features |
| Courses-related GUIs and features | Bookmarks-related GUIs and |
| Groups-related GUIs and features | features |
| Social Networking-related GUIs and | Notes-related GUIs and features |
| features | Comments-related GUIs and |
| Episodes-related GUIs and features | features |
| Chapters-related GUIs and features | Search-related GUIs and features |
| Index-related GUIs and features | Transcript-related GUIs and |
| Instructions-related GUIs and features | features |
| Animations-related GUIs and features | Documents-related GUIs and |
| Simulations-related GUIs and features | features |
| Games-related GUIs and features | Links-related GUIs and features |
| | Slides-related GUIs and features |
| | Spreadsheets-related GUIs and |
| | features |
| | Comment-related GUIs and |
| | features |
| | Tools-related GUIs and features |
| | Etc. |

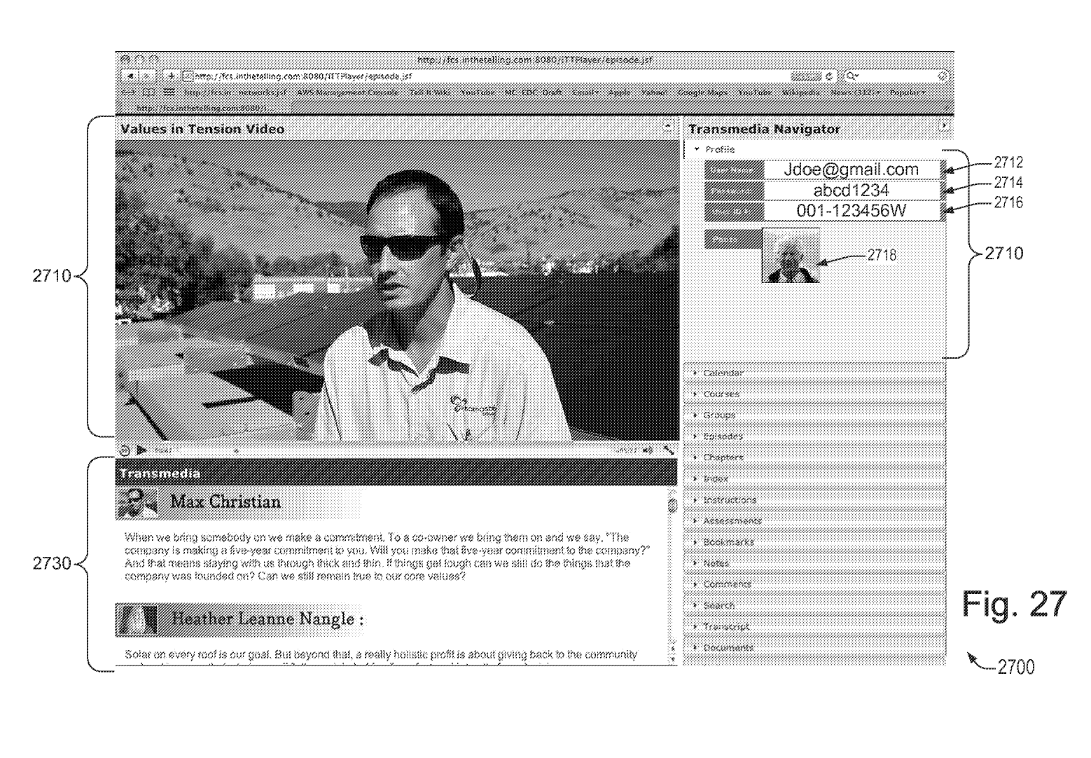

FIG. 27 shows an example embodiment of the Profile feature(s) in the Transmedia Navigator. The user may elect to provide a profile. Providing a profile has several advantages for the user, including facilitating in-App purchasing, enabling the ability to chat with other users, to join groups, to interact with other users' calendars, and to enable the user to quickly integrate information like schedules, class information, etc.

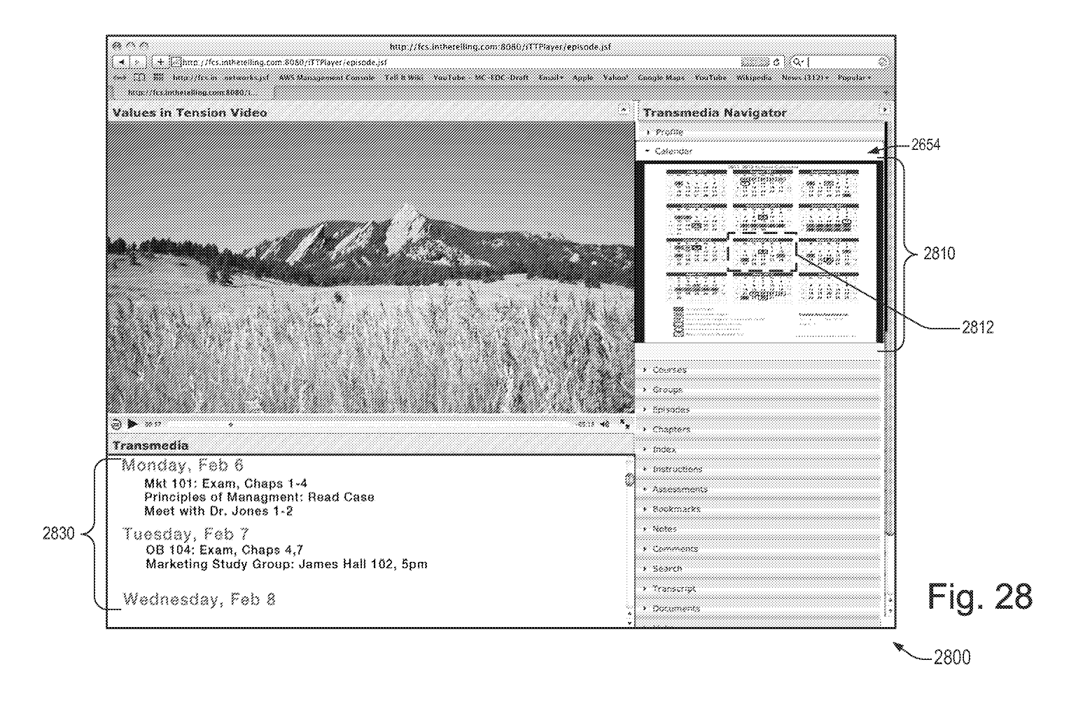

FIG. 28 shows an example embodiment of the Calendar feature(s) and related GUI(s) in the Transmedia Navigator. The user may tap or click on the Calendar bar to open the Calendar. Multiple calendars may be accessed, including personal calendars, class calendars, work calendars, etc. The Calendar may have more detailed information available, in which case the user may open the calendar in the Resources Display GUI to see more detail for a specific day/time/week/month, etc.

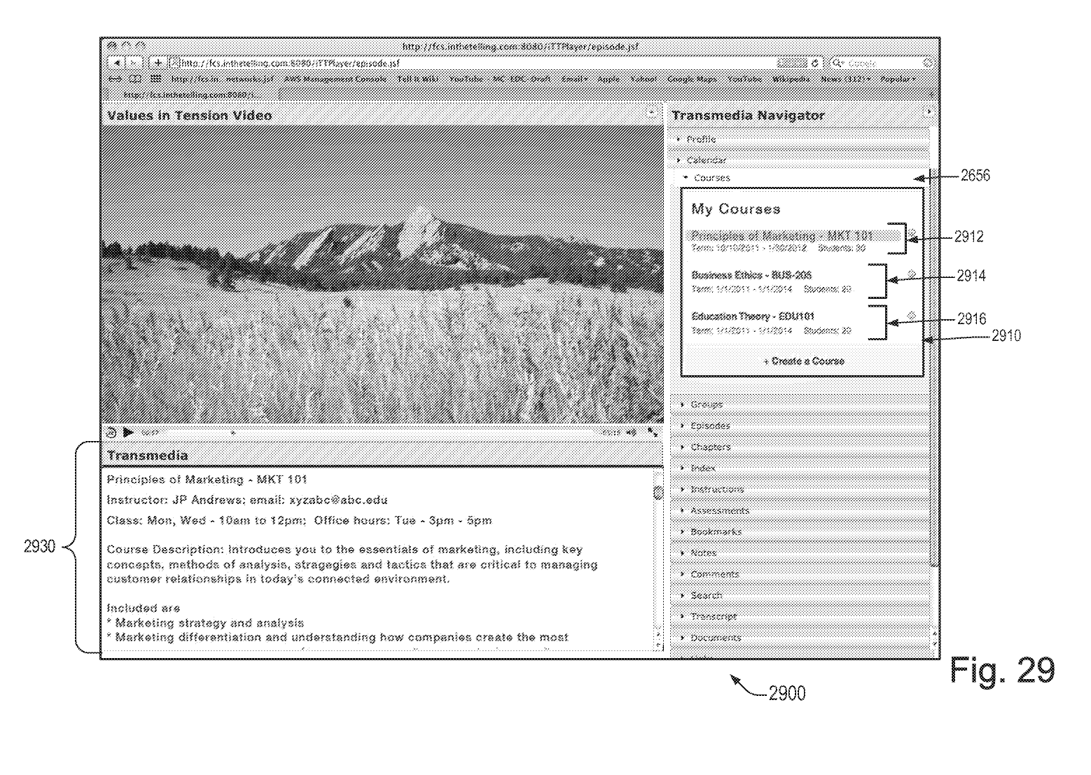

FIG. 29 shows an example embodiment of the Courses feature(s) and related GUI(s) in the Transmedia Navigator. The user may tap or click on the Course bar to see his/her courses. Tapping/clicking on any course in the Courses Navigator may show course detail in the Resources Display GUI.

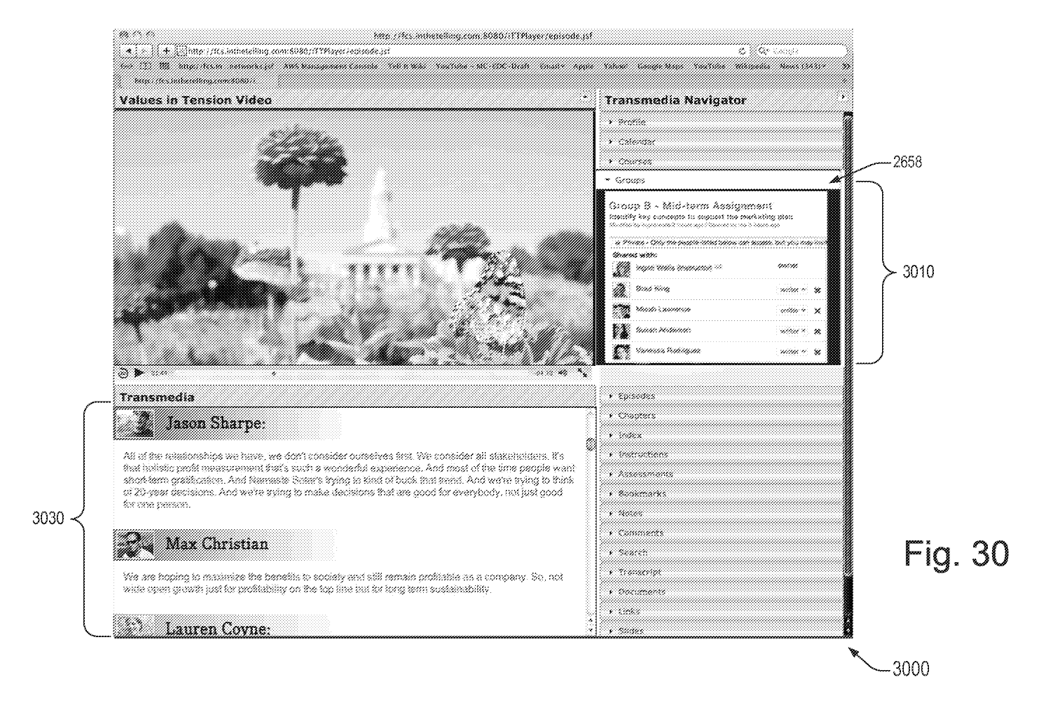

FIG. 30 shows an example embodiment of the Groups feature(s) and related GUI(s) in the Transmedia Navigator. The user may tap or click on the Groups bar to show a Group (or multiple groups) in which the user is participating. Tapping on the Group shows more detail in the Resources Display GUI. This example shows a group (Group B), along with an upcoming class assignment. Groups may be within a place of employment, an industry group, a social group, or any other affiliated group.

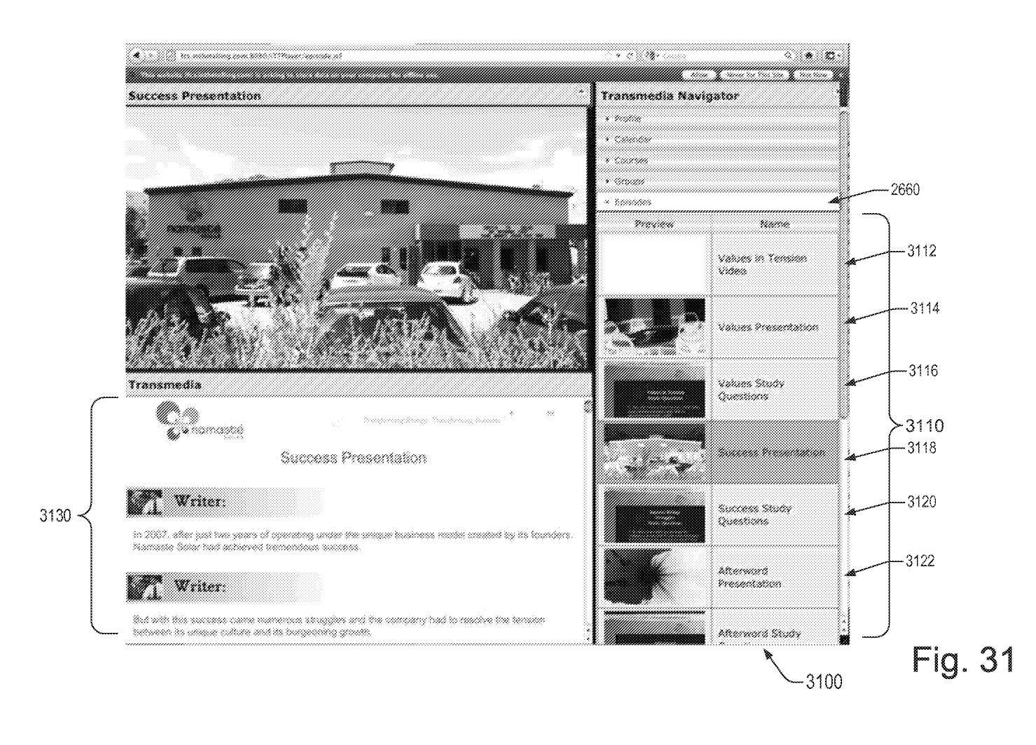

FIG. 31 shows the Episodes feature(s) and related GUI(s) and its navigation. Transmedia Narratives may be segmented into Episodes to provide logical sections within the overall Narrative. Tapping or clicking on any Episode takes the user to the beginning point of that Episode, and syncs one or more time-based feature(s) to the associated timecode, scene, or reference point.

According to specific embodiments, examples of various time-based features may include, but are not limited to, one or more of the following (or combinations thereof):
video playback
audio playback
image display/presentation
textual transcription presentation
commentary information
document display/presentation
notes display/presentation
and/or other types of resources/information which may be accessed by users and/or displayed or presented by the Transmedia Navigator at specified times.

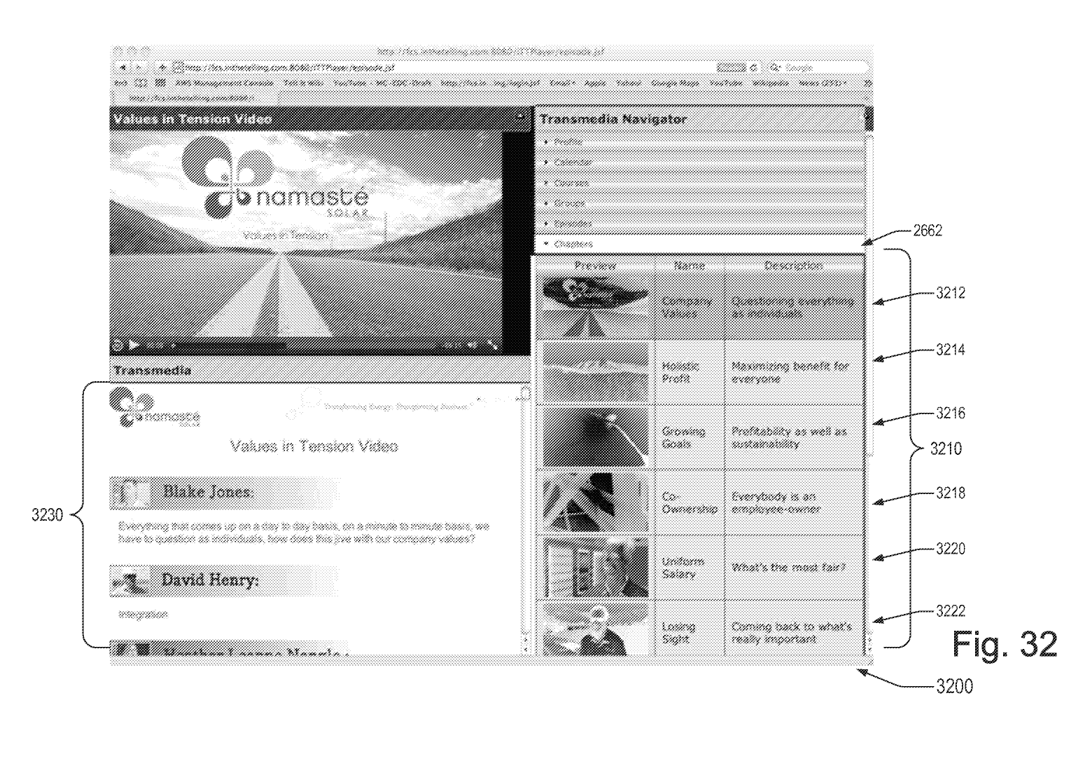

FIG. 32 shows an example embodiment of the Chapters feature(s) and related GUI(s) and navigation. Chapters are smaller segments within an Episode. Tapping or clicking on the Chapter takes the user to the beginning point of that Chapter, and syncs one or more time-based feature(s) to the associated timecode, scene, or reference point.

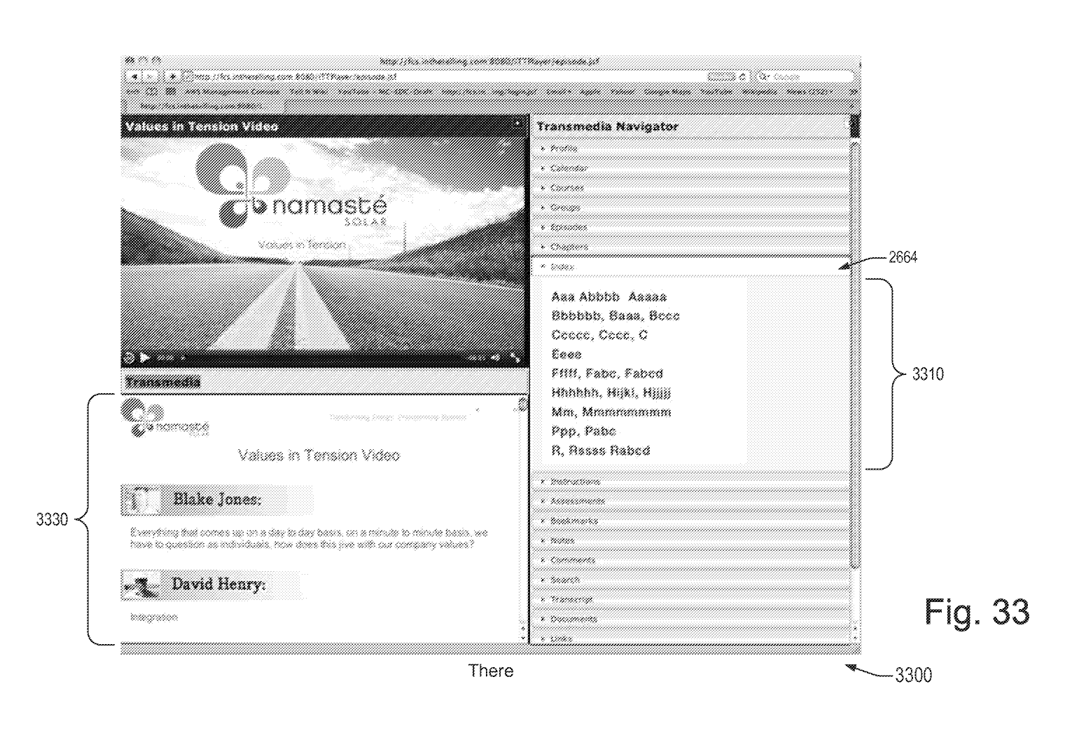

FIG. 33 shows an example embodiment of the Index feature(s) and related GUI(s). The Index includes an alphabetized index of subjects and topics within the Narrative. Tapping/clicking on any index feature(s) takes the user to the associated timecode, scene, or reference point within the Narrative, and syncs one or more time-based feature(s) to that associated timecode, scene, or reference point.

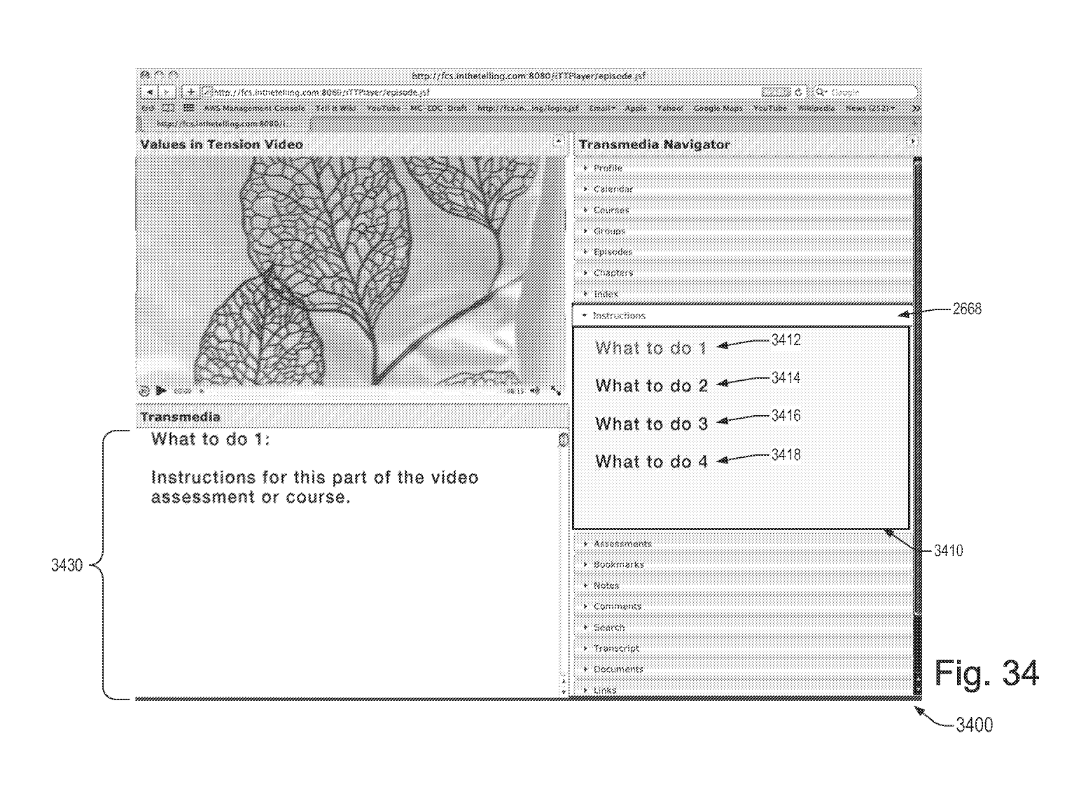

FIG. 34 shows example embodiments of the Instructions feature(s) and related GUI(s) and functionality. Instructions may be used to inform the user about a specific set of steps for a class assignment, a work assignment, a training procedure, or any process that informs the user about what to do. Tapping/clicking on the Instruction in the Transmedia Navigator GUI shows more detail in the Resources Display GUI.

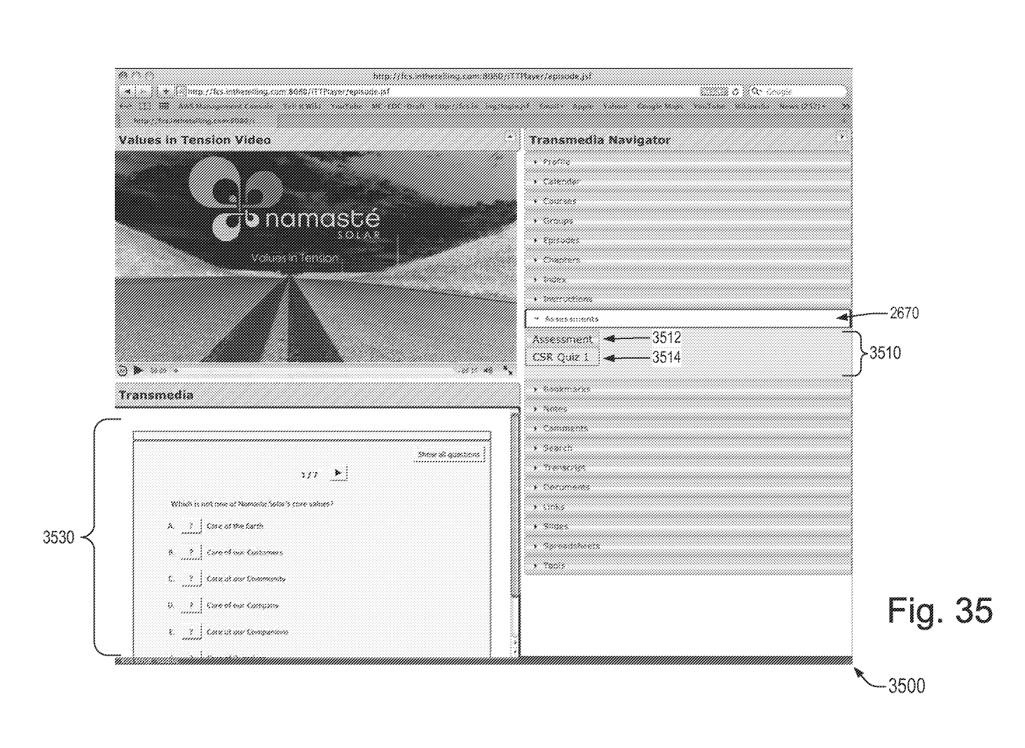

FIG. 35 shows example embodiments of the Assessments feature(s) and related GUI(s) and functionality. Assessments are used to determine the user's grasp of the material being presented in the Transmedia Narrative. They may be accessed by tapping/clicking on the Assessments bar, and may also appear automatically at specific areas within the Narrative when a student may go through the Assessment before proceeding to the next section of the Narrative. When an Assessment is accessed, it comes into the Resources Display GUI.

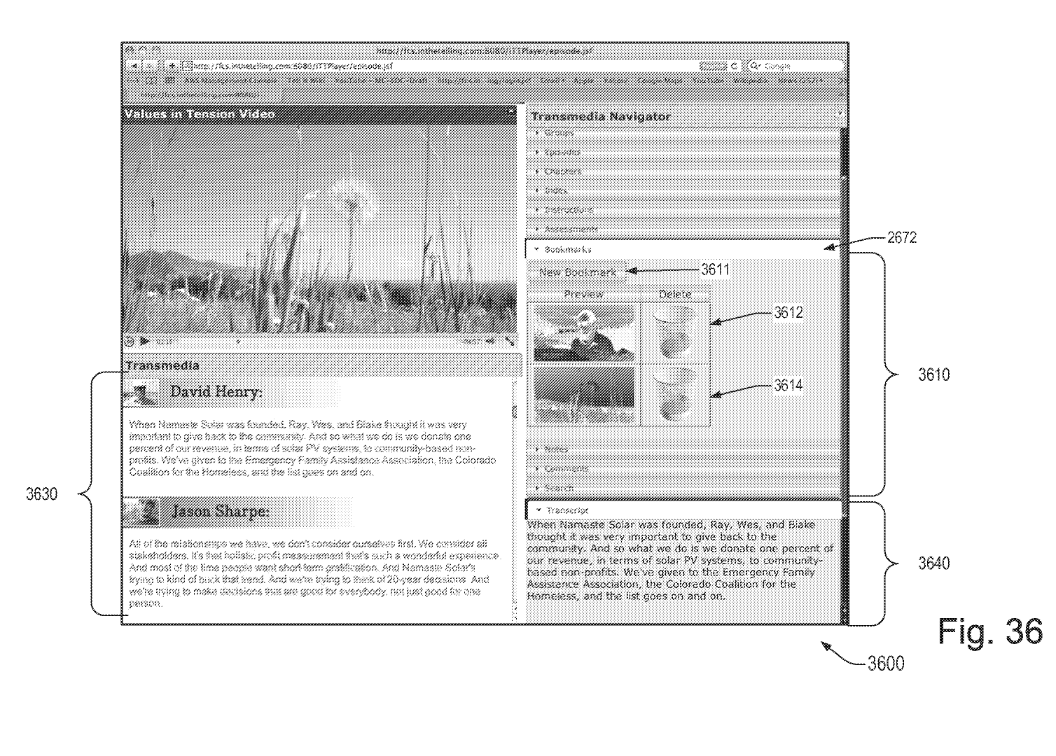

FIG. 36 shows example embodiments of the Bookmarks feature(s) and related GUI(s) and functionality. Bookmarks are created and deleted by the user, and are comprised of “idea segments.” At least one idea segment is a logical grouping of sentences that, together, form a contextually tied idea, concept, or statement. To create a bookmark, the user taps/clicks on the New Bookmark tab within the Bookmark section of the Transmedia Navigator. The idea segment for the associated timecode, scene, or reference point in the Narrative becomes a new Bookmark. This section also shows how multiple Transmedia Navigator feature(s) may be opened simultaneously (in this case, the Bookmarks and Transcript feature(s)) to enable the user to have more information and media content at hand.

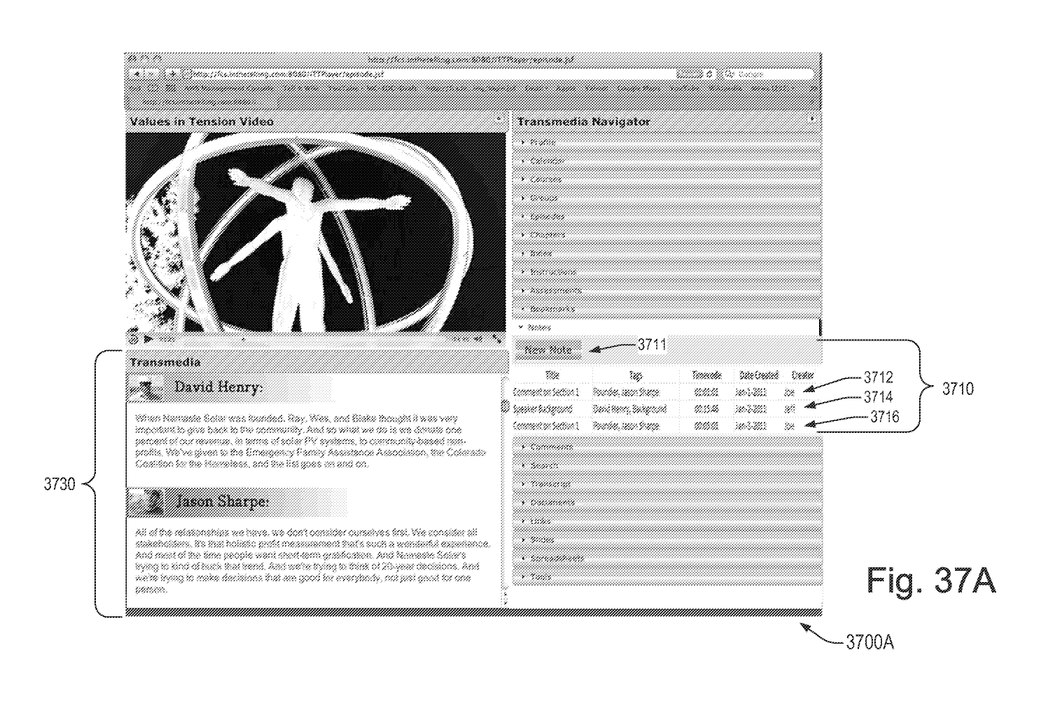

FIGS. 37A-37B show example embodiments of the Notes feature(s) and related GUI(s) in the Transmedia Navigator. When clicking or tapping on notes, the user may open the Note Editor. Notes that are created are placed in sync along the timeline with the video and one or more other synced Navigator feature(s).

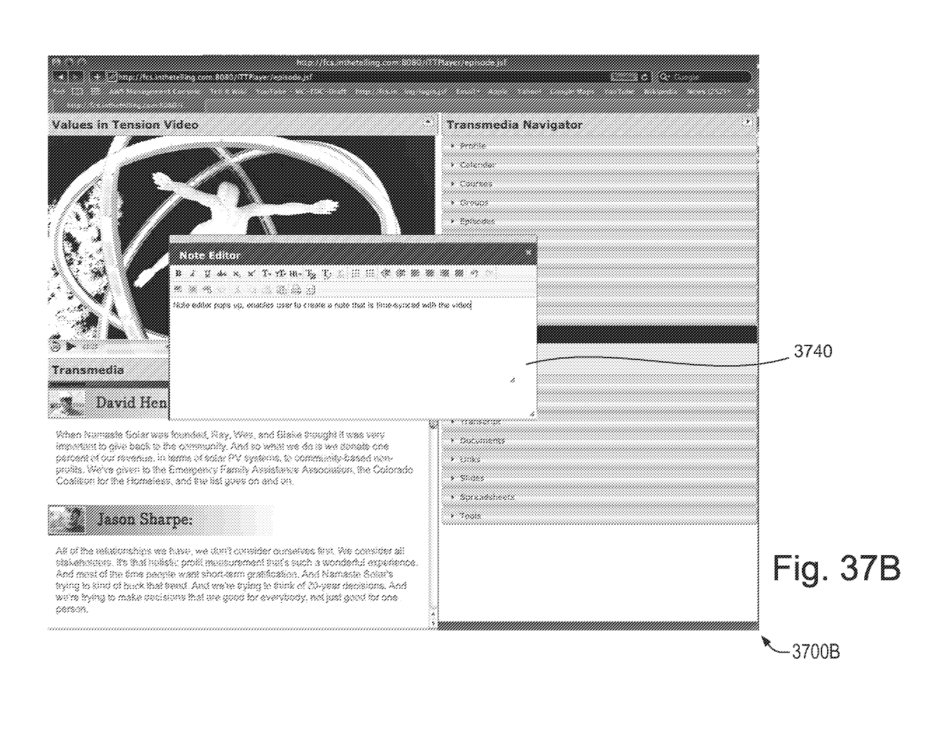

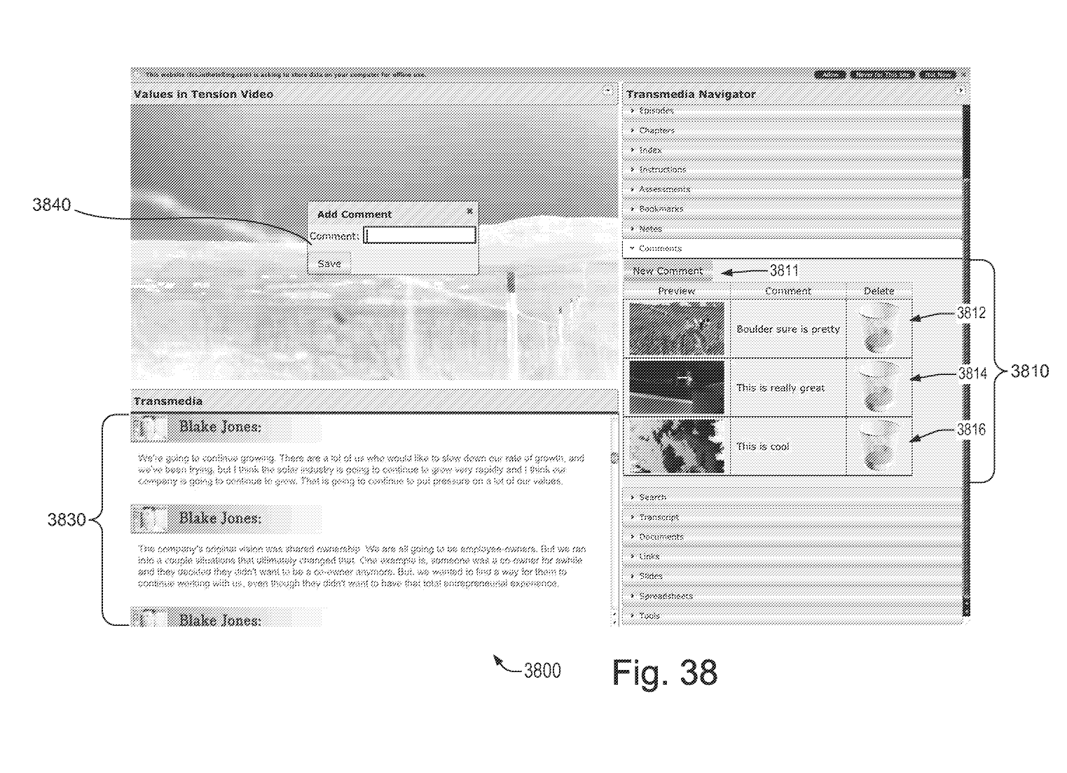

FIG. 38 shows an example embodiment of the Photos feature(s) and related GUI(s) of the Transmedia Navigator. At any moment in the Transmedia Narrative, the user may create a new photo. Tapping/clicking on the Photos bar opens the Photos feature(s), and shows one or more the photos that the user has created. To add a new photo, the user taps/clicks on the New Photo tab, and a GUI pops up, enabling the user to create a photo. Once created, that photo appears in the Photo feature(s), and is time-synced with the video and other time-synced feature(s). Photos may also be shared with other users.

FIG. 39 shows an example embodiment of the Search feature(s) and related GUI(s) and functionality. Tapping/clicking on the Search bar in the Transmedia Navigator opens a Search GUI. The user may then type the word or phrase they are searching for, and one or more instances of that word or phrase appear as search results. Tapping/clicking on any of the results may take the user to the associated timecode, scene, or reference point in the Transmedia Narrative, and may sync one or more other time-synced feature(s) to that associated timecode, scene, or reference point.

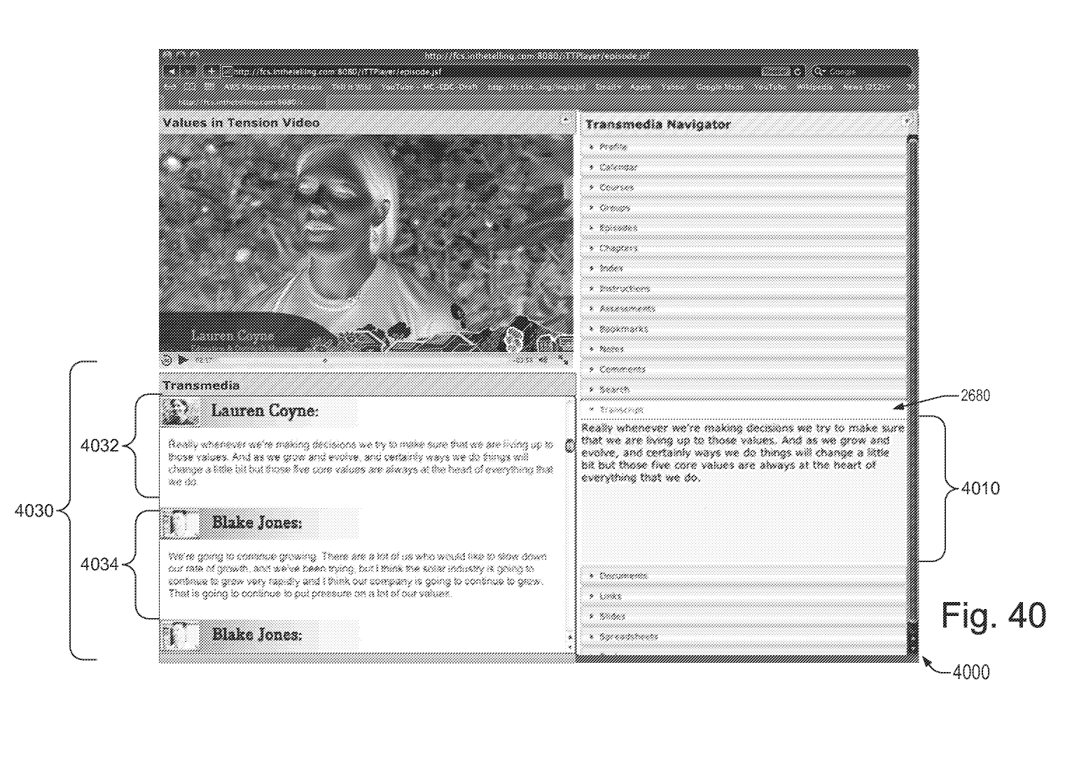

FIGS. 40-41 show example embodiments of the Transcript feature(s) and related GUI(s) and functionality. The video transcript may be generated verbatim, or automatically using video-to-text translation software. Transcripts are comprised of “idea segments.” At least one idea segment is a logical grouping of sentences that, together, form a contextually tied idea, concept, or statement. The transcript is often displayed in the Transmedia Player as an adjunct to the video. It is also available in the Transcript feature(s) within the Transmedia Navigator. Tapping on the Transcript bar opens the feature(s), and shows the idea segment that is time-synced with the moment of the video that is being played. Like other feature(s) in the Transmedia Navigator, the Transcript may be shown simultaneously with other feature(s) in the Transmedia Player. In this case, the Transcript is shown in the Navigator while a slide is shown in the Transmedia Player, enabling the user to have several media and content types available simultaneously.

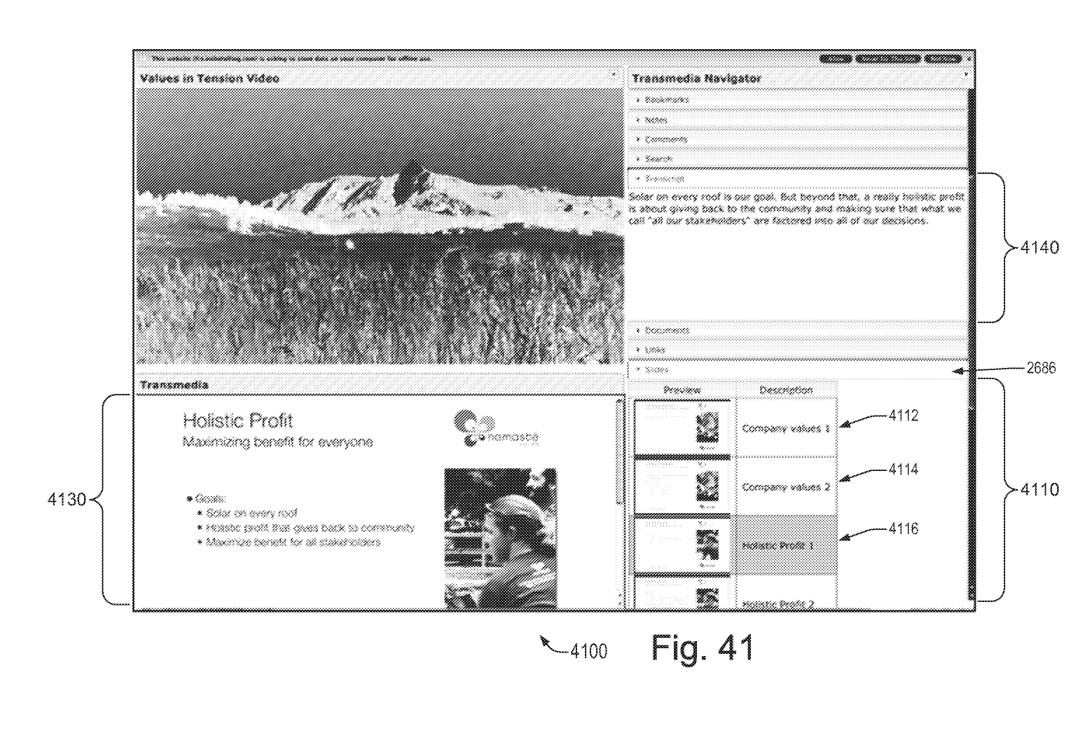

FIG. 42 shows example embodiments of the Documents feature(s) and related GUI(s) and functionality. Tapping/clicking on the Documents bar opens the feature(s), and shows a list of available documents tied to the Narrative. Tapping/clicking on any of the documents opens that document in the Transmedia Player.

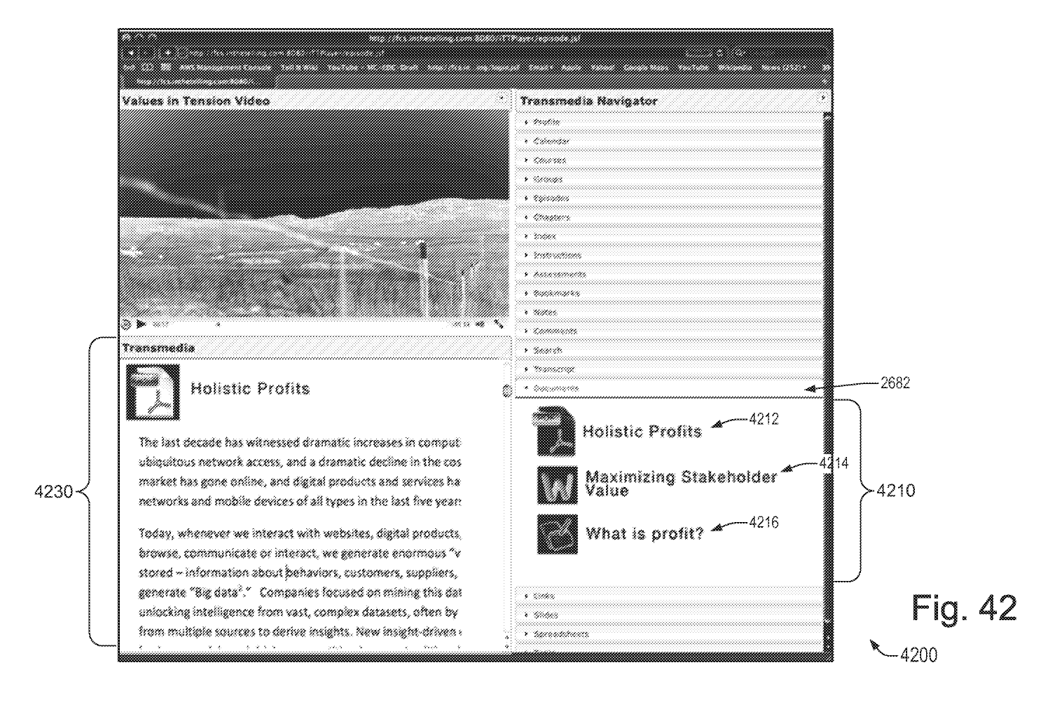

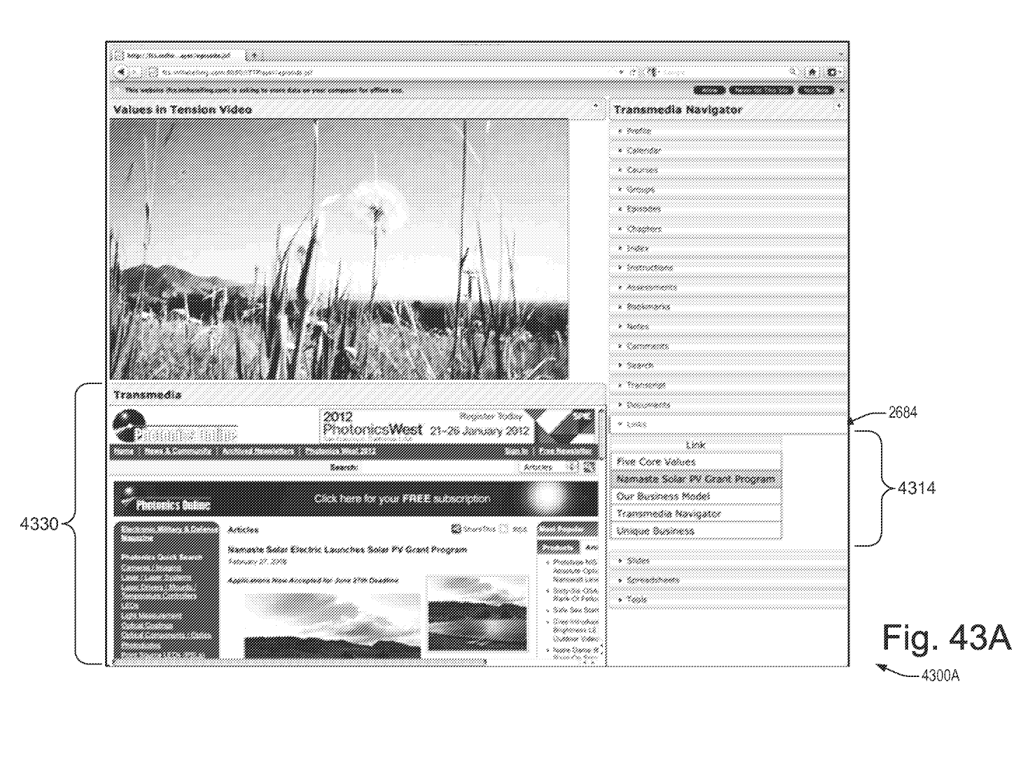

FIGS. 43A-43B show example embodiments of the Links feature(s) and related GUI(s) and functionality. Tapping/clicking on the Links bar opens the feature(s), and shows a list of available URL links for that Narrative. The specific link that is associated with the moment in the video at the time when the Links feature(s) is opened is highlighted. Tapping on any link within the Links feature(s) may take the user to that link and its associated moment in the video. The Web page that has been accessed in the Player may be maximized, and the user may use the navigation feature(s) of the accessed Web page.

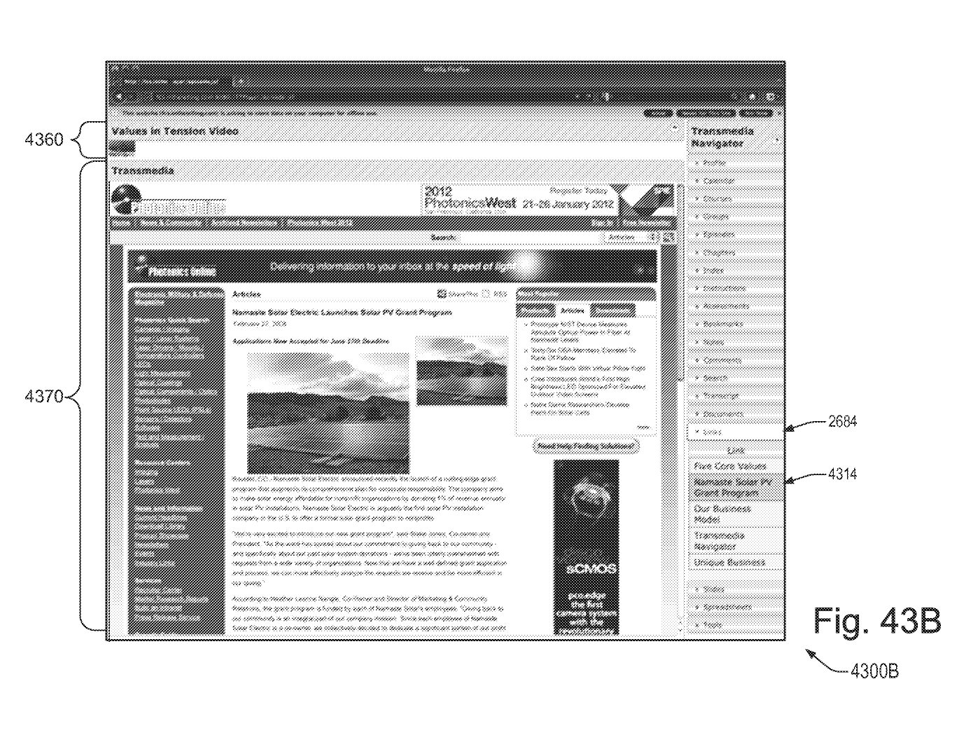

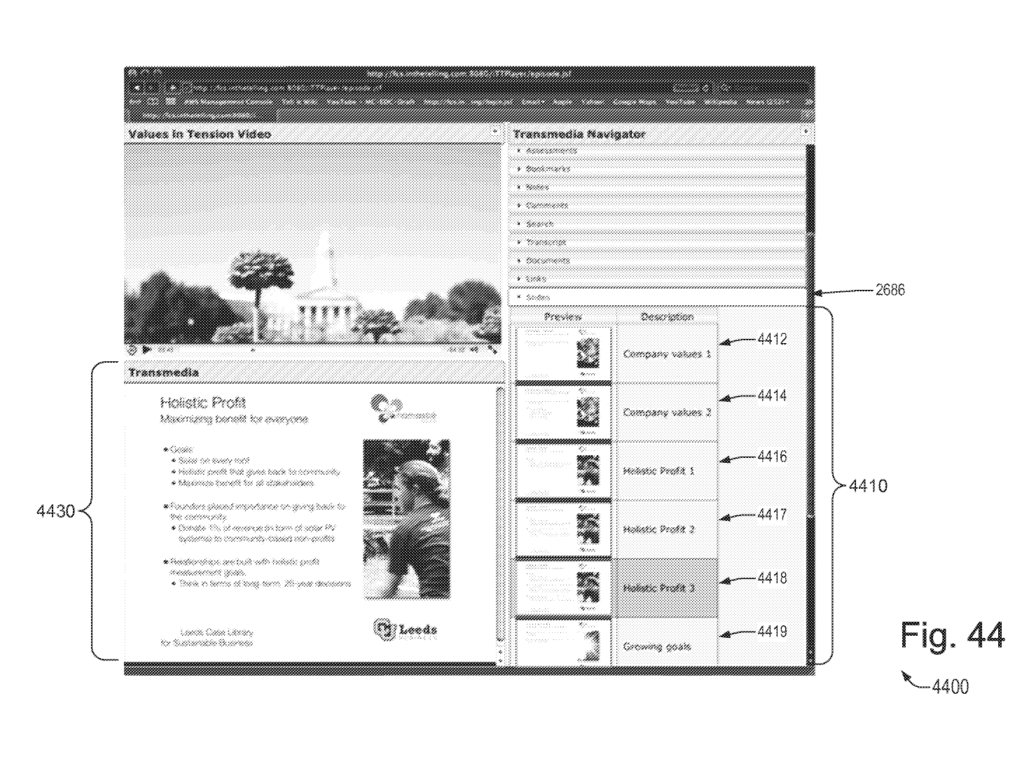

FIG. 44 shows an example embodiment of the Slides feature(s) and related GUI(s) and functionality. Tapping/clicking on the Slides bar in the Transmedia Navigator opens the feature(s) to show a list of presentation slides that are associated with the Transmedia Narrative. The specific slide that is associated with the moment in the video at the time when the Slides feature(s) is opened is highlighted. Tapping on any slide within the Slide feature(s) may take the user to that slide and its associated moment in the video, and may open the slide in the Transmedia Player.

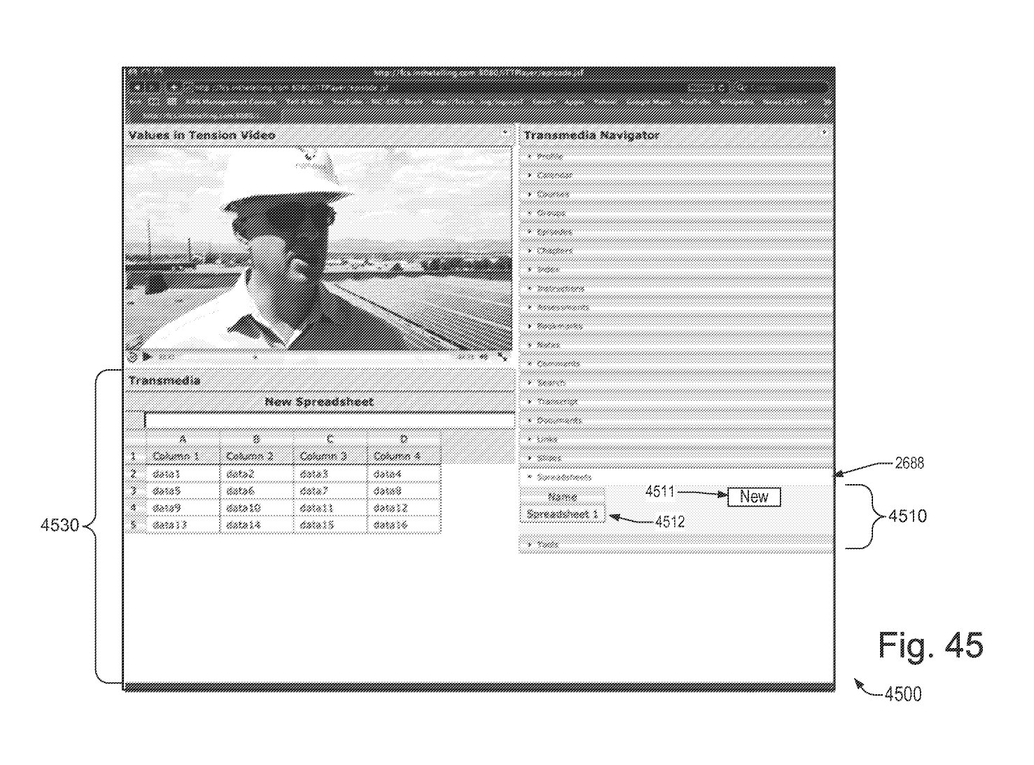

FIG. 45 shows an example embodiment of the Spreadsheets feature(s) and related GUI(s) and functionality. Tapping/clicking on the Spreadsheets bar in the Transmedia Navigator opens the feature(s) to show a list of spreadsheets that are associated with the Transmedia Narrative. The specific spreadsheet that is associated with the moment in the video at the time when the Spreadsheet feature(s) is opened is highlighted. Tapping on any spreadsheet within the Spreadsheet feature(s) may take the user to that spreadsheet and its associated moment in the video, and may open the spreadsheet in the Transmedia Player. Spreadsheets may be static, or may enable the user to interact with them.

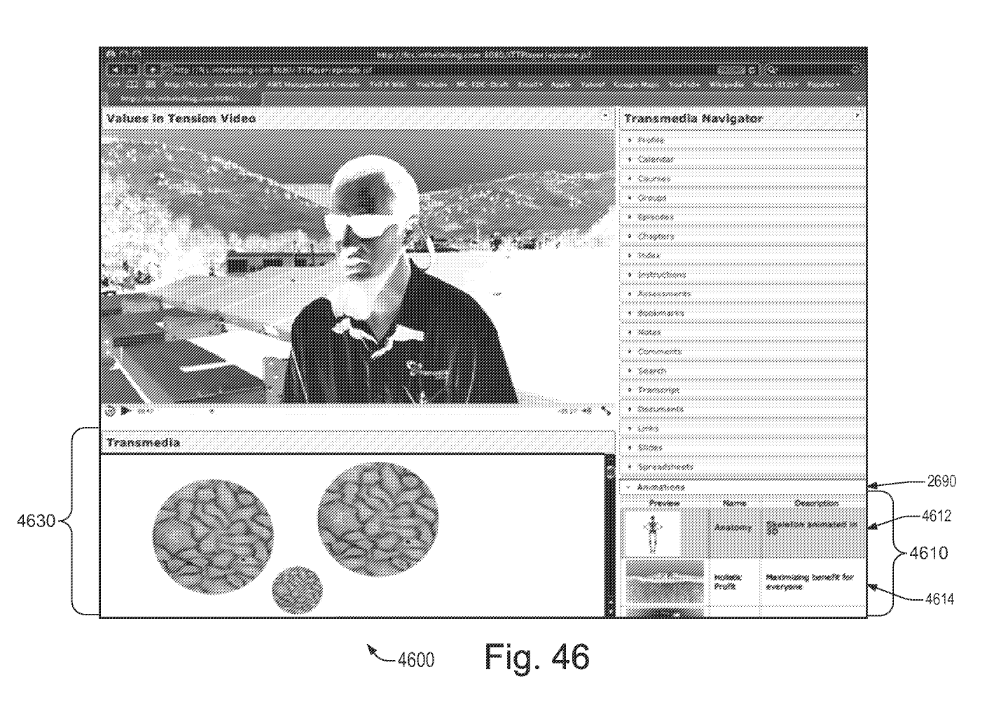

FIG. 46 shows the Animations feature(s) and related GUI(s) and functionality. Tapping/clicking on the Animations bar in the Transmedia Navigator opens the feature(s) to show a list of animations that are associated with the Transmedia Narrative. The specific game that is associated with the moment in the video at the time when the Animation feature(s) is opened is highlighted. Tapping on any animation within the Animation feature(s) may take the user to that animation and its associated moment in the video, and may open and play the animation in the Transmedia Player.

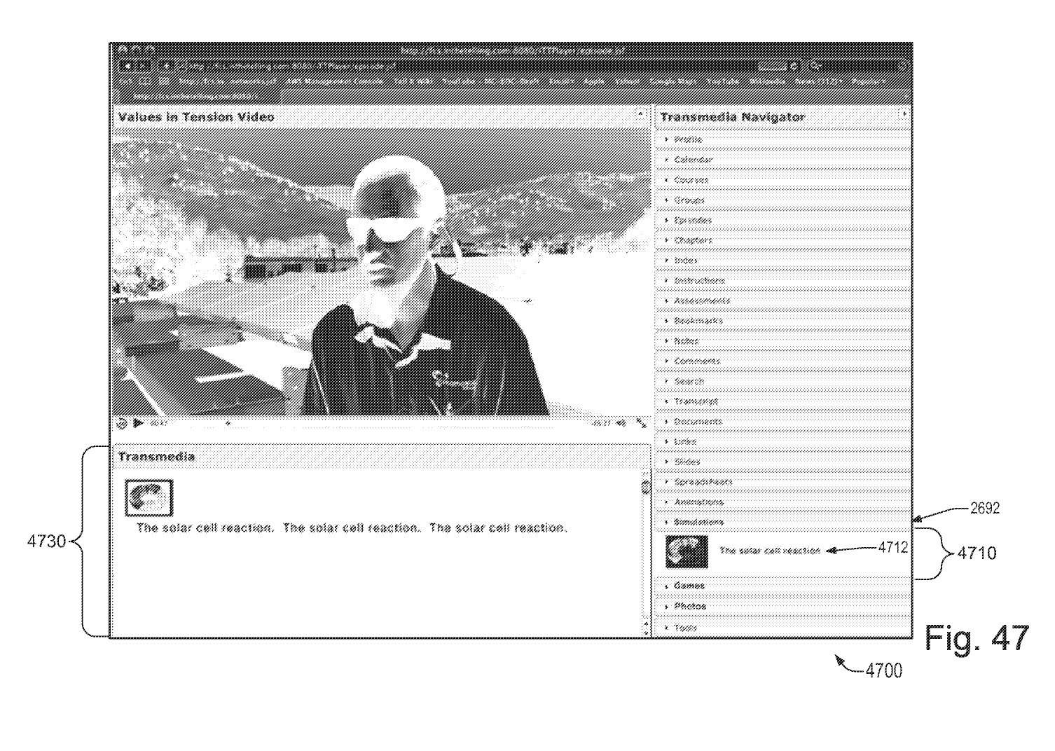

In at least one embodiment, interactive games and simulations may be integrated as events within Transmedia Narratives. For example, FIG. 47 shows the Simulations feature(s) and related GUI(s) and functionality. Tapping/clicking on the Simulations bar in the Transmedia Navigator opens the feature(s) to show a list of simulations that are associated with the Transmedia Narrative. The specific simulation that is associated with the moment in the video at the time when the Simulation feature(s) is opened is highlighted. Tapping on any simulation within the Simulation feature(s) may take the user to that simulation and its associated moment in the video, and may open and play the simulation in the Transmedia Player.

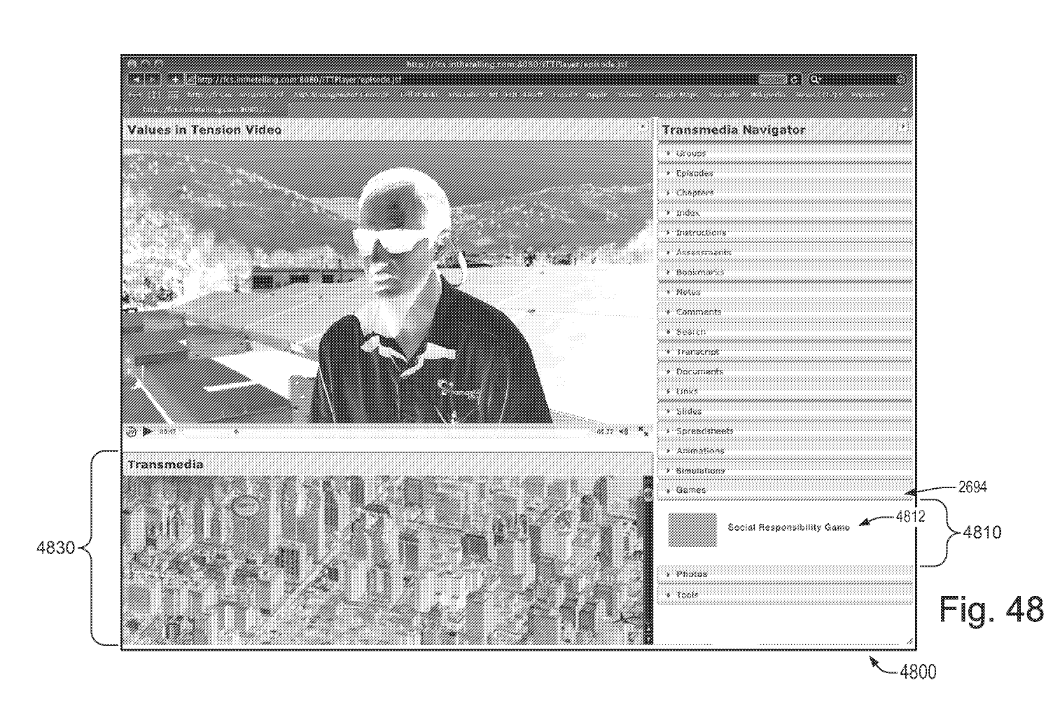

FIG. 48 shows the Games feature(s) and related GUI(s) and functionality. Games may be used within educational, training, and entertainment settings. The Transmedia Narrative is interleaved to game play that lets a user play and interact with a game that simulates real-world situations, processes, tasks, challenges, crises, etc. Tapping/clicking on the Games bar in the Transmedia Navigator opens the feature(s) to show a list of games that are associated with the Transmedia Narrative. The specific game that is associated with the moment in the video at the time when the Game feature(s) is opened is highlighted. Tapping on any game within the Game feature(s) may take the user to that game and its associated moment in the video, and may open the game and enable the user to play the game in the Transmedia Player.

For example, imagine a STEM course for K-12 on Xbox Connect where the video narrative is interleaved to game play that lets a user simulate activities such as, for example: adding the cap head to a well, mixing virtual chemicals to see the reaction, etc. such educational games may be interspersed into the Transmedia Narrative structure.

In some embodiments, advertisements may also be integrated as events within Transmedia Narratives. For example, in at least one embodiment, advertisement events may be programmed in such that the equivalent of a pop up add may be authored into specific moments in the Transmedia Narrative.

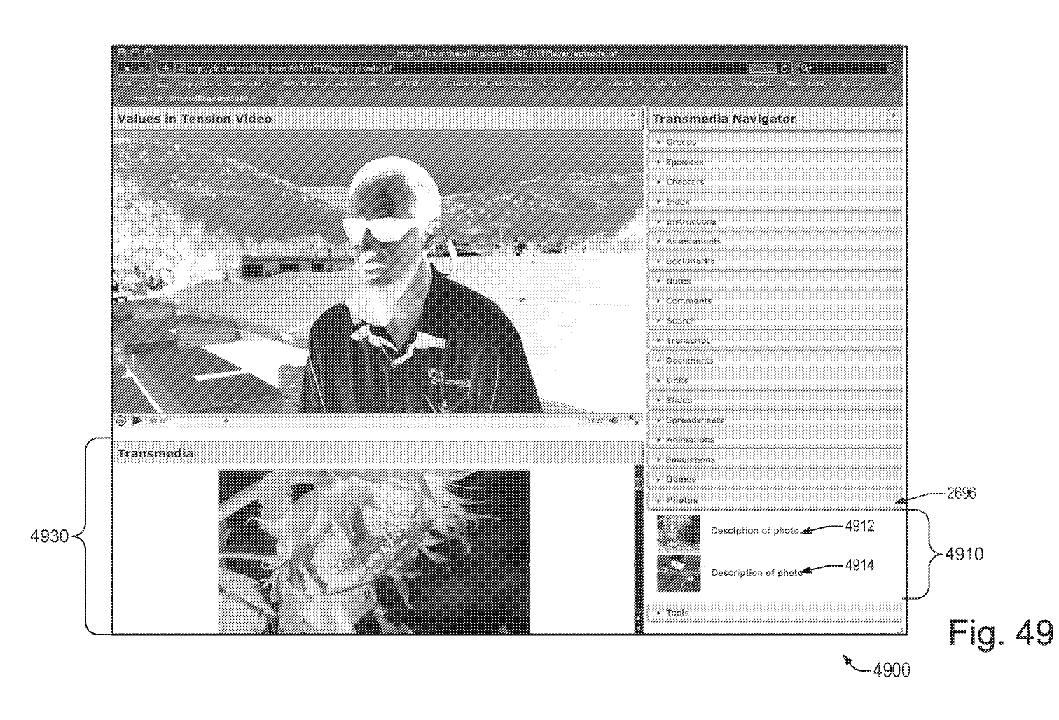

FIG. 49 shows the Photos feature(s) and related GUI(s) of the Transmedia Navigator. Tapping/clicking on the Photos bar opens the Photos feature(s), and shows one or more the photos that are associated with the Transmedia Narrative. Tapping/Clicking on a photo may take the user to the associated timecode, scene, or reference point in the Narrative, and open the photo in the Transmedia Player. The photo is time-synced with the video and other time-synced feature(s). Photos may also be shared with other users.

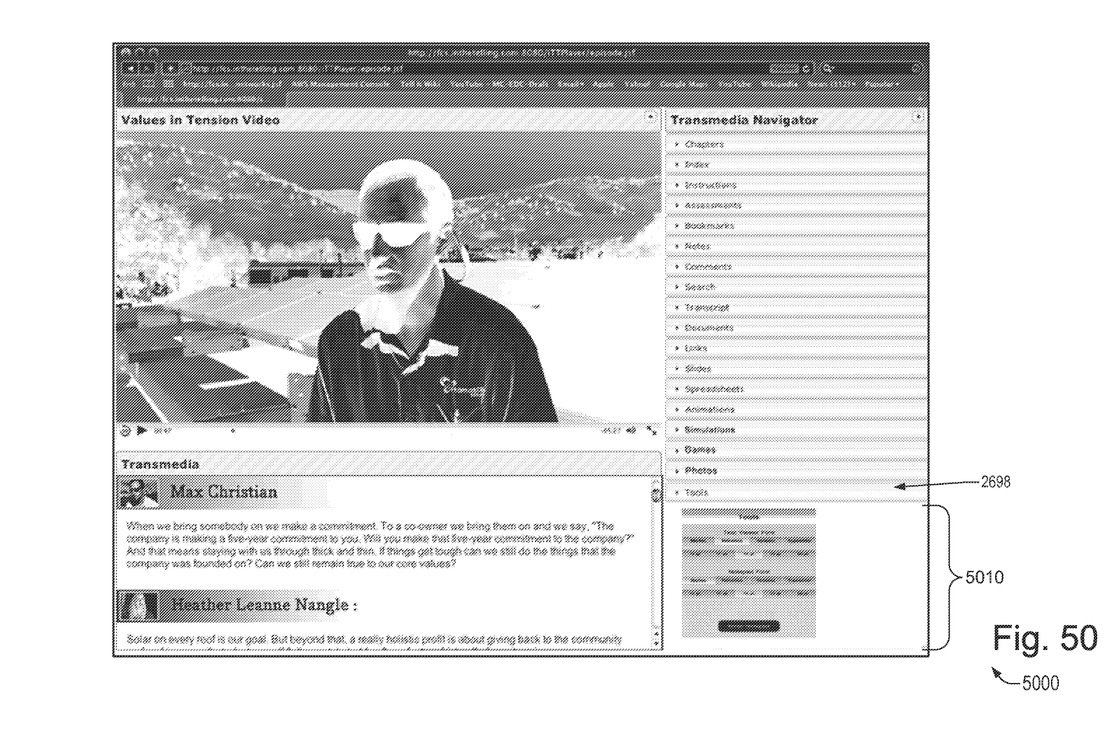

FIG. 50 shows the Tools feature(s) and related GUI(s). Tools include the ability to email notes, to change fonts, to change font sizes. The Tools feature(s) may also enable the user to set preferences for the Transmedia Navigator, the Transmedia GUI, and other feature(s).

### Specific Example Embodiment(s) of Transmedia Narrative Authoring

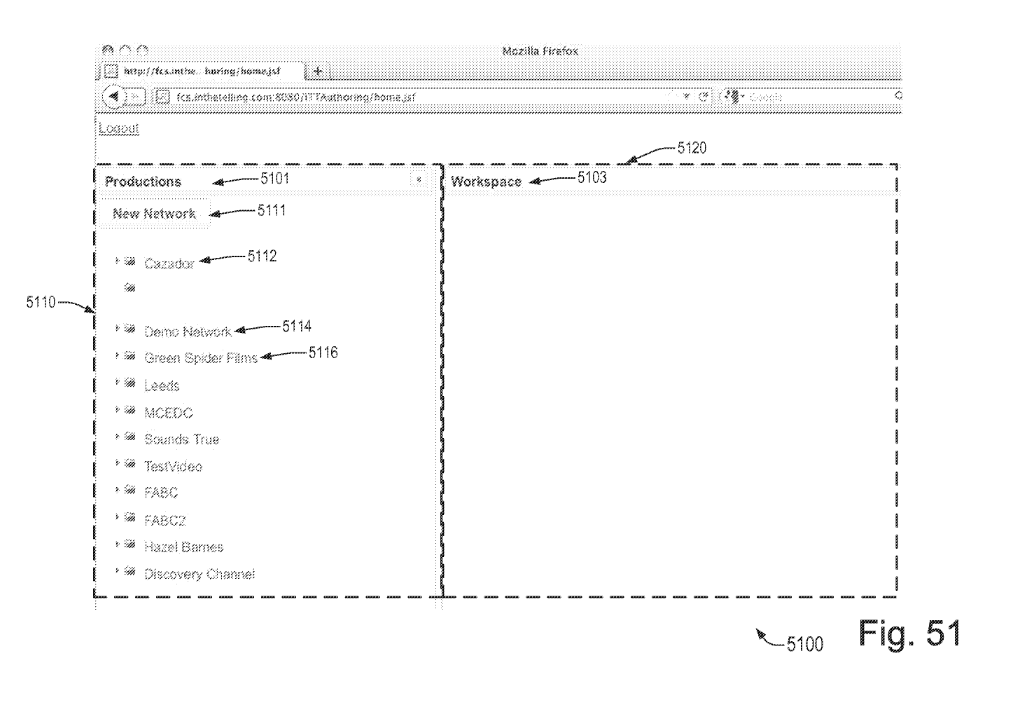

FIGS. 51-85 show various example embodiments of Transmedia Narrative Authoring data flows, architectures, hierarchies, GUIs and/or other operations which may be involved in creating, authoring, storing, compiling, producing, editing, bundling, distributing, and/or disseminating Transmedia Narrative packages. In at least one embodiment, a Transmedia Narrative Authoring application may be used to facilitate, initiate and/or perform various activities relating to the authoring, producing, and/or editing of Transmedia Narrative packages. As described herein, the term “Transmedia Narrative Authoring application” may also be referred to herein by it's trade name(s) iTell Author and/or Appetize.

In some embodiments, the Transmedia Narrative Authoring application may be installed and deployed locally at one or more client systems or local server systems. In other embodiments, the Transmedia Narrative Authoring application may be instantiated at a remote server system (such as, for example, the DAMAP Server System) and may be deployed and/or implemented at one or more client systems via a web browser application (e.g., Microsoft Explorer, Mozilla Firefox, Google Chrome, Apple Safari, etc.) which is operable to process, execute, and/or support the use of scripts (e.g., JavaScript, AJAX, etc.), Plug-ins, executable code, virtual machines, HTML5, vector-based web animation (e.g., Adobe Flash), etc. In at least one embodiment, the web browser application may be configured or designed to instantiate components and/or objects at the Client Computer System in response to processing scripts, instructions, and/or other information received from a remote server such as a web server, DAMAP Server(s), and/or other servers described and/or referenced herein. In at least one embodiment, at least a portion of the Transmedia Narrative Authoring operations described herein may be initiated or performed at the DAMAP Server System.

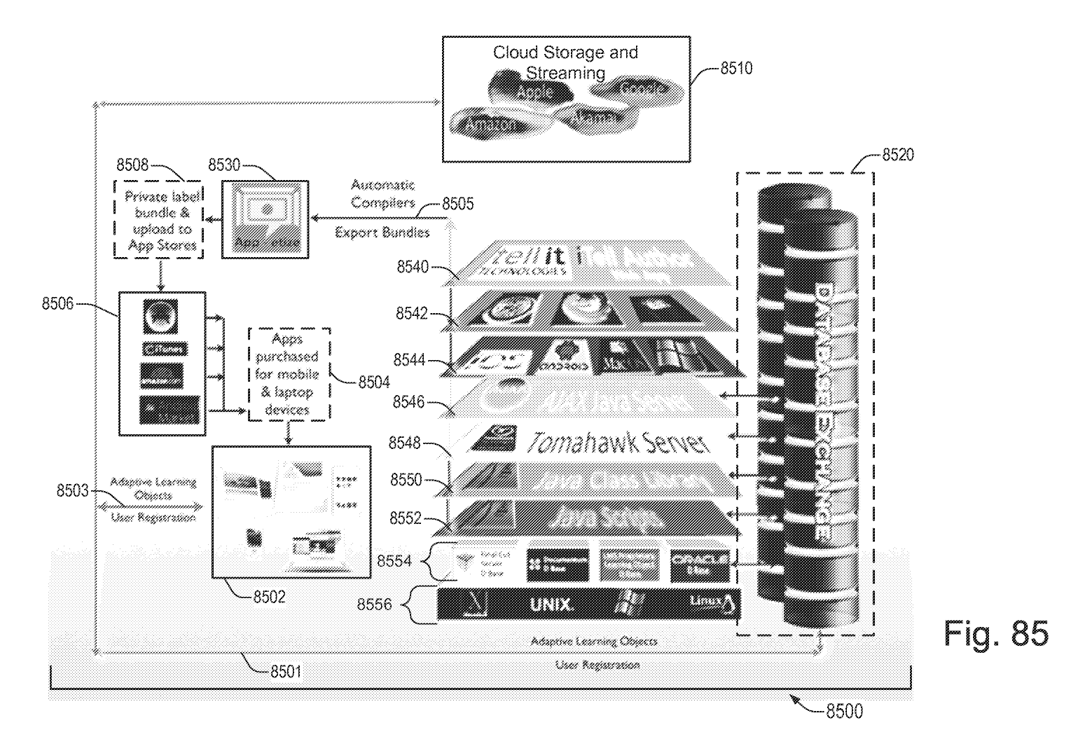

FIG. 85 illustrates an example embodiment of the various processes, data flows, and operations which may be involved in creating, authoring, storing, compiling, producing, bundling, distributing, and disseminating a Transmedia Narrative package. As illustrated in the example embodiment of FIG. 85, data and content for authored Transmedia Narratives may be stored and exchanged in database exchanges (8520). Database exchanges may be used to house assets, to procure assets, and to exchange assets as they are processed through the Transmedia Narrative Authoring application. Assets are brought into data base management systems and learning management systems (8556), which are run on operating systems, such as UNIX, Windows, Linux, and OSX (8556). In one embodiment, the Transmedia Narrative Application (Transmedia Narrative package) is created, organized, and processed using Java Scripts (8552), which are then compiled in a Java Class Library (8550). Tomahawk Server (8548) processes compiled library files along with AJAX Java Server (8546). Once the objects are processed, the Authored project is compiled for operating systems and platforms (8544), such as iOS, Android, MacOS, Windows, and HTML5. The HTML5 version (8540) is enabled for one or more major browsers (8542), including Safari, FireFox, Internet Explorer, and more.

When the Transmedia Narrative has been Authored, the Transmedia Narrative code, contents, and authored Transmedia Narrative are compiled automatically (8505), and bundled as a fully functioning Transmedia Narrative package (8530). The Transmedia Narrative package may include several series, as well as the accompanying content within at least one series. Once the Transmedia Narrative package is bundled, it may be private labeled. The Transmedia Narrative package is then uploaded to App Stores (8508), and may be bundled for clients as a private label (8508).

App Stores (8506) may be distributors for the Transmedia Narrative package. Customers purchase the Transmedia Narrative package from an App Store (8504) for mobile devices and/or desktop computers (8502). Mobile devices include tablets, smartphones, and hybrid e-readers. The Transmedia Narrative package may also be made available on an enterprise level to large organizations, where it is housed in that organization's server and/or storage system(s).

A Transmedia Narrative package includes the Transmedia Narrative content, which is made up of the Transmedia Narrative elements like video files, audio files, slides, transcripts, photos, documents, quizzes and assessments, speaker images, comments, notes, graphics, spreadsheets, animations, simulations, games, and other digital files that may be associated with the context of the Transmedia Narrative. This content is bundled to create the Transmedia Narrative package. When the Transmedia Narrative is created, the data and content may be stored locally on servers, or may be stored in the Cloud (8510). The cloud is used for storage of existing content, and for streaming content. In-Transmedia Narrative package purchases of Transmedia Narrative packages may be made through the Cloud or through private servers.

A Transmedia Narrative Media Manager manages uploads and downloads of content to and from the Cloud (8501). Included in the media management uploads and downloads are content, adaptive learning objects, and user information, such as user profiles, transaction histories, and ongoing Transmedia Narrative package purchases.

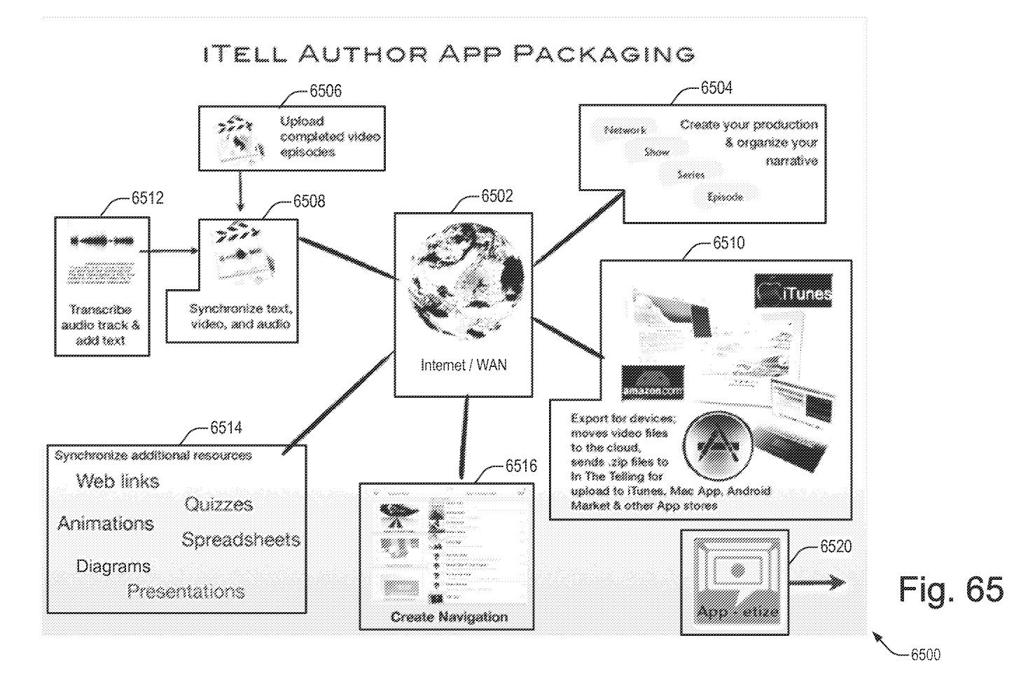

FIG. 65 shows Transmedia Narrative Author Packaging elements and bundling to prepare for making the authored package into an Transmedia Narrative package. The Transmedia Narrative bundle includes uploaded completed video episodes (6506), synchronized tex, video, and audio (6508), and transcribed audio track and added text (6512). Also included in the package are other synchronized additional resources, such as web links, animations, diagrams, quizzes, spreadsheets, presentations, simulations, animations, photos, documents, and other contextually appropriate digital information (6514). Part of the Transmedia Narrative authoring includes creating navigation, such as the library of series, tables of contents for at least one episode, navigation to web links, notes, bookmarks, comments, slides, urls, spreadsheets, animations, simulations, diagrams, quizzes, and other resources that are included within the Transmedia Narrative (6516). FIG. 6504) shows the Authoring hierarchy that is used to create new Networks, Shows, Series, and Episodes. As part of the Transmedia Narrative creation process, the bundled content is compiled and exported for mobile and desktop devices (6510). It is then compiled as a Transmedia Narrative package (6520).

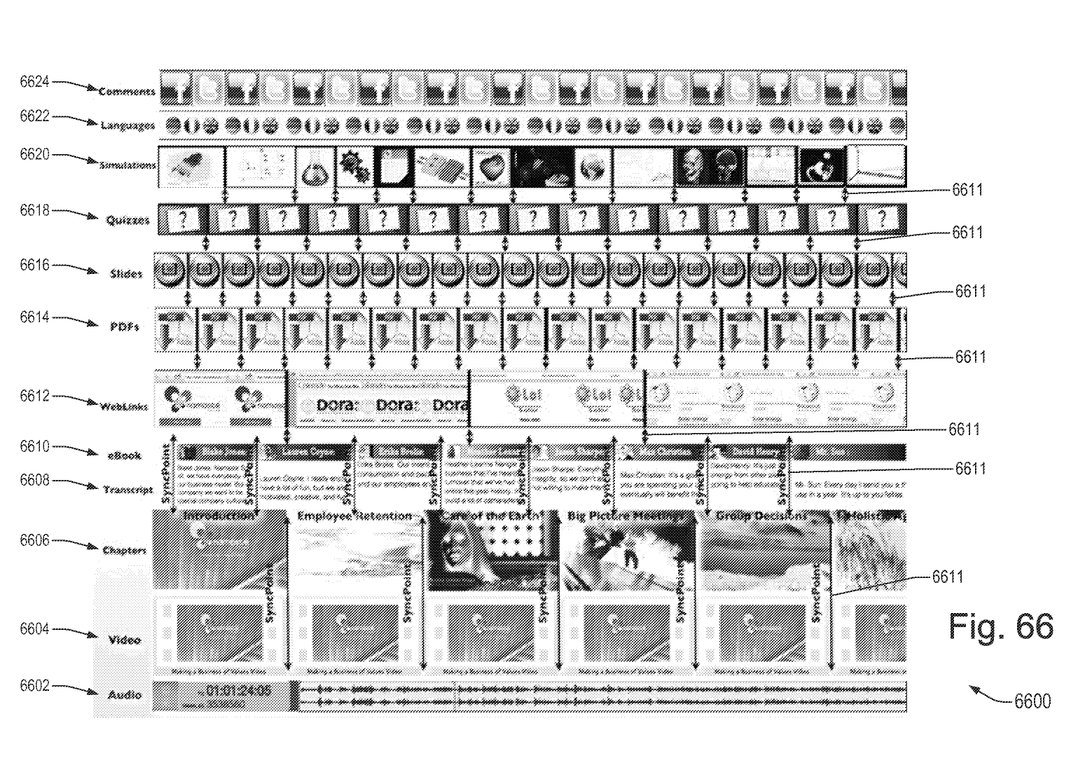

FIG. 66 shows how the elements within a Transmedia Narrative are tied together and brought into the narrative along a timeline. In the specific example embodiment of FIG. 66, the timeline goes from left to right, and one or more assets and content are synced to a common timeline. According to different embodiments, the common timeline may be contained within the Transmedia Narrative. In other embodiments, the common timeline may exist external to the Transmedia Narrative. In at least one embodiment, the common timeline may originally be generated by the Transmedia Narrative Author system. At the core of the Transmedia Narrative are the video (6604) and audio (6602).

Within an episode are included chapters (6606). Note how new chapters appear along the timeline, at least one synced (6611) with the video and audio. Similarly, the transcript (6608) is synced (6611) with the video and audio (e.g., via syncpoints 6611). The transcript (6608) is synced with the audio, and is organized around idea segments. Idea segments are short sections of audio (e.g., several sentences) that, together, represent an idea within a context being described by the speaker.

The ebook (6610) is synced to the audio and video, and may be viewed separately or combined with audio and other transmedia to enrich the ebook experience. In this example, the ebook is being shown separately as it follows the video, audio, and other resources.

Weblinks (6612) are added within the Transmedia Narrative Author, and are timesynced (6611) to the narrative as contextual links to web resources. As playback of the Transmedia Narrative progresses through time, new Weblinks may appear along the timeline to match the context of the narrative. Unlike the ebook, which progresses word by word, and idea segment by idea segment, any one Weblink may be available over longer period of time in the narrative.

PDFs and documents (6614) are added within the Transmedia Narrative Author, and are timesynced (6611) to the narrative as contextual resources. As the Transmedia Narrative progresses through time, new document resources (PDFs, Word documents, Google docs, etc) appear along the timeline to match the context of the narrative.

Slides (6616) are added within the Transmedia Narrative Author, and are timesynced (6611) to the narrative as contextual links to slide resources. As the Transmedia Narrative progresses through time, new Slides appear along the timeline to match the context of the narrative. Any given slide may be available over a short or extended period of time in the narrative.

Quizzes and assessments (6618) are added within the Transmedia Narrative Author, and are timesynced (6611) to the narrative. One instance of quizzes is to have the Transmedia Narrative automatically pause at a logical point where a student may answer the quiz questions pertaining to the previous section of the narrative. Once answered, the narrative resumes. Another instance of quizzes and assessments is to make questions available to students for their own reference to be sure that they understand the material.

Simulations and animations (6620) are added within the Transmedia Narrative Author, and are timesynced (6611) to the narrative as contextual resources. As the Transmedia Narrative progresses through time, new simulations and/or animations become available along the timeline to match the context of the narrative.

Languages (6622) are available to the Tell user along the timeline. Non-English languages such as French, German, Spanish, Mandarin, Hindi, Italian, Arabic, and other spoken languages may be accessed by the user in sync (6611) with the video. Audio and text resources switch to match the chosen language.

Comments (6624) are created by the Transmedia Narrative user (and/or other users/3^{rd} parties), and are synced (6611) along the timeline to show the comments that have been made by the user, as well as comments shared by the user, and/or shared by other users.

Other instances and/or resources that may be created and synced to the timeline are games, notes, spreadsheets, diagrams, and other contextually relevant digital resources.

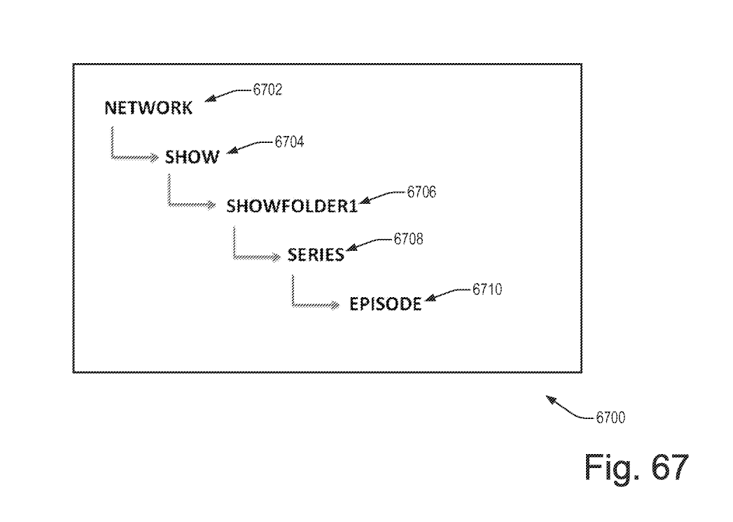

FIG. 67 show an example hierarchy of authoring levels in Transmedia Narrative Author. The Network (6702) is at the top of the hierarchy. Examples of a Network would be a company, organization, or enterprise. For at least one Network, Shows (6704) are set up as the primary sections for at least one network to organize its Authored Transmedia Narratives. Within a Show, there are Showfolders (6706). Showfolders are Transmedia Narrative Author's holding areas for Series and Episodes. Series (6708) are set up by the author. A Series is a collected set of Episodes, or one Episode. Episodes (6710) are single Transmedia Narratives. They are bundled together to create Series (6708).

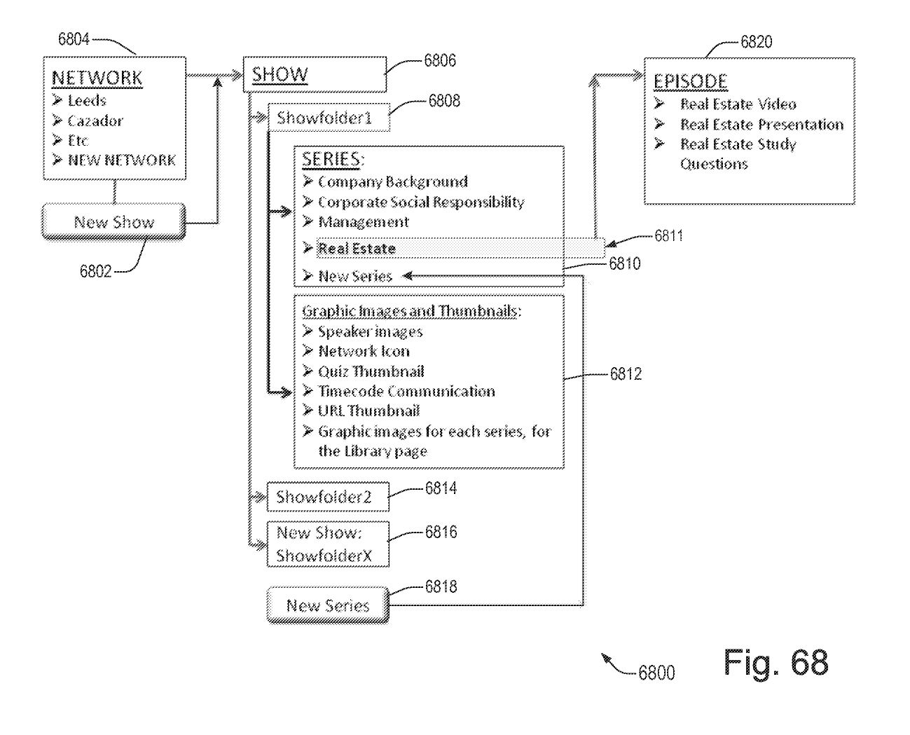

FIG. 68 show the Transmedia Narrative Author hierarchy, with examples for the elements that go within at least one of the hierarchies levels. The Network (6804) is at the top of the hierarchy. Examples of Networks are organizations, Leeds and Cazador. New Networks are created at this level. Also at the Network level, a New Show is created. As described in FIG. 67, the Show (6806) is the primary level for at least one network to organize its Authored Transmedia Narratives. At the next level, a Show includes a number of Showfolders (6808, 6814).

The Showfolder is the level where at least one Series resides (as described in FIG. 67). Examples of Series are shown (6810), and include Company Background, Corporate Social Responsibility, etc. New Series may also be created at this level. Also included in the Showfolder level (6812) are the graphics, images, thumbnails, and timecode information that are used across the group of Series within a Showfolder. For example, the Series' Company Background, Corporate Social Responsibility, Management, and Real Estate (6810) one or more may utilize the resources in (6812). When Authoring in a Series, the same Speaker Images, thumbnails, and graphic images may be accessed and added to any Series within that Showfolder.

Within at least one Series are Episodes (6710 and 6820). Episodes are single Transmedia Narratives. In this example, The Series Real Estate (in 6810), has several Episodes (6820), including Real Estate Video Episode, Real Estate Presentation Episode, and Real Estate Study Questions Episode. Episodes are collected to make a Series.

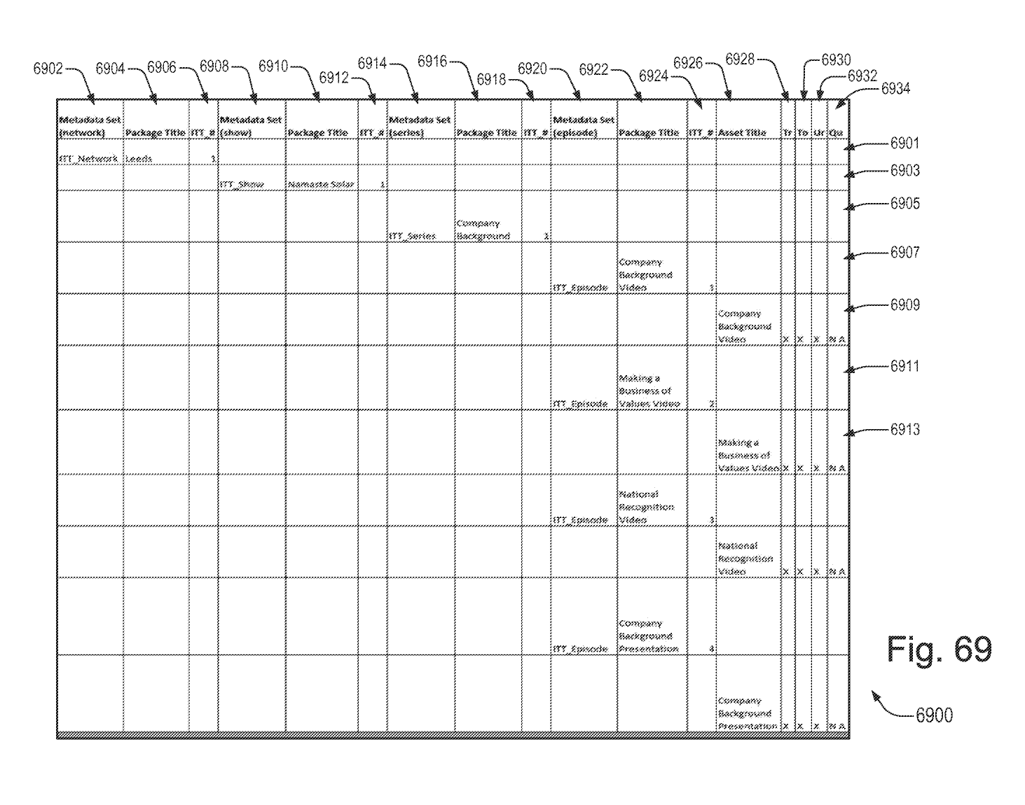

The Transmedia Narrative Author hierarchy and elements described in FIGS. 67 and 68 are further described in FIG. 69. As illustrated in the example embodiment of FIG. 69, the Network (6902) is the top level in the hierarchy. Visible at the Network level (6901) are at least one of the Networks. An example is Leeds (6904). The ITT_#, (6906, 6912, 6918, 6924) is the designated level for at least one Package as it relates to other Packages. It is used to order the Networks in the way they appear in Transmedia Narrative Author. A higher number would move a Package further down in the Transmedia Narrative Author tool, so that that Package would physically appear below other Packages at its level whose ITT_# is lower. ITT_# may be changed at any level for at least one Package and group of Packages. The level immediately beneath the Network is the Show level (6903), within which an example of a Show (6908) is Namaste Solar. Directly underneath the Show level is the Series level (6905). As described in FIGS. 67 and 68, the Series (6914) includes Episodes. In this example, the Series (ITT_Series) is the organizing metadata set for the Packages within it, in this example Company Background (6916).

Within the Series are ITT_Episodes (6922). Examples of ITT_Episodes are Company Background Video, Making a Business of Values Video, National Recognition Video, and Company Background Presentation. At least one of these Episodes is part of the Series, Company Background (6916). Note that Episodes at least one have a unique ITT_# (6924). This means that when displayed in Transmedia Narrative Author, and when shown in the final Transmedia Narrative transmedia product, Company Background Video (6907), with its ITT_# value of 1, may be shown above the other Episodes within this series, and may be shown first within the Transmedia Narrative library final product. Similarly, Making a Business of Values Video (6913), with its ITT_# value of 2 may be shown directly after Company Background, and before National Recognition Video, with its ITT_# value of 3.

The Asset Title (6926) is the title of an asset within an Episode. In this example, Company Background Video (6909) is the name of the asset within the Episode called Company Background Video (6922 and 6907), in the Series Package called Company Background (6916 and 6905). Columns 6928, 6930, 6932, and 6934 are examples of content, resources, and navigation tools that are included in Episodes. Assets (6926) include resources (described in FIGS. 65 and 66) and navigation tools. Part of the Transmedia Narrative authoring includes creating navigation, such as the library of series, tables of contents for at least one episode, navigation to web links, notes, bookmarks, comments, slides, urls, spreadsheets, animations, simulations, diagrams, quizzes, and other resources that are included within the Transmedia Narrative episode (6516).

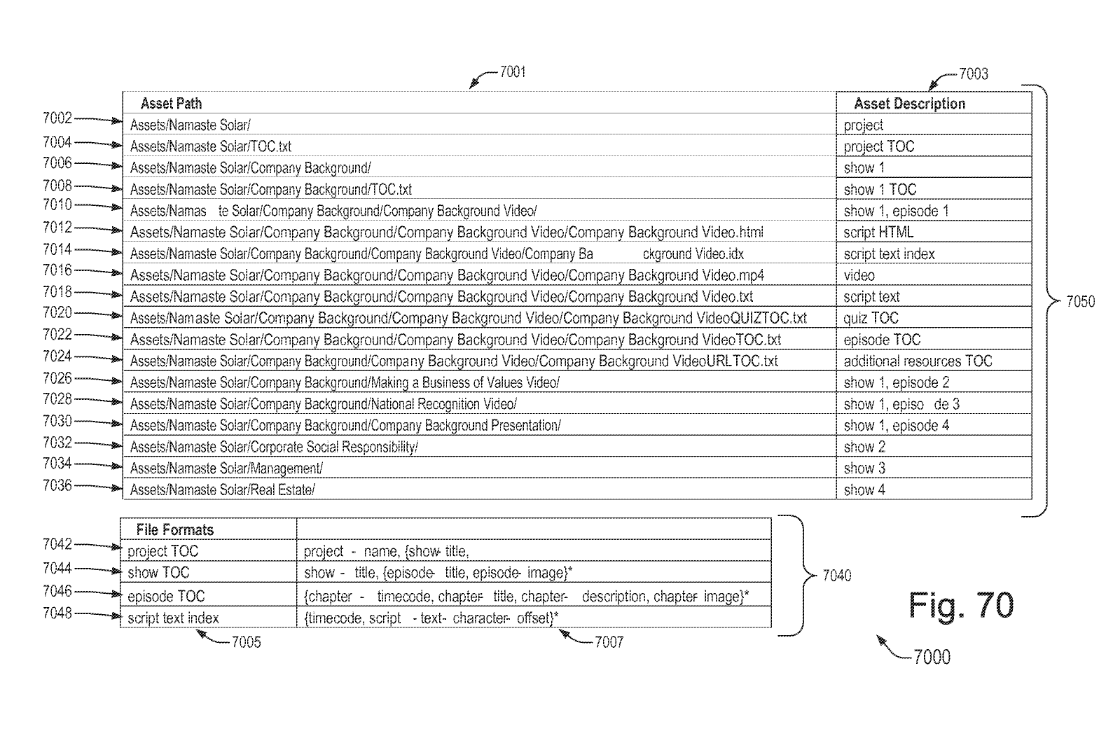

FIG. 70 shows example embodiments file structures and locations of assets which may be managed and/or accessed by the Transmedia Narrative Author for creation of a Transmedia Narrative. FIG. 70 also shows file formats (7040) for creating and timestamping Tables of Contents. Section (7001) shows the Assets and Asset file paths in which assets reside at the Network, Show, Series, and Episode levels of Transmedia Narrative Author. Section (7003) is an Asset Description for the files created. (7002) shows the file hierarchy in which the Project resides. (7004) shows the file location for the asset TOC.txt, supporting the Project TOC (table of contents). (7006) shows the file location for the asset Company Background Show (Show 1, Episode 1). (7008) shows the Asset location for the TOC text (TOC.txt) within the Company Background Show. (7010) shows the file location for the Company Background Video Episode. (7012, 7014, 7016, 7018, 7020, 7022, and 7024) show the Asset Paths for assets within the Company Background Video Episode. Examples of these assets are Video.html, Video.idx (script text index), Video.mp4 (video), Video.txt (script text), VideoQUIZTOC.txt (quiz TOC), VideoTOC.txt (episode TOC), and VideoURLTOC.txt (additional resources TOC). (7026) shows the Asset Path for Show 1, Episode 2, Making a Business of Values Video. (7028) shows the Asset Path for Show 1, Episode 3, National Recognition Video. (7030) shows the Asset Path and hierarchy for Show 2, Episode 4, Company Background Presentation. (7032, 7034, and 7036) show the Asset Paths for Shows 2, 3, and 4.

Section (7040) of FIG. 70 shows file formats (7005) to support the creation of titles of projects, shows, series, and episodes. Section (7007) indicates the file types to support creation of tables of contents and titles by the Transmedia Narrative Author. These are used to set the location, sync timecodes, and create text rules for titles and text. (7042) shows the description for Project TOC naming rules. (7044) shows the description for the Show TOC. (7046) shows the description for the Episode TOC. Section (7040) also shows how a Script Text Index (7048) is used to incorporate timecode information and script-text character offset rules.

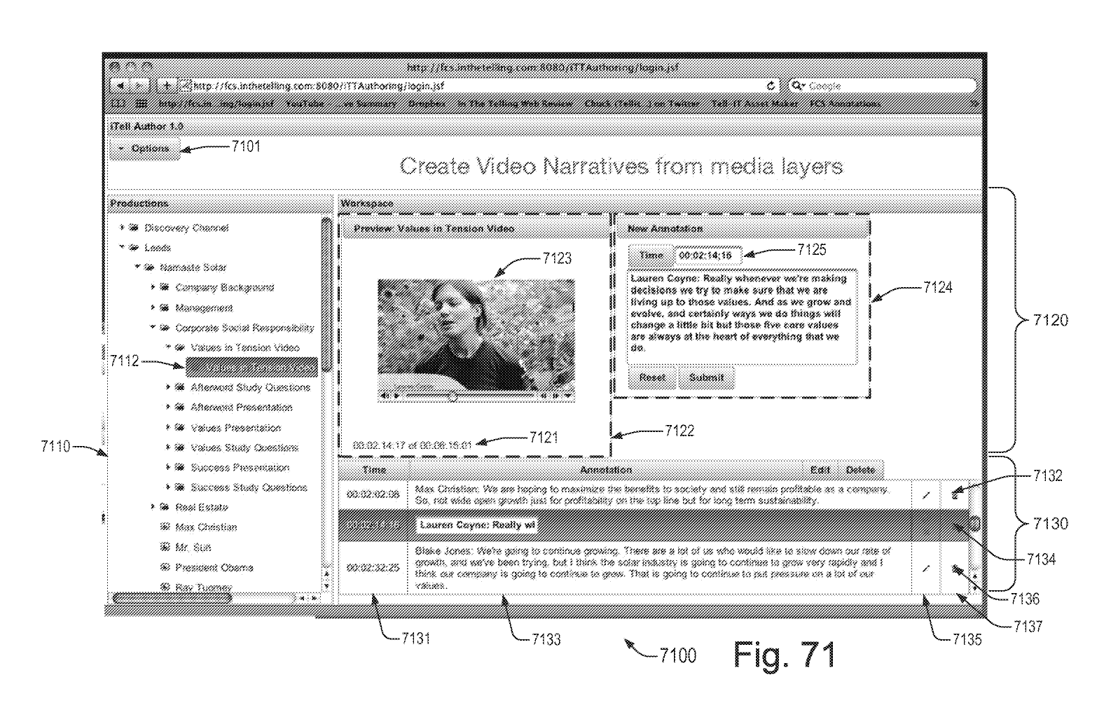

FIG. 71 shows an example of creating a transcript and adding it to an episode. (7110) shows the Author hierarchy, as described in FIGS. 67, 68, and 69. To create a transcript and add it to an Episode, tap/click first on the Episode (7112). This opens the Workspace (7120). Included in the Workspace are the Video preview (7122), with the Video (7123) and timestamp (7121). To create the transcript, in the New Annotation workspace (7124), click/tap on the Time button, and the timestamp (7125) for the moment in the video (in this example, 2 minutes, 14 seconds, 16 frames) is automatically shown. To create the transcription, the author may input text as the Speaker (7123) is speaking. Text may also be copied and pasted from another document source to the New Annotation Text GUI (7124). To submit the text that is in the text window, press the Submit button. To reset the text window for alternate text, press the Reset button.

Once text is submitted, it is shown in the Synced Asset Description GUI (7130). The Synced Asset Description GUI (7130) shows one or more the resources that have been created and placed in the Episode. Time stamps for at least one asset are shown in the Time column (7131); Annotation (7133) is shown, and includes text blocks (idea segments), and one or more other resources that have been created and placed in the Episode by the author. The transcribed text in this example is automatically time-stamped, synced with the other text and assets in the Episode, and inserted into the GUI at the appropriate moment in relation to other text and content (7134). Note that the transcribed text (7134) automatically was placed in time sequence to follow earlier text (7132), and following text (7136). The time stamp for at least one block of inserted text is shown in the Time column (7131). In addition to text blocks, one or more the resources which have been created for the episode are shown according to their time in the Episode, and at least one is described in the Annotation (7133) sections. To edit an existing text block or resource, the author taps on the pencil icon (7135). This opens that resource in the New Annotation GUI (7124), and enables the author to edit that resource. To delete a text block or resource, the author taps on the trashcan icon (7137). This deletes that asset (text, URL, slides, etc) from the Episode.

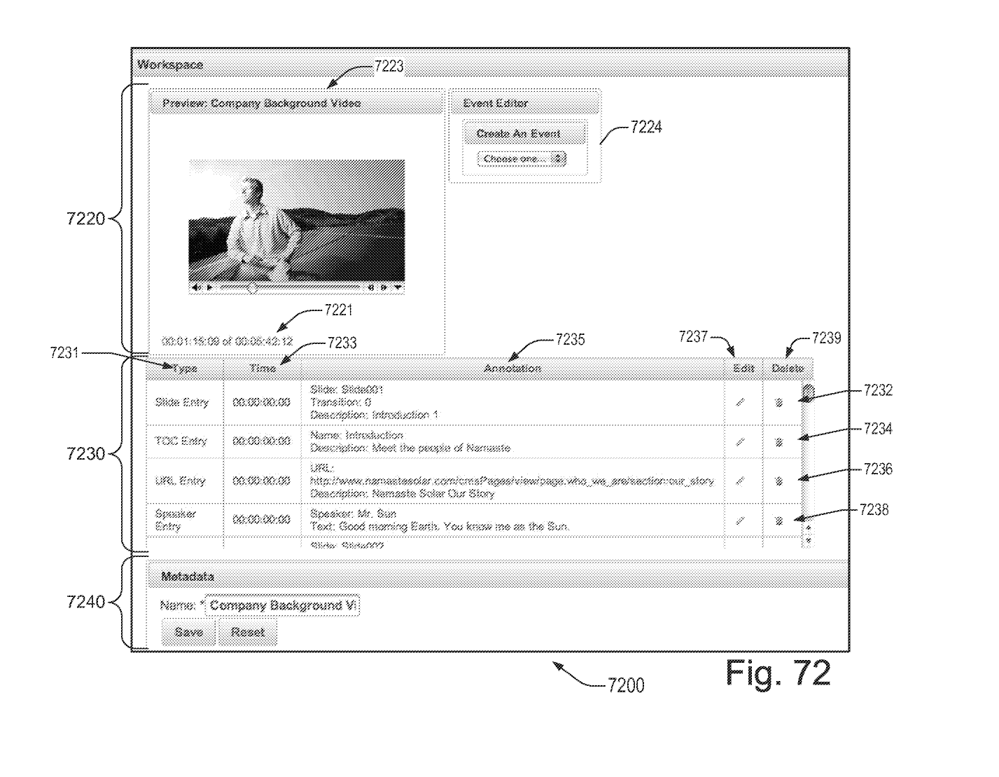

FIG. 72 shows the Synced Asset Description GUI (7230) and its features. The Type column (7231) shows the type of asset. The time-stamp for at least one asset is shown in column (7233). The Annotation column (7235) is the annotation associated with at least one asset. If the asset is a text block (described in FIG. 71), the entire block of text is shown. Other assets in the Annotation column note the type of asset, and include an author-generated description for at least one asset. An example is the Slide Entry, (7232). This Slide is inserted at the beginning of the Episode (timecode 00:00:00:00), is Slide001, does not have a transition associated with it, and is described as Introduction 1. Similarly other asset types and descriptions (7234, 7236, and 7238) show the type of asset, the time at which that asset is synced with the video and audio (7223), and an annotated description. The author may also Create an Event (7224) as a new asset to be included in the Episode. (7224) shows the Series name of the Episode that is being viewed and authored.

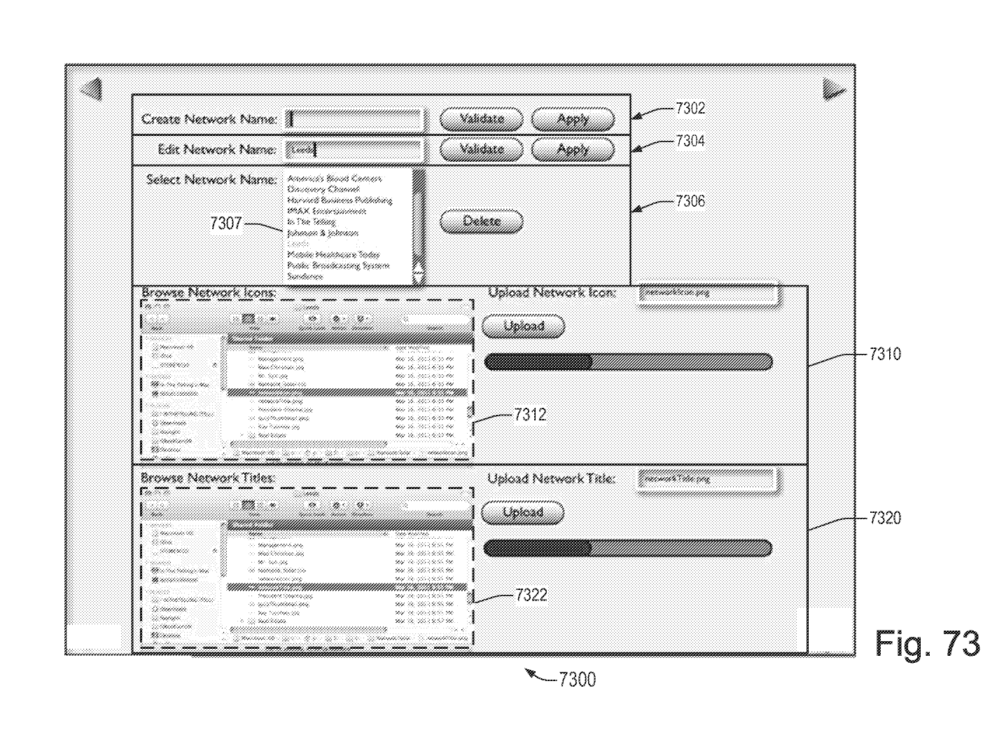

As illustrated in the example embodiment of FIG. 73, to create a New Network (7302), the author inputs the name, then validates that the name is secure and follows the naming rules. Once validated, the author taps/clicks the appropriate button to create that New Network. To edit the Network name that has been created, or to an existing Network name (7304), the Author types the desired name in the Edit Network Name Input GUI, validates, and applies (7304). To work with an existing Network (7306), a dropdown menu appears with the list of networks (7307), and the desired network may be selected. To delete a Network, the author taps/clicks the Delete button. As shown at 7310, the Network Icon is a graphic that has been created to represent a given network in the Transmedia Narrative Player. To upload a Network Icon, the author browses for the correct icon (7312), the name appears in the Upload Network Icon GUI, then the author taps/clicks the Upload button to upload that icon into Transmedia Narrative Author. A progress bar indicates the progress of the file being uploaded to Transmedia Narrative Author. As shown at 7320, the Network Title is a graphic that has been created to represent a given network in the Transmedia Narrative Player. To upload a Network Title, the author browses for the correct icon (7322), the name appears in the Upload Network Title GUI, then the author taps/clicks the Upload button to upload that icon into Transmedia Narrative Author. A progress bar indicates the progress of the file being uploaded to Transmedia Narrative Author.

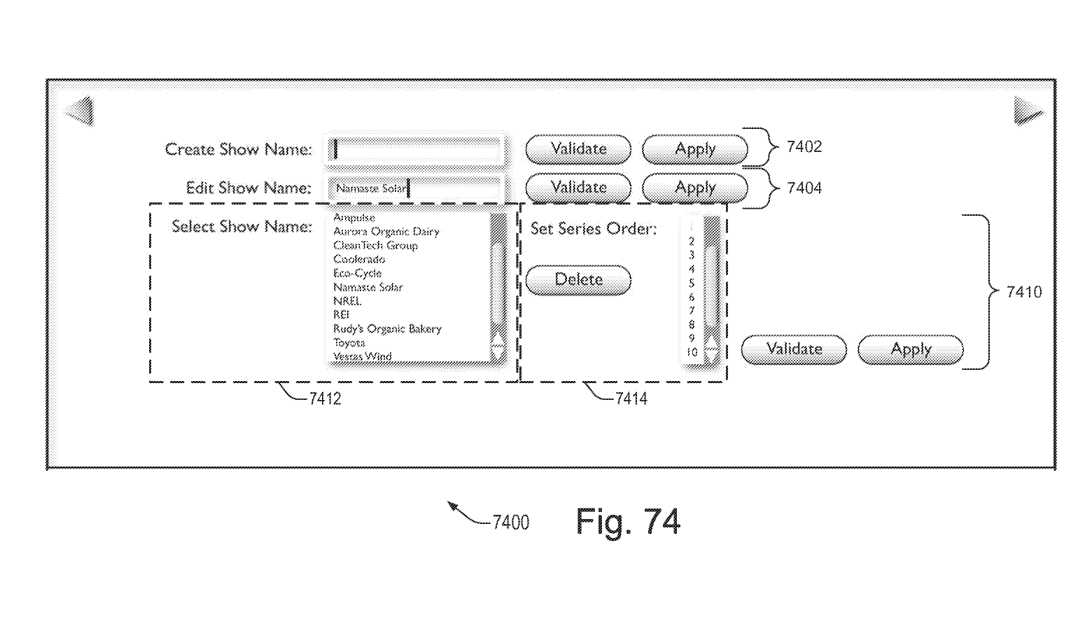

FIG. 74 shows the interface for creating a new Show, or locating an existing Show to be edited. To create a new Show (7402), input the name of the Show in the Create Show Name Input GUI, tap Validate, then Tap Apply. To edit the name (7404), or edit the name of an existing Show, in the Edit Show Name Input GUI, edit the Show name as desired, Validate, and Apply. The (7410) workspace enables the author to select existing shows from a menu, and to set Series order. To Set Series Order (7414), select the show in the Select Show Name menu (7412). The Set Series Order workspace enables the author to order Series. Once completed, the author validates and applies.

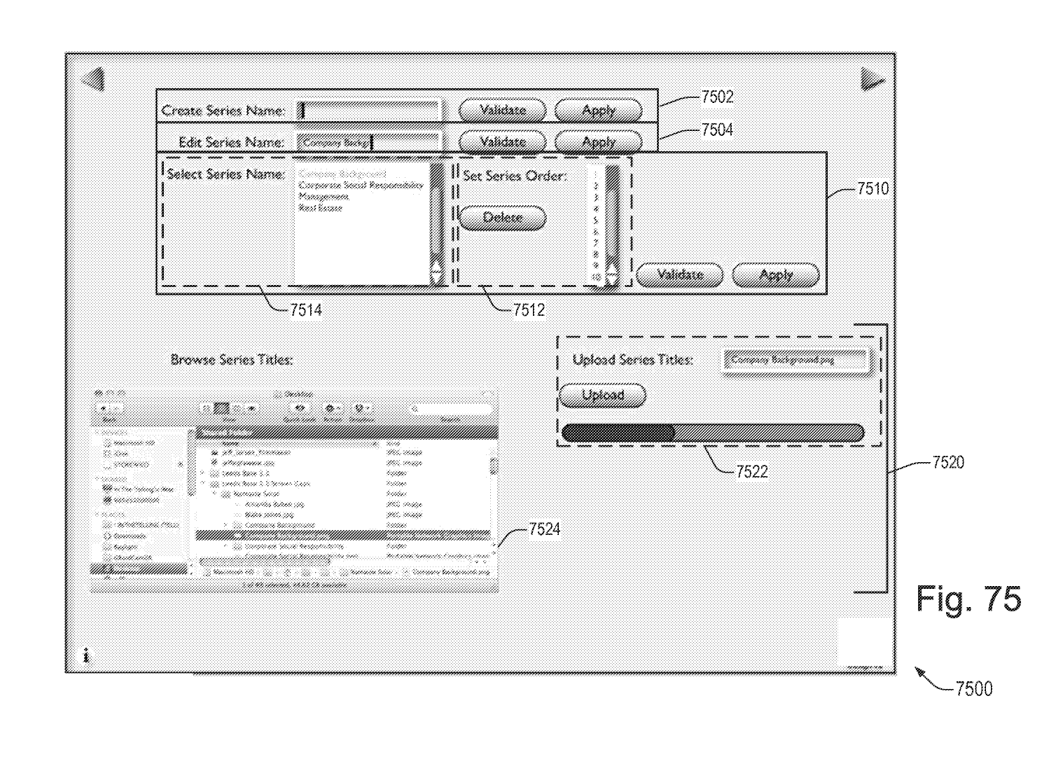

FIG. 75 show the GUI(s) to Create New Series, and to edit existing Series. To Create a Series Name (7502), input the name of the Series, Validate, and Apply. The Series may now be placed in Transmedia Narrative Author. To edit the name the user has created, or to edit an existing Series name, (7504), input the new name, Validate, then Apply. Selecting an existing Series Name is done in the Select Series Name (7514) workspace. A menu shows the existing Series'. To Set Series Order (as explained in FIG. 69), Select the Series and the current Series order is shown in the Set Series Order workspace (7512). There, Series order may be changed, and Series may be deleted from the Show. Once finished, Validate and Apply to put the revised Series in Transmedia Narrative Author.

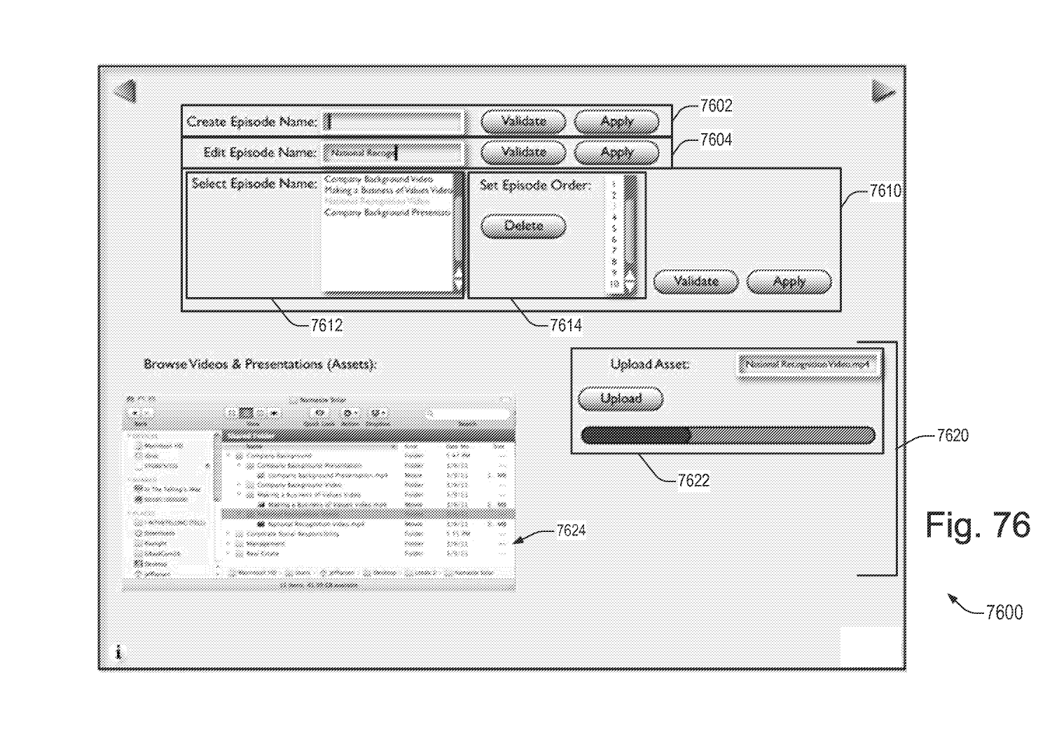

FIG. 76 show the GUI(s) to Create New Episodes, and to edit existing Episodes. To Create a Episode Name (7602), input the name of the Episode, Validate, and Apply. The Episode may now be placed in Transmedia Narrative Author. To edit the name the user has created, or to edit an existing Episode name, (7604), input the new name, Validate, then Apply. Selecting an existing Episode Name is done in the Select Episode Name (7614) workspace. A menu shows the existing Episode. To Set Episode Order (as explained in FIG. 69), Select the Episode and the current Episode order is shown in the Set Episode Order workspace (7612). There, Episode order may be changed, and Episodes may be deleted from the Series. Once finished, Validate and Apply to put the revised Episode in Transmedia Narrative Author. To upload Assets into an Episode, an Asset may be selected from a file (7624), and the name of that asset may appear in the Upload Asset input area (7622). That asset may now be Uploaded into Transmedia Narrative Author within the Episode.

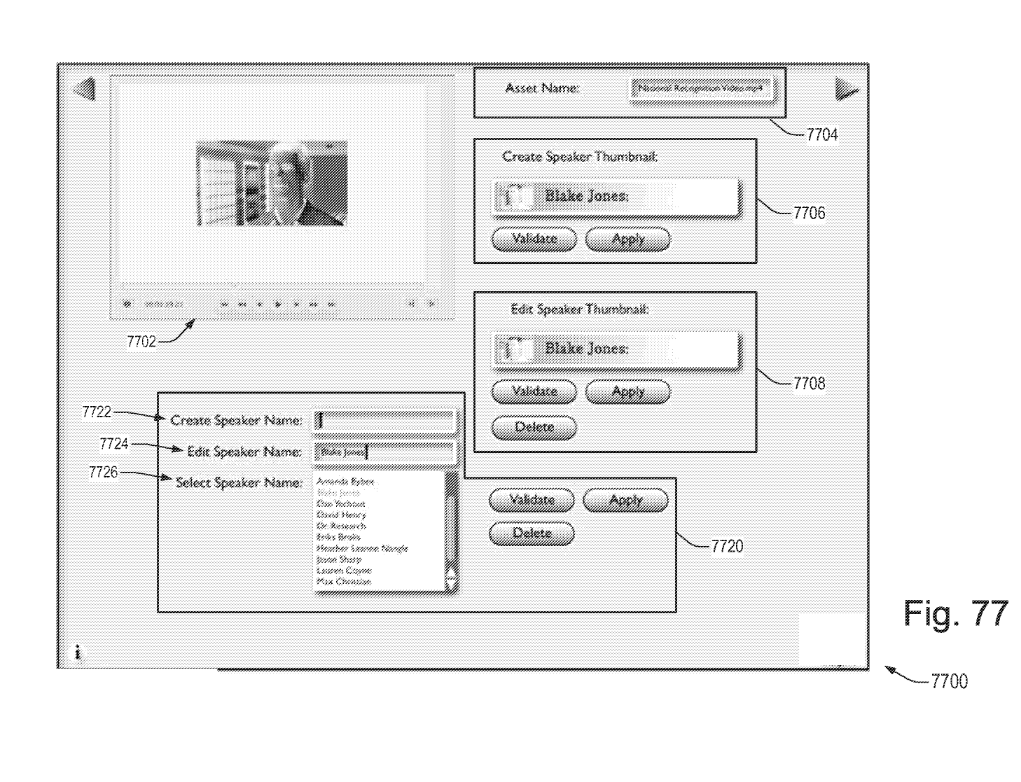

FIG. 77 show the GUI(s) and workspace for a adding Speaker information into Transmedia Narrative Author. Speaker thumbnail graphics are created in graphics programs. Another embodiment is a Speaker Graphic creator, which enables the Speaker graphic to be created within Transmedia Narrative Author. (7704) identifies the video that is being played. Create Speaker Thumbnail (7706) enables the author to locate a Speaker thumbnail graphic, to upload it, and to Validate/Apply it to Transmedia Narrative Author. Another embodiment is a Speaker Graphic creator, which enables the Speaker graphic to be created within Transmedia Narrative Author. Edit Speaker Thumbnail (7708) enables the author to show a speaker thumbnail graphic, and to edit either the graphic or the text. This tool also enables the author to delete that speaker thumbnail. Creating and editing a Speaker Name (7720) is a tool for creating a new Speaker (7722) or editing the name of a Speaker (7724). Speaker names may be accessed from the Select Speaker Name (7726). In an alternate embodiment, the Transmedia Narrative Author may be operable to automatically and/or dynamically identify a Speaker's ID, name voice and/or image through use of facial and/or voice recognition software, and may automatically populate information relating to the identified Speaker such as, for example, the Speaker image, Speaker name, Speaker's transcribed text, etc.

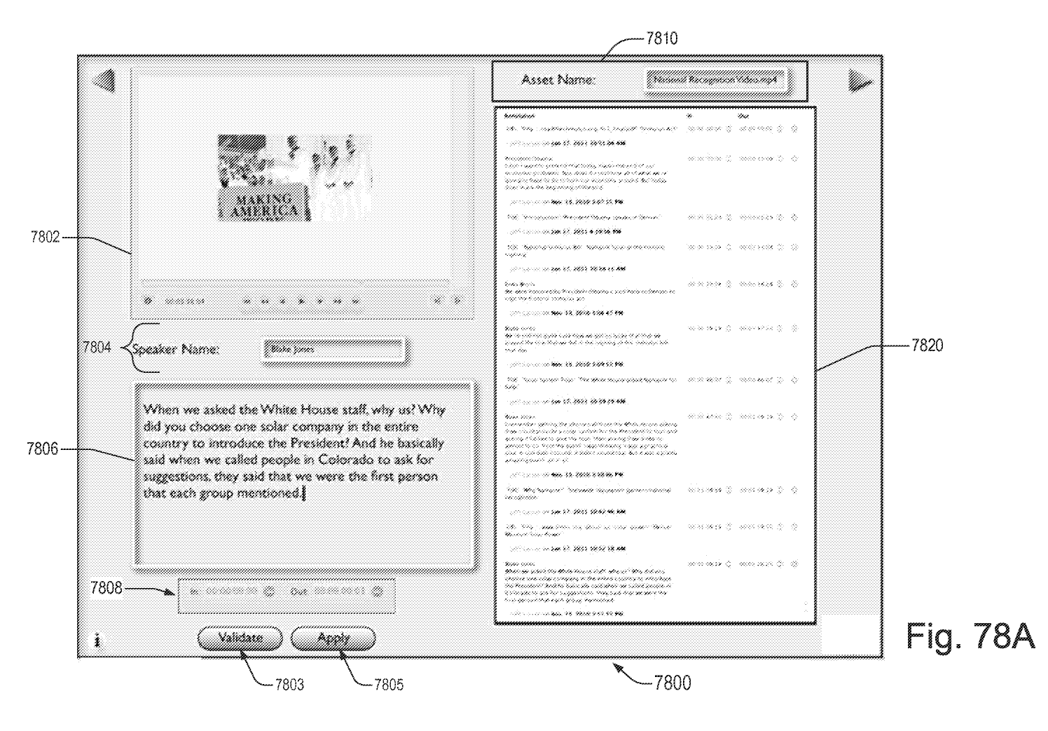

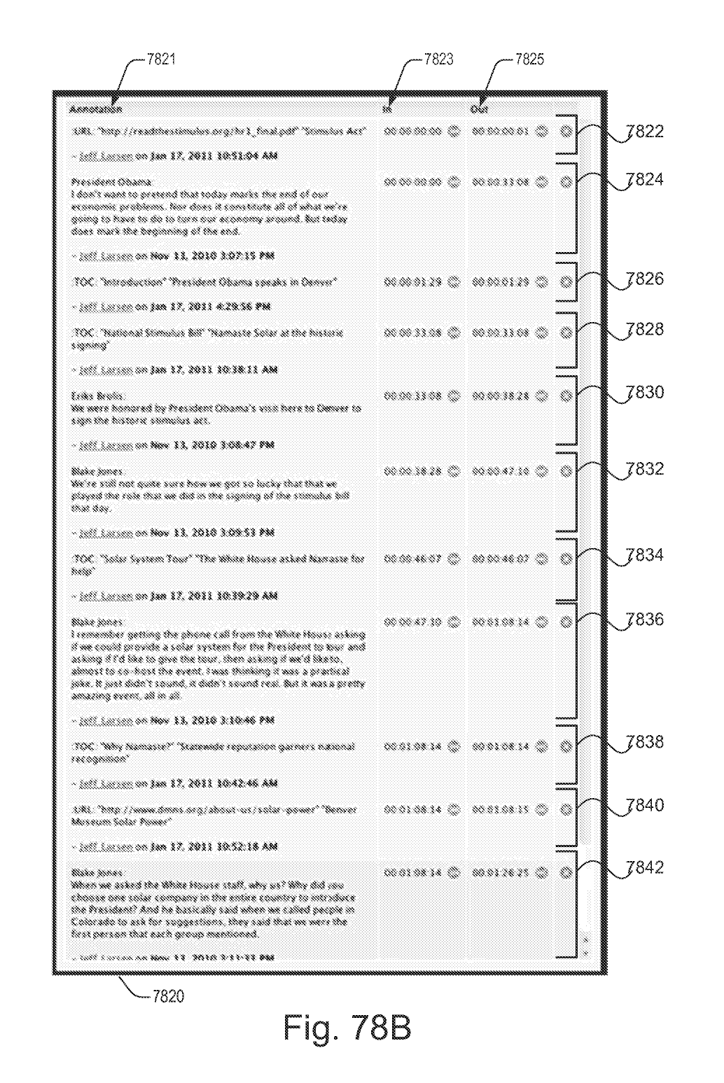

FIG. 78A shows the workspace and tools for adding transcriptions within Transmedia Narrative Author. Transcription text may be entered manually in the Transcription GUI (7806), or copied/pasted from written text, or via voice recognition software that automatically places the text in the Transcription GUI as the speaker is speaking. The Speaker Name (7804) shows the name of the Speaker. The Time Stamp Tool (7808) enables the author to set in- and out-points for transcribed text blocks and idea segments. In another embodiment, in- and out-points are automatically generated as the author selects or inputs the text. The Synced Asset Description GUI (7820) is in this workspace, and is describe in detail in FIG. 78B.

FIG. 78B shows the Synced Asset Description GUI. This GUI has columns showing one or more the resources that have been created and placed in the Episode (7821). Time stamps for at least one asset are shown in the Time column (7823 and 7825). (7823) shows the precise in-point or beginning moment for the Asset. (7825) shows the precise out-point or ending moment for that Asset. Annotation (7821) is shown, and includes text blocks (idea segments), and one or more other resources that have been created and placed in the Episode by the author. The transcribed text in this example is automatically time-stamped, synced with the other text and assets in the Episode, and inserted into the GUI at the appropriate moment in relation to other text and content. Another embodiment for this workspace is the ability to drag and drop new Assets into the GUI, and to have that Asset flow automatically into the timeline based on its metadata.

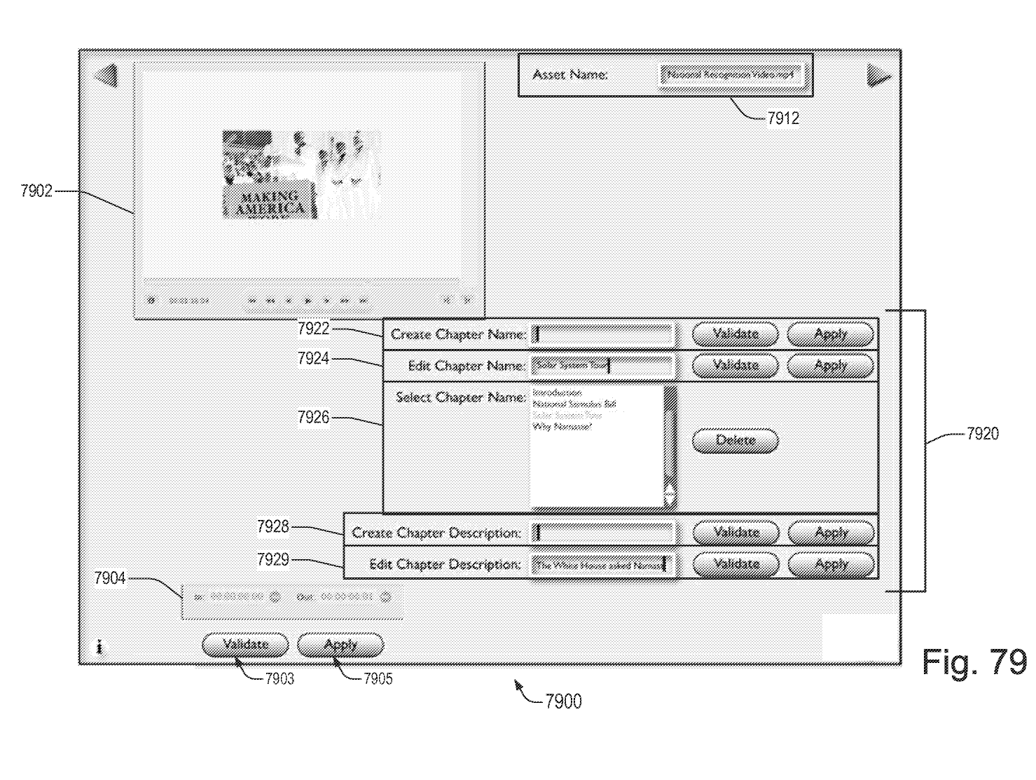

FIG. 79 shows the workspace and GUI(s) for creating, editing, and adding descriptive information for a Chapter. Chapters are described in FIGS. 67, 68, and 69. Create Chapter Name enables the author to create a new Chapter name. Edit Chapter Name (7924) enables the author to edit the name that has been created, or to select from the list (7926) and edit a name from that list. Create Chapter Description (7928) enables the author to provide a description of a new or existing chapter. Edit Chapter Description (7929) enables the author to edit a description of a new or existing chapter. The Time Stamp Tool (7904) enables the author to set in- and out-points for Chapters and idea segments. In another embodiment, in- and out-points are automatically generated as the author selects the Chapter section.

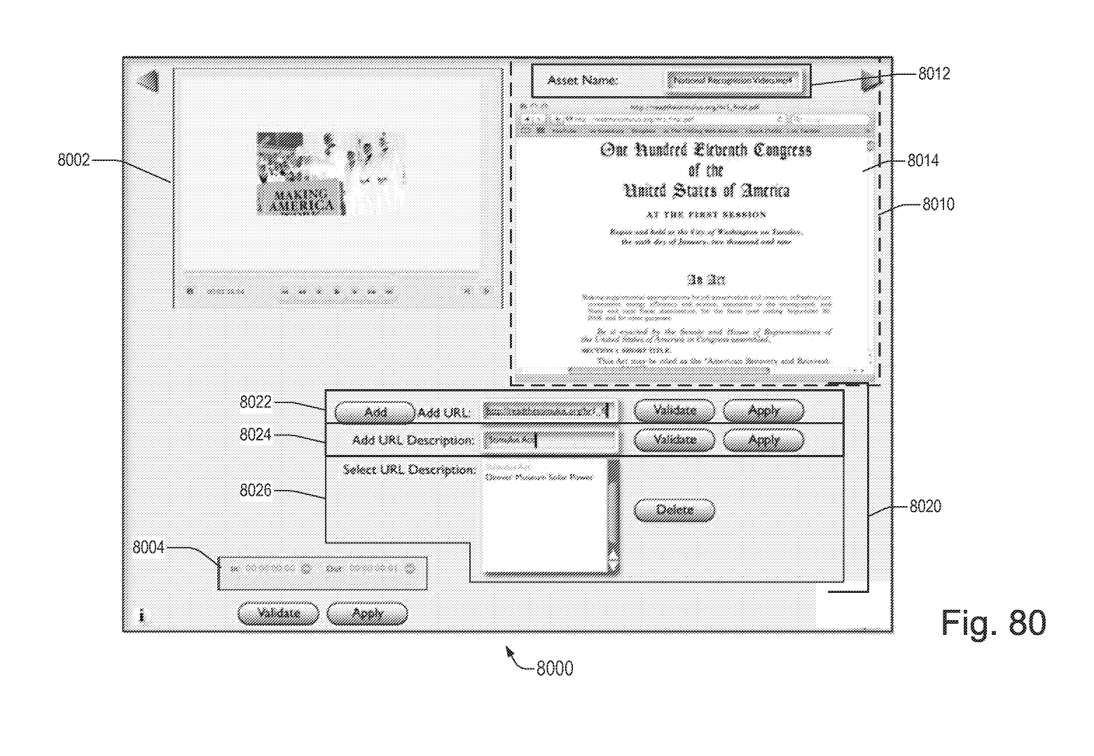

FIG. 80 provides an example illustration of how to add a new Asset resource (in this example, a URL for a Web page) to Transmedia Narrative Author. The Resource Display GUI (8014) enables the author to browse the Internet for any Web page, and to then add the URL link (8022) to Transmedia Narrative Author. That link is automatically time stamped to moment in the video (8002). To set the in-point the Time Stamp tool (8004) is used to establish when the URL first appears as an available transmedia resource. Setting the out-point in (8004) establishes the length of time that URL may be available as a contextual resource to the video and other synced transmedia resources.

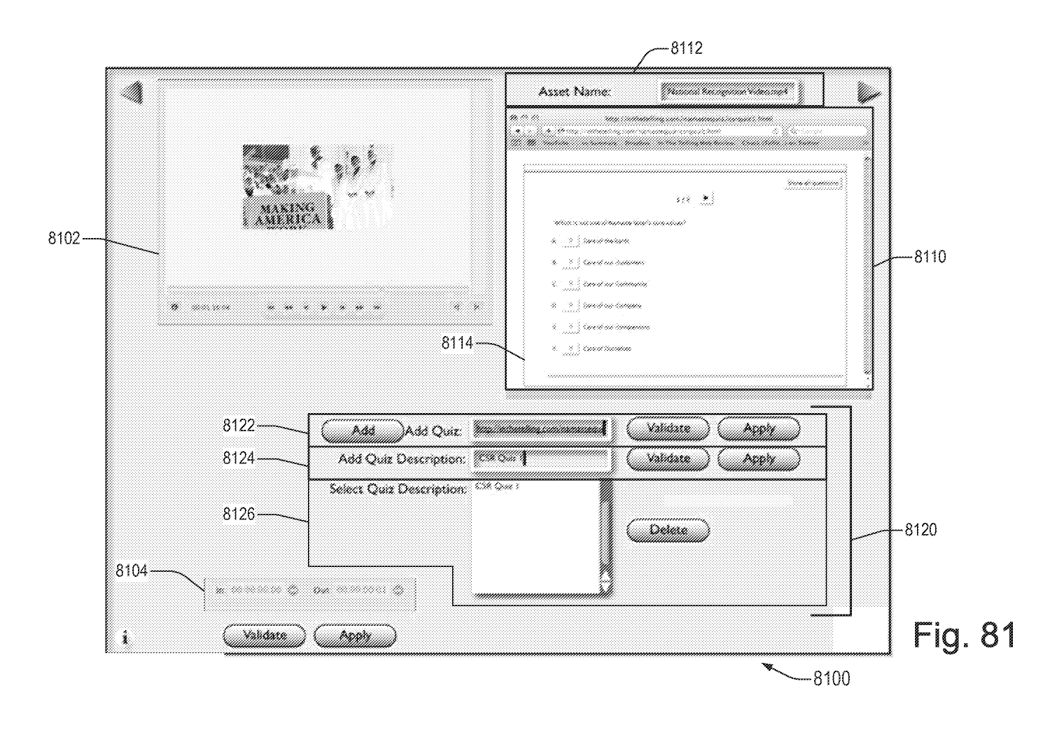

FIG. 81 provides an example illustration of how to add a new Asset resource (in this example, a Quiz) to Transmedia Narrative Author. The Resource Display GUI (8110) enables the author to browse files or the Web to locate the desired quiz, and to then add the Quiz (8120) to Transmedia Narrative Author. The Quiz is automatically time stamped to moment in the video (8102). To set the in-point the Time Stamp tool (8104) is used to establish when the Quiz first appears as an available transmedia resource. Setting the out-point in (8104) establishes the length of time that Quiz may be available as a contextual resource to the video and other synced transmedia resources. Other embodiments include Assets such as transcripts, audio, ebook, Weblinks, PDFs and documents, Slides, Simulations and animations, Comments, Games, Notes, Spreadsheets, Diagrams, and other contextually relevant digital resources.

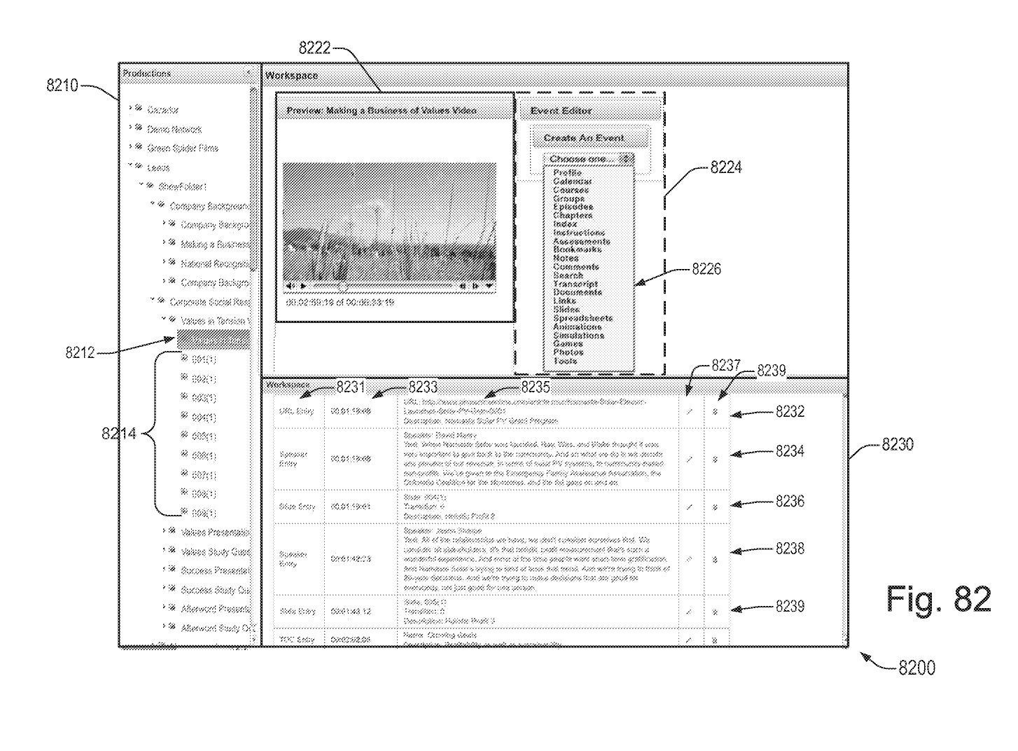

FIG. 82 shows the workspace and GUI(s) for Creating an Event, and showing how that Event is automatically time-synced with one or more the resources in an Episode. These processes are described in detail in FIGS. 67, 68, 69, and 71. The Create and Event Dropdown Menu (8326) shows a list of transmedia resources that may be added to an episode. Other embodiments include digital files, widgets, etc.

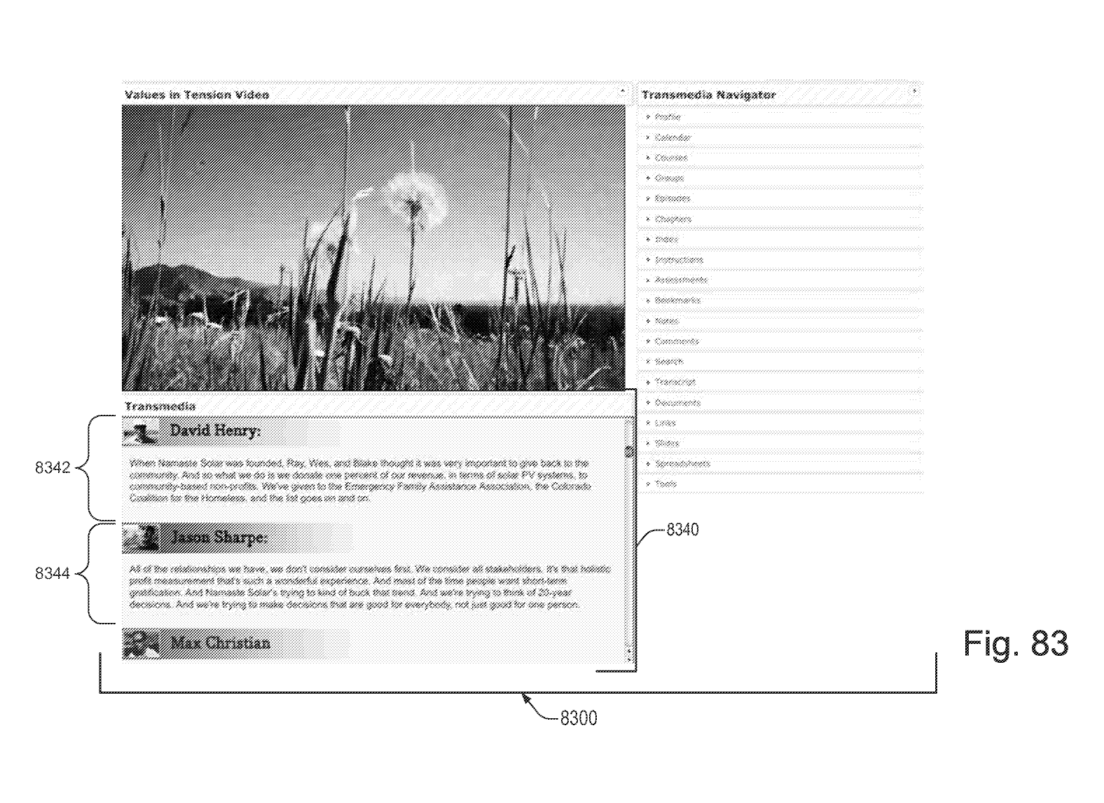

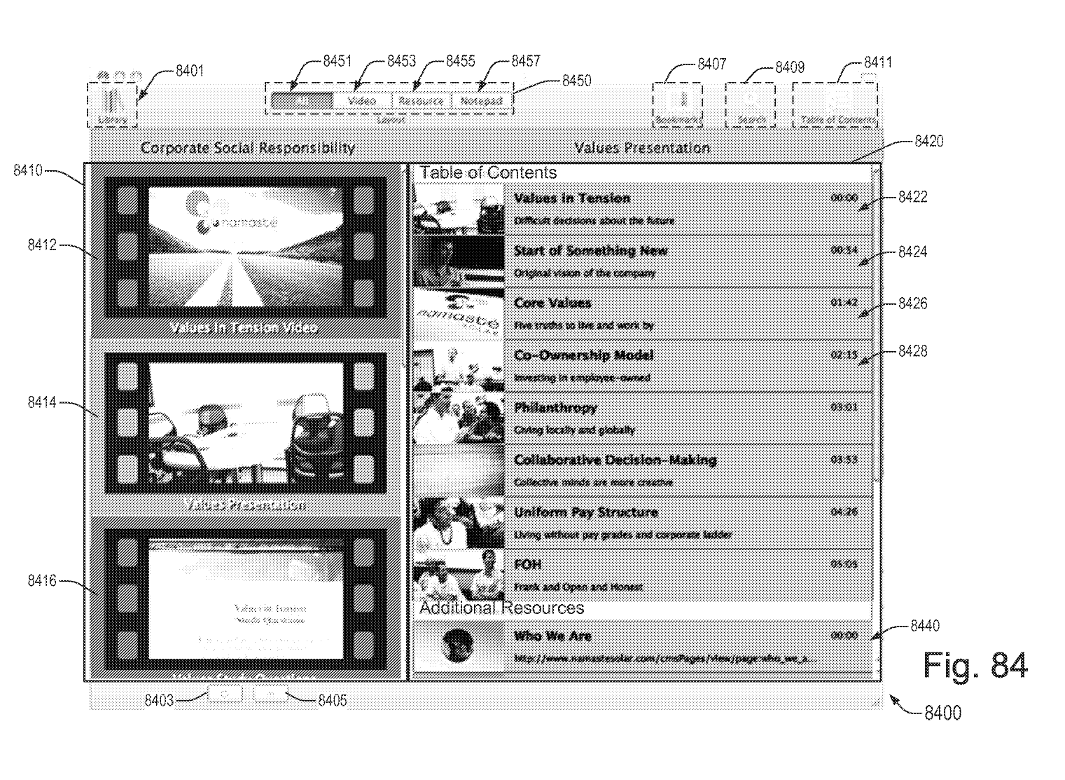

FIG. 83 shows the relationship between the video and the transmedia asset, in this case a transcript. Transcriptions may be segmented by Speaker (8342, 8344), and if there is a long transcription block, may be segmented into shorter, contextual segments, call idea segments. (8340) shows the Resource Display GUI with transcribed text within.

FIG. 84 shows an embodiment of the Transmedia Narrative as applied to Laptop computers (8400). Tapping/clicking the Library Series icon (8401) opens the Library GUI, showing the available Series. (8450) shows the View Selector. Within the View Selector, may elect to see just the Video Player GUI (8453), just the Resource Display GUI (8455), just the Notepad GUI (8457), or one or more Transmedia Narrative Player windows simultaneously (8451). Another embodiment enables the Notepad GUI to be replaced by a Transmedia Navigator GUI, which then enables the user to select from any Transmedia Resource available. Available bookmarks (which have been set by the user) may be accessed with the Bookmarks icon (8407). The Search icon (8409), when tapped or clicked, enables the user to Search for any word or phrase within a Series. Tapping on the Table of Contents icon (8411), opens the Table of Contents GUI (8400). The Table of Contents of an episode are shown (8420). Sections within Within the Table of Contents include a time-based, sequential listing of sections within the Transmedia Narrative (e.g. 8422, 8424, 8426, and 8428). The Additional Resources section of the Table of Contents (8440) is a time-based, sequential listing of other transmedia resources. Shown in this example is a URL and Weblink (Who We Are) that links to a contextually appropriate Web page. In addition to Web links, other embodiments include assets such as transcripts, audio, ebook, PDFs and documents, Slides, Simulations and animations, Comments, Games, Notes, Spreadsheets, Diagrams, and other contextually relevant digital resources.

As illustrated in the example embodiment of FIGS. 67, 68, and 69, at least one Series is made up of one or more Episodes (8410). Episodes may be selected by the user by tapping/clicking. When and Episode (8412,8414, 8416) is selected Transmedia Narrative transmedia player opens that Episode and shows the Table of Contents and Resources for that Episode. Episodes may be deleted from the user's personal storage hard drive by pressing the Delete button (8403). The Episode filmstrip icon (8412,8414, 8416) is not removed, however, so that the Episode may be downloaded again at any time using the button (8405).

FIGS. 51-64 show alternate example embodiments of Transmedia Narrative Authoring GUIs, features and/or other operations which may be involved in creating, authoring, producing, and/or editing Transmedia Narrative packages.

FIG. 51 shows the top level of the Transmedia Narrative Author hierarchy, the Network GUI (5100) in Transmedia Narrative Author includes the Productions (5101) and Networks (5110). Examples of Networks are Cazador (5112), Demo Network (5114), and Green Spider Films (5116). The Network level is the overarching level, in which new networks are created representing organizations, large projects that may include groups of shows, etc. To create a new Network, tap or click the New Network button (5111). The Workspace area (5120, 5103) is the area in which Authoring applications are shown and worked with. Within the network is a nested structure of shows, series', episodes, and productions

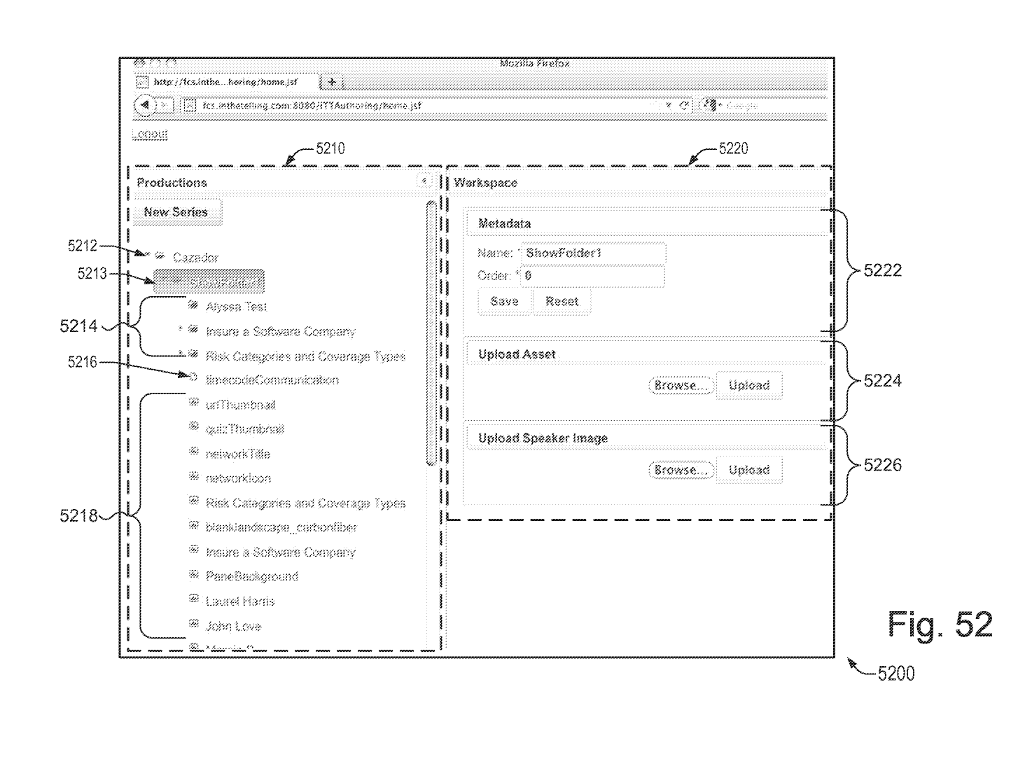

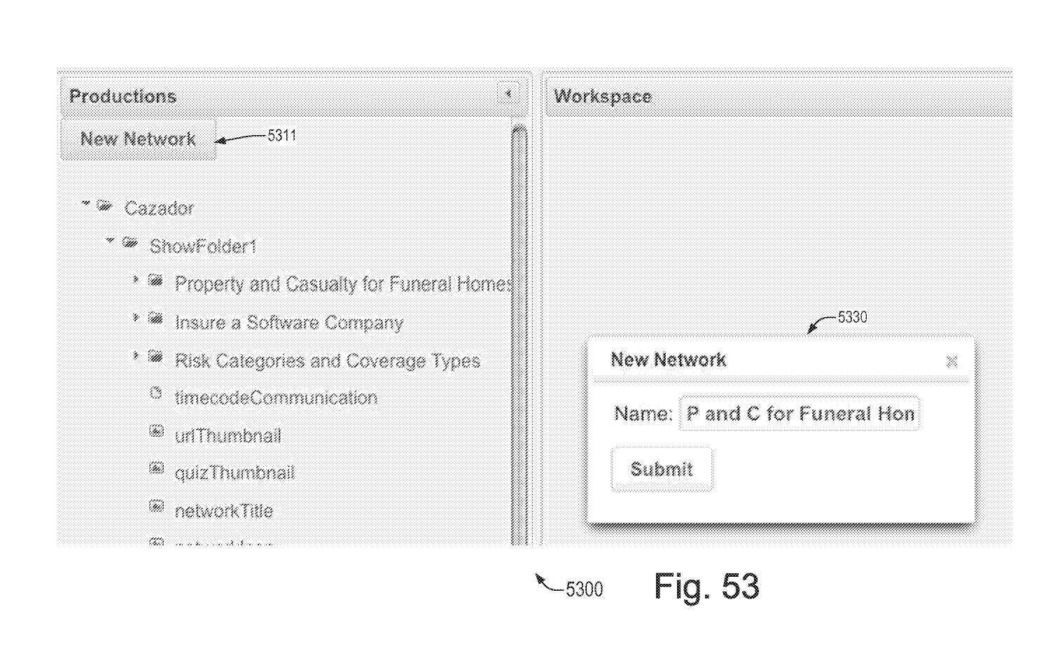

FIG. 53 shows the tools and GUI (5300) for creating a new Network. To create a New Network, after logging in, clicking/tapping on the New Network button (5311) opens an input GUI (5330). The author may then input the name, and tap the Submit button to create the New Network. As illustrated in the example embodiment of FIG. 53, the New Network now appears in the Transmedia Narrative Author networks. To upload media assets, the author clicks/taps on the Choose button within the Upload Asset GUI.

FIG. 52 shows the Showfolder files and assets and the Showfolder Workspace (5200). Showfolder1 (5213), within the Transmedia Narrative Author Network hierarchy, follows the Network (5212) and New Show levels. In Showfolder1, New Series' may be added. Series in this example are Company Background, Corporate Social Responsibility, Management, and Real Estate (5214). The TimecodeCommunication file (5216) is created automatically within Transmedia Narrative Author, and is the code and file used to ensure that assets and media are aligned according to their time stamp associated with the video. Showfolder1 is also the location where media assets (5218) are uploaded that may be used within at least one Show, Series, and Episode. Uploaded assets include speaker images, Series graphics, graphics that may be displayed for branding, graphic headers, network icons, graphic thumbnails for url's, table of contents graphics. The workspace area (5220) includes a section for naming the Showfolder, and changing the order of assets in the hierarchy (5222); a section (5224) for uploading media assets, using a browsing tool to locate the media asset file; and a section (5226) for browsing for, and uploading, Speaker Images.

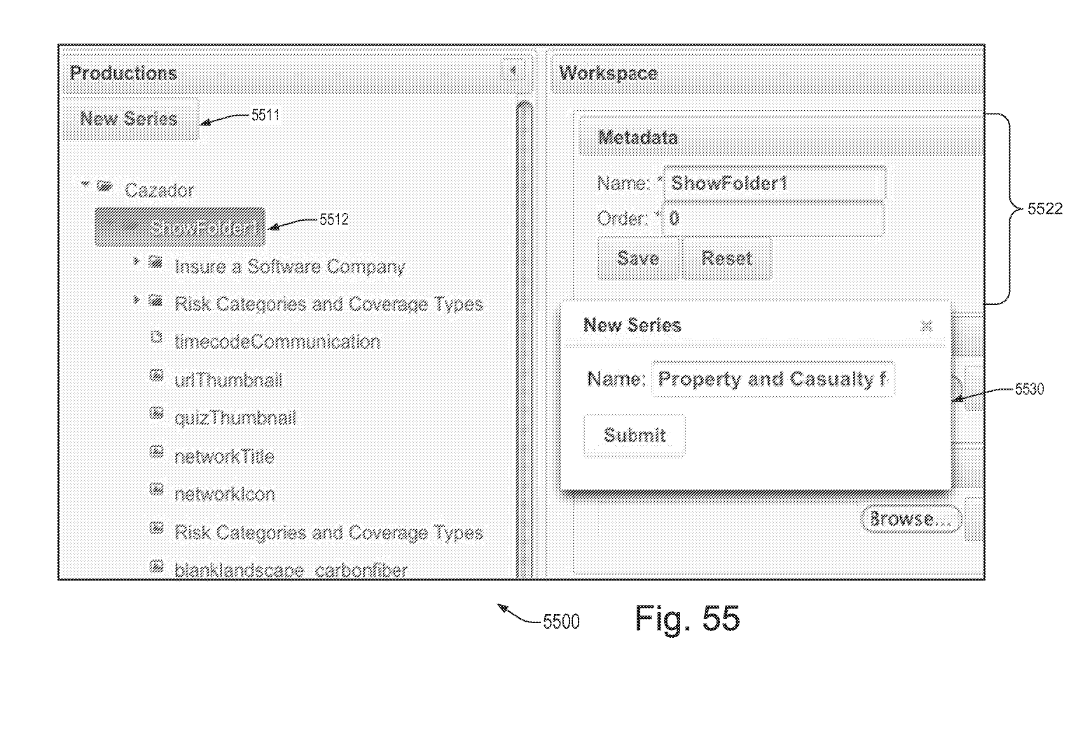

FIG. 55 shows the GUI (5500) for creating a New Series. Tapping on the icon next to Showfolder1 enables the viewer to see the existing series' within a Showfolder (5512), in this example, the existing series within this Showfolder are Insure a Software Company, Risk Categories. Tapping/clicking the New Series button (5511), opens an input GUI (5530) where the name of the new series may by typed, then submitted.

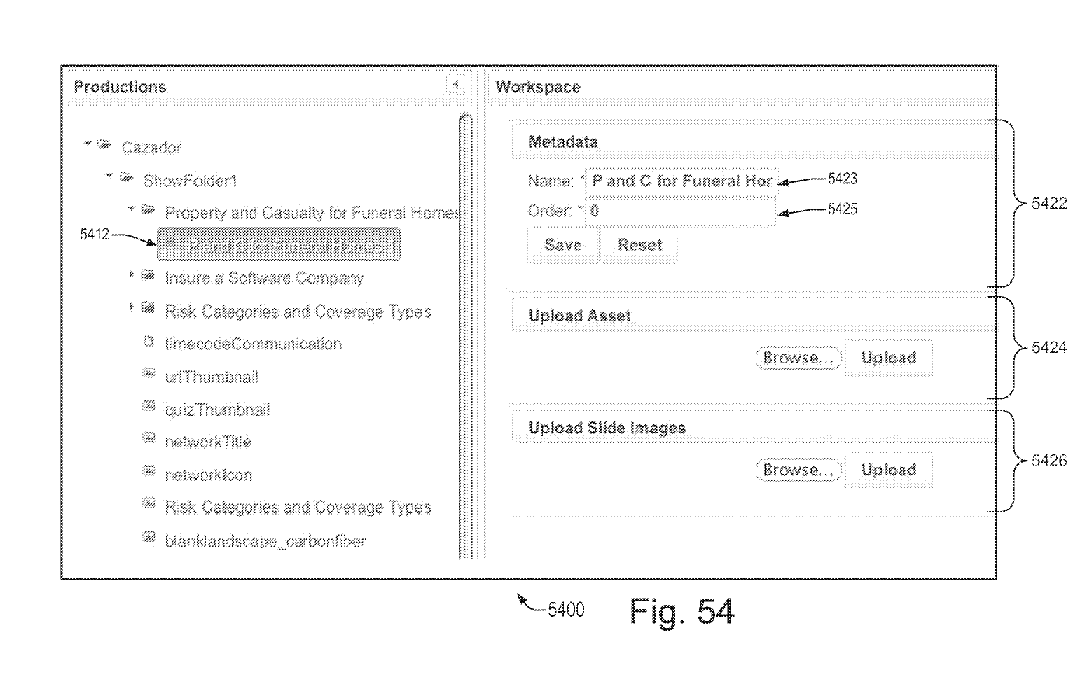

FIG. 54 shows the GUI for creating a new episode (5400), in this example, P and C for Funeral Homes. An example of an episode within a Series is shown (5412). The Workspace for creating a new Episode is shown in items (5422, 5424, and 5426). Naming an Episode is done in the input area (5423). The author may change the order of episodes as they appear in the folder and the Player Library by changing the number in the Order Input GUI (5425). Browsing and uploading assets for the Episode are done in the Upload Asset work area (5424). Browsing and uploading slide images are done in the Upload Slide Images work area (5426).

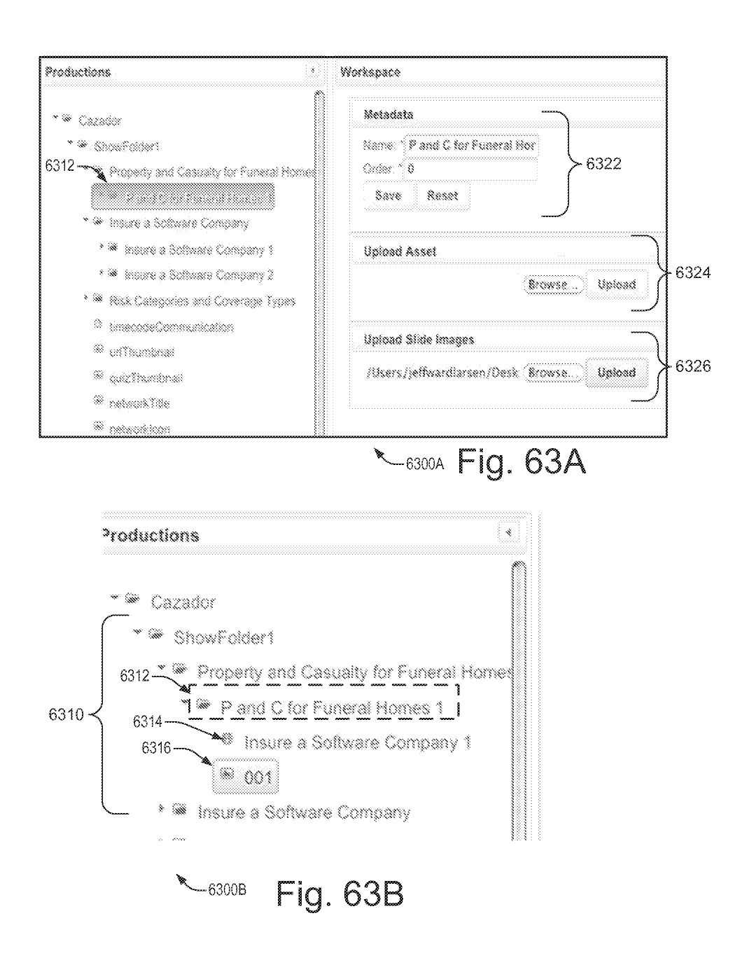

FIGS. 63A and 63B show how to upload Slides to Transmedia Narrative Author. FIG. (6300A) is the workspace for adding the slide, or group of slides. Slide files are placed in the Episode to which they pertain (6312). To upload a slide, the author uses the Upload Slide Images work area (6326). Files are located by browsing, locating the desired slide or slides, then tapping/clicking on the Upload button. Other assets may be added to Episodes, using the Upload Asset work area (6324). The Metadata area (6322) shows the Episode to which assets are being added, and enables the author to save the most current information, or reset it.

FIG. 63B shows the hierarchy in which Slides are placed into an Episode. FIG. 6300B is a closeup of the file structure, with Cazador being the Network, Showfolder1 the location for Shows, Series' and Episodes, Property and Casualty for Funeral Homes (6310) the Show in which the slides are to be uploaded, P and C for Funeral Homes (6312) the Series in which the video file (6314) and slide files (6316) reside.

FIG. 55 shows the GUI (5500) for creating a New Series. Tapping on the icon next to Showfolder1 enables the viewer to see the existing series' within a Showfolder (5512), in this example Insure a Software Company and Risk Categories and Coverage Types. Tapping/clicking on the New Series button (5511) opens an input GUI (5530), which is nested one level beneath Showfolder1 (5512, and 5522). When the input GUI (5530) opens, the author may input the name of the new series, and press Submit to place the new series in Transmedia Narrative Author.

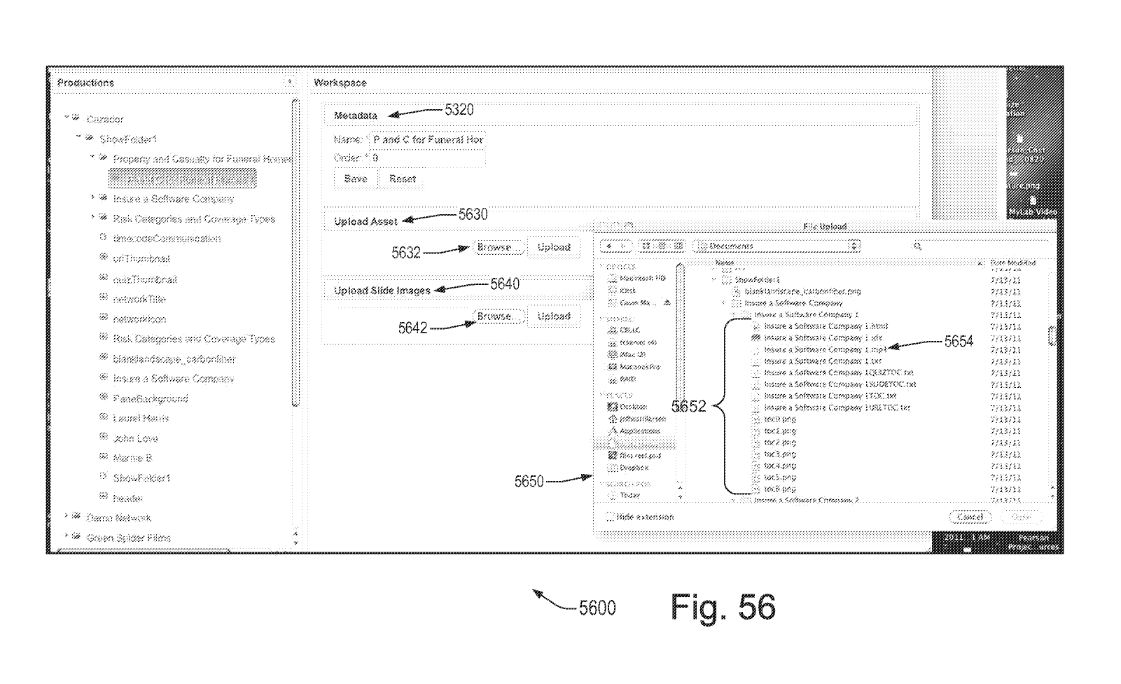

FIG. 56 shows the GUI (5600) for uploading a video asset (5654). Digital assets may be video files, audio files, slides, transcripts, photos, documents, quizzes and assessments, speaker images, comments, notes, graphics, spreadsheets, animations, simulations, games, and other digital files that may be associated with the context of the Transmedia Narrative Transmedia Narrative. Examples are shown in the file list (5652). The Transmedia Narrative Author digital asset management system includes metadata (5620) for one or more digital asset. Metadata within a digital asset includes asset title, file name, media format, asset type, asset ID number, file size, file creation date, duration (if it is a video file), key words, geographic locale, information about people in a video (for example: name, job title, race, gender, age, etc), season in which the video was taken, indoor or outdoor location, time of day, server location, when the file was last accessed, who has accessed the file, and other descriptive metadata that enable classification across a broad spectrum of information that is useful for current and future needs.

In this example the video file (5654) is accessed from a local computer file (5650). Video files may also be accessed from a server, from the cloud, and from portable storage media. Uploading the video file is done in the Upload Asset GUI (5630). Browsing for the file (5632) opens the local file (5650), from which the video file (5654) is located, then uploaded. Similarly, other digital assets like slide images may be accessed and uploaded in the Upload Slide Image work area. Browsing for the file (5642) opens the local file (5650), where a list of video assets (5652) are shown. The author identifies the desired slides, clicks/taps on the Upload button, and the files are uploaded for use in Transmedia Narrative Author.

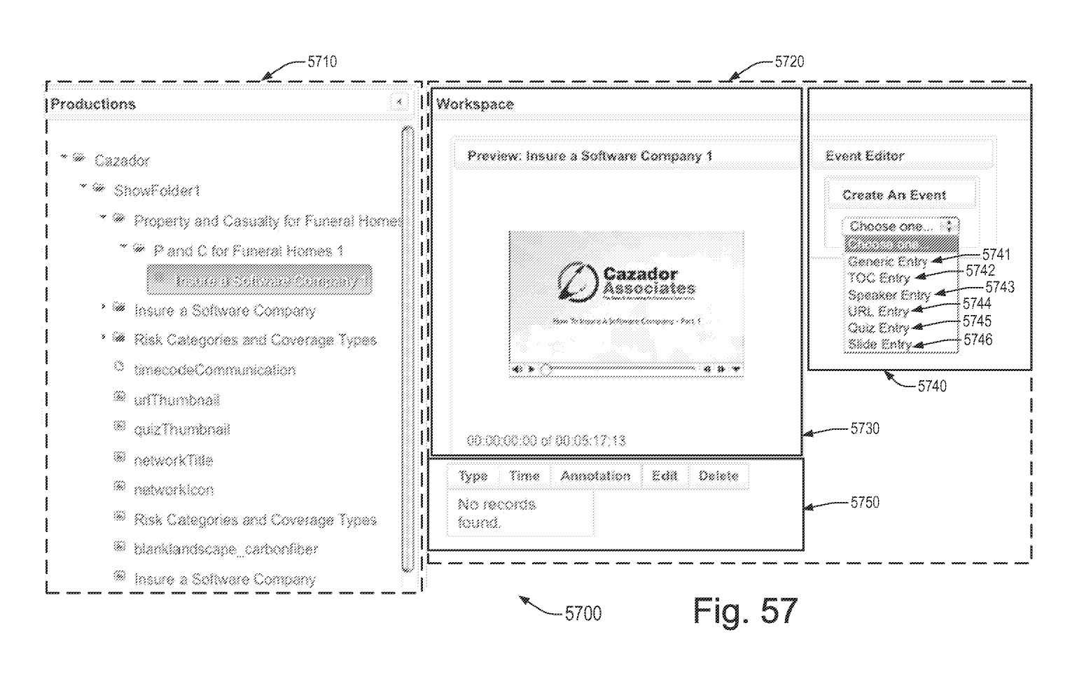

FIG. 57 shows the work GUI (5700) for opening an Episode, and adding digital files to the Transmedia Narrative Transmedia Narrative. Episodes begin with a video file (5730). Tapping/clicking on the forward arrow underneath the video plays the video. Shown with the video are the name of the Episode, time and frame at the moment of the video as it is being played, and the total length of the video. The Event Editor (5740) enables the author to Create an Event, which is to place a digital file in the Transmedia Narrative Transmedia Narrative, at the desired moment that coincides contextually with the video. Examples of files and information that may be added are transcripts, audio files, slides, photos, documents, quizzes and assessments, comments, notes, speaker images, graphics, spreadsheets, animations, simulations, games, and other digital files that may be associated with the context of the Transmedia Narrative Transmedia Narrative. In this example the types of Events are shown in the Create an Event dropdown menu (5740). Event types in this example are Generic Entry (5741), TOC (Table of Contents) Entry (5742), Speaker Entry (5743), URL Entry (5744), Quiz Entry (5745), and Slide Entry (5746). The Transmedia Narrative Author editing history and input work area are shown (5750).

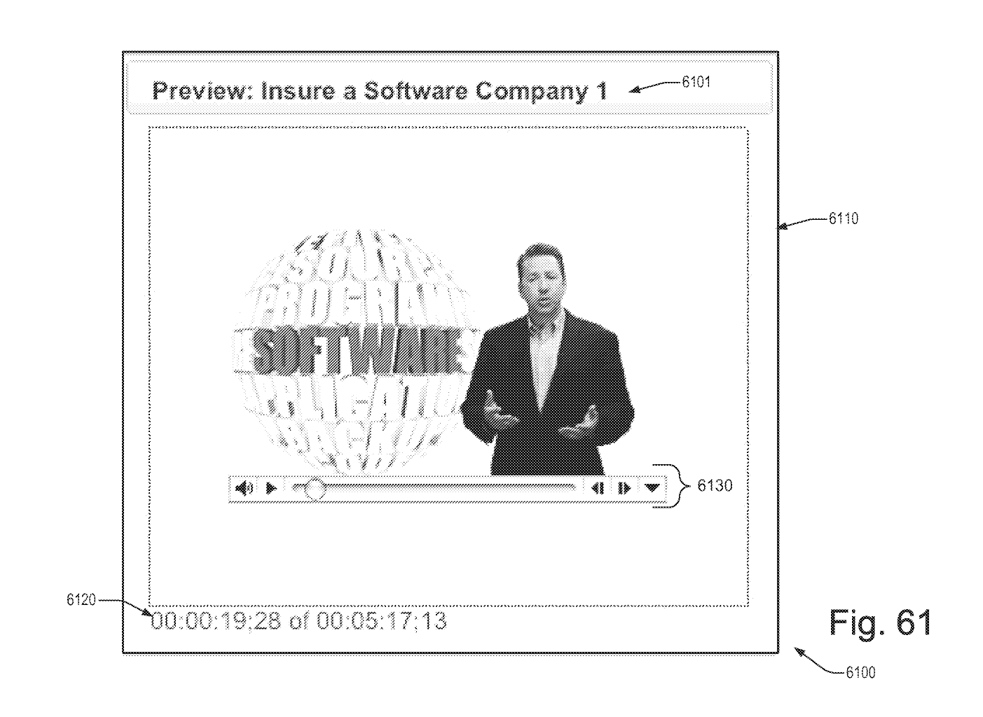

FIG. 61 shows the workspace (6100) for the video file. When editing an Episode, the video file (6110) is placed in the workspace. Included in the workspace are the name of the Episode (6101), the video (6110), the video slider navigation bar (6130), and the timecode information for the video (6120). The video slider navigation bar (6130) includes buttons to start and pause the video, to move frame-by-frame forwards or backwards, and to adjust the volume as the video is being played. The timecode (6120) shows the exact moment where the video is as it is being played or paused. In this example the video is at 00:00:19:28, or 19 seconds, 28 frames into the video. The timecode also shows the overall length of the video, in this case 00:05:17:13, or 5 minutes, 17 seconds, 13 frames.

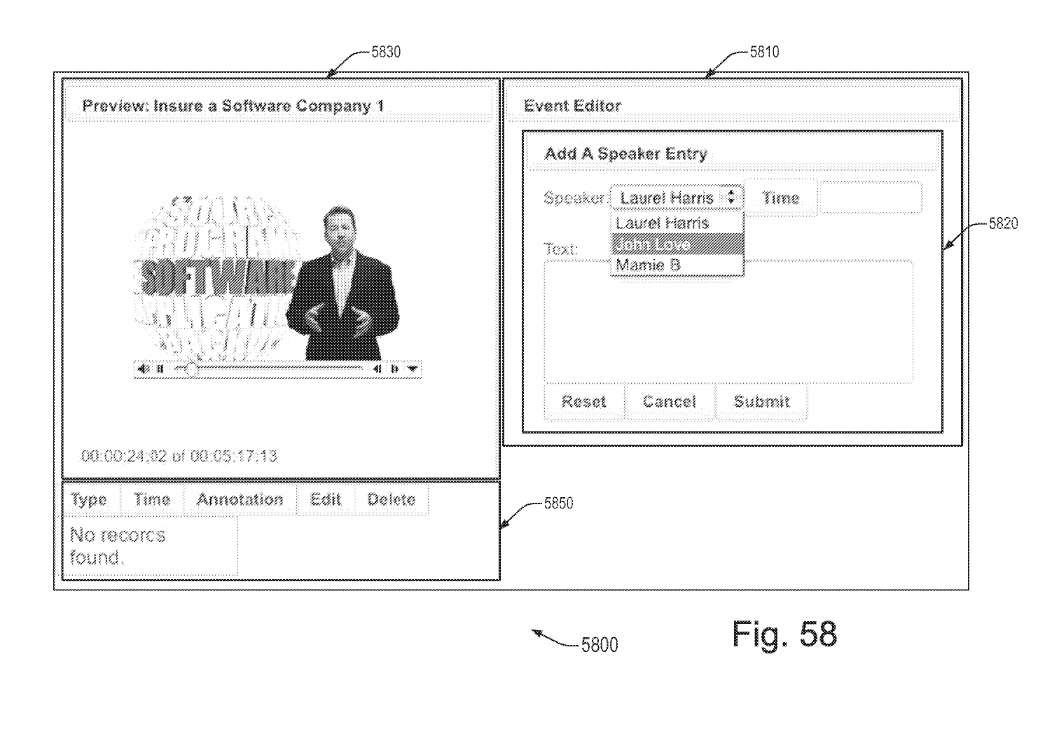

FIG. 58 shows the workspace (5800) to add an Event to the video. The Video Player GUI (5830), and the Event Editor (5820) are shown. In this example, a speaker entry is being added at 00:00:24:02 (24 seconds, 2 frames) into the video. Tapping on the Create an Event dropdown menu, opens the possible types of assets. Tapping on Speaker Entry opens the Add a Speaker Entry GUI (5820). Tapping/clicking on the arrows opens a dropdown menu that includes the list of possible speakers. Tapping/clicking on the Speaker who is speaking at the moment in the video may place the speaker image and speaker name in Transmedia Narrative Author at the moment in the video. This is accomplished by tapping on the Time button, which then automatically syncs the speaker image with that moment (24 seconds, 2 frames) in the video.

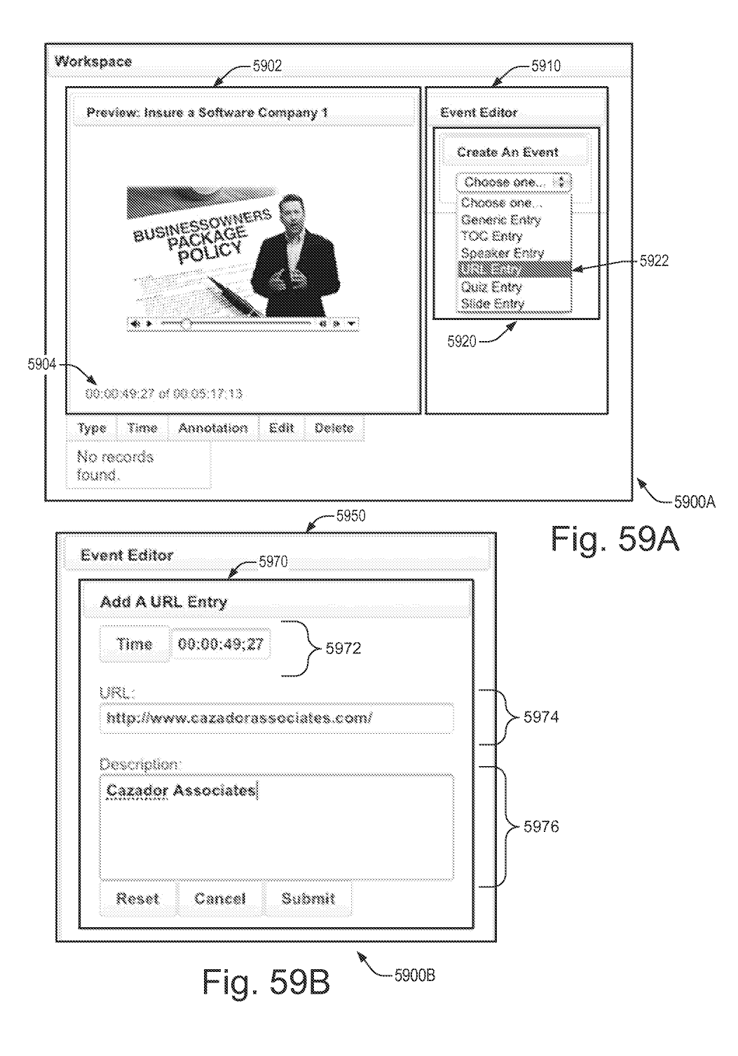

FIG. 59A shows the workspace (5900 A) to add a URL Entry Event to the video. The Video Player GUI (5902), and the Event Editor (5910) are shown. In this example, a URL entry is being added at 00:00:49:27 (5904) (49 seconds, 27 frames) into the video. Tapping on the Create an Event dropdown menu (5920), opens the possible types of assets. Tapping on URL Entry (5922) opens the Add a URL Entry GUI (5970) within the Event Editor (5950).

FIG. 59B shows the Add a URL Entry GUI (5970) within the Event Editor (5950) and workspace (5900B). To add a specific URL, the author may input the URL into the URL input area (5974), or may copy and paste a URL from a Web page. To add a description of what the URL pertains to, in the Description input area (5976), the author types the desired description.

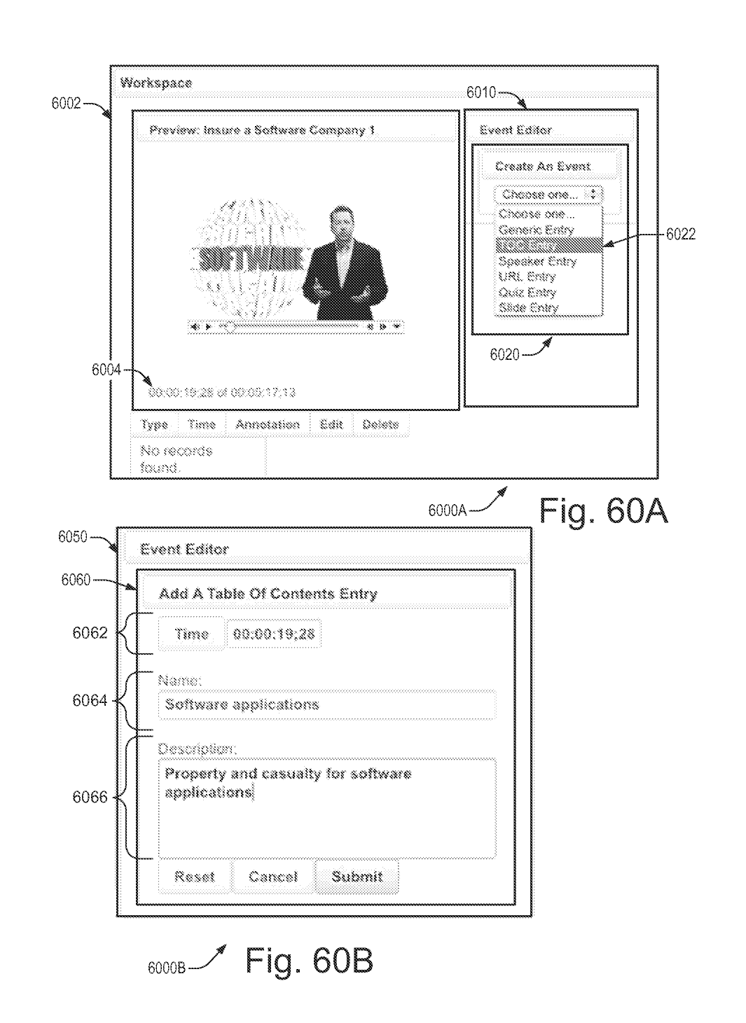

FIG. 60A shows the workspace (6000 A) to add a TOC (Table of Contents) Entry Event to the video. The Video Player GUI (6002), and the Event Editor (6010) are shown. In this example, a TOC entry is being added at 00:00:19:28 (6004) (19 seconds, 28 frames) into the video. Tapping on the Create an Event dropdown menu (6020) within the Event Editor (6010), opens the possible types of assets. Tapping on TOC Entry (6022) opens the Add a TOC Entry GUI (6000B) within the Event Editor (6010).

FIG. 60B shows the Add a TOC Entry GUI within the Event Editor (6050) and workspace (6000B). To add a specific TOC Entry at any moment in the Transmedia Narrative (in this example, 00:00:19:28), when the author clicked/tapped on the TOC Entry (6022) Transmedia Narrative Author automatically opened the Add a Table of Contents Entry GUI (6000B), and synced the time of the video with this entry, shown in the Time input area (6062). The author may also change the timestamp manually. Add the Name of that TOC Entry in the Name input GUI (6064), and a description of the TOC Entry in the Description input GUI (6066).

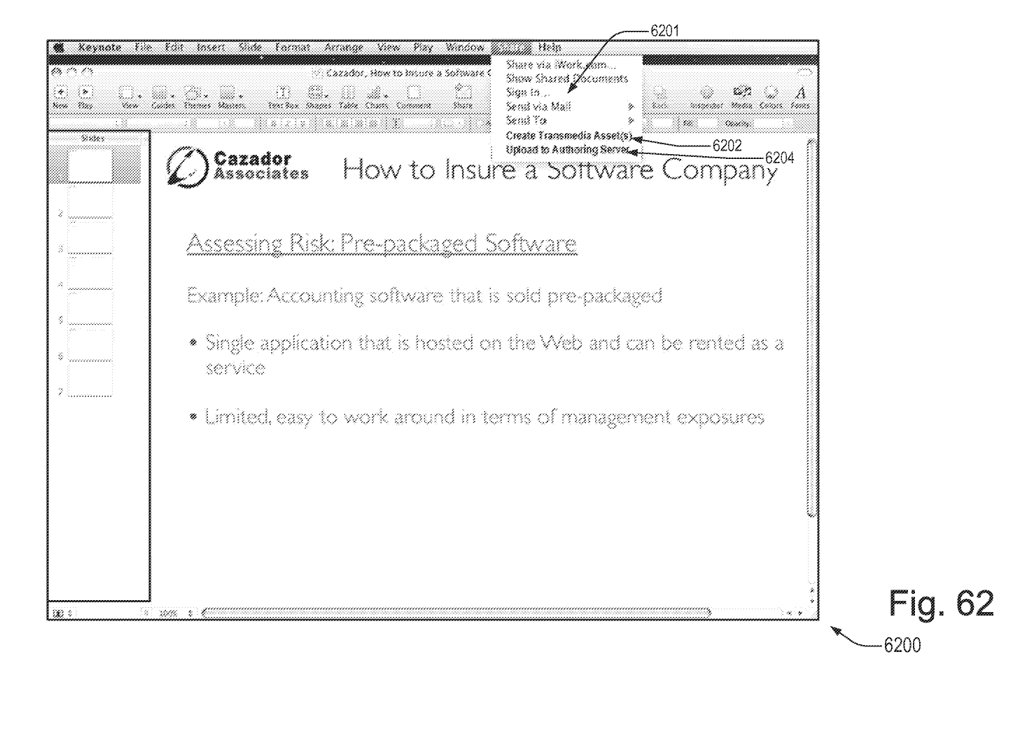

FIG. 62 shows how to export a slide from presentation software into Transmedia Narrative Author. The workspace (6200) shows the slide, along with a dropdown Share menu (6201). Using this menu, the slide may be exported to a Transmedia Narrative by tapping/clickin on Create Transmedia Asset(s) (6202), then on Upload to Authoring Server (6204).

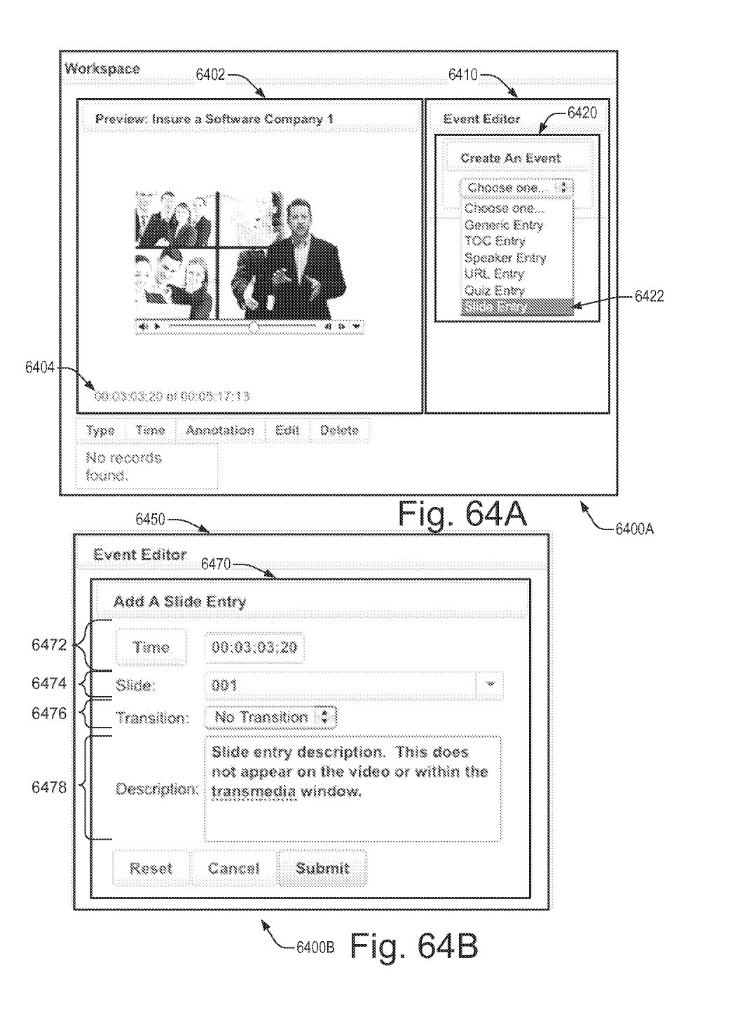

FIGS. 64A and 64B show the authoring process for adding Slides to the Transmedia Narrative Transmedia Narrative. For example, FIG. 64A shows the workspace (6400A) to add a Slide to the video. The Video Player GUI (6402), and the Event Editor (6410) are shown. In this example, a Slide is being added at 00:03:03:20 (6404) (3 minutes, 3 seconds, 20 frames) into the video. Tapping on the Create an Event dropdown menu (6420), opens the possible types of assets. Tapping on Slide Entry (6422) opens the Add a Slide Entry GUI (6470) within the Event Editor (6450).

FIG. 64B shows the Add a Slide Entry GUI (6470) within the Event Editor (6450) and workspace (6400B). The timecode for the Slide Entry is automatically generated when the author taps on Slide Entry (6422). However, the author may also change the time manually within the Time input GUI (6472). To add a specific Slide, the author uses the Slide input GUI (6474), and tapping on the arrow to the right of the input GUI, is shown a list of slides that may be placed in this episode. A description of how slides are uploaded is shown in FIGS. 63A and 63B. The author may elect to add a slide transition using the Transition menu (6476). Transitions include Fade, Dissolve, Wipe, and other common slide transitions used in presentations. To provide a description of the slide that is being added, the author uses the Description input area (6478).

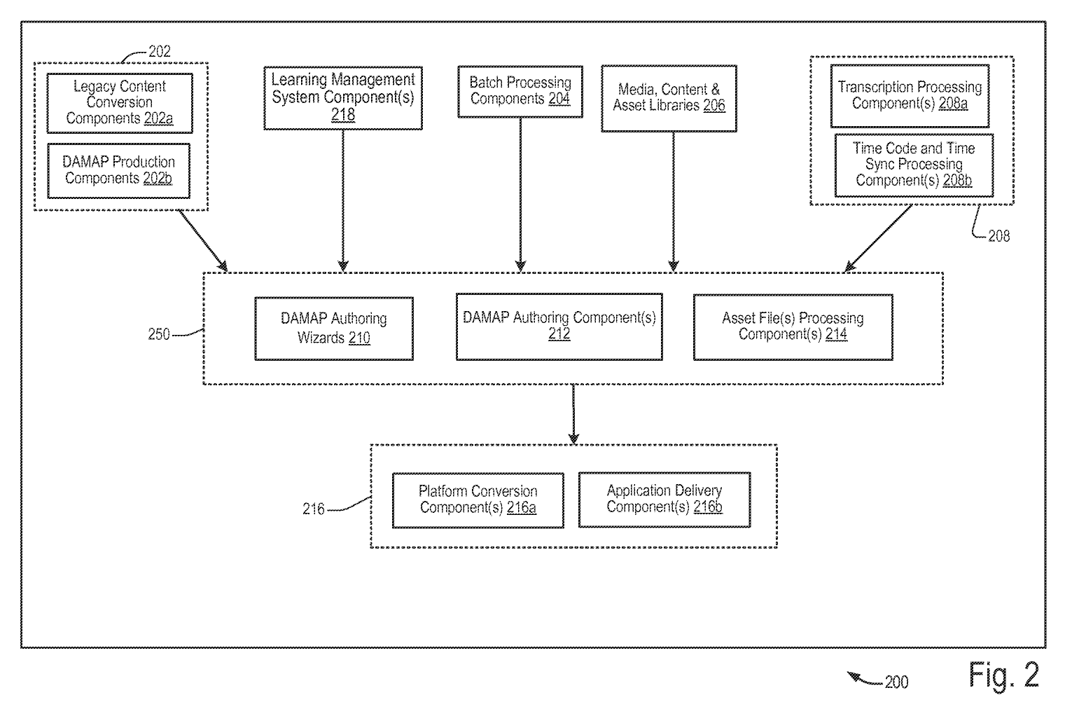

FIG. 2 illustrates a simplified block diagram of a specific example embodiment of a DAMAP Server System 200 which may be implemented in network portion 200. As described in greater detail herein, different embodiments of DAMAP Server Systems may be configured, designed, and/or operable to provide various different types of operations, functionalities, and/or features generally relating to DAMAP Server System technology. Further, as described in greater detail herein, many of the various operations, functionalities, and/or features of the DAMAP Server System(s) disclosed herein may provide may enable or provide different types of advantages and/or benefits to different entities interacting with the DAMAP Server System(s).

According to different embodiments, the DAMAP Server System may include a plurality of different types of components, devices, modules, processes, systems, etc., which, for example, may be implemented and/or instantiated via the use of hardware and/or combinations of hardware and software. For example, as illustrated in the example embodiment of FIG. 2, the DAMAP Server System may include one or more of the following types of systems, components, devices, processes, etc. (or combinations thereof):
Legacy Content Conversion Component(s) 202a
DAMAP Production Component(s) 202b
Batch Processing Component(s) 204
Media Content Library Component(s) 206
Transcription Processing Component(s) 208a
Time Code And Time Sync Processing Component(s) 208b
DAMAP Authoring Wizard Component(s) 210
DAMAP Authoring Component(s) 212
Asset File Processing Component(s) 214
Platform Conversion Component(s) 216a
Application Delivery Component(s) 216b
Other Learning Management System Component(s) 218
etc.

For purposes of illustration, at least a portion of the different types of components of a specific example embodiment of a DAMAP Server System may now be described in greater detail with reference to the example DAMAP Server System embodiment of FIG. 2.
Legacy Content Conversion component(s) (e.g., 202a)—In at least one embodiment, the Legacy Content Conversion component(s) may be operable to perform and/or implement various types of functions, operations, actions, and/or other features such as, for example, one or more of the following (or combinations thereof):
   Facilitating organization, identification, selection, access, storage and/or management of different types of legacy content;
   Facilitating identification and/or selection of specific legacy content which is to be process for conversion;
   Validating, analyzing and/or screening selected portions of legacy content in order to determine whether or not it may be desirable or preferable to perform one or more content conversion operations on such content;
   Manual, automatic and/or dynamic conversion of legacy content such as, for example, video content (e.g., video tape, digital video, analog video, audio content, image content, text content, game content, metadata, etc.)

According to specific embodiments, multiple instances or threads of the Legacy Content Conversion component(s) may be concurrently implemented and/or initiated via the use of one or more processors and/or other combinations of hardware and/or hardware and software. For example, in at least some embodiments, various aspects, features, and/or functionalities of the Legacy Content Conversion component(s) may be performed, implemented and/or initiated by one or more systems, components, systems, devices, procedures, and/or processes described or referenced herein.

According to different embodiments, one or more different threads or instances of the Legacy Content Conversion component(s) may be initiated in response to detection of one or more conditions or events satisfying one or more different types of minimum threshold criteria for triggering initiation of at least one instance of the Legacy Content Conversion component(s). Various examples of conditions or events which may trigger initiation and/or implementation of one or more different threads or instances of the Legacy Content Conversion component(s) may include, but are not limited to, one or more of the different types of triggering events/conditions described or referenced herein.

In at least one embodiment, a given instance of the Legacy Content Conversion component(s) may access and/or utilize information from one or more associated databases. In at least one embodiment, at least a portion of the database information may be accessed via communication with one or more local and/or remote memory devices such as, for example, one or more memory devices, storage devices, databases, websites, libraries, systems and/or servers described or referenced herein.
DAMAP Production Component(s) 202b—In at least one embodiment, the DAMAP Production Component(s) may be operable to perform and/or implement various types of functions, operations, actions, and/or other features such as, for example, one or more of the following (or combinations thereof):
   Simultaneous development of digital video recordings, still photography, graphics and illustrations with metadata significantly reduces original production development schedules.
   Transmedia Narrative storyboarding shortcuts development processes leading to Application Delivery (e.g., 216b) of productions.
   Example types of input to the DAMAP Production Component(s):
      Comma Separated Values (CSV) spreadsheets replace typical log notes during production and become automated metadata information source for Batch Processing Components (204)
      Transmedia Narrative storyboards automate table of contents development leading to Application Delivery (216b)
   Example types of output from the DAMAP Production Component(s):
      Source video files with matching metadata
      Source image (photography) files with matching metadata
      Source illustration files with matching metadata
      Transmedia Narrative original production components with matching metadata

According to different embodiments, one or more different threads or instances of the DAMAP Production Component(s) may be initiated in response to detection of one or more conditions or events satisfying one or more different types of minimum threshold criteria for triggering initiation of at least one instance of the DAMAP Production Component (s). Various examples of conditions or events which may trigger initiation and/or implementation of one or more different threads or instances of the DAMAP Production Component (s) may include, but are not limited to, one or more of the different types of triggering events/conditions described or referenced herein.

In at least one embodiment, a given instance of the DAMAP Production Component component(s) may access and/or utilize information from one or more associated databases. In at least one embodiment, at least a portion of the database information may be accessed via communication with one or more local and/or remote memory devices such as, for example, one or more memory devices, storage devices, databases, websites, libraries, systems and/or servers described or referenced herein.

Batch Processing Component(s) 204—In at least one embodiment, the Batch Processing Component(s) may be operable to perform and/or implement various types of functions, operations, actions, and/or other features such as, for example, one or more of the following (or combinations thereof):
Changing or modifying resolution (e.g., video and/or audio)
Converting the file format type
Shortening and/or lengthening selected content
Performing color correction operations on selected content
Performing audio correction operations on selected content
Performing dynamic filtering and/or selection operations
Smart metadata tagging functionality
Automated Table of Contents entry generation
Automated Table of Contents thumbnail image generation
Media files batch process and automatically moved into Media Content Library (206)
Etc.

In at least one embodiment, the smart metadata tagging functionality may be operable to automatically and/or dynamically perform one or more of the following types of operations (or combinations thereof):
Determine (e.g., from the audio portion of content of a video file) the voice identities or voice identifiers associated with one or more speakers/narrators during selected portions of video content
Determine locational coordinates or other location information associated with selected portions of content
Determine environmental conditions associated with selected portions of content (e.g., video segments, video frames, images, audio clips, etc.)
Populate and manage one or more databases or indexes which, for example, may be used for tracking different portions of content which are associated with a given speaker/narrator (e.g., create a searchable index which may be used for identifying one or more video segments which are narrated by a specified person or speaker)
Populate and manage one or more databases or indexes which, for example, may be used for tracking text transcriptions of selected portions of content which are associated with a given speaker/narrator
Etc.

In at least one embodiment, various example types of metadata which may be identified, tagged and/or otherwise associated with various types of content may include, but are not limited to, one or more of the following (or combinations thereof):

| | |
|---|---|
| Project ID | Race ID |
| Metadata Set ID | Heritage ID |
| MVU Customer ID | Category ID |
| Department ID | Owner ID |
| MVU Region ID | Status ID |
| Grade Level ID | Camera Number ID |
| Product ID | Camera Roll ID |
| Career Focus ID | Interior/Exterior ID |
| First Name ID | Clip Name ID |
| Last Name ID | Description ID |
| Gender ID | Keywords ID |
| Age ID | |

In at least one embodiment, various example types of input to the Batch Processing Component(s) may include, but are not limited to, one or more of the following (or combinations thereof):
Comma Separated Values spreadsheets including metadata
Transmedia Narrative storyboards including Table of Contents information and other metadata
Metadata automatically generated in the recording device (e.g. video camera internal metadata)
Media file information (e.g. lighting conditions, different speakers, location, etc.)

In at least one embodiment, various example types of output from the Batch Processing Component(s) may include, but are not limited to, one or more of the following (or combinations thereof):
Transformed media files
Metadata matched with media files
Table of Contents files
Table of Contents thumbnails

According to different embodiments, one or more different threads or instances of the Batch Processing Component(s) may be initiated in response to detection of one or more conditions or events satisfying one or more different types of minimum threshold criteria for triggering initiation of at least one instance of the Batch Processing Component (s). Various examples of conditions or events which may trigger initiation and/or implementation of one or more different threads or instances of the Batch Processing Component (s) may include, but are not limited to, one or more of the different types of triggering events/conditions described or referenced herein. For example, according to different embodiments, one or more triggering events/conditions may include, but are not limited to, one or more of the following (or combinations thereof):
Folder watch event
Manual input detected
Change of state detected (e.g., change in state or content of media asset detected)
Change of state or content of external data detected
Etc.

In at least one embodiment, a given instance of the Batch Processing Component component(s) may access and/or utilize information from one or more associated databases. In at least one embodiment, at least a portion of the database information may be accessed via communication with one or more local and/or remote memory devices such as, for example, one or more memory devices, storage devices, databases, websites, libraries, systems and/or servers described or referenced herein.
Media Content Library 206—In at least one embodiment, the Media Content Library(s) may be operable to perform and/or implement various types of functions, operations, actions, and/or other features such as, for example, one or more of the following (or combinations thereof):
   Source media which may be desired or needed to edit videos, produce game, create graphics, games, illustrations, etc. are stored in a database architecture with searchable and editable metadata (versus saved in a hierarchical directory structure). This saves significant development time in producing original content or managing legacy content by improving file management efficiencies. It also reduces the chance for error, file redundancy, and data loss.
   Finished media which may be desired or needed to create Transmedia Narratives are stored in a database architecture with searchable and editable metadata and are ready for the Transmedia Narrative authoring process which occurs in the same database architecture (versus exporting from one software environment to another for authoring). This saves significant development time in developing and managing Transmedia Narratives.

In at least one embodiment, various example types of information which may be stored or accessed by the Media Content Library(s) may include, but are not limited to, one or more of the following (or combinations thereof):
Video files with metadata
Audio files with metadata
Text files with metadata
Graphics files with metadata
Illustration files with metadata
Game files with metadata
Transcript files (part of the metadata associated with Video Files)
Index files for Transmedia Narratives
Table of Contents files for Transmedia Narratives

In at least one embodiment, various example types of output from the Media Content Library(s) may include, but are not limited to, one or more of the following (or combinations thereof):
Original media files with metadata
Thumbnail files with metadata
Edit proxy files with metadata
Transcription files associated with Video Files
Metadata associated with Video files
Index files for Transmedia Narratives
Table of Contents Files for Transmedia Narratives

According to different embodiments, one or more different threads or instances of the Media Content Library(s) may be initiated in response to detection of one or more conditions or events satisfying one or more different types of minimum threshold criteria for triggering initiation of at least one instance of the Media Content Library (s). Various examples of conditions or events which may trigger initiation and/or implementation of one or more different threads or instances of the Media Content Library (s) may include, but are not limited to, one or more of the different types of triggering events/conditions described or referenced herein.

In at least one embodiment, a given instance of the Media Content Library component(s) may access and/or utilize information from one or more associated databases. In at least one embodiment, at least a portion of the database information may be accessed via communication with one or more local and/or remote memory devices such as, for example, one or more memory devices, storage devices, databases, websites, libraries, systems and/or servers described or referenced herein.
Transcription Processing Component(s) 208a—In at least one embodiment, the Transcription Processing Component(s) may be operable to perform and/or implement various types of functions, operations, actions, and/or other features such as, for example, one or more of the following (or combinations thereof):
   Transcription of words spoken and recorded as audio or video files, and the recording of narration for words that are written, are the underlying points for synchronization in Transmedia Narratives. Matching the written word with the spoken word based on timecode information enables synchronization.
   Labor-intensive transcription processes are shortcut through a variety of enabling technologies incorporated within (208a)
      Manual transcription templates
      Keyboard shortcuts
      Voice Recognition software
      Lip Reading software
      Optical Character Recognition software

In at least one embodiment, various example types of input to the Transcription Processing Component(s) may include, but are not limited to, one or more of the following (or combinations thereof):
Text files
Keyboard entry
User input
GUI input
Keyboard shortcuts
Voice Recognition software files
Optical Character Recognition software files

In at least one embodiment, various example types of output from the Transcription Processing Component(s) may include, but are not limited to, one or more of the following (or combinations thereof):
Transcription files
Transcription metadata files
Audio files with metadata (including transcriptions)
Video files with metadata (including transcriptions)

According to different embodiments, one or more different threads or instances of the Transcription Processing Component(s) may be initiated in response to detection of one or more conditions or events satisfying one or more different types of minimum threshold criteria for triggering initiation of at least one instance of the Transcription Processing Component (s). Various examples of conditions or events which may trigger initiation and/or implementation of one or more different threads or instances of the Transcription Processing Component (s) may include, but are not limited to, one or more of the different types of triggering events/conditions described or referenced herein.

In at least one embodiment, a given instance of the Transcription Processing Component component(s) may access and/or utilize information from one or more associated databases. In at least one embodiment, at least a portion of the database information may be accessed via communication with one or more local and/or remote memory devices such as, for example, one or more memory devices, storage devices, databases, websites, libraries, systems and/or servers described or referenced herein.
Time Code And Time Sync Processing Component(s) 208b—In at least one embodiment, the Time Code And Time Sync Processing Component(s) may be operable to perform and/or implement various types of functions, operations, actions, and/or other features such as, one or more of those described or referenced herein. Video and audio files lack direct linkages to the words that are spoken by people being interviewed, narrators, actors, etc. In order to create and index and locate any specific point in an audio or video file, there be at least a) a timecode stamp, and 2) descriptive information (metadata) about that location in the audio or video file. The most robust, descriptive information about video and audio files for indexing are written words corresponding to spoken words. By automating the process of synchronization of Time Code and Time Sync Processing, we are able to automatically generate Table of Contents and index files that allow the Application Delivery Components (216b) to synchronize video, audio, text, and other media resources when played back on various devices.

In at least one embodiment, various example types of input to the Time Code And Time Sync Processing Component(s) may include, but are not limited to, one or more of the following (or combinations thereof):
Timecode embedded within audio and video files
Transcript metadata
Descriptive information metadata
Audio files
Video files
Waveform information
Changes in color, light, sound, and other signals

In at least one embodiment, various example types of output from the Time Code And Time Sync Processing Component(s) may include, but are not limited to, one or more of the following (or combinations thereof):=
Index files
Metadata
Table of Contents files

According to different embodiments, one or more different threads or instances of the Time Code And Time Sync Processing Component(s) may be initiated in response to detection of one or more conditions or events satisfying one or more different types of minimum threshold criteria for triggering initiation of at least one instance of the Time Code And Time Sync Processing Component (s). Various examples of conditions or events which may trigger initiation and/or implementation of one or more different threads or instances of the Time Code And Time Sync Processing Component (s) may include, but are not limited to, one or more of the different types of triggering events/conditions described or referenced herein.

In at least one embodiment, a given instance of the Time Code And Time Sync Processing Component component(s) may access and/or utilize information from one or more associated databases. In at least one embodiment, at least a portion of the database information may be accessed via communication with one or more local and/or remote memory devices such as, for example, one or more memory devices, storage devices, databases, websites, libraries, systems and/or servers described or referenced herein.
DAMAP Authoring Wizard Component(s) 210—In at least one embodiment, the DAMAP Authoring Wizard Component(s) may be operable to perform and/or implement various types of functions, operations, actions, and/or other features such as, for example, one or more of those described or referenced herein. Creating Transmedia Narratives that synchronize audio, video, text, and other media based on timecode information would be a time consuming, labor-intensive, and error-prone process. By layering the DAMAP Wizard Component(s) (210) over the DAMAP Authoring Component(s) (212) we have significantly reduced the potential for authoring error as well as the time and expense involved with creating Transmedia Narratives.

In at least one embodiment, various example types of input to the DAMAP Authoring Wizard Component(s) may include, but are not limited to, one or more of the following (or combinations thereof):

| | |
|---|---|
| Keyboard entry | Popup menus |
| User input | Pull down menus |
| GUI input | Drag and drop functionality |
| User input | Staged input/response guides |
| GUI input | Automated suggestions and prompts |
| Keyboard shortcuts | Buttons and other user input shortcuts |
| Voice input | |

In at least one embodiment, various example types of output from the DAMAP Authoring Wizard Component(s) may include, but are not limited to, one or more of the following (or combinations thereof):
Index files
Metadata files
Table of Contents files
Media files with associated metadata
Manifest files
One or more files necessary to enable synchronization of Transmedia Narratives

According to different embodiments, one or more different threads or instances of the DAMAP Authoring Wizard Component(s) may be initiated in response to detection of one or more conditions or events satisfying one or more different types of minimum threshold criteria for triggering initiation of at least one instance of the DAMAP Authoring Wizard Component (s). Various examples of conditions or events which may trigger initiation and/or implementation of one or more different threads or instances of the DAMAP Authoring Wizard Component (s) may include, but are not limited to, one or more of the different types of triggering events/conditions described or referenced herein.

In at least one embodiment, a given instance of the DAMAP Authoring Wizard Component component(s) may access and/or utilize information from one or more associated databases. In at least one embodiment, at least a portion of the database information may be accessed via communication with one or more local and/or remote memory devices such as, for example, one or more memory devices, storage devices, databases, websites, libraries, systems and/or servers described or referenced herein.
DAMAP Authoring Component(s) 212—In at least one embodiment, the DAMAP Authoring Component(s) may be operable to perform and/or implement various types of functions, operations, actions, and/or other features such as, for example, one or more of those described or referenced herein. These components may be configured or designed to function as the structural layer that manages input and output to and from the Media Library (206). In order to extend the functionality of the Media Library beyond that of a Digital Asset Management System, these components allow users to design and modify Transmedia Narratives by setting in and out points in the time code for any video or audio file. These components also allow users to associate transcript information and other metadata with any set of in and out points in the timecode of a video or audio file. These components also allow users to identify and associate images, web-based resource links, other databases and devices, and any other digital media file or resource with the timecode base of the video or audio file that is incorporated with the Transmedia Narrative.

In at least one embodiment, various example types of input to the DAMAP Authoring Component(s) may include, but are not limited to, one or more of those described or referenced herein. In at least one embodiment, various example types of output from the DAMAP Authoring Component(s) may include, but are not limited to, one or more of those described or referenced herein.

According to different embodiments, one or more different threads or instances of the DAMAP Authoring Component(s) may be initiated in response to detection of one or more conditions or events satisfying one or more different types of minimum threshold criteria for triggering initiation of at least one instance of the DAMAP Authoring Component (s). Various examples of conditions or events which may trigger initiation and/or implementation of one or more different threads or instances of the DAMAP Authoring Component (s) may include, but are not limited to, one or more of the different types of triggering events/conditions described or referenced herein.

In at least one embodiment, a given instance of the DAMAP Authoring Component component(s) may access and/or utilize information from one or more associated databases. In at least one embodiment, at least a portion of the database information may be accessed via communication with one or more local and/or remote memory devices such as, for example, one or more memory devices, storage devices, databases, websites, libraries, systems and/or servers described or referenced herein.
Asset File Processing Component(s) 214—In at least one embodiment, the Asset File Processing Component(s) may be operable to perform and/or implement various types of functions, operations, actions, and/or other features such as, for example, one or more of those described or referenced herein. By automating the export process from the DAMAP Authoring (212) Component(s), one or more the files necessary to generate a Transmedia Narrative from the Media Library™ are completed through these Asset File Processing Components.

In at least one embodiment, various example types of input to the Asset File Processing Component(s) may include, but are not limited to, one or more of those described or referenced herein. In at least one embodiment, various example types of output from the Asset File Processing Component(s) may include, but are not limited to, one or more of those described or referenced herein.

According to different embodiments, one or more different threads or instances of the Asset File Processing Component(s) may be initiated in response to detection of one or more conditions or events satisfying one or more different types of minimum threshold criteria for triggering initiation of at least one instance of the Asset File Processing Component (s). Various examples of conditions or events which may trigger initiation and/or implementation of one or more different threads or instances of the Asset File Processing Component (s) may include, but are not limited to, one or more of the different types of triggering events/conditions described or referenced herein.

In at least one embodiment, a given instance of the Asset File Processing Component component(s) may access and/or utilize information from one or more associated databases. In at least one embodiment, at least a portion of the database information may be accessed via communication with one or more local and/or remote memory devices such as, for example, one or more memory devices, storage devices, databases, websites, libraries, systems and/or servers described or referenced herein.
Platform Conversion Component(s) 216a—In at least one embodiment, the Platform Conversion Component(s) may be operable to perform and/or implement various types of functions, operations, actions, and/or other features such as, for example, one or more of those described or referenced herein. Because some media files may need to be altered in some way in order to operate on specific platforms, these Platform Conversion Components automate the process of transformation in terms of file size, bit rate, sound level, etc. depending on the Transmedia Narrative device being targeted for playback.

In at least one embodiment, various example types of input to the Platform Conversion Component(s) may include, but are not limited to, one or more of those described or referenced herein. In at least one embodiment, various example types of output from the Platform Conversion Component(s) may include, but are not limited to, one or more of those described or referenced herein.

According to different embodiments, one or more different threads or instances of the Platform Conversion Component(s) may be initiated in response to detection of one or more conditions or events satisfying one or more different types of minimum threshold criteria for triggering initiation of at least one instance of the Platform Conversion Component (s). Various examples of conditions or events which may trigger initiation and/or implementation of one or more different threads or instances of the Platform Conversion Component (s) may include, but are not limited to, one or more of the different types of triggering events/conditions described or referenced herein.

In at least one embodiment, a given instance of the Platform Conversion Component component(s) may access and/or utilize information from one or more associated databases. In at least one embodiment, at least a portion of the database information may be accessed via communication with one or more local and/or remote memory devices such as, for example, one or more memory devices, storage devices, databases, websites, libraries, systems and/or servers described or referenced herein.

Application Delivery Component(s) 216b—In at least one embodiment, the Application Delivery Component(s) may be operable to perform and/or implement various types of functions, operations, actions, and/or other features such as, for example, one or more of the following (or combinations thereof):
Enabling, controlling, managing, and/or facilitating distribution and delivery of Transmedia Narratives to one or more client system(s), Learning Management System(s), Server System(s), network devices, etc.
Enabling, controlling, managing, and/or facilitating local and/or remote access to DAMAP related data, metadata, Transmedia Narratives, and/or other content.
Tracking and/or managing end user activities.
Etc.

In at least one embodiment, the Application Delivery Component(s) may be operable to provide access to media assets and their associated metadata in one or more relational databases (such as, for example, ReelContent Library™). In at least one embodiment, this server-based architecture may facilitate the assembling of Transmedia Narratives, and/or may also facilitate exporting of the Transmedia Narrative and/or asset files to the DAMAP Client Application.

In at least one embodiment, various example types of input to the Application Delivery Component(s) may include, but are not limited to, one or more of those described or referenced herein. In at least one embodiment, various example types of output from the Application Delivery Component(s) may include, but are not limited to, one or more of those described or referenced herein.

According to different embodiments, one or more different threads or instances of the Application Delivery Component(s) may be initiated in response to detection of one or more conditions or events satisfying one or more different types of minimum threshold criteria for triggering initiation of at least one instance of the Application Delivery Component (s). Various examples of conditions or events which may trigger initiation and/or implementation of one or more different threads or instances of the Application Delivery Component (s) may include, but are not limited to, one or more of the different types of triggering events/conditions described or referenced herein.

In at least one embodiment, a given instance of the Application Delivery Component component(s) may access and/or utilize information from one or more associated databases. In at least one embodiment, at least a portion of the database information may be accessed via communication with one or more local and/or remote memory devices such as, for example, one or more memory devices, storage devices, databases, websites, libraries, systems and/or servers described or referenced herein.
Learning Management System Component(s) 218—In at least one embodiment, the Learning Management System Component(s) may be operable to perform and/or implement various types of functions, operations, actions, and/or other features such as, one or more of those described or referenced herein. Learning Management System Components provide user login, registration, communication, and classroom services. These components interoperate with Application Delivery Component(s) 216b—to create a complete learning environment for students and users who interact with Transmedia Narratives. In at least one embodiment, various example types of input to the Learning Management System Component(s) may include system calls from Application Delivery Component(s) 216b.

According to different embodiments, one or more different threads or instances of the Learning Management System Component(s) may be initiated in response to detection of one or more conditions or events satisfying one or more different types of minimum threshold criteria for triggering initiation of at least one instance of the Learning Management System Component (s). Various examples of conditions or events which may trigger initiation and/or implementation of one or more different threads or instances of the Learning Management System Component (s) may include, but are not limited to, one or more of the different types of triggering events/conditions described or referenced herein.

In at least one embodiment, a given instance of the Learning Management System Component component(s) may access and/or utilize information from one or more associated databases. In at least one embodiment, at least a portion of the database information may be accessed via communication with one or more local and/or remote memory devices such as, for example, one or more memory devices, storage devices, databases, websites, libraries, systems and/or servers described or referenced herein.

It may be appreciated that the DAMAP Server System of FIG. 2 is but one example from a wide range of DAMAP Server System embodiments which may be implemented. Other embodiments of the DAMAP Server System (not shown) may include additional, fewer and/or different components/features that those illustrated in the example DAMAP Server System embodiment of FIG. 2.

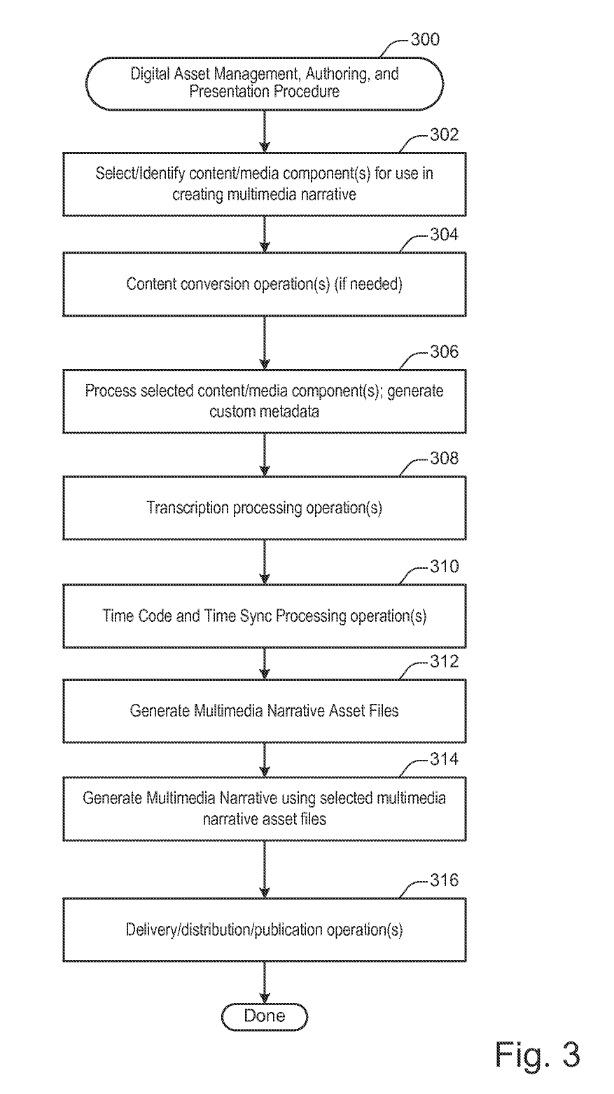

FIG. 3 shows a flow diagram of a Digital Asset Management, Authoring, and Presentation (DAMAP) Procedure in accordance with a specific embodiment. In at least one embodiment, the DAMAP Procedure may be operable to perform and/or implement various types of functions, operations, actions, and/or other features, examples of which are described herein. In at least some embodiments, portions of the DAMAP Procedure may also be implemented at other devices and/or systems of a computer network. According to specific embodiments, multiple instances or threads of the DAMAP Procedure may be concurrently implemented and/or initiated via the use of one or more processors and/or other combinations of hardware and/or hardware and software. In at least one embodiment, one or more or selected portions of the DAMAP Procedure may be implemented at one or more Client(s), at one or more Server(s), and/or combinations thereof. For example, in at least some embodiments, various aspects, features, and/or functionalities of the DAMAP mechanism(s) may be performed, implemented and/or initiated by one or more systems, components, systems, devices, procedures, and/or processes described or referenced herein.

According to different embodiments, one or more different threads or instances of the DAMAP Procedure may be initiated in response to detection of one or more conditions or events satisfying one or more different types of criteria (such as, for example, minimum threshold criteria) for triggering initiation of at least one instance of the DAMAP Procedure. Examples of various types of conditions or events which may trigger initiation and/or implementation of one or more different threads or instances of the DAMAP Procedure are described herein. According to different embodiments, one or more different threads or instances of the DAMAP Procedure may be initiated and/or implemented manually, automatically, statically, dynamically, concurrently, and/or combinations thereof. Additionally, different instances and/or embodiments of the DAMAP Procedure may be initiated at one or more different time intervals (e.g., during a specific time interval, at regular periodic intervals, at irregular periodic intervals, upon demand, etc.).

In at least one embodiment, a given instance of the DAMAP Procedure may utilize and/or generate various different types of data and/or other types of information when performing specific tasks and/or operations. This may include, for example, input data/information and/or output data/information. For example, in at least one embodiment, at least one instance of the DAMAP Procedure may access, process, and/or otherwise utilize information from one or more different types of sources, such as, for example, one or more databases. In at least one embodiment, at least a portion of the database information may be accessed via communication with one or more local and/or remote memory devices. Additionally, at least one instance of the DAMAP Procedure may generate one or more different types of output data/information, which, for example, may be stored in local memory and/or remote memory devices.

In at least one embodiment, initial configuration of a given instance of the DAMAP Procedure may be performed using one or more different types of initialization parameters. In at least one embodiment, at least a portion of the initialization parameters may be accessed via communication with one or more local and/or remote memory devices. In at least one embodiment, at least a portion of the initialization parameters provided to an instance of the DAMAP Procedure may correspond to and/or may be derived from the input data/information.

For purposes of illustration, an example of the DAMAP Procedure may now be described by way of example with reference to the block diagram of FIG. 2 (and/or other Figures described or illustrated herein).

As illustrated in the example embodiment of FIG. 3, at 302 one or more content components and/or media components may be identified/selected for use in creating the multimedia narrative (e.g., Transmedia Narrative). Examples of different types of content/media components may include, but are not limited to, one or more of the following (or combinations thereof):
Video files/content (e.g., movie clips, video clips, digital video content, analog video content, etc.)
Image files/content
Text files (such as, for example, a text transcript of a video to be included in the multimedia narrative)
Game files/content
Metadata
Keywords
DAMAP production components
Legacy Content Components
Etc

As illustrated in the example embodiment of FIG. 3, at 304 one or more content conversion operation(s) may be performed, if desired. For example, according to different embodiments, various types of content conversion operation(s) which may be performed may include, but are not limited to, one or more of the following (or combinations thereof):
Changing or modifying resolution (e.g., video and/or audio)
Converting the file format type
Shortening and/or lengthening selected content
Performing color correction operations on selected content
Performing audio correction operations on selected content
Performing dynamic filtering and/or selection operations
Smart metadata tagging functionality
Automated Table of Contents entry generation
Automated Table of Contents thumbnail image generation
Media files batch process and automatically moved into Media Content Library (206)
Etc.

In at least one embodiment, at least a portion of the content conversion operations may be performed by the Batch Processing Component(s) 204.

As illustrated in the example embodiment of FIG. 3, at 306, custom metadata may be generated, for example, by processing selected portions of content/media. In one embodiment, custom metadata may be generated using spreadsheets, ReelContent CGI, PERL scripts, etc. According to different embodiments, examples of the different types of metadata which may be generated may include, but are not limited to, one or more of the following (or combinations thereof):

| | |
|---|---|
| Project ID | MVU Region ID |
| Metadata Set ID | Grade Level ID |
| MVU Customer ID | Product ID |
| Department ID | Career Focus ID |
| First Name ID | Status ID |
| Last Name ID | Camera Number ID |
| Gender ID | Camera Roll ID |
| Age ID | Interior/Exterior ID |
| Race ID | Clip Name ID |
| Heritage ID | Description ID |
| Category ID | Keywords ID |
| Owner ID | Etc |

In at least one embodiment, the smart metadata tagging functionality may be operable to automatically and/or dynamically perform one or more of the following types of operations (or combinations thereof):
Determine (e.g., from the audio portion of content of a video file) the voice identities or voice identifiers associated with one or more speakers/narrators during selected portions of video content
Determine locational coordinates or other location information associated with selected portions of content
Determine environmental conditions associated with selected portions of content (e.g., video segments, video frames, images, audio clips, etc.)
Populate and manage one or more databases or indexes which, for example, may be used for tracking different portions of content which are associated with a given speaker/narrator (e.g., create a searchable index which may be used for identifying one or more video segments which are narrated by a specified person or speaker)
Populate and manage one or more databases or indexes which, for example, may be used for tracking text transcriptions of selected portions of content which are associated with a given speaker/narrator
Etc.

As illustrated in the example embodiment of FIG. 3, at 308, various transcription processing operations may be performed (if desired). For example, according to different embodiments, various types of transcription processing operation(s) which may be performed may include, but are not limited to, one or more of the following (or combinations thereof):
Transcription of words spoken and recorded as audio or video files, and the recording of narration for words that are written, are the underlying points for synchronization in Transmedia Narratives.
Matching the written word with the spoken word based on timecode information enables synchronization.
Automatically and/or dynamically recognize different voices in the video's audio track(s) (e.g., using voice pitch and/or other distinguishing vocal characteristics).
Automatically and/or dynamically determining an identity (and/or associated identifier) of at least one different voice that is recognized in the video's audio track(s).
Generating dialog tracking information which may be used to track and/or determine the specific proportions of the video where the voice of a given person has been detected in the video's audio track(s).
According to different embodiments, transcription processes may be implemented and/or facilitated using a variety of techniques such as, for example, one or more of the following (or combinations thereof):
   Manual transcription templates
   Keyboard shortcuts
   Voice Recognition software
   Lip Reading software
   Optical Character Recognition software
   Etc.

In at least one embodiment, at least a portion of the transcription processing operations may be performed by the transcription processing components 208a. In at least one embodiment, various example types of input to the Transcription Processing Component(s) may include, but are not limited to, one or more of the following (or combinations thereof):
Text files
Keyboard entry
User input
GUI input
Keyboard shortcuts
Voice Recognition software files
Optical Character Recognition software files

In at least one embodiment, various example types of output from the Transcription Processing Component(s) may include, but are not limited to, one or more of the following (or combinations thereof):
Transcription files
Transcription metadata files
Audio files with metadata (including transcriptions)
Video files with metadata (including transcriptions)

In at least one embodiment, the text of the transcribed audio and other data/information associated therewith may be stored as metadata in a relational database which, for example, may be centered around a video file being processed. For example, in one embodiment, the text of the transcription and/or other data/metadata may be stored in one or more annotation fields associated with a selected video editing software program such as, for example, Apple Inc.'s Final Cut Server video editing software application.

As illustrated in the example embodiment of FIG. 3, at 310, various time coding and/or time sync operations may be performed (if desired). For example, conventional video and audio files lack direct linkages to the words that are spoken by people being interviewed, narrators, actors, etc. In order to create and index and locate any specific point in an audio or video file, there may preferably be provided a) a timecode stamp, and 2) descriptive information (metadata) about that location in the audio or video file. One of the more robust, descriptive information about video and audio files for indexing are written words corresponding to spoken words. By automating the process of synchronization of Time Code and Time Sync Processing, we are able to automatically generate Table of Contents and index files that allow the Application Delivery Components (e.g., 216b) to synchronize video, audio, text, and other media resources when played back on various devices.

In at least one embodiment, at least a portion of the time coding and/or time sync operations may be performed by the Time Code and Time Sync Processing Component(s) 208b. In at least one embodiment, various example types of input to the Time Code And Time Sync Processing Component(s) may include, but are not limited to, one or more of the following (or combinations thereof):
Timecode embedded within audio and video files
Transcript metadata
Descriptive information metadata
Audio files
Video files
Waveform information
Changes in color, light, sound, and other signals

In at least one embodiment, various example types of output from the Time Code And Time Sync Processing Component(s) may include, but are not limited to, one or more of the following (or combinations thereof):
Index files
Metadata
Table of Contents files

As illustrated in the example embodiment of FIG. 3, at 312, one or more multimedia narrative asset files may be generated. Without the use of the various DAMAP techniques described herein, the creating of Transmedia Narratives that synchronize audio, video, text, and other media based on timecode information may be a time consuming, labor-intensive, and error-prone process. However, in at least one embodiment, by layering the DAMAP Wizard Component(s) over the DAMAP Authoring Component(s), we have significantly reduced the potential for authoring error as well as the time and expense involved with creating Transmedia Narratives.

In at least one embodiment, at least a portion of the multimedia narrative asset file generating operations may be performed by the DAMAP authoring wizards 210 and DAMAP authoring components 212. These components may be configured or designed to function as the structural layer that manages input and output to and from the Media Library (206). In order to extend the functionality of the Media Library beyond that of a Digital Asset Management System, these components allow users to design and modify Transmedia Narratives by setting in and out points in the time code for any video or audio file. These components also allow users to associate transcript information and other metadata with any set of in and out points in the timecode of a video or audio file. These components also allow users to identify and associate images, web-based resource links, other databases and devices, and any other digital media file or resource with the timecode base of the video or audio file that is incorporated with the Transmedia Narrative.

According to different embodiments, examples of different types of multimedia narrative asset files which may be generated may include, but are not limited to, one or more of the following (or combinations thereof):

| | |
|---|---|
| URL Index | Publication text |
| Table of Contents (TOC) entry | Publication html |
| thumbnails | Metadata files |
| Table of Contents (TOC) files | Media files with associated metadata |
| Transcript html | Manifest files |
| Index file (text) | Any other files necessary to enable |
| Index file (html) | synchronization of Transmedia |
| Case text | Narratives |
| Case html | |

As illustrated in the example embodiment of FIG. 3, at 314, one or more multimedia narrative(s) may be generated. In at least one embodiment, at least a portion of the multimedia narrative files and/or multimedia narrative applications may be automatically and/or dynamically generated using various types of multimedia narrative asset files and/or other content. For example, by automating the export process from the DAMAP Authoring (212) Component(s), one or more the files necessary to generate a Transmedia Narrative from the Media Library™ may be automatically and/or dynamically identified and assembled/processed by the Asset File Processing Components (214) to thereby generate a Transmedia Narrative package (or multimedia narrative package).

As illustrated in the example embodiment of FIG. 3, at 316, various delivery, distribution and/or publication operations may be performed (if desired). In at least one embodiment, at least a portion of the delivery, distribution and/or publication operations may be performed by the platform conversion components 216a and/or application delivery components 216b. For example, according to different embodiments, various types of delivery, distribution and/or publication operation(s) which may be performed may include, but are not limited to, one or more of the following (or combinations thereof):
Enabling, controlling, managing, and/or facilitating distribution and delivery of Transmedia Narratives to one or more client system(s), Learning Management System(s), Server System(s), network devices, etc.
Enabling, controlling, managing, and/or facilitating local and/or remote access to DAMAP related data, metadata, Transmedia Narratives, and/or other content.
Tracking and/or managing end user activities.

Because some media files may need to be altered in some way in order to operate on specific platforms, these Platform Conversion Components may be configured or designed to automatically and/or dynamically manage or control the process of transformation in terms of file size, bit rate, sound level, etc. depending on the Transmedia Narrative device being targeted for playback.

It may be appreciated that different embodiments of the DAMAP Procedure (not shown) may include additional features and/or operations than those illustrated in the specific embodiment of FIG. 2, and/or may omit at least a portion of the features and/or operations of DAMAP Procedure illustrated in the specific embodiment of FIG. 3.

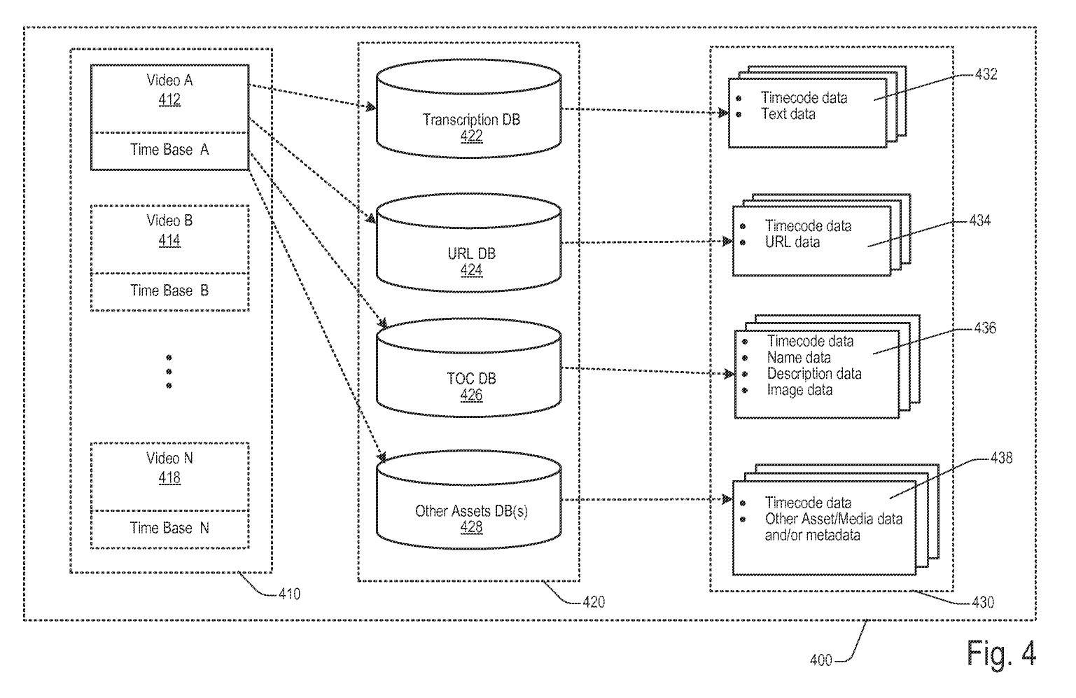

FIG. 4 shows a simplified block diagram illustrating a specific example embodiment of a portion of Transmedia Narrative package 400. As illustrated in the example embodiment of FIG. 4, the Transmedia Narrative package 400 may be configured or designed to include one or more of the following (or combinations thereof):
One or more video files (e.g., 410). In at least one embodiment, at least one video file may have associated therewith respective portions of visual content, audio content. Additionally, in at least one embodiment, at least one video file may have associated therewith a respective time base which, for example, may be used for generating associated timecode data and/or other time synchronization information.
One or more databases (e.g., 420) which, for example, may be configured or designed to store different types of media asset information (e.g., data, metadata, text, URLs, visual content, audio content, etc.) associated with at least one (or selected ones) of the video files 410. For example, as illustrated in the example embodiment of FIG. 4, databases 420 may include one or more of the following (or combinations thereof):
   At least one Transcription database 422 which, for example, may be configured or designed to store transcription data and/or other related information that is associated with at least one of the video files 410.
   At least one URL database 424 which, for example, may be configured or designed to store URL data and/or other related information that is associated with at least one of the video files 410
   At least one Table of Contents database 426 which, for example, may be configured or designed to store TOC data and/or other related information that is associated with at least one of the video files 410
   At least one other Media Assets database 428 which, for example, may be configured or designed to store other types of media asset data, information and/or content (e.g., images, games, non-text media, audio content, charts, data structures, etc.) that is associated with at least one of the video files 410.
One or more defined relationships (e.g., 430) which, for example, may be used to define or characterize synchronization relationships between the various types of media assets of the Transmedia Narrative. In at least one embodiment, synchronization between the various types of media assets may be achieved, for example, by defining or establishing respective relationships between video timecode data and the other types of media assets to be synchronized.

Generally, the DAMAP techniques described herein may be implemented in software and/or hardware. For example, they may be implemented in an operating system kernel, in a separate user process, in a library package bound into network applications, on a specially constructed machine, or on a network interface card. In a specific embodiment, various aspects described herein may be implemented in software such as an operating system or in an application running on an operating system.

Hardware and/or software+hardware hybrid embodiments of the DAMAP techniques described herein may be implemented on a general-purpose programmable machine selectively activated or reconfigured by a computer program stored in memory. Such programmable machine may include, for example, mobile or handheld computing systems, PDA, smart phones, notebook computers, tablets, netbooks, desktop computing systems, server systems, cloud computing systems, network devices, etc.

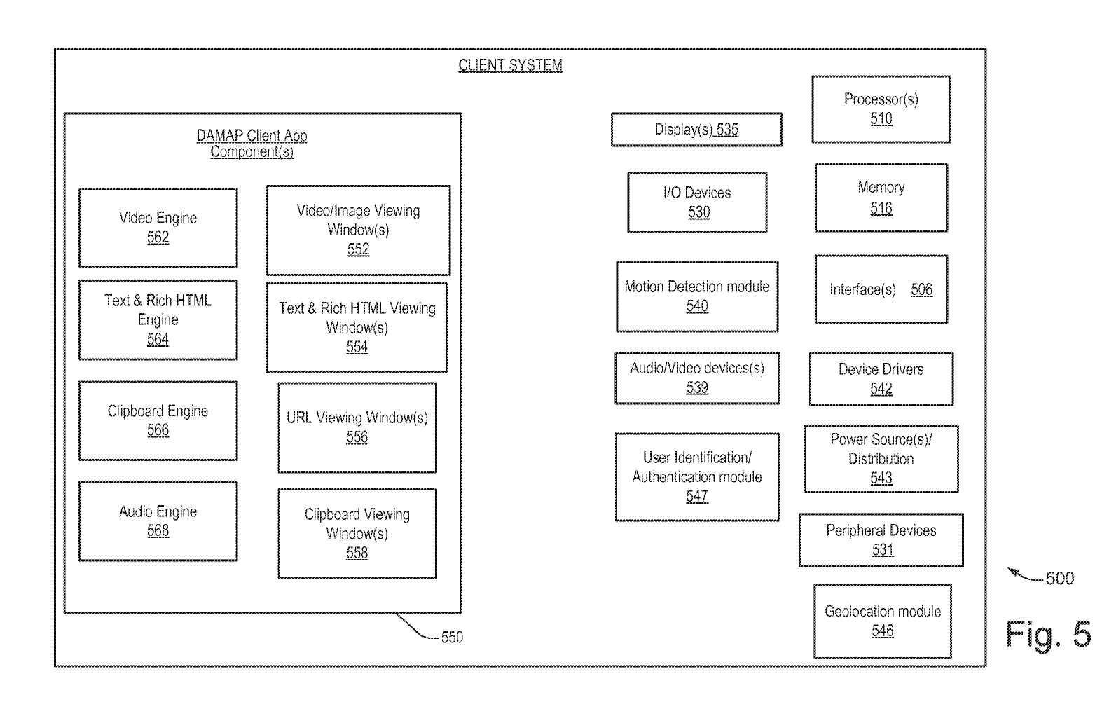

FIG. 5 is a simplified block diagram of an exemplary client system 500 in accordance with a specific embodiment. In at least one embodiment, the client system may include DAMAP Client App Component(s) which have been configured or designed to provide functionality for enabling or implementing at least a portion of the various DAMAP techniques at the client system. For example, in at least one embodiment, the DAMAP Client Application may provide functionality and/or features for enabling a user to view and dynamically interact with Transmedia Narratives which are presented via the client system 500.

In at least one embodiment, a Transmedia Narrative may be characterized as a story which is told primarily through video, and displayed on a digital device like an iPad or laptop computer. Transmedia Narratives may be configured or designed to allow users to search for keywords, create bookmarks and highlights, or use the traditional reference features inherent with books. For example, in at least one embodiment, a Transmedia Narrative may include words presented using scrolling text as well as voice-over audio that is synchronized to the visual media. Bonus material, exhibits, games, interactive games, assessments, Web pages, discussion threads, advertisements, and other digital resources are also synchronized with the time-base of a video or presentation.

According to different embodiments, a mobile device running the DAMAP Client Application may also include functionality commonly provided by e-book readers, video players, and/or presentation displays. DAMAP Client Application is the first Transmedia Narrative app that synchronizes video, audio, and text with other digital media. Scroll the video and text scrolls along with it; scroll the text and the video stays in sync. Let the video or audio play and the synchronized text scrolls along with the words being said, similar to closed captioning. However, at least one difference is that the text is dynamically searchable by the user. The user may also: select and copy desired portions of text to a notepad or clipboard (e.g., DAMAP clipboard), email selected portions of text and/or content to other users, bookmark the scene, and may generally reach a deeper understanding of the Transmedia Narrative through interactive audio, video, images, text, and dynamically interactive input/output control.

DAMAP Client Application creates a new video-centric, multi-sensory communication model that transforms read-only text into read/watch/listen/photo/interact Transmedia Narratives. This breakthrough technology synchronizes one or more forms of digital media, not just text and video.

In at least one embodiment, one of the unique features of the DAMAP technology relates to the ability of the different data-content-metadata-timecode relationships to be centered around the video components of a Transmedia Narrative. For example, in one embodiment, the construction of a Transmedia Narrative starts first with the video portion(s) of the narrative and their respective timecodes. Thereafter, one or more of the other types of content, data, metadata, messaging, etc. to be associated with the Transmedia Narrative may at least one be integrated into the narrative by defining specific relationships between the video timecode and at least one of the other types of content, data, metadata, messaging, etc. to be associated with the Transmedia Narrative.

DAMAP Client Application enables users to choose from any combination of reading, listening, or watching Transmedia Narratives. The app addresses a wide variety of learning styles and individual needs including dyslexia, attention deficit disorder, and language barriers. Users may select voice-over audio in their native tongue while reading the written transcript in a second language or vice versa.

In at least one embodiment, Transmedia Narratives may be configured as collections of videos and presentations with synchronized text and other digital resources. A video may be a short documentary film, while a presentation may be a slide show with voice over narration. In both cases, the words that a user hears on the sound track are synchronized with the text transcriptions from the sound track. Whether the story began as a screen play, an interview, a speech, a book, or an essay, the DAMAP Client Application synchronizes the spoken word with the written word along a timeline.

In at least one embodiment, the DAMAP Technologies described herein may be implemented using automatic and/or dynamic processes which may be configured or designed to store one or more media assets and their associated metadata in one or more relational databases (such as, for example, ReelContent Library™). That server-based architecture may communicate directly with an Transmedia Narrative Authoring environments and tools. Assembling Transmedia Narratives is easy in the Transmedia Narrative Authoring environment and files may be exported to the Transmedia Navigator App in just a few seconds.

As illustrated in the example of FIG. 5 client system 500 may include a variety of components, modules and/or systems for providing various functionality. For example, as illustrated in FIG. 5, client system 500 may include, but is not limited to, one or more of the following (or combinations thereof):
At least one processor 510. In at least one embodiment, the processor(s) 510 may include one or more commonly known CPUs which are deployed in many of today's consumer electronic devices, such as, for example, CPUs or processors from the Motorola or Intel family of microprocessors, etc. In an alternative embodiment, at least one processor may be specially designed hardware for controlling the operations of the client system. In a specific embodiment, a memory (such as non-volatile RAM and/or ROM) also forms part of CPU. When acting under the control of appropriate software or firmware, the CPU may be responsible for implementing specific functions associated with the functions of a desired network device. The CPU preferably accomplishes one or more these functions under the control of software including an operating system, and any appropriate applications software.
Memory 516, which, for example, may include volatile memory (e.g., RAM), non-volatile memory (e.g., disk memory, FLASH memory, EPROMs, etc.), unalterable memory, and/or other types of memory. In at least one implementation, the memory 516 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the client system and/or other information relating to the functionality of the various DAMAP techniques described herein. The program instructions may control the operation of an operating system and/or one or more applications, for example. The memory or memories may also be configured to store data structures, metadata, timecode synchronization information, audio/visual media content, asset file information, keyword taxonomy information, advertisement information, and/or information/data relating to other features/functions described herein. Because such information and program instructions may be employed to implement at least a portion of the DAMAP techniques described herein, various aspects described herein may be implemented using machine readable media that include program instructions, state information, etc. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files including higher level code that may be executed by the computer using an interpreter.
Interface(s) 506 which, for example, may include wired interfaces and/or wireless interfaces. In at least one implementation, the interface(s) 506 may include functionality similar to at least a portion of functionality implemented by one or more computer system interfaces such as those described herein and/or generally known to one having ordinary skill in the art. For example, in at least one implementation, the wireless communication interface(s) may be configured or designed to communicate with selected electronic game tables, computer systems, remote servers, other wireless devices (e.g., PDAs, cell phones, player tracking transponders, etc.), etc. Such wireless communication may be implemented using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, etc.
Device driver(s) 542. In at least one implementation, the device driver(s) 542 may include functionality similar to at least a portion of functionality implemented by one or more computer system driver devices such as those described herein and/or generally known to one having ordinary skill in the art.
At least one power source (and/or power distribution source) 543. In at least one implementation, the power source may include at least one mobile power source (e.g., battery) for allowing the client system to operate in a wireless and/or mobile environment. For example, in one implementation, the power source 543 may be implemented using a rechargeable, thin-film type battery. Further, in embodiments where it is desirable for the device to be flexible, the power source 543 may be designed to be flexible.
Geolocation module 546 which, for example, may be configured or designed to acquire geolocation information from remote sources and use the acquired geolocation information to determine information relating to a relative and/or absolute position of the client system.
Motion detection component 540 for detecting motion or movement of the client system and/or for detecting motion, movement, gestures and/or other input data from user. In at least one embodiment, the motion detection component 540 may include one or more motion detection sensors such as, for example, MEMS (Micro Electro Mechanical System) accelerometers, that may detect the acceleration and/or other movements of the client system as it is moved by a user.
User Identification/Authentication module 547. In one implementation, the User Identification module may be adapted to determine and/or authenticate the identity of the current user or owner of the client system. For example, in one embodiment, the current user may be required to perform a log in process at the client system in order to access one or more features. Alternatively, the client system may be adapted to automatically determine the identity of the current user based upon one or more external signals such as, for example, an RFID tag or badge worn by the current user which provides a wireless signal to the client system for determining the identity of the current user. In at least one implementation, various security features may be incorporated into the client system to prevent unauthorized users from accessing confidential or sensitive information.
One or more display(s) 535. According to various embodiments, such display(s) may be implemented using, for example, LCD display technology, OLED display technology, and/or other types of conventional display technology. In at least one implementation, display(s) 535 may be adapted to be flexible or bendable. Additionally, in at least one embodiment the information displayed on display(s) 535 may utilize e-ink technology (such as that available from E Ink Corporation, Cambridge, Mass., www.eink.com), or other suitable technology for reducing the power consumption of information displayed on the display(s) 535.
One or more user I/O Device(s) 530 such as, for example, keys, buttons, scroll wheels, cursors, touchscreen sensors, audio command interfaces, magnetic strip reader, optical scanner, etc.
Audio/Video device(s) 539 such as, for example, components for displaying audio/visual media which, for example, may include cameras, speakers, microphones, media presentation components, wireless transmitter/receiver devices for enabling wireless audio and/or visual communication between the client system 500 and remote devices (e.g., radios, telephones, computer systems, etc.). For example, in one implementation, the audio system may include componentry for enabling the client system to function as a cell phone or two-way radio device.
Other types of peripheral devices 531 which may be useful to the users of various client systems, such as, for example: PDA functionality; memory card reader(s); fingerprint reader(s); image projection device(s); social networking peripheral component(s); etc.
DAMAP Client App Component(s) 550. In at least one embodiment, the DAMAP Client App Component(s) may be configured or designed to provide functionality for enabling or implementing at least a portion of the various DAMAP techniques at the client system. As illustrated in the example embodiment of FIG. 5, the DAMAP Client App Component(s) may include, but are not limited to, one or more of the following (or combinations thereof):
   Video Engine 562 which, for example, may be configured or designed to manage video related DAMAP tasks such as user interactive control, video rendering, video synchronization, video display, etc.
   Video/Image Viewing Window(s) 552 which, for example, may be configured or designed for display of video content, image content, game, etc.
   Text & Rich HTML Engine 564 which, for example, may be configured or designed to manage text/character related DAMAP tasks such as user interactive control, data/content rendering, text/transcription synchronization, text/character display, etc.
   Text & Rich HTML Viewing Window(s) 554 which, for example, may be configured or designed for display of text, HTML, icons, characters, etc.
   Clipboard Engine 566 which, for example, may be configured or designed to manage clipboard/notebook related DAMAP tasks such as user interactive control, GUI rendering, threaded conversations/messaging, user notes/commentaries, social network related communications, video/audio/text synchronization, text display, image display, etc.
   Clipboard Viewing Window(s) 558 which, for example, may be configured or designed for display of DAMAP related clipboard content, user notes, etc.
   URL Viewing Window(s) 556 which, for example, may be configured or designed for display of URL content, image content, text, etc.
   Audio Engine 568 which, for example, may be configured or designed to manage audio related DAMAP tasks such as user interactive control, audio synchronization, audio rendering, audio output, etc.

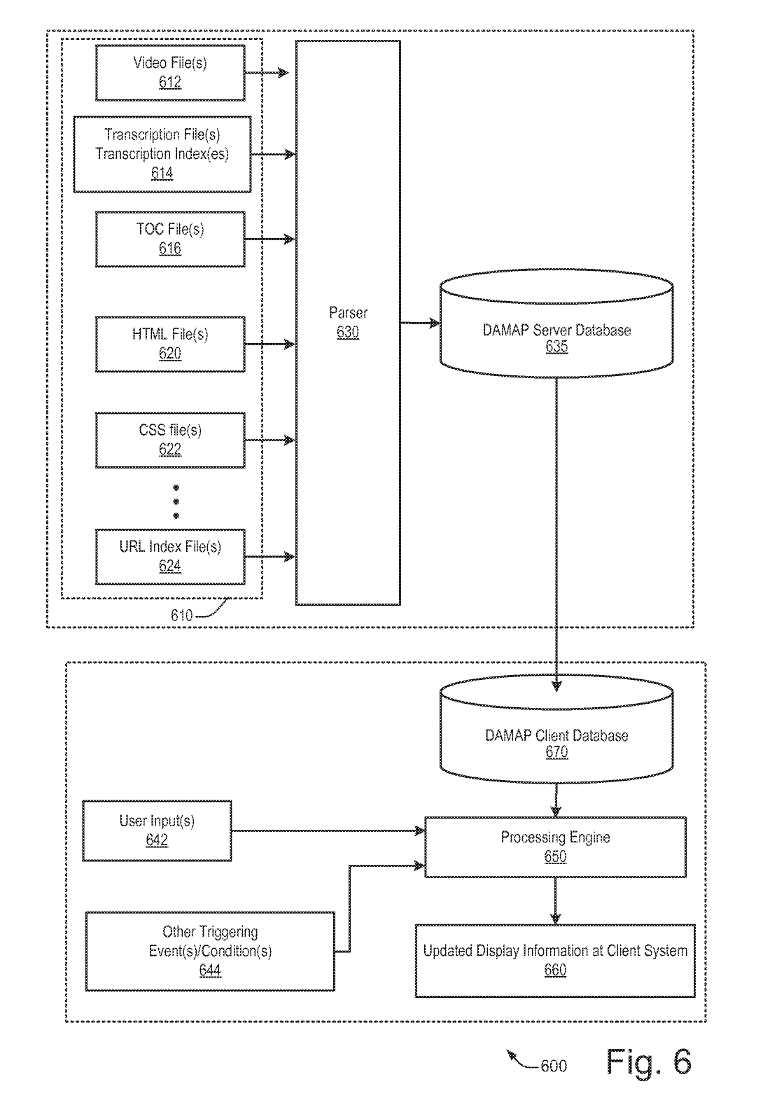

FIG. 6 shows a specific example embodiment of a portion 600 of a DAMAP System, illustrating various types of information flows and communications between components of the DAMAP Server System 601 and DAMAP client application 690.

As illustrated in the example embodiment of FIG. 6, a Transmedia Narrative may include a plurality of different types of multimedia asset files (e.g., 610) including information which may be processed and/or parsed (e.g., by parser 630) using associated video timecode information to thereby generate parsed, timecoded multimedia asset information which may be stored in a relational database (e.g., DAMAP Server Database 635) based on timecode, for example.

In at least one embodiment, at least one record or entry in the DAMAP Server Database 635 may include various types of information relating to one or more of the field types (and/or combinations thereof):

| | |
|---|---|
| Project | Metadata Set |
| MVU Customer | Heritage |
| Department | Category |
| MVU Region | Owner |
| Grade Level | Status |
| Product | Camera Number |
| Career Focus | Camera Roll |
| First Name | Interior/Exterior |
| Last Name | Clip Name |
| Gender | Description |
| Age | Keywords |
| Race | |

In at least one embodiment, a Transmedia Narrative package may be electronically delivered to a client system, and processed by the DAMAP Client Application 690 running at the client system. In one embodiment, the delivered Transmedia Narrative package may include at least a portion of relational parsed, timecoded multimedia asset information which, for example, may be accessed or retrieved from the DAMAP Server Database 635 and stored in a local DAMAP Client Database 670 residing at the client system.

In at least one embodiment, the DAMAP Client Application may be configured or designed to access and process (e.g., using processing engine 650) selected portions of the Transmedia Narrative information and to generate (e.g., 660) updated Transmedia Narrative presentation information to be displayed/presented to the user of the client system. In at least one embodiment, the DAMAP Client Application may be further configured or designed to monitor events/conditions at the client system for detection of user inputs (e.g., 642) and/or detection of other types of triggering events/conditions (e.g., 644) which, when processed, may cause newly updated Transmedia Narrative presentation information to be generated (e.g. 660) and displayed/presented to the user.

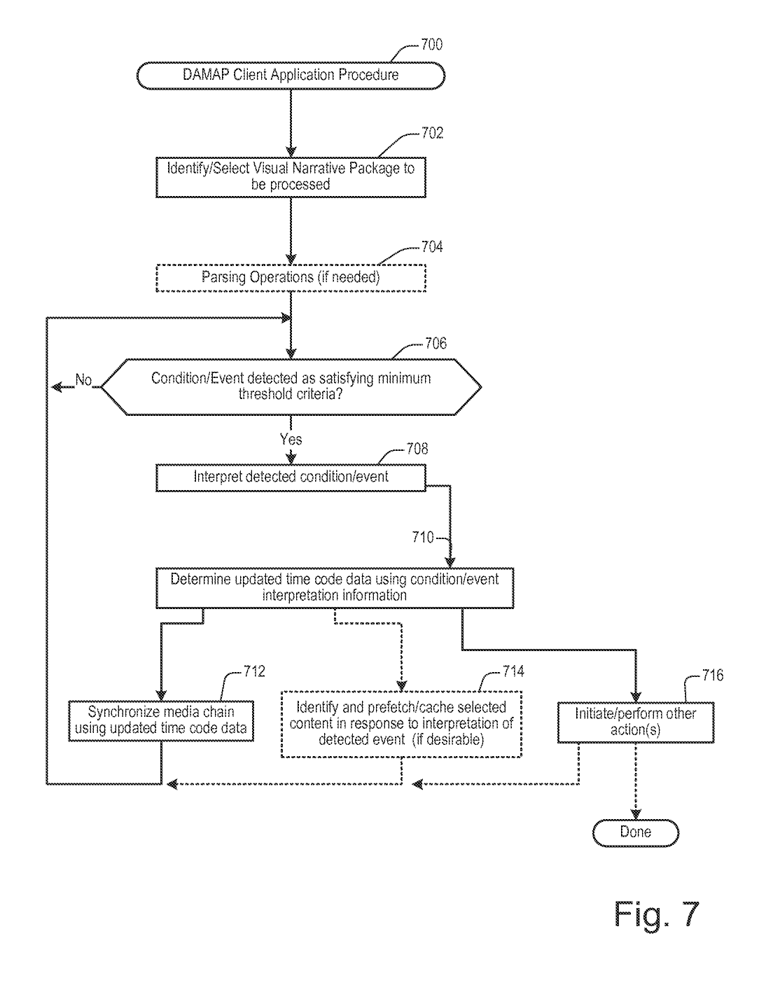

FIG. 7 shows a flow diagram of a DAMAP Client Application Procedure in accordance with a specific embodiment. In at least one embodiment, the DAMAP Client Application Procedure may be operable to perform and/or implement various types of functions, operations, actions, and/or other features, examples of which are described herein. In at least some embodiments, portions of the DAMAP Client Application Procedure may also be implemented at other devices and/or systems of a computer network. According to specific embodiments, multiple instances or threads of the DAMAP Client Application Procedure may be concurrently implemented and/or initiated via the use of one or more processors and/or other combinations of hardware and/or hardware and software. In at least one embodiment, one or more or selected portions of the DAMAP Client Application Procedure may be implemented at one or more Client(s), at one or more Server(s), and/or combinations thereof. For example, in at least some embodiments, various aspects, features, and/or functionalities of the DAMAP mechanism(s) may be performed, implemented and/or initiated by one or more systems, components, systems, devices, procedures, and/or processes described or referenced herein.

According to different embodiments, one or more different threads or instances of the DAMAP Client Application Procedure may be initiated in response to detection of one or more conditions or events satisfying one or more different types of criteria (such as, for example, minimum threshold criteria) for triggering initiation of at least one instance of the DAMAP Client Application Procedure. Examples of various types of conditions or events which may trigger initiation and/or implementation of one or more different threads or instances of the DAMAP Client Application Procedure are described herein. According to different embodiments, one or more different threads or instances of the DAMAP Client Application Procedure may be initiated and/or implemented manually, automatically, statically, dynamically, concurrently, and/or combinations thereof. Additionally, different instances and/or embodiments of the DAMAP Client Application Procedure may be initiated at one or more different time intervals (e.g., during a specific time interval, at regular periodic intervals, at irregular periodic intervals, upon demand, etc.).

In at least one embodiment, a given instance of the DAMAP Client Application Procedure may utilize and/or generate various different types of data and/or other types of information when performing specific tasks and/or operations. This may include, for example, input data/information and/or output data/information. For example, in at least one embodiment, at least one instance of the DAMAP Client Application Procedure may access, process, and/or otherwise utilize information from one or more different types of sources, such as, for example, one or more databases. In at least one embodiment, at least a portion of the database information may be accessed via communication with one or more local and/or remote memory devices. Additionally, at least one instance of the DAMAP Client Application Procedure may generate one or more different types of output data/information, which, for example, may be stored in local memory and/or remote memory devices.

In at least one embodiment, initial configuration of a given instance of the DAMAP Client Application Procedure may be performed using one or more different types of initialization parameters. In at least one embodiment, at least a portion of the initialization parameters may be accessed via communication with one or more local and/or remote memory devices. In at least one embodiment, at least a portion of the initialization parameters provided to an instance of the DAMAP Client Application Procedure may correspond to and/or may be derived from the input data/information.

For purposes of illustration, an example of the DAMAP Client Application Procedure may now be described by way of example with reference to the block diagram of FIG. 6 (and/or other Figures described or illustrated herein).

As illustrated in the example embodiment of FIG. 7, it is assumed at 702 that a specific Transmedia Narrative package is identified/selected to be processed and presented at the client system.

As shown at 704, one or more parsing operations may be performed, as desired (or required). In at least one embodiment, at least a portion of the parsing operations may be similar to parsing operations performed by parser 630 (FIG. 6).

As illustrated in the example embodiment of FIG. 7, as shown at 706 the DAMAP Client Application Procedure may continuously or periodically monitor for detection of one or more condition(s) and/or event(s) which satisfy (e.g., meet or exceed) some type of minimum threshold criteria. Various examples of the different types of conditions/events may include, but are not limited to, one or more of the following (or combinations thereof):
Presence of user detected (or not detected)
User identity detected
User input detected
Remote instructions detected
Time-based condition/event detected
Location-based condition/event detected
Communication-based condition/event detected
Change in environmental conditions detected
Change of state or content of external data detected
Change of state detected (e.g., change in state or content of media asset detected)
Change in status of web resource detected
Folder watch event detected
Etc.

As shown at 708, assuming that a condition/event has been detected which satisfies the minimum threshold criteria, the DAMAP Client Application Procedure my respond by analyzing and/or interpreting the detected condition/event.

As shown at 710, updated timecode data may be determined based on the interpreted condition/event information.

Using the updated timecode data and/or the interpreted condition/event information, the DAMAP Client Application Procedure may initiate one or more appropriate actions/operations such as, for example, one or more of the following (or combinations thereof):
Synchronize (712) media chain using updated time code data
Identify and prefetch/cache (714) selected content in response to interpretation of detected event (if desirable)
Initiate/perform other action(s) (716)
Etc.

For example, in a specific example situation, a user may provide input to the client system (e.g., via the DAMAP Client Application GUI) to cause the DAMAP Client Application to navigate to a desired portion of the Transmedia Narrative. The DAMAP Client Application may interpret the user's input and determine the location of the desired portion of the Transmedia Narrative which the user wishes to access. In at least one embodiment, any given portion of the Transmedia Narrative may have a respective timecode value associated therewith. Accordingly, in at least one embodiment, a specific portion of the Transmedia Narrative may be identified and/or accessed by determining its associated timecode value. Once the desired (e.g., updated) timecode value has been determined, the DAMAP Client Application may navigate to the desired portion of the Transmedia Narrative by synchronizing (712) the Transmedia Narrative media chain (e.g., video display, audio output, text transcription, URLs, etc.) using the updated time code data.

In at least one embodiment, the DAMAP Client Application may synchronize video, audio, and text with other digital media. For example, scroll the video portion of a Transmedia Narrative and text transcription scrolls along with it; scroll the text transcription and the video stays in sync. Let the video or audio play and the synchronized text scrolls along with the words being said, similar to closed captioning.

In at least one embodiment, the video, text, and notes functions may be linked by time (e.g., timecode). As the video plays, the text transcription may automatically and synchronously scroll to match the video/audio. If the user scrolls forward or backward in the text file (e.g., via gesture input using the DAMAP Client Application GUI), the video may move to the point in the production that matches that point in the text. The user may also move the video forward or backward in time, and the text may automatically scroll to that point in the production that matches the same point in the video.

In at least one embodiment, a Transmedia Narrative may include words presented using scrolling text as well as voice-over audio that is synchronized to the visual media. Bonus material, exhibits, games, interactive games, assessments, Web pages, discussion threads, advertisements, and other digital resources may also be synchronized with the timecode or time-base of a video or Transmedia Narrative presentation.

In at least one embodiment, a notes function of the DAMAP Client Application enables the user to take electronic notes, and also to copy portions of the displayed transcription text (and/or displayed video frame thumbnails) and paste them into the notepad. This copy/paste into notes also creates a time-stamp and bookmark so that the user may go to any note via the bookmark, touch the bookmark, and the video and text go immediately to that moment in the video/text that corresponds with the original note.

In at least one embodiment, Transmedia Narratives may be configured as collections of videos and presentations with synchronized text and other digital resources. A video may be a short documentary film, while a presentation may be a slide show with voice over narration. In both cases, the words that a user hears on the sound track are synchronized with the text transcriptions from the sound track. Whether the story began as a screen play, an interview, a speech, a book, or an essay, the DAMAP Client Application synchronizes the spoken word with the written word along a timeline.

In addition to scrolling text, DAMAP Client Application also synchronizes other media along the timelines of videos and presentations. When a moment in the story relates contextually to a website, then that website becomes available to view. If the story calls for an interactive game to help explain a concept in depth, then that game becomes available to interact with. The same is true for test questions, graphic illustrations, online discussions, or any other digital media relevant to that part of the story—with DAMAP Client Application, everything is in sync. Stop the video and explore the website, take the test, or interact with the game. When the user is ready to continue, hit play and one or more the media in the Transmedia Narrative stays in sync.

### Other Features, Systems and Embodiments

An important aspect for any Transmedia Narrative is an underlying, plot-driven, story that is told from beginning to end. Focused on the intersection of mobile device applications, cloud-computing, and digital asset management, the DAMAP technology disclosed herein is on the frontier of media convergence where communications theory and market trends meet state-of-the-art engineering.

In at least one embodiment, the DAMAP System takes an ecological approach to engineering for transmedia experiences. That is to say, its central paradigm is synergistic, rather than predatory, in designing transmedia navigation and collaboration solutions that fit within the existing and future network ecosystem. For example, one DAMAP strategy for providing onramps to and from YouTube, Facebook and Twitter communities aims at providing seamless experiences in creating, consuming, appropriating, modifying, and sharing transmedia content. Through API (application program interface) sharing and Web-portal integration, the DAMAP System blends other best-of-breed digital experiences.

The DAMAP System's ecological approach to software design leverages the interrelationship among digital communication technologies and the cultural communities that grow up around them. In at least one embodiment, the DAMAP System may include a cloud-based crowd sourcing service (herein referred to as ReelCrowd) which may be operable to function as an industry-leading destination for transmedia storytellers looking to find a story, tell a new story, enhance an existing story, learn about storytelling, meet other storytellers, or share and appropriate storytelling assets. Part storefront, part community center, ReelCrowd may emerge as a premiere Web-enabled community located at the intersection of digital video and social media. Beyond the immediate horizon of digital content publishing for mobile devices lies the vast potential of content enrichment through crowd sourcing. ReelCrowd taps into the heart of this surging phenomenon made popular by knowledge sharing portals like Wikipedia.

Digital files or URLs (universal resource locators) tagged with metadata and stored within a digital asset management system are important enabling technologies behind the DAMAP System's transmedia platform. In at least one embodiment, a cloud-based storage service (herein referred to as ReelContent Library) may be configured or designed to function as repository to manage and facilitate database exchange relationships with stock photo and footage providers, streaming video services, media conglomerates, and specialty content providers. A database of databases may evolve from this aggregation of content partnerships and may provide Transmedia Narrative, Transmedia Navigator, and Transmedia Narrative Authoring platform users with a broad spectrum of digital resources from which to combine and recombine narrative resources.

In at least one embodiment, the Transmedia Narrative Authoring application is configured or designed for the collaborative world of transmedia immersion. The Transmedia Narrative Authoring application provides a structured approach to creating Transmedia Narratives that export directly to the Transmedia Navigator. With Transmedia Narrative Authoring application, the creation of a product framework is as simple as creating folders within folders. Uploading and registering assets from the ReelContent Library, a user's local hard drive, LAN, or WAN is a one-click operation. Adding relevant metadata is as simple as filling out a short survey. Alternative embodiment of the Transmedia Narrative Authoring application allow users to simply drag and drop additional content onto a graphical timeline. Voice and facial recognition facilitates the process of automatically and/or dynamically transcribing and synchronizing text and video, as well as expanding search and indexing features and capabilities.

In at least one embodiment, the DAMAP System's approach to authoring is similarly ecological. It is compatible with many of today's commonly popular productivity tools like Keynote, Pages, Powerpoint, Word, Photoshop, iMovie, and Final Cut Express. Files created in these and other popular formats may be leveraged in Transmedia Narrative Authoring application to enrich the baseline narrative material. For example, slides created in Powerpoint may be exported from that application, imported with Transmedia Narrative Authoring application, and synchronized with iMovie video files of a speaker presenting these slides. The DAMAP System also provides deeper integration of these popular formats within Transmedia Narrative Authoring application using plugins and API connections.

Optimized for specific operating systems and mobile devices, Transmedia Navigator is the world's first transmedia navigation and collaboration player application. Transmedia Navigator responds to multi-touch inputs on the iPad, Android tablets, smart-phones, and other mobile devices where gestures with fingertips on glass are replacing mouse and keyboard controllers. Designed to read Transmedia Narrative packages and/or other content assembled in the Transmedia Narrative Authoring application, Transmedia Navigator synchronizes video, audio, text, and other transmedia resources that are downloaded from the cloud or connected through the Internet and Virtual Private Networks.

Transmedia Navigator encourages users to become immersed in transmedia stories by reading, watching, listening, interacting, and contributing to the featured narrative. In the years ahead, this combination App and Web portal may evolve into the launchpad for one or more Transmedia Navigator platform services, including authoring, collaborating, purchasing, and engaging with the ReelCrowd community

Among the engineering breakthroughs achieved by the DAMAP technology, the DAMAP System's SoundSync engine is operable to read controller files authored in the Transmedia Narrative Authoring application and to link together and/or to thread directly into the timeline of a Transmedia Narrative, chains of spatial media of different types and formats including, for example, one or more of the following (or combinations thereof): audio, video, text, slides, WebLinks, PDF files, simulations, second languages, and commentary.

### TimeLine4D

TimeLine4D is be the first graphical user interface (GUI) configured or designed for transmedia immersion, which, for example, may include both navigation and collaboration that fuses the expanding ecosystem of digital communications technologies into an immersive narrative experience. TimeLine4D may combine X, Y, and Z axes (three dimensions) with the concept of linear time (the fourth dimension) into a game-like environment that invites multitouch exploration on mobile devices like the iPad and Android tablets.

By combining a multi-player game experience with spatial-temporal exploration and collaborative play, TimeLine4D may deliver easy access for consumers and contributors of transmedia content. Tell It with TimeLine4D blends story-driven linearity with exploration-based interactivity to achieve deeper, immersive content experiences. TimeLine4D is an animated content visualization display and multi-touch game controller providing Tell It users with the ability to move gracefully through a landscape of transmedia resources integrated within a story's timeline.

To understand how TimeLine4D may work, imagine that you are driving a car along the highway, traveling from point A to point B. What you see through the windshield during a user's journey represents the main narrative in a Tell It publication, typically delivered as a sequence of short videos with synchronized transcripts. These displays of the main narrative and transcribed text compare with the current Tell It design. Using the analogy of a road trip, imagine that you glance out the driver's side window and begin to notice the gas stations, billboards, restaurants, and local museums that dot the edges of the road. Depending on a user's interests, you may decide to pull over and explore one or more of these roadside attractions, or you may just continue on a user's way. These objects in the foreground represent additional resources that were originally combined with the main Tell It narrative, like PDF files, simulations, and WebLinks. If you focus a user's attention beyond the roadside attractions and out toward the horizon, you may notice trees and cows, fields and farm houses. These distant objects represent the crowd-sourced materials supplied by ReelCrowd members and may include other videos, animations, essays, social media comments, and Web pages that fellow travelers have contributed before you got there. If you exit the highway for a closer look, or to leave a message of a user's own tacked to a bulletin board, we consider that to be an expression of “participatory culture.”

Participatory cultures encourage new modalities for learning through play, discovery, networking, remixing content, pooling intelligence, and transmedia navigation. As new media technologies make it possible to “archive, annotate, appropriate, and recirculate media content,” participatory culture emerges as a response to the possibilities created by the explosion of these digital tools. In education, this represents a paradigm shift away from the printed textbook model where users are not encouraged to question the structure or interpretation of published content, to the tendency for immersive play, simulation, and the testing of hypotheses. As described herein, the DAMAP System is operable to support and encourage transmedia immersion through enabling tools and compelling narratives designed for the growing membership of participatory cultures.

### HTML5 & EPUB 3 Embodiments

DAMAP System's multi-platform app publishing system streamlines the process of synchronizing transmedia assets along a timeline. Rather than placing video/audio files into a text document the way most enhanced books are designed, DAMAP System turns that model on its head and inserts text (as well as other transmedia assets) into the video/audio narrative spine. The book-centric approach is page-based, while the DAMAP System transmedia approach is time-based. With the integration of more HTML5 and EPUB 3 content within the DAMAP System experience, users may also be offered the choice of making the book experience central and the media experience peripheral, or vice versa.

HTML5 and EPUB 3 offer several distinct opportunities to the DAMAP System transmedia app publishing system. For example, one opportunity is tighter integration of HTML5 and EPUB 3 content within the existing device-native players. For example, in one scenario, EPUB 3 documents are managed within the iPad app, for example, using the existing browser display feature. By exploiting key features of the new HTML5 markup language within the existing HTML display window, the Transmedia Navigator experience is enriched by deeper levels of intertextual hyperlinking, transmedia synchronization, and eBook services matching the EPUB 3 specification. In the example below, Transmedia Navigator on the iPad displays HTML through a cascading style sheet (CSS). This is the first integration point for HTML5 and EPUB 3 within DAMAP System's existing framework.

A second opportunity for DAMAP System regarding HTML5 and EPUB 3 is the creation of a new HTML5-based Web App player as an alternative to the DAMAP System's device-specific players that were built to operate within the native operating system of the device. In this scenario, HTML5 provides the framework for the player mechanism, and web-based components like Java Server Faces or Ruby-on-Rails may be deployed to support the fetching and displaying of content. Functions of this Web App version of the Transmedia Navigator may be operational in the authoring environment. For example, annotation text, graphics, and URLs are displayed in the browser, while video segments may be accessed by clicking on their timecode start points in the annotation field as in the example below.

DAMAP System is one of the first transmedia app publishing systems for HTML5-based EPUB 3 products. The DAMAP System's existing Transmedia Narrative Authoring application and Transmedia Navigator combination anticipates several key aspects of these emerging standards. As eBooks today may become one feature of transmedia publications with the advent of HTML5 and EPUB 3, DAMAP System Technologies may deliver rapid authoring and deployment of HTML5- and EPUB 3-compliant Transmedia Narratives.

In order to assemble and integrate synchronized transmedia content for various different client device-specific players and platforms, engineering effort has been undertaken to represent the underlying DAMAP System data model through a Web App environment. By manipulating the metadata stored in digital asset management software via this Web App. Using the Transmedia Narrative Authoring application environment, ASCII and HTML text files are created, edited, and automatically generated as part of the export function. Parts of these text files are used to control synchronization, while other parts are used for display in the Transmedia Navigator. These text files are linked into the player app, both as part of the original app download from various app stores, and again from the cloud when the files have been updated. These ASCII and HTML text files form the basis for claiming that “DAMAP System is one of the first transmedia app publishing systems for HTML5-based EPUB 3 products.” An example of current DAMAP System HTML document:
-chtmb-dink rel=“stylesheet” type=“text/css” media=“screen,print” hret=“. .I . .IShowFolder1.css”!><Iink rel=“stylesheet” type=“text/css” media=“screen,print” hret=“../..Ispeake rs. css”/><head><scri pt type=“textfj avascri pt” src=“../..Iti m ecodeCo m m u nicatio n. js”><!scri pl><!head><body><d iv cl ass=“header”></d iV><d iv class=“title”>Redetining Mgmt Presentation<!div><a name=“O”></a><div class=“Writer”></div><div class=“annotation”><p>One morning in early June, the bell rang in the Namaste Solar ott ice in Boulder, Colo. This signaled yet another sale for this unassuming, but market-leading, solar panel installation company.

As previously described, synchronizing transmedia assets along a timeline is a valuable feature of the Transmedia Navigator design. This design feature anticipated a new transmedia standard in EPUB 3. Accordingly, one notable distinction of the DAMAP System architecture is that audio and text synchronization behave differently in the HTML5 world than they do in Transmedia Navigator environments. For example, with HTML5 synchronization, highlights appear over at least one word being spoken, jumping down the page as the word is spoken. Readers are encouraged to follow along with the words being spoken without skipping ahead. However, in the Transmedia Navigator, text blocks move up to the top edge of the window, allowing users to scan the text as a whole for context.

In some embodiments, Transmedia Navigators use a WebKit browser in iOS and MacOS, and the Chrome-like browser in Android Honeycomb to display the HTML document. The Transmedia Navigator's full screen text mode displays an .html text file and cascading style sheet (CSS) associated with at least one video episode. Synchronization of the HTML document with its associated video file is currently the result of a javascript mechanism in combination with markup language that is automatically inserted into the .html file.

In at least one embodiment of the Transmedia Narrative Authoring application, users select an audio/video asset and create synchronization points from a pull down menu called “Create An Event”. This function allows users to add metadata to those text files that create synchronization of media assets. Similarly, HTML5 markup language may be added according to the EPUB 3 standard using the same operation that currently generates the .html document at the episode level.

While full screen text in the Transmedia Navigator may be used to synchronize the transcript text associated with the video episode, customers have expressed interest in concurrently synchronizing elements of longer documents within a video episode that are not derived from the video episode transcript. In this way, eBook content may be fully realized within Transmedia Navigator and synchronized with relevant moments of a video episode. The purpose may be to provide Transmedia Navigator users with more depth than the video provides, allowing users to jump from the textual, to the visual, depending on their needs.

Since bandwidth and storage of video/audio files are always factors in a transmedia product, eBook content mayor may not include a prerecorded audio file matching the eBook textual content. In the case where a prerecorded audio file is not available, text to speech is another option. HTML5 and EPUB 3 address this synchronization option as well.

Even deeper levels of integration with the EPUB 3 format may be achieved via Transmedia Navigator built largely on HTML 5, and which may be deployed and implemented within compatible Web browser applications. In The HTML 5 version of the Transmedia Navigator, Java Server Faces may be used to access web pages and perform functions that recreate the experience of the native device versions of the player. The same authoring process in Transmedia Narrative Authoring application that generates one or more the files necessary to synchronize media in the device-native versions of the player would simultaneously generate one or more the files necessary for the WebApp version. This WebApp version of the Transmedia Navigator may be attractive to publishers and other organizations that are looking for integration opportunities with their eLearning and Web-based content delivery platforms.

Although several example embodiments of one or more aspects and/or features have been described in detail herein with reference to the accompanying drawings, it is to be understood that aspects and/or features are not limited to these precise embodiments, and that various changes and modifications may be effected therein by one skilled in the art without departing from the scope of spirit of the invention(s) as defined, for example, in the appended claims.

It is claimed:

1. A multimedia display system comprising:
at least one processor;
at least one interface operable to provide a communication link to at least one network device; and
memory;
the system being operable to:
identify a digital multimedia package, wherein the digital multimedia package includes: a video content portion, an audio content portion, and a text content portion, wherein the text content portion includes a text transcription content portion representing a transcription of the audio content portion;
cause, at a client system, synchronous presentation of the video content portion, audio content portion, and text transcription content portion;
wherein the synchronous presentation of the video content portion, audio content portion, and text transcription content portion are each maintained in continuous synchronization with each other during playback of the video content portion;
wherein the synchronous presentation of the video content portion, audio content portion, and text transcription content portion are each maintained in continuous synchronization with each other as a user selectively navigates to different scenes of the video content portion;
wherein the video content portion is presented via an interactive Video Player graphical user interface (GUI) at a display of the client system;
wherein the audio content portion is presented via an audio output device at the client system; and
wherein the text transcription content portion is presented via a an interactive Resources Display GUI at the display of the client system.

2. The system of claim 1 being further operable to:
cause a first portion of video content corresponding to a first scene to be displayed in the Video Player GUI;
cause a first portion of text transcription content corresponding to the first scene to be displayed in the Resources Display GUI;
wherein the display of the first portion of video content in the Video Player GUI is concurrent with the display of the first portion of text transcription content in the Resources Display GUI;
receive user input via the Resources Display GUI;
cause, in response to the received user input, the presentation of text displayed in the Resources Display GUI to dynamically scroll to a second portion of the text transcription content corresponding to a second scene; and
cause, in response to the received user input, the presentation of video content displayed in the Video Player GUI to dynamically display a second portion of video content corresponding to the second scene.

3. The system of claim 1 being further operable to:
cause a first portion of video content corresponding to a first scene to be displayed in the Video Player GUI, wherein the first portion of the video content is mapped to a first timecode value set;
cause a first portion of text transcription content corresponding to the first scene to be displayed in the Resources Display GUI, wherein the first portion of the text transcription content is mapped to the first timecode value set;
wherein the display of the first portion of video content in the Video Player GUI is concurrent with the display of the first portion of text transcription content in the Resources Display GUI;
receive user input via the Resources Display GUI;
cause, in response to the received user input, the presentation of text displayed in the Resources Display GUI to dynamically scroll to a second portion of the text transcription content corresponding to a second scene, wherein the second portion of the text transcription content is mapped to a second timecode value set;
cause, in response to the received user input, the presentation of video content displayed in the Video Player GUI to dynamically display a second portion of video content corresponding to the second scene, wherein the second portion of video content is mapped to the second timecode value set; and
wherein the display of the second portion of video content in the Video Player GUI is concurrent with the display of the second portion of text transcription content in the Resources Display GUI.

4. The system of claim 1:
wherein the digital multimedia package further includes timecode synchronization information for use maintaining synchronized presentation of the video content portion, audio content portion, and text transcription content portion.

5. The system of claim 1:
wherein the digital multimedia package further includes: timecode synchronization information and at least one additional resource selected from a group consisting of: metadata, notes, games, drawings, images, diagrams, photos, assessments, documents, slides, documents, photos, games, communication threads, events, URLs, and spreadsheets;
wherein the video content portion comprises a plurality of distinct video segments, each video segment being mapped to a respective timecode of the timecode synchronization information;
wherein the audio content portion comprises a plurality of distinct audio segments, each audio segment being mapped to a respective timecode of the timecode synchronization information;
wherein the text transcription content portion comprises a plurality of distinct text transcription segments, each text transcription segment being mapped to a respective timecode of the timecode synchronization information;
wherein each of the at least one additional resource is being mapped to a respective timecode of the timecode synchronization information;
the system being further operable to:
maintain, using at least a portion of the mapped timecode information, presentation synchronization among different portions of content being concurrently displayed at the client system display.

6. A system for automated conversion of a source video into a digital multimedia package, wherein the source video includes video content and audio content, the system comprising:
at least one processor;
at least one interface operable to provide a communication link to at least one network device; and
memory;
the system being operable to:
analyze the source video for identifying specific properties and characteristics;
automatically generate a text transcription of the source video's audio content using speech processing analysis;
automatically generate synchronization data for use in synchronizing distinct chunks of the text transcription with respective distinct chunks of the video content; and
automatically generate the digital multimedia package, wherein the digital multimedia package includes: a video content portion derived from the source video, an audio content portion derived from the source video, and a text transcription content portion representing a transcription of the audio content portion.

7. The system of claim 6 being further operable to:
cause, at a client system, synchronous presentation of the video content portion, audio content portion, and text transcription content portion;
wherein the synchronous presentation of the video content portion, audio content portion, and text transcription content portion are each maintained in continuous synchronization with each other during playback of the video content portion; and
wherein the synchronous presentation of the video content portion, audio content portion, and text transcription content portion are each maintained in continuous synchronization with each other as a user selectively navigates to different scenes of the video content portion;
wherein the video content portion is presented via an interactive Video Player graphical user interface (GUI) at a display of the client system;
wherein the audio content portion is presented via an audio output device at the client system; and
wherein the text transcription content portion is presented via a an interactive Resources Display GUI at the display of the client system.

8. The system of claim 6 being further operable to:
analyze the source video in order to automatically identify one or more different segments of the source video which match specific characteristics selected from a group consisting of:
voice characteristics relating to voices of different persons speaking in the audio portion of the source video;
image characteristics relating to facial recognition features, color features, object recognition, and/or scene transitions; and
audio characteristics relating to sounds matching a particular frequency, pitch, duration, and/or pattern.

9. The system of claim 6 being further operable to automatically:
analyze the audio portion of the source video to automatically identify different vocal characteristics relating to voices of one or more different persons speaking in the audio portion of the source video; and
identify and associate selected portions of the text transcription with a particular voice identified in the audio portion of the source video.

10. The system of claim 6 being further operable to perform at least one operation selected from a group consisting of:
identify one or more scenes in the digital multimedia package where a selected person's face has been identified in the video content portion of the digital multimedia package;
identify one or more scenes in the digital multimedia package where a selected person's voice has been identified in the audio content portion of the digital multimedia package;
identify one or more scenes in the digital multimedia package where audio characteristics matching a specific pattern or criteria have been identified in the audio content portion of the digital multimedia package;
identify one or more scenes in the digital multimedia package which have been identified as being filmed at a specified geographic location;
identify one or more scenes in the digital multimedia package where image characteristics matching a specific pattern or criteria have been identified in the video content portion of the digital multimedia package.

11. A method for presenting multimedia content comprising:
identifying a digital multimedia package, wherein the digital multimedia package includes: a video content portion, an audio content portion, and a text content portion, wherein the text content portion includes a text transcription content portion representing a transcription of the audio content portion;
causing, at a client system, synchronous presentation of the video content portion, audio content portion, and text transcription content portion;
wherein the synchronous presentation of the video content portion, audio content portion, and text transcription content portion are each maintained in continuous synchronization with each other during playback of the video content portion;
wherein the synchronous presentation of the video content portion, audio content portion, and text transcription content portion are each maintained in continuous synchronization with each other as a user selectively navigates to different scenes of the video content portion;
wherein the video content portion is presented via an interactive Video Player graphical user interface (GUI) at a display of the client system;
wherein the audio content portion is presented via an audio output device at the client system; and
wherein the text transcription content portion is presented via a an interactive Resources Display GUI at the display of the client system.

12. The method of claim 11 further comprising:
causing a first portion of video content corresponding to a first scene to be displayed in the Video Player GUI;
causing a first portion of text transcription content corresponding to the first scene to be displayed in the Resources Display GUI;
wherein the display of the first portion of video content in the Video Player GUI is concurrent with the display of the first portion of text transcription content in the Resources Display GUI;
receiving user input via the Resources Display GUI;
causing, in response to the received user input, the presentation of text displayed in the Resources Display GUI to dynamically scroll to a second portion of the text transcription content corresponding to a second scene; and
causing, in response to the received user input, the presentation of video content displayed in the Video Player GUI to dynamically display a second portion of video content corresponding to the second scene.

13. The method of claim 11 further comprising:
causing a first portion of video content corresponding to a first scene to be displayed in the Video Player GUI, wherein the first portion of the video content is mapped to a first timecode value set;
causing a first portion of text transcription content corresponding to the first scene to be displayed in the Resources Display GUI, wherein the first portion of the text transcription content is mapped to the first timecode value set;
wherein the display of the first portion of video content in the Video Player GUI is concurrent with the display of the first portion of text transcription content in the Resources Display GUI;
receiving user input via the Resources Display GUI;
causing, in response to the received user input, the presentation of text displayed in the Resources Display GUI to dynamically scroll to a second portion of the text transcription content corresponding to a second scene, wherein the second portion of the text transcription content is mapped to a second timecode value set;
causing, in response to the received user input, the presentation of video content displayed in the Video Player GUI to dynamically display a second portion of video content corresponding to the second scene, wherein the second portion of video content is mapped to the second timecode value set; and
wherein the display of the second portion of video content in the Video Player GUI is concurrent with the display of the second portion of text transcription content in the Resources Display GUI.

14. The method of claim 11:
wherein the digital multimedia package further includes timecode synchronization information for use maintaining synchronized presentation of the video content portion, audio content portion, and text transcription content portion.

15. The method of claim 11:
wherein the digital multimedia package further includes: timecode synchronization information and at least one additional resource selected from a group consisting of: metadata, notes, games, drawings, images, diagrams, photos, assessments, documents, slides, documents, photos, games, communication threads, events, URLs, and spreadsheets;
wherein the video content portion comprises a plurality of distinct video segments, each video segment being mapped to a respective timecode of the timecode synchronization information;
wherein the audio content portion comprises a plurality of distinct audio segments, each audio segment being mapped to a respective timecode of the timecode synchronization information;
wherein the text transcription content portion comprises a plurality of distinct text transcription segments, each text transcription segment being mapped to a respective timecode of the timecode synchronization information;
wherein each of the at least one additional resource is being mapped to a respective timecode of the timecode synchronization information;
the method further comprising:
maintain, using at least a portion of the mapped timecode information, presentation synchronization among different portions of content being concurrently displayed at the client system display.

16. A method for automated conversion of a source video into a digital multimedia package, wherein the source video includes video content and audio content, the method comprising:
analyzing the source video for identifying specific properties and characteristics;
automatically generating a text transcription of the source video's audio content using speech processing analysis;
automatically generating synchronization data for use in synchronizing distinct chunks of the text transcription with respective distinct chunks of the video content; and
automatically generating the digital multimedia package, wherein the digital multimedia package includes: a video content portion derived from the source video, an audio content portion derived from the source video, and a text transcription content portion representing a transcription of the audio content portion.

17. The method of claim 16 further comprising:
causing, at a client system, synchronous presentation of the video content portion, audio content portion, and text transcription content portion;
wherein the synchronous presentation of the video content portion, audio content portion, and text transcription content portion are each maintained in continuous synchronization with each other during playback of the video content portion; and
wherein the synchronous presentation of the video content portion, audio content portion, and text transcription content portion are each maintained in continuous synchronization with each other as a user selectively navigates to different scenes of the video content portion;
wherein the video content portion is presented via an interactive Video Player graphical user interface (GUI) at a display of the client system;
wherein the audio content portion is presented via an audio output device at the client system; and
wherein the text transcription content portion is presented via a an interactive Resources Display GUI at the display of the client system.

18. The method of claim 16 further comprising:
analyzing the source video in order to automatically identify one or more different segments of the source video which match specific characteristics selected from a group consisting of:
voice characteristics relating to voices of different persons speaking in the audio portion of the source video;
image characteristics relating to facial recognition features, color features, object recognition, and/or scene transitions; and
audio characteristics relating to sounds matching a particular frequency, pitch, duration, and/or pattern.

19. The method of claim 16 further comprising automatically:
analyzing the audio portion of the source video to automatically identify different vocal characteristics relating to voices of one or more different persons speaking in the audio portion of the source video; and
identifying and associate selected portions of the text transcription with a particular voice identified in the audio portion of the source video.

20. The method of claim 16 further comprising performing at least one operation selected from a group consisting of:
identifying one or more scenes in the digital multimedia package where a selected person's face has been identified in the video content portion of the digital multimedia package;
identifying one or more scenes in the digital multimedia package where a selected person's voice has been identified in the audio content portion of the digital multimedia package;
identifying one or more scenes in the digital multimedia package where audio characteristics matching a specific pattern or criteria have been identified in the audio content portion of the digital multimedia package;
identifying one or more scenes in the digital multimedia package which have been identified as being filmed at a specified geographic location;
identifying one or more scenes in the digital multimedia package where image characteristics matching a specific pattern or criteria have been identified in the video content portion of the digital multimedia package.
